(19) United States
(12) Patent Application Publication
(10) Pub. No.: US 2003/0172205 A1
(43) Pub. Date: Sep. 11, 2003

(54) Methods and components for mechanical computer

(76) Inventor: Richard Henry Bastian, Hayward, CA (US)

Correspondence Address: Richard H. Bastian, 25125 Santa Clara St., #169, Hayward, CA, 94544, US

(21) Appl. No.: 10/043,960

(22) Filed: Jan. 11, 2002

(51) Int. Cl. G06F 3/02

(52) U.S. Cl. 710/45

(57) ABSTRACT

Mechanical data transfer and signal processing systems are described, as internal parts of a complete stand-alone computer. These components for a Mechanical Computer operate under a unifying BUS methodology using a single moving path-differentiated particle for each signal. A binary wheel flip-flop component family and an advanced multi-state component family allows both conventional and highly unconventional uses, including natural decimal BUS operations. At present, all necessary supporting components are anticipated, if not detailed. Some system details are incomplete, such as for exact component interconnection lists, sequencer lists, and host system development software, although use of such internal sequencer lists is taught. A modular or plug-in compatible packaging method is also detailed, which frees the user or experimenter from having to design individual connections.

### BACKGROUND

1. Field of Invention

This invention relates generally to computer logic, and by direct analogy to electronic computer logic and associated support apparatus such as timing clocks, and cabling, and specifically relates to mechanical switching logic for mechanical computer construction.

2. Prior Art References

Regarding the following related U.S. Patents:

| | | | |
|---|---|---|---|
| 6,220,593 | Pierce, et al. | PACHINKO STAND-ALONE GAME also, 5,779,569 | |
| 5,785,573 | Rothbart, et al | KINETIC TOY also, 5,908,343 | 446/171 |
| 5,818,351 | Neubauer | DATA TRANSFER SYSTEM | 340/825.65 |
| 5,700,193 | Van Enschut | VIRTUAL PINBALL GAMES | 463/3 |
| 5,425,643 | Strickland | MECHANICAL . . . TEACHING AID COMPUTER | 434/194 |
| 6,125,358 | Hubbell, et al. | . . . SIMULATION SYSTEM FOR . . . EDUCATION . . . | 706/11 |

The above KINETIC TOY disclosure (referred to as '573 but including all issued) has several elements with similarities to the present invention disclosed herein. Especially noted is a ball operated switch, with physical function resembling the enclosed description on binary logical XOR (exclusive-or) done by mechanical means. This KINETIC TOY ('573) ball operated switch element has left and right exit paths for a rolling ball. The switch moving portion has a centered, vertically attached and up-reaching vane which leans slightly to the left or right, depending on pivotal positioning of the see-saw action moving switch. This ball operated switch in the TOY ('573) has guiding means that are continuous between stationary receiving track-ways and the intermittently rocking pivot-able switch. The guiding means, or track of KINETIC TOY ('573) is for guiding a rolling ball, and is V shaped, and sloped downward, with an open top, similar to traditional open-top water canals or aqueducts.

KINETIC TOY ('573) describes:

1. A ball operated oscillating switch that maintains oscillation for a period of time after the passage of a ball.

2. Operation and set-up on a flat supporting surface (such as a floor.)

3. Vertical and horizontal members assembled for creating a substantial vertical drop, through the elements of the toy, for a track-way guided single rolling ball.

4. Re-cycling of the single rolling ball for repeated dispensing at the top of the TOY.

5. The potential inclusion of unspecified computer software which aids in the hobby or educational use for designs of TOY variations in construction.

However, in response to the disclosures of KINETIC TOY Patent ('573), and all the other current issued KINETIC TOY patents I respond with:

1. The present herein disclosed invention, COMPONENTS FOR MECHANICAL COMPUTER, is based on direct vertically or semi-vertically (slightly diagonal) falling particles, and thus has fully enclosed conduit means.

2. The present disclosed invention, (hereafter as COMPUTER COMPONENTS), is primarily a data transfer BUS, by definition, with various components, such as a BALL OPERATED SWITCH used as interchangeable enabling elements, but with each such enabling element not used as a sole or critical invention enabling element. In other words, this COMPUTER COMPONENTS invention may work perfectly fine using other means of switching than disclosed. For example, the herein disclosed STACKED BASE ONE LEVER DECIMAL REGISTER may have a replacement component in a future Patent application, known as a ROTARY SELECTION SWITCH, where such switch conforms to the definitions of this invention bus. This new switch would have a position-able J-shaped conduit channel responsible for multiple selectable output, according to position, as in a conventional electric rotary switch. At this time of filing, it is not determined how a falling particle or steel ball is to rotate or position this J-shaped commutator. Thus, this in-completely defined BALL OPERATED SWITCH would conform to the input (WRITE) and output (READ) mechanical BUS rules, as herein disclosed, assuming the additional positioning function could be implemented.

3. With some exception, the BALL OPERATED SWITCH of ('573) has an identical structure as earlier products sold in commerce. The exception is that the product to now be discussed, an accumulating RAIN (weather instrument) gauge, has additional frictional or detent means which stops the pivoting rain bucket device on each action in a one-at-a-time see-saw manner. The BALL OPERATED SWITCH of ('573), however, operates in a continuous oscillating see-saw manner until eventually stopped by friction. In addition, the inventors of ('573) apparently added a pendulum means, for causing or extending the time period of this see-saw action for random effects of outcome (direction of issued BALL), and also pointedly caused such pendulum to be highly visible in this see-saw action, for the benefit of viewers of the ('573) KINETIC TOY. The pivoting device of the weather gauge (patent status un-known at this time), has means for guiding rain water down to accumulate by being diverted, either to the left or to the right by the approximately vertical vane of a pivot-able dual bucket, where such vane divides or creates such double bucket. Each cycle of accumulation causes the rain gauge device to fill and then eventually tip, causing water dump, and activating a magnet and sensor as a tilt sensor, thereby causing an electric pulse to be issued. The difference between such tipping bucket rain gauge and KINETIC TOY ('573) is the operation by fluid accumulated and the ('573) operation by weight of a rolling BALL.

Although the use of a falling particle is a key to this COMPUTER COMPONENTS invention disclosure, as a BASE ONE signal (defined herein), it is obvious that the use of such moving material as activator of some kind is highly common in machines today. Therefore, the inventor of this disclosed COMPUTER COMPONENTS invention claims that the use of the tipping bucket rain gauge with a particle activating means, rather than a continuous quantity of liquid is mechanically obvious. (This inventor encountered the tipping bucket rain gauge in 1990.) Furthermore, this inventor claims that the discovery of the use or potential modification of an existing prior-art rain gauge for activation by a falling particle, (or lump-mass), occurred after independent conception of the use of such PARTICLE OPERATED SWITCH. In other words, this inventor of the present COMPUTER COMPONENTS invention had already developed a moving mass OPERATED SWITCH when the existing rain gauge was discovered. The point to be made is that this component, while existing in 1990, did not lead to a mechanical computer components invention, but rather that it was later (1996-2000 time period) that novel data transfer BUS methods were in place to optionally use such switching means.

(Further response to prior-art PATENT ('573):

4. Furthermore, in regard to the ('573) BALL OPERATED SWITCH, it was observed that the PACHINKO GAME, (patent '593), also has a similar BALL OPERATED pivot-type SWITCH, with the PACHINKO device able to freely rotate when hit by a rolling ball. This device has three vanes, and resembles parts of this disclosed invention, specifically the binary toggle switch. The stated purpose of the PACHINKO BALL OPERATED SWITCH was to randomize a falling ball equally into one of two possible rolling paths, to cause an avoidance of wear patterns in the wood surface of the game (or “ruts”.) It was observed by this inventor that the PACHINKO BALL OPERATED SWITCH rotated for several seconds after activated by the force of a passing rolling game ball.

### Inventors Further Response to ('573), and ('593)

In observation of ('573) KINETIC TOY objects of invention it can be stated that no data processing effects or functions have been pointed out in the respective disclosures. It could be stated that the BALL OPERATED SWITCH of ('573) could implement a flip-flop if modified with a detent or frictional stop means. However, operation of this flip-flop would still need to be described, and no means of achieving this operation are mentioned, although it is possible for a human operator to issue such ball and describe such ('573) operation in terms of a computer flip-flop, thus partially demonstrating such flip-flop action. The KINETIC TOY ('573) has no reference to such computer related function in other components either, such as in the ball lifting elevator, a swinging pendulum etc.

In addition, neither the KINETIC TOY, nor the tipping bucket weather gauge have the additional means necessary to utilize such flip-flop action, especially the herein described improvements. The improvements described in this COMPUTER COMPONENTS disclosure, over the rain gauge and some over ('573) include:

1. Means to guide a left and right output, or outlet of such flip-flop like function. (The rain gauge simply has a single water outlet or drain.)

2. Means to non-destructively read the pivoting flip-flop position, without changing such position. (Each rain gauge access will move or toggle it.)

3. Means for constructing tandem or parallel multiples of such reading paths. (Rain gauge has only one path for the water activating material.) This is the BUS SWITCH component of this COMPUTER COMPONENTS invention.

4. Means to effectively and practically connect and use such flip-flop action. This is a gray area, related to the useful properties of this mechanical COMPUTER COMPONENTS invention. It could be argued that this invention disclosure provides enough information to visualize an entire, working computer, if not describing all details. Without this expectation, of a full system, the useful qualities of this invention are more limited. It could be argued that a most key enabling component of this invention is the sequencer, which enables full operation of the mechanical COMPUTER COMPONENTS in any sub-system.

5. An improved sequencer component was designed, which has toggle means on only one side. Cascades of such devices can be constructed to make a re-entrant sequencer which commutates each new signal to an ordered sequence of outputs.

6. An improvement was made by connecting commutating switches to operate the discrete BUS data transfer system. The novel multi-state decimal BUS of this invention disclosure goes far beyond the rolling ball display of KINETIC TOY ('573.)

7. Construction and operation of the so-called ROM-CORE is also far beyond the reach of ('573.)

8. Teaching assisting means is provided. This invention provides methods for constructing and operating semi-automatic devices which simplify the task of a teacher or machine demonstrator. An above referenced invention, TEACHING AID . . . (U.S. Pat. No. 5,425,643), displays much of the spirit and forethought needed for a classroom computer training system.

### Prior Art in Regards to Positional Encoding of a Signal

1. It is to be noted that many machines use multiple parallel paths to convey information, according to a singular activator. One example is a conventional coin sorter which splits coins according to value and which eventually causes a position encoded action in one of many vertical paths or compartments. This position encoded moving object may then be distinctly sensed and reported, sometimes as a pay-out.

2. Relating to the positional encoded BUS of this invention, it is known that there was a system in PUNA, INDIA which used steel balls to convey data at a distance, where such data constituted gambling-related wagers and pay-offs, and such steel balls roll on tracks connecting gamblers with a central office. This could be termed as a BALL-SEMAPHORE information transmission system. This inventor does not have more information on this system at this time.

3. Another positional encoded example could be made of conventional PINBALL games, where such games typically place great importance on the horizontal position or path of motion, of a rolling BALL.

A good test for useful data storage and transfer is with how closely related the forms are, between input and output. The above prior-art references have well defined actuation forms, that is such things as pinball pay-out lanes, but none of the prior-art meets the reverse symmetric criteria. For example, to perform useful computer data storage and later read-out in logically compatible, if not identical forms, a pinball game would need to have a feature as follows:

A row of pinball pay-out lanes would have a feature where a previous pay-out ball could have caused a latching action, where such latching would affect an upper game ball deflector. This upper deflector position would then affect a future, or next ball, such that an identical lane is selected. In other words, a sort-of backwards process or reversal is at work, creating or re-creating the original signal or cause (relative position of rolling pinball), from the effect (the latching of a distinct pay-out lane.) This functional symmetry was not observed in any of the above referenced prior-art, but is present in the current invention (the digit register device.)

Concerning my invention disclosure, in a very briefest sense, the discrete impulse BUS could be said to consist not exactly of data, but rather of discrete activation signals. These activation signals, called a WRITE BUS, are in the exact form needed to cause a remotely connected device to assume or be changed to the newly transmitted state. A useful feature of this discrete impulse BUS is that symmetrical READ/WRITE devices can be constructed which not only accept a multi-state input set, from a WRITE BUS, but which also will accept a single READ impulse and convert such impulse into a multi-state READ BUS output set. This so-called READ BUS output is literally another WRITE BUS.

Concerning the above referenced DATA TRANSFER SYSTEM, (U.S. Pat. No. 5,818,351), there is some similarity to the BUS SWITCH presented in multiple connections in this invention disclosure, in one limited sense. The prior-art electronic DATA TRANSFER SYSTEM ('351), appears to have multiple cascaded commutating switches, with a feature where any particular switch can enter a transparent mode, where a controlling means can then serially select which of a chain of switch devices is accessed. The mechanical multiplexed BUS SWITCH of my invention can be connected such that once it is positioned it can enter a data-transparent mode where subsequent impulses simply flow through an established path through the device.

Concerning the above referenced VIRTUAL PINBALL GAME (U.S. Pat. No. 5,700,193), there were only minor similarities, with ('193) mostly helpful in providing some terminology relating to machines with freely moving parts (i.e. lanes in a pinball computer.) Concerning the above referenced SIMULATION SYSTEM . . . FOR EDUCATION . . . (U.S. Pat. No. 6,125,358), Hubbell, et al., as in the mechanical teaching aid computer, ('643), this prior-art patent also shows much of the spirit and forethought to teaching aspects and details of presentation and interactivity with students, although differing technically.

### MORE BACKGROUND

### Early and Recent Prior Art

In 1971, the first programmable microprocessor was sold, the Intel 4004. By about 1990, technology for true, single-chip computers had matured, enabling development of products by medium sized businesses and universities. Increasingly, the capabilities of the microprocessor device, or actually more correctly termed micro-controller, have not expanded nearly so much as the support services and products that help machine designers produce a useful product.

To show this trend towards easier development of micro-controller based products are the following three examples:

### 1971-1980

Intel 4004, 8008, 8080 chips become available, with some hardware support design required, and firmware development on a VAX mini-computer or other expensive host system. Costs to develop could be from 1 to 4 million dollars.

### 1990

Intel, NEC, Hitachi, Motorola, and others, all have microprocessor chips available, and usually provide development support and compilers that run on a personal computer (PC). Development tools become available with some very high quality and low cost products for hobby and experimenters, with costs of under $10,000 (ten thousand dollars).

It should be noted that this discussion is about the microprocessor type of device, as opposed to the central processing unit chip used in a personal computer (PC). A microprocessor or micro-controller is usually seen as an embedded controller with a limited amount of ROM (Read Only Memory), although this distinction is becoming increasingly blurred.

By 1999, an individual hobbyist/experimenter could choose from a variety of micro-code program development kits of high quality and affordability. Truly, it is these program development systems that exhibit the maturity of the marketplace, rather than the price of any single chip device. Perhaps even more important, a large body of expertise and enthusiasm for microprocessor software and firmware development now exists world-wide.

Although these trends ease and diversify the activities of experimenter programming, one aspect that remains out of reach involves internal microprocessor functions. Each microprocessor type is still manufactured in a standardized form and with standard internal/external workings. Thus a developer of software for a processing chip, the Intel 8048 for example, cannot make any change or improvement in internal register, bus function, or instruction definition, as these are usually built into the integrated circuit (IC) wafer or die itself.

Of course, special arrangements and short manufacturing runs can be done, but are expensive. Perhaps, then, it is this idea of specific internal accessibility that leads some experimenters to become fans of the early history of mechanical computing. They study the work of Charles Babbage, and the more recent work of Konrad Zuse.

Conversely to today's trends, having a compiler/assembler and other services such as CAD/CAM (computer assisted drawing) would probably have been a welcome sight by the likes of Babbage. This lack of development support in the early days of mechanical computers had un-seen costs as hand assembly of programs is tedious and error-prone. Also unavailable were the various epoxies, plastics, and plastic molding processes which now make construction of a mechanical computer much easier.

### Prior Art and Today's Tech Museums

Today, many museums feature simulated computer components that are super-enlarged such as a hard disk drive unit that is a whole room. An interactive feel is encouraged by having museum visitors walk through such enclosures, which also sometimes feature lines of colored lights which simulate a data bus.

These technology museums will often offer various other displays which better show or teach mechanics or physics. Using swinging pendulums, turning gears, air pressure, acoustical tricks, optical tricks, and other effects, these displays can be more engaging than the nearby computer black box assemblage emblazoned with the words “COMPUTER FLIP-FLOP”. Museums and classrooms could therefore benefit by increasing audience interactivity, especially if computer functionality can be directly demonstrated.

### SUMMARY

In the flow-path computer a steel ball is dropped, which constitutes a clock bit, and the ball then proceeds to fall through a series of conduits, paths, and physically interactive actuations which as a whole represents a process thread.

As analogous with electronics, this thread or increment of processing is defined by the application and so can have a wide or narrow scope such as;

1. An elemental process thread of flipping one bit;

2. A multi-step process thread of clocking a four bit counter;

3. A multi-step process thread of data transmission and subsequent reception;

As seen above, the familiar “black box” approach can be applied to define a thread. Also, a thread may contain a series of more primitive threads. In the black box perspective this thread is a time sequential series of discrete activities starting at the top of the black box, running through it, and then exiting at the bottom. An interesting feature of this invention of mechanical computing components is the use of this falling steel ball, or other particle. This singular moving object corresponds exactly with the highly abstract token concept, where in a board game a physical token is incremented to hold a current place in relation to time. In computing a token can be stored in a program counter (PC register) or can be a line number or label for a higher level language.

In this mechanical computer the falling steel ball is literally a physical token or place holder by its sheer physical presence. In the present embodiment this impulse (or mass pulse) usually represents a lowest level token, such as for the physical progress of a signal through multiple physical processes. For example, in implementation of XOR logic a falling particle (which is shorthand for steel ball or other objects), can start as a control, flow down through a logic gate, and emerge as a resolved answer. Then this resolved answer, usually position encoded for each possible result, can then be guided down to write to a latching register, which is yet another process.

### OBJECTS AND ADVANTAGES

One of the earliest objects of the present invention involved the accomplishment of a falling particle array computer which used collisions to achieve multiple Boolean process outcomes, with such multiple processes inspired by the array mathematics used for signal and image processing. For example, the presence of both bits (or falling particles) A, and B, directed to fall simultaneously and precisely diagonally, could cause a collision, then causing deflection to a collector for output. The output could be used as a Boolean logical AND-TRUE indicator. Otherwise, other collectors in various positions relative to the collision paths could indicate various other Boolean possibilities such as logical AND-NOT-TRUE (meaning that both particles were not simultaneously present). Obviously, a Boolean logical OR can be implemented in simple fashion, using simple Y conflux combiners of two or more downward directed hoses, resembling the plumbing of water drain pipes.

In this invention, the present embodiment uses a singular moving particle for processing and for the transfer of data. The collision mechanisms envisioned for using particle pairs for a Boolean A, B logical pair (or operands), have been re-designed to apply to the interactive logic implemented using one moving or falling particle and one pivoting mechanically interactive element. The mechanical element is designed to either or both be actuated on or actuate as the moving particle passes near, is deflected, or has a collision with parts of the mechanical element.

In effect, direct particle pair collision interactivity is now expressed indirectly logically in multiple half-interactions. For example, in the Binary Wheel invention a first particle can be used as data to position a pivoting wheel, thereby taking on or saving an image of the data bit which flowed through. The second particle can then later be made to read the wheel in such a way that a Boolean logical AND is resolved.

Another early object of the invention was the implementation of a microprocessor that was almost totally decimal, that is on the signal or physical level rather than using binary coded logic. This was for various reasons, including the inherent obscure nature of the binary math and the need to describe large memory blocks and locations using such conventional binary representations. Even more interesting was the quest for an arithmetic logic system (or ALU) that used fundamentally different and novel input and output bus definitions to represent the desired decimal inputs and outputs along with the internal decimal calculations, such as addition and subtraction. Another complementary invention object was to gain the ability to access a microprocessor internal instruction set for various alterations of function, which allows for individual experimentation and implementations of favored or custom instructions. Both of these goals, however, were apparently distant ones, at least until a suitable platform for these fundamental system variations came into existence. In a way, the early system concept was of a novel bus, but one that was wanting of suitable devices or functional elements.

The appearance of the mechanical subsystem element inventions ended the dormancy of the above ideas for decimal operation with individually varied instruction sets. The binary wheel invention, with the attendant new features of separate read-only and write-only functions made a practical or interface-ready mechanical flip-flop possible. Most importantly, this binary or two state wheel invention was a driving force for the further inventions of multiple state bus operation, through the binary simulation (or emulation) of decimal logic, beyond BCD (or binary coded decimal digits.) In other words, the emulation of natural decimal operation external to the binary wheel device then allowed the practical development of the discrete signal bus definitions of this invention. After this functional or bus methodology was in place a further invention, of the stacked lever arrays, provided a device family which is naturally suited to interfacing such novel bus means and storing naturally compatible multiple state (or digit) data. This is a decimal digit, or numeral, in base ten but stacked lever devices can also be configured for any other base, such as base, or radix five. For example if control logic has five variations of output a stacked lever device can be operated for input, storage, and output of such a digit, in the range of 0 through 4.

The Binary Wheel invention with the falling particle method of data transmission or circulation helped to expand progress towards the above objects by the embodiment of what was given an early term of PN bus, which turned out to be an early forerunner of the discrete bus of the present invention. The PN bus is essentially identical to the S-R signals of a Set-Reset flip flop (in electronics), at least logically. In electronics, the PN bus was to work by always asserting one or the other of the two logical signals, with the P, or positive assertion representing a one, and the N or negated assertion representing a zero, to be determined by conventional static digital voltage levels. This is also seen in some conventional digital circuits that output both polarities of signal, Q and Q-NOT. As a result of using two signals for each binary bit using conventional powers of two representation a four bit logical bus would then physically have eight signals, Q and Q-not for each of the four bits.

The first break from the binary coded, or two-state logic world came with an early version of this theoretical speculation on novel electronic ALU logic. The design concept had a decimal input/output bus with ten PN signals for a total of 20 wires. The work with the mechanical computer components cleared up this concept by reducing the bus design to 10 lines, operated under mutual exclusion. Thus the concept of asserting a multi-state integer on the bus became closer to practical application.

The advantage to be gained is the facilitation of an approach of processing by bus (or by connection). For example, simply reversing or crossing a two signal PN bus creates a logical invert function. To create a logical AND function on two operands, each operand P signal (Q TRUE) must be AND'ed to create a P result, and each N signal (Q-NOT) must OR'ed to create an N result. This logical processing to create a result compatible with the PN concept is interesting because the logical OR is accomplished using only bus connections. This disclosure will show how the logical AND process can be accomplished using the Binary Wheel or flip flop invention. (Refer to the BINARY section.)

In the mechanical computing components, these PN bus goals or objects could be naturally attained, due to the impulsive (or mass-pulse) nature of the moving particle signal. Also, as will be seen in this specification, the Binary Wheel invention provides all the logical processing needed to implement a complete binary computer. Actually, it turns out that the early PN bus ideas represented the discrete bus functionality, that is the N term is literally the integer value of zero and the P term is literally the integer value of one. As these concepts of processing by bus were developed it became apparent that the concept is really one of operation in BASE ONE, with the ability to also represent any other number base (also called radix base) by simple concatenation of multiple base one signals. Thus, the PN bus concept can be used to create a computer bus that operates in decimal on the physical or signal level.

On a last note on the various versions of mechanical logic, an advantage of the impulsive or moving particle nature of the signal transmission is that the signal itself is a direct actuator, that is it can be usefully applied to directly cause a desired action. Thus a transmitted integer, such as the digit numeral 3 for example, when sent into a storage register or other device does not have to be converted or processed to produce an internal actuation effect, as it is already in such a form.

In keeping with the above invention objects, a brief list of advantages is now listed:

For both system types, binary or multiple state there is the advantage that an impulse is self-clocking, in that logic can be operated (by a sequencing means) in a send-and-forget manner, assuming that any path switches are not altered until the moving particle has passed through. This opens the door to application of various multiple processing thread schemes.

### Advantages of Binary Computer 100 CM-1

### CM-1 Comprises the Invention Alternate Embodiment

Binary flip flop device 400 can provide static data storage, integral switching, pulse separation sequencing and arithmetic logic unit (ALU) functions in a visible and observable manner, assuming transparent construction materials are used.

Conceptual minimal computer 100, processor CM-1, with a simple sequencing instruction set with 28 instructions will be described. Readers with skills in the relevant arts should understand every significant aspect of subsystem construction and operation. A student, teacher, or demonstrator can activate the performance of instructions and data transfers for observation.

### Advantages for the Second Generation Decimal Computer 200 CM-2

The CM-2 computer 200 is the more advanced system, the preferred embodiment of this invention, along with preferred discrete integer bus operation methodology. It could be said that conventional binary representation has a processing disadvantage in that all bits of a number representation must always be considered as a set. Thus a binary number system provides easy means for multiplication by powers of two by way of shifted bus connections, thus processing by bus rather than active logic, but must have active logic means to accomplish addition of any binary encoded numbers. The discrete bus feature of this invention allows simple left or right shifts of the bus to accomplish addition and subtraction respectively. In addition, the discrete bus has by nature the advantage that each integer state is exposed or un-coded. In addition, as will be seen, a process sequencer or control source can issue or transmit any particular integer to a ten line decimal bus using only one connection directly from a ROM or Read-only memory, to the desired integer signal line (or conduit in the case of the Mechanical Computer.)

An improved instruction and bus supervisor sequencer for decimal signal operation is described, along with the CM-2 internal topology and instruction set.

A demonstrator of CM-2 machine type multiplexed digital transmissions, and of decimal signal bus data transfer operations, is described. Hour-Glass demonstrator 300 can be used as a good warm-up or starting demonstrator because it can be fully taught so that audience members can get a quick sense of completion in understanding.

A smaller demonstrator of decimal digit storage teaches operation of the discrete signal bus for decimal data transfers and processing. Multi-state read-out module 720 is described.

Advantages of application of these various subsystems and components:

Motivation of students.

Facilitation of experimentation.

Operation in binary, with many conventional features.

Novel operation in decimal, if desired, and with no binary, if desired.

Relaxation, entertainment, and amusement for engineers and scientists.

Potential to build very large, for museums and other displays.

Demonstration of difficult to understand lowest level of functions.

### BRIEF DESCRIPTION OF DRAWINGS

Introduction and Orientation;

FIG. 1 is the CM-2 Decimal Mechanical Computer (preferred embodiment)

FIG. 2 is orientation blocks to this disclosure of the Mechanical Computer Components invention. (Ranging from elements to complete systems.)

FIG. 3a is a Binary Mechanical Computer 100 Experimenter KIT, generic name CM-1.

FIG. 3b is a partial exploded view of the CM-1 Computer 100.

FIG. 4 is the READ-UP Semaphore device.

FIG. 5 is the five main modules, or pods.

FIG. 6 is a close-up of the register card cage mounting inside the register pod.

FIG. 7a is the particle conveyor belt elevator unit.

FIG. 7b is the assembly of four such elevator modules, for attachment to the CM-1 frame.

FIG. 8 is a system block diagram of the CM-1 system

FIG. 9 is a system block diagram of the CM-2 system

FIG. 10 is a view of the CM-2 machine, (former FIG. 1), for comparison with FIG. 9

FIG. 11a is an introductory view of Decimal Digit Register 700

FIG. 11b is a partial register interior view

FIG. 11c is a novel register schematic symbol

FIG. 12 is grid plate material (801)

FIG. 13a is output indicator table-top register 720

FIG. 13b is an internal view of register 720

FIG. 13c is a close up of the WRITE section shafts and tabs

FIG. 14a is a package connection foot-print of register 720

FIG. 14b is a package connection foot-print of register 700

FIG. 15 is a side-view internal schematic flow diagram of the multi-state register 720

FIG. 16a shows precise element construction (for the WRITE section)

FIG. 16b shows precise element construction (for the READ section)

FIG. 17 is a schematic for a register to register data transfer

FIG. 18a is experimenter's rig 250

FIG. 18b shows BUS processor 780

FIG. 19a shows an example BUS processor for dividing by two and rounding

FIG. 19b shows an example BUS processor for dividing and truncating

FIG. 20a is an interchangeable conduit positioning CORE for processing Y=SINC (X)

FIG. 20b is an integer or whole number graph of the trigonometric function Y=SINC (X)

FIG. 20c is a free-fall processor of Y=SINC (X)

FIG. 21a is a FIFO data buffer arrangement

FIG. 21b is a means for the READ and clear function element

FIG. 21c is a READ and clear BUS sequencer

FIG. 21d is a schematic of a BUS sequencer

FIG. 22a is a fully position-able BUS SWITCH element

FIG. 22b is a compact BUS SWITCH element or stage

FIG. 22c is a BUS SWITCH internal parts view

FIG. 22d is a novel device schematic with switch 840 and register 700

FIG. 23a is a package or housing view of the BUS SWITCH 840 module

FIG. 23b is a right side engineering view of BUS SWITCH 840

FIG. 23c is the selection pen details

FIG. 23d is a bottom view of BUS SWITCH 840

FIG. 23e is a perspective view of the first back grid plate (for output)

FIG. 24a is a digit storage module, POD 230

FIG. 24b is BUS combiner 880

FIG. 25a is a digit storage sub-system, having 30 digits

FIG. 25b is a package foot-print detailing the BUS switch 840 component

FIG. 26a is a WIDE-BUS look-up table processor, with MUX-BUS interface

FIG. 26b introduces the encoder 860 of the look-up table processor

FIG. 26c is a stack of two processors, MUX-BUS plug connected

FIG. 26d is three separate MUX-BUS connected processors, stacked serially

FIGS. 27, a, b, c, and d are a-joined sections of a system schematic of CM-2

FIG. 28 shows enclosure segment plans for internal BUS SWITCH device locations

FIG. 29a shows an automatic INCREMENT working register arrangement

FIG. 29b shows an automatic DECREMENT working register arrangement

FIG. 29c has details of a practical MUX-BUS WORKING REGISTER

FIG. 29d shows a BUS sequencer housing, for controlling the WR block in FIG. 27b

FIG. 30 is the system processor carry flag, and carry propagator

FIGS. 31a, b, and c are a-joined, showing upper supervisor and instruction sequencers:

FIG. 31a shows CM-2 clock and BUS live signal supervisor sequencer details

FIG. 31b shows a CM-2 program counter and ROM-CORE program rack frame

FIG. 31c shows CM-2 ROM-CORE instruction capture and execution switches

### Wide Bus

FIG. 32 is a finished version embodiment DEMO machine showing a teacher or presenter

FIG. 33a is a view of the DEMO HOURGLASS 300 machine and references

FIG. 33b is the DEMO WIDE-BUS FREE FALL machine

FIG. 34 has close-up details of DEMO machine components and conduits

### Binary Section

FIG. 35 is an external view of flip-flop 400 and connections

FIG. 36A is flip-flop 400

FIG. 36B shows a connector, a conduit, and a steel ball

FIG. 36C is the internal flip-flop pivoting wheel

FIG. 36D is pivoting wheel alternate position

FIG. 36E is exploded internal view of flip-flop 400

FIG. 36F is a flow model of flip-flop 400

FIG. 37A is section view of flip-flop 400

FIG. 37B is one plastic molded half of flip-flop 400

FIG. 37C shows wheel placement internally

FIG. 38A is a sectional view, with active SET action

FIG. 38B is a sectional view, with passive SET action

FIG. 39 is a sectional view, with data ZERO reading action

FIG. 40 is a sectional view, with SET-TOGGLE action

FIG. 41 is a set of different schematics, for different flip-flop devices

FIG. 42A is an experimenter's rig for data transfer (double-sided)

FIG. 42B is a rig for single-sided data transfer

FIG. 42C shows equivalent schematics to the previous two figures

FIG. 43A shows how two flip-flops are connected, for consolidation into one module

FIG. 43B is a schematic of the previous figure

FIG. 44 is a schematic of integrated four-bit module 600

### DESCRIPTION OF MECHANICAL COMPUTER COMPONENTS

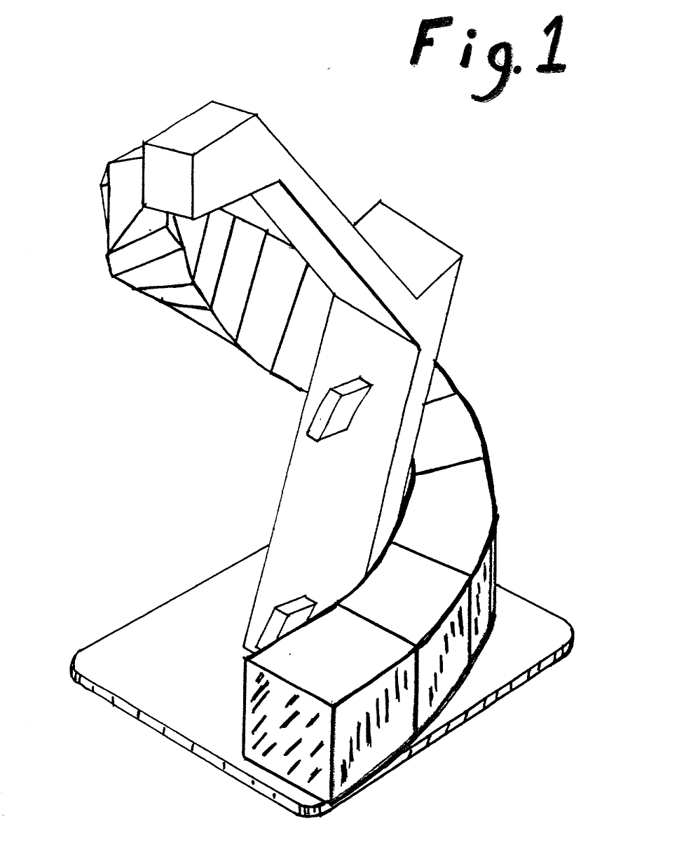

FIG. 1 is an introductory view of the preferred embodied computer machine, generically labeled CM-2. This introductory view will be covered in detail later.

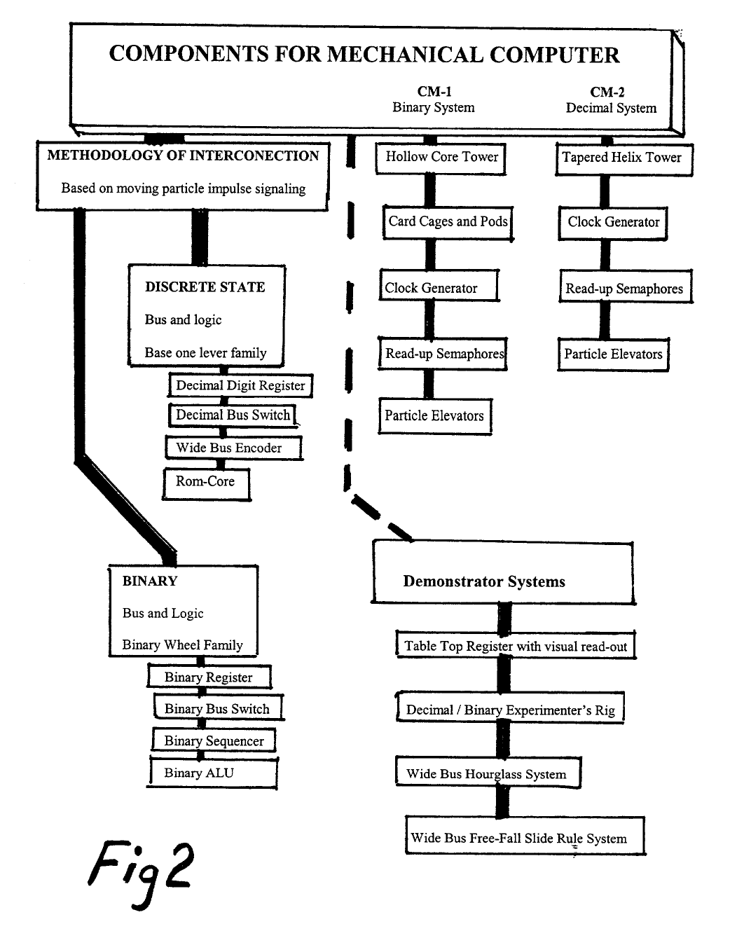

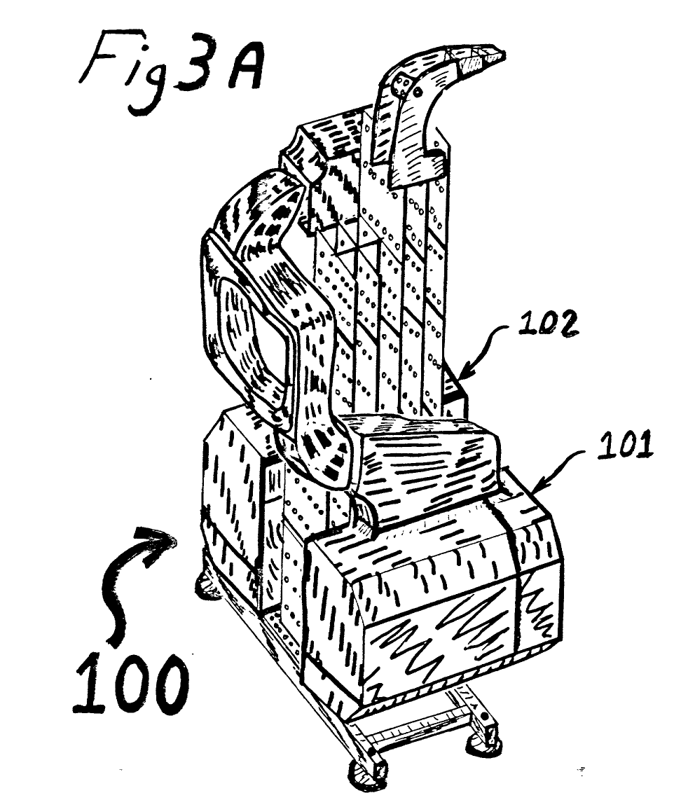

FIG. 2 is an orientation diagram showing major blocks of topics and groupings, in three major topics;

1. The major topics, (or preferred embodiment) of these inventions of mechanical computer components is the pulsed bus operation with optional decimal on the lowest physical signal level. This is the most advanced generation preferred embodiment conceptual machine referred to generically as CM-2.

2. A second topic, (or alternate embodiment), perhaps deserving of equal attention, covers devices and pulsed bus operation of the mechanical computer for conventional binary coded numerical processing results. This is the alternative embodiment conceptual machine CM-1.

3. A third topic, quite novel, involves uses of a large bus, such as the wide bus hour-glass digital demonstrator with a 100 line discrete integer bus, and other concepts such an analog free-fall bus which operates and interfaces digitally. This third topic is extremely novel and has several uses for large public displays and computer demonstrations.

### Quick Preview of Decimal Computing Machine

This disclosure relates to an entire computing system and thus necessarily has a high volume of detail. Although all due efforts were extended to be concise, some readers, overwhelmed by a sheer volume of details, can skip forward to get a best glimpse of the CM-2 mechanical computer. The present, best embodiment of a register file system and controller and the closely associated decimal instruction set can be seen in the system diagram view of FIG. 27 and the instruction set, TABLE 8 (ahead of this current discussion.)

The current block diagram of FIG. 2 can be consulted as needed to understand this specification. It is better that the readers of this specification be well versed in electronics and microprocessor internal design and not so skilled in mechanical comprehension than the reverse. A reader with a highly developed background with mechanical devices may have trouble understanding the conventional digital processes that are heavily used in analogous forms.

Therefore the following questions are indicative of the comprehension needed for reasonable understanding of the implementation of the mechanical computer. On the other hand, while this document does not attempt to teach microprocessors the intent is to create a family of mechanical machines that do facilitate such understanding.

### Relevent Questions

### For Any General Computer

1. How is the computer powered? (Commonly, this is electric power.)

2. How is it clocked?

3. How does it control an instruction, including all details of fetch, decode and sequencing?

4. How does it accomplish selection of multiple locations using an address?

5. What register and memory resources are provided?

6. What input and output, or interfacing does it do?

7. How does it pass data between these sub-systems of registers, memory, and external interfaces?

8. What program flow control mechanisms does it have? (Such as skips, branches, and interrupts.)

9. How does it accomplish a set of ALU or arithmetic logic functions?

10. What speeds can be expected?

11. What special accommodations are made for experimenters and for teaching?

12. Are there any unique social aspects or implications?

### Technical Terms Used in this Specification

Impulse Signal—a reference to a moving steel ball as an actuator.

Discrete State Bus—a bus which operates with mutually exclusive, or one at a time signaling.

Conventional binary bus—a mechanical bus which, although operating in the same physically novel way as the discrete bus, has results which logically emulate on/off binary operation and have the same multiple parallel binary powers of two number representations.

Stackable base one lever—a pivoting assembly with long shaft and attached lever tabs, with the shaft mounted in a suitable housing or housing segment containing stationary guiding or conduit means.

Decimal digit register—a module built from ten stacked lever elements.

Decimal-plus register—an optional chainable version which has a NIL output for simple implementation of multiple bus transfers (as in a FIFO or first in first out data buffer).

Bus Switch Element—an expanded size flip flop device which switches multiple lines at once or in tandem, to one of two BUS outputs, or also a base one lever type element, usually for switching or commutating an entire bus including associated control lines.

Bus Switch Module—a toaster sized assembly of multiple bus switch elements of modular construction and generally for switching an entire bus to multiple outputs sets of such entire bus. Also considered a path switch. Under this invention disclosure there is a Binary and a Decimal Bus Switch type, each with a standardized or consistent interface definition.

Signal Pulse Separator—a device which conducts a first impulse to a first output and then switches (or pivots mechanically) to cause any subsequent pulses to be commutated to a second (or chain) output.

Bus de-multiplexer—also called BUS Signal Pulse Separator, the multiple input (or bus) device will separate a first pulse from subsequent pulses, with the separation action being for a whole bus. In the more conventional binary system, each of these cascaded devices must be switched to transparent mode by an interim control impulse, between each data cycle. In the decimal system, however, the passage of the data impulse itself also will cause each stage in a cascade of BUS switch elements to auto-switch, or self-clock.

Bus Encoder—a relatively large module with multiple sections, each of which is an encoder, and which can extract a low digit from a bus signal passing through, where the bus signal is of a higher number base, or radix, (such as base 100) and the outputs are of a lower base (base 10).

BUS Combiner—an assembly of multiple Y shaped conduits, each having multiple inputs and a single, combined output. Each such Y combiner combines like terms, so that each of a multiple of BUS sources has each like term connected to the same Y combiner. In the binary systems each of these like terms is a binary weighted bit. In the decimal systems each of these like BUS terms is a discrete integer signal. The BUS combiner takes a number of BUSSES and produces one BUS.

Decade Combiner—similar to the above BUS combiner, the decade combiner is the same assembly of multiple Y shaped conduits, each having multiple inputs, but connected for combining each signal within each BUS to produce a decade output signal BUS. When ten busses are related in this way, the Y combiner produces a ten signal BUS output that represents each of the decades, from 0 through 99, and that is literally a divide by ten function. It could be said that this decade combiner is connected in an x,y transposed manner, compared with the above BUS combiner. This relates to one possible spatial organization of BUS conduits where there are ten BUSSES arranged in rows, with each of the ten defined signals in columns.

Binary Style Mechanical Computer Frame—(CM-1) a term loosely used to describe a computer with certain options and design decisions of a binary logic family.

Decimal Style Mechanical Computer Frame—(CM-2) a term loosely used to describe a computer with decimal logic devices and a novel decimal BUS, and also encompasses certain design options and machine enclosure (i.e. second generation mechanical computer.)

### Introductory Description, Part I

### The CM-1 Mechanical Computer

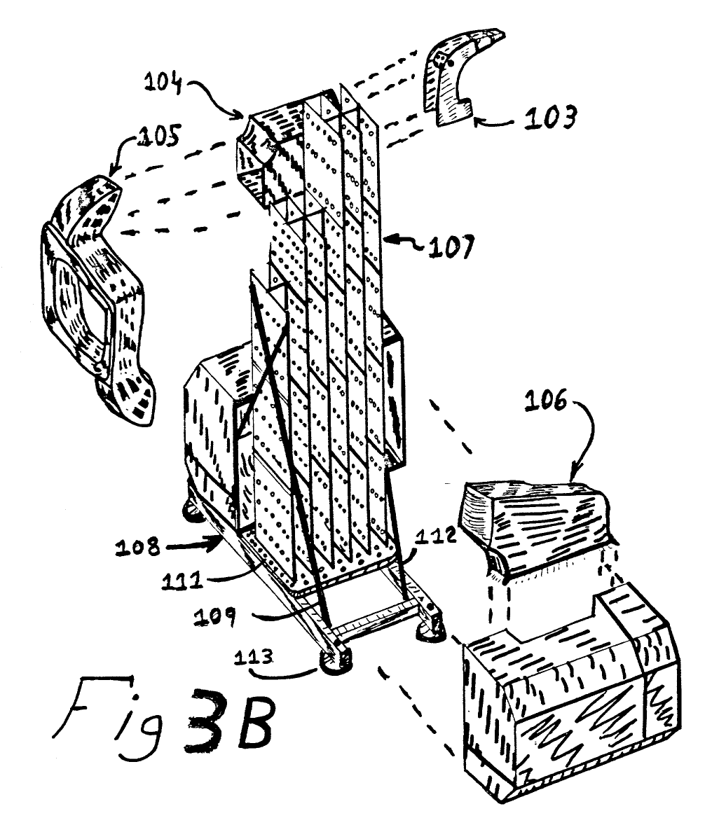

In FIG. 3A and FIG. 3B are views of complete stand-alone Mechanical Computer System 100 with the generic model name of CM-1, which is a short name for Computing Mechanically, version 1. This system oriented portion of this disclosure provides as much details on conceptual design as are available, and provides a valuable context in which to understand the usefulness of the claimed areas of the invention.

Stand-alone Binary Mechanical Computer System 100 is a binary computer in a form familiar to many programmers of electronic computers. Parts of this form are to be considered as prior art, such as the basic sequencing instruction program and the use of a register set. Many features, however, are novel and apply only to the use of mechanical logic to implement familiar processing/computing. This will become apparent in this description.

This Computer System 100 has a four and eight bit bus structure for data and signaling. There are sixteen special purpose registers and sixteen general purpose registers. These mechanical registers are contained in Register Pod 101, and are used as a LOW BANK (address 0 through 15), and a HIGH BANK (address 16 through 31). Programmers of four and eight bit binary computers will recognize this familiar addressing structure as having five bits embedded within an instruction to specify a desired register.

A bank bit selects between HIGH or LOW bank, and four bits are used to encode the selection of one of sixteen registers for the function specified in an instruction. It will be useful later to compare this CM-1 binary system 100 with the decimal system (CM-2). The general description in part 1, here, is for a binary structure throughout the CM-1 system 100.

In Memory Pod 102 are contained integrated mechanical memory modules which have a total of 256 words for program and data storage. Memory Pod 102 and Register Pod 101 are left and right symmetrical mirrors in appearance.

The Binary Computer or Mechanical Computer System 100 stands in the approximate floor space and volume of two side-by-side rack mount enclosures of the electronic industry standard. This is roughly an order of 2 meters height by 1 meter wide by 1 meter depth. (Actually, 230 mm Height×82 mm Width×56 mm Depth, or 90 inches Height×32 inches Width×22 inches Depth).

The Mechanical Computer System 100 uses a nominal 100 watts of electric power. Common 12 volt DC converters power each of the small motors used, at a nominal 850 mA (milli-amperes). In FIG. 3B is shown stand 108 containing these miscellaneous power supplies (supplies and gear motors not shown.) The particle (or ball) elevators mount to the back of tower 107, but are omitted here for clarity.

### Hollow Core Tower Construction

FIG. 3B has Hollow Core Tower 107 which runs the whole vertical height of the computer. The tower is constructed of upright rigid sheet material that has an array of numerous pre-drilled, un-committed holes, which can be used for attaching 2 or 3 mm approximate sized, or light-duty machine screws (or the English system as #4 or #6 machine screws) in the mounting of various devices. This reflects the kit form of CM-1, which allows an experimenter to use variations of mechanical processing devices. The Tower 107 is constructed in five segments, which allows variations on the system height for other designs, which can result from experimentation with the system design and features.

Each of the first three segments, starting from stand 108 are approximately 50 mm (19 inches) in height, and have five vertical bays on each side. The bays result from the I-BEAM like bonding of the sheet material to form each bay, which is a three sided vertical shaft. The next tower segment, the fourth, is approximately 30 mm (12 inches) in height, and has four vertical bays on each side.

The final, top, tower segment is again 50 mm (19 inches) in height and is customized for the mounting of Clock module 103. Many details are omitted in order to prioritize this introduction to the system.

The Hollow Core Tower 107 is well braced and bears the weight of the various attached pod enclosures. Right front diagonal brace 109 is shown intersecting across the left front diagonal brace 110, with both attached to the front plate of tower 107. The tower must be sufficiently strong and adjustable so that each of the pods (enclosures) are supported for operation in an upright position.

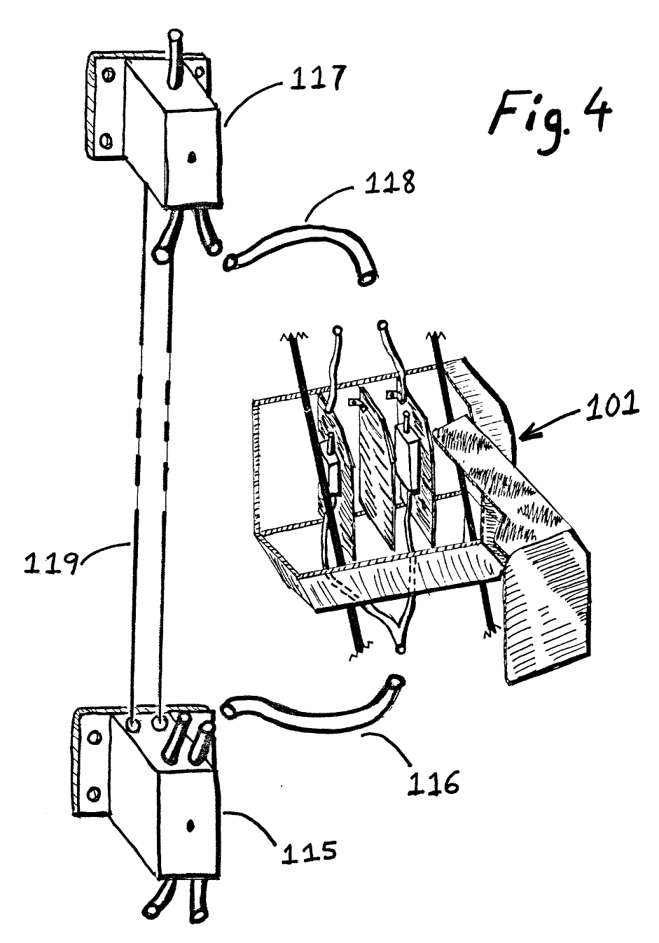

Even more critical, the tower must not flex or bend. Semaphore devices, mounted in the vertical bays, have tensioned signaling lines which run the length of tower 107 and so must not change in separation distance or a malfunction will result. For later discussion in this section, FIG. 4 shows these novel semaphore devices.

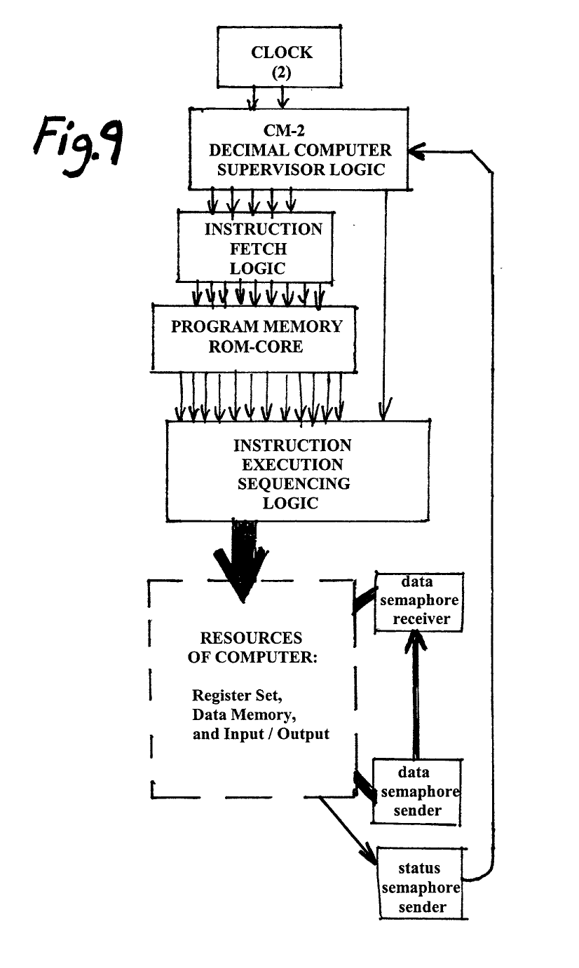

In FIG. 3b are also seen base connector plate 111 and right rear diagonal brace 112, which contribute to the required tower strength. Each foot attached to stand 108, such as adjustable right front foot 113, can be adjusted for overall machine stability and vertical alignment. For clarity, some features not shown are additional smaller braces, both diagonal and upright, and various connecting hardware by which the five tower segments are secured to each other. Later, particle elevator sub-system 123 will be described (FIG. 7). The views in FIG. 3a and 3b omit the elevator in order to clearly show more important elements of CM-1, Mechanical Computer System 100.

### Read-up Semaphore Devices

### FIG. 4

A read-up semaphore is a term for a device consisting of paired shafts, usually as a lower, sender shaft and an upper receiver shaft with connecting tension lines or a belt. Operation is intended to be bi-stable, assuming one of two possible pivotal positions, with nominal angular travel or rotating arc of 40 degrees between resting positions. The two tension lines are driven in a see-saw fashion, so that when one line is tensioned for movement the other line is slackened. Logically, these two lines act as SET or RESET activators, transmitting a binary state from the sender to the receiver.

When a system is under sequencer control, a meta-stable condition is avoided by not accessing both sending means and receiving means at the same time. For some higher level system functions, between asynchronous sub-systems, there can be such coincident access. This situation is discussed later in regards to avoiding a meta-stable logic condition.

FIG. 4 shows semaphore sender 115, sender input conduit 116, semaphore receiver 117, receiver output conduit 118, and semaphore line pair 119. Between the sender and receiver are shown an example of the system register pod 101, at a smaller scale, which sends data to and receives data from the semaphore arrangement.

### Physical Introduction to Pods as Subsystems

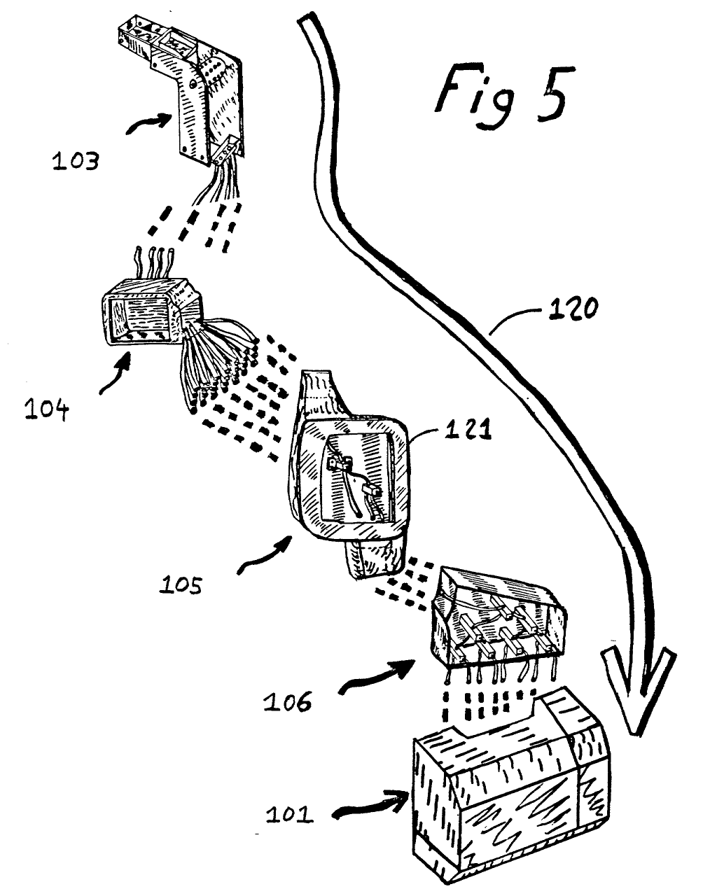

FIG. 5, pod module organization, has computer functions compartmentalized for teaching and demonstration purposes. As seen, there are conduit hoses connecting from one pod down to the next, in a serial or cascaded order, as follows:

System Clock Module 103

System Supervisor Pod 104,

Instruction Execution/Sequencer Pod 105,

Address/Path POD 106,

and the Register File Pod 101.

From the System Clock module 103 a set of four hoses runs down to Supervisor POD 104. Then the supervisor POD 104 sends down seven bundles of hoses, with four conduit hoses in each bundle. The Execution/Sequencer Pod 105 accepts these bundles, as inputs into a large duct, seen in the upper left comer of the unit, and itself sends four bundles out of a large output duct, seen in the lower right comer of the unit. These hose bundles then connect down to address/path POD 106.

Eventually, these hoses connect through down to actual flip-flop devices in the register pod. A large arrow 120, (FIG. 5), shows the general flow of each particle as it falls down through the system during a data transfer of one bit per particle. The arrow 120 ends at one of the devices mounted within the Register Pod. The general flow for control signals may also be generally down, as shown, but some signals may only be along part of the system.

Generally, the pods for clock module 103, Supervisor pod 104, and memory pod 102 (shown previously in FIG. 3) contain devices that are somewhat pre-fabricated and so are not necessarily easy to change or alter. The execution pod 105, address/path pod 106, and register pod 101 are constructed to allow easy user access.

A user is someone who wishes to examine, touch, or modify the kit construction for variations of operation or architecture. In keeping with the idea of a teaching or training computer are the following sequencer pod features, (some of which do not necessarily contribute to function):

Execution/sequencer pod 105 has an antique-style wood trim 121 edging around the pod enclosure front. This front wood surface of the pod provides user/experimenters with an array of uncommitted mounting holes (not shown) for several devices. After a new mechanical device, connection, or function is verified, the user may then re-locate the new device(s) into the pod, which also includes a similar array of uncommitted mounting holes. Address/path pod 106 also includes internally an array of such mounting holes (not shown).

### Card Cage for Registers

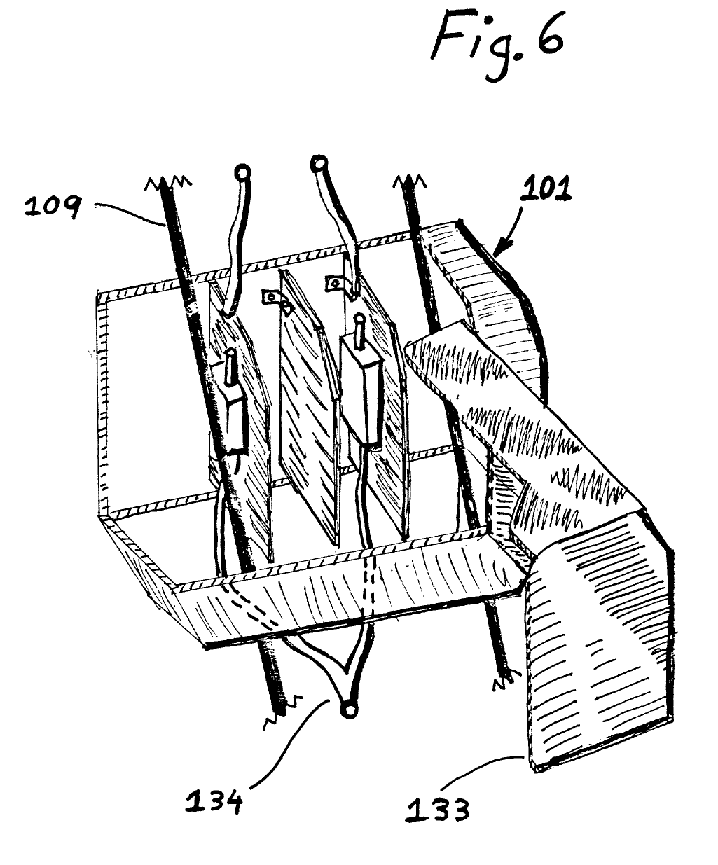

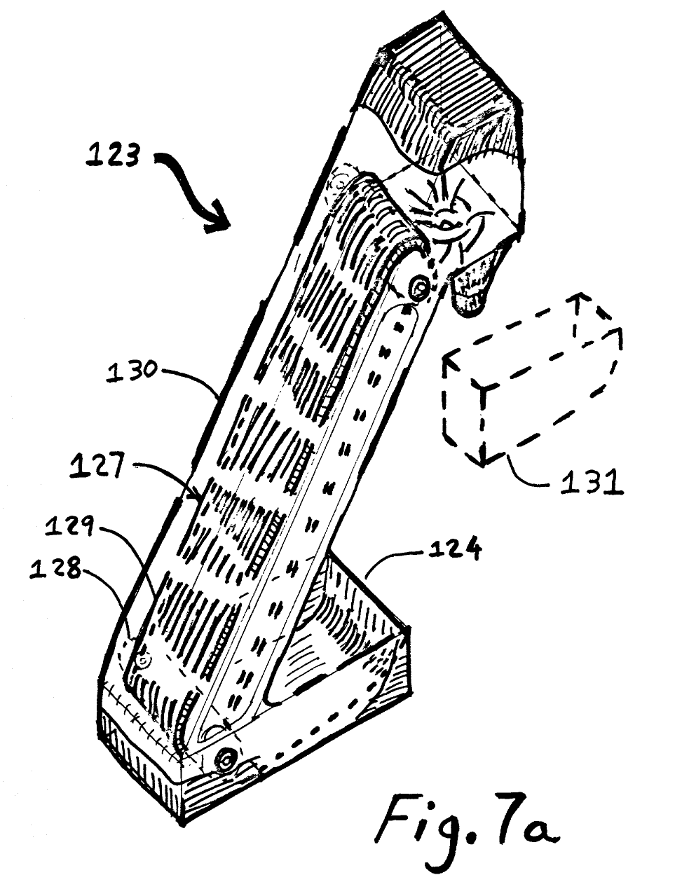

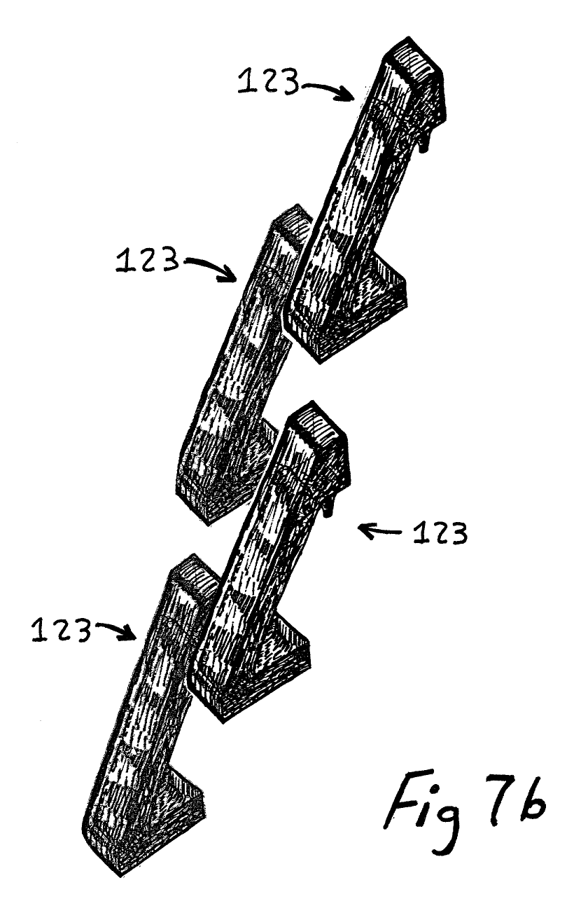

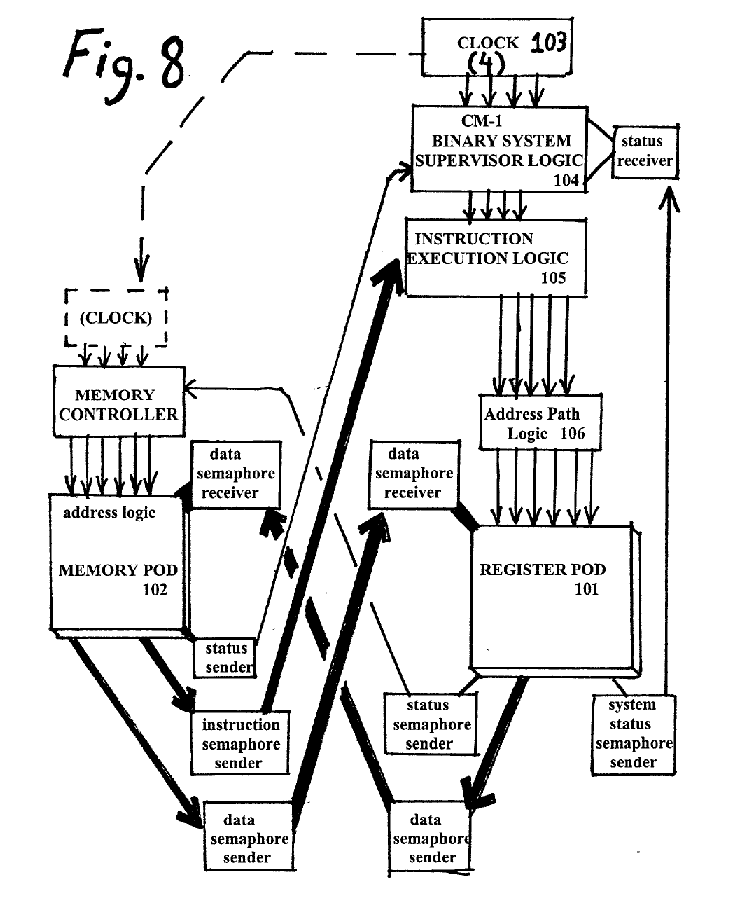

In FIG. 6 is shown an internal view of register pod 101. The view through open door 133 shows three board assemblies resembling electronic mother boards, a simplified view. In actuality, there are five boards internal to register pod 101 as follows (not shown):

The first four boards each have mounted two logical 8-bit registers, each of which can be split into two 4-bit registers. For example, the system PC (program counter) is 8-bit size, while the A and B registers are each 4-bit. Connections reflect particular sizes used. For the convenience of experimenter access, these registers are not integrated or consolidated. Usually, such as in the PC register, the actual hardware is two 4-bit register modules, connected in series to facilitate binary counting. These modules can be separately mounted on the assembly board, using small cards, in a similar manner to electronic assemblies.

The fifth board assembly in register pod 101 has mounted on it an integrated assembly of 16 registers each having 4-bits. This is for computer scratch-pad data storage functions.

For easy experimenter's access, the board assemblies, and attached registers are ordered, from front to back, in the following simplified order:

TABLE 1
Register Card Cage

| map (in hex) | board # | contents |
|---|---|---|
| C,D,E,F hex | 1. | 4-bit A and 4-bit B, plus misc. ALU logic, and |
| | | 8-bit flags (includes ZERO, CARRY, USER, etc.) |
| 8,9,A,B hex | 2. | 8-bit counter-timer, and 8-bit Loop counter |
| 4,5,6,7 hex | 3. | 8-bit memory pointer 1, and 8-bit pointer 2 (PTR1 and PTR2) |
| 0,1,2,3 hex | 4. | 8-bit PC (program counter), and 8-bit PC buffer |
| 10 h - 1F hex | 5. | Integrated module for scratch-pad registers 16 through 31 |

In actuality, the above is simplified regarding the data accumulator (A), the second data register (B), and the associated ALU logic (arithmetic logic unit.), as will be apparent. For data loading and mapping of the registers the above serves as an orientation to the requirements of the address/path module or POD 106 which will be described as a binary tree structure, along with other details in the CM-1 discussion at the end of the binary section of this specification. For reading data out of any of the registers, is shown example Y combiner 134 which is intended for connection to a semaphore sender unit.

### Card Cage for Memory

### See FIG. 3a

Briefly, the memory card cage, pod 102, is left-side symmetric to the right side register pod 101 (no internal view is shown.) Internally, as in the register pod, there are board assemblies (eight in the case of memory pod 102.) Each board assembly has an integrated module containing 16 registers of four bits each, the same as the above described scratch-pad registers in register pod 101. Thus the CM-1 system is here described with a total of 128 nibbles for the initial machines, out of a total addressing capacity of 256 nibbles.

### Brief Description of Particle Elevations

### FIG. 7a

Feed Bin 124 has a conventional fail-safe drain, (not shown), which assures any over-flow will run down through connected conduit hoses to the CM-1 system bottom pan (not shown), and so prevents the particles, which are steel balls in this system, from interfering with the machine moving parts.

Belt System 127 uses simple rollers 128 with bearings for driving and supporting belt 129 inner surface and adjustable clearance pinch plate 130. The clearance is designed and adjusted so that a steel ball will be pinched and thus will be rolled upwards between the belt and plate 130. This is very similar to typical farm grain elevators or other factory material feed systems.

For safety, a door open switch (not shown) operates to halt electric motors if a hatch is opened giving access to the moving parts of the belt enclosure. Other motor controls include sensors for detecting the amounts of particles delivered to a reservoir. At the point of 20% full, a motor will be started. At 80% full, the motor will be stopped.

Considerable difficulties arise in avoiding jam-ups of the particles, particularly at points where a supply tube narrows (or necks down). For this reason, upper reservoir 131 should be stationary, of consistent slope for reliable flow and so should not pivot. A design choice was then made to use optical sensors rather than having the contained weight cause a pivoting action for sensing the volume of particles in the reservoir.

Other conventional controls allow adjustment of motor voltage to allow coarse control of capacity of delivery to accommodate a particular type of machine. These controls are on the DC power supply modules, which are available as consumer market products.

FIG. 7b shows how four of the above described elevator modules can be cascaded, to pump, or transport, the steel balls up to the top-most reservoir. Each module dumps into the incoming catch-tray of the next-higher elevator module.

### Logical Block View of CM-1

### FIG. 8

### The Pods as Functional Sub-systems

While there are many various options, FIG. 8 is presented to emphasize the separation of the CPU sub-system (register POD 101, et. al.), from the memory sub-system (POD 102) in CM-1. Chip designers and programmers usually have an understanding that a conventional program fetch involves presenting a specific binary program address to a ROM or a RAM chip. (ROM is read-only, and RAM is random access memory.) In these separated left and right portions of the FIG. 8 CM-1 block diagram a feature is that a simple one-line signal is used for commanding another byte, where the right-side CPU portion issues the command, called fetch, or fetch request. This is an implicitly defined function where memory POD 102 maintains an internal copy or image of the PC (or binary program counter.) When program branches occur, an internal cycle transfers a copy of the 8-bit PC register to the PC image maintained in memory POD 102. (These details and signals are not shown.)

The CM-1 machine embodiment communicates between the left-side memory POD 102, and the right-side CPU block area, by way of two registers, called the MDR, or memory data register, and the MAR, or memory address register. In some alternative embodiments, memory data reads are sent directly to the CPU accumulator, or A register. Another future planned embodiment extends the above feature of an implicit, auto-incrementing PC to additionally provide several conventional channels for sequential reading from memory. This speeds up execution of mechanical computer programs by only requiring a single transfer of a pointer address, a feature closely recognized as in the BASIC computer source language as the logical initialization; “OPEN (2),##”. Subsequent multiple accesses using the familiar BASIC language source instruction; “READ (2)”, will each return one next byte, or next character from memory POD 102 to the CPU (register POD 101.) This kind of speed-up feature helps boost the performance of the mechanical computer system.

FIG. 8 shows the main computer system as the right-half portion of the block diagram. A very brief introduction will now be given of each section.

### System Clock Module 103 Introduction

The clock means of the CM-1 Mechanical Computer serves as an impulse source for initiating and synchronizing all subsequent events or actuations. Nominally, every 840 Msec., this clock module 103 issues a set of one or more steel balls, which are both the mechanical actuators, and the data or information transmitting particles of the system. The clock modules have many interesting features in the present embodiment. However, due to the volume of details, there is only a brief introduction given in this disclosure. It is likely that a future patent application will be filed to more fully describe the options in the clock portion of the computer.

### Brief Introduction to Computer Clock Innovations

A clock module as an impulse source was developed according to the following brief list:

1. The first clock module was to release, or dispense, at approximately one ball per second, to be supplied by a feed bin reservoir. This dispensing action was to be regulated by a conventional spring wind-up clock with pendulum, with added means for a ball release gate. Alternately, the mechanical system clock was to be a conventional electric solenoid actuated dispenser. Research could then proceed on developing the logic portions of the mechanical computer. The disadvantage of this short-term approach is that it is preferred to maintain the environmental advantages of a totally mechanical computer machine so that operation is possible in harsh environments such as with very high temperatures, caustic or explosive gasses, etc.

2. A simple pendulum linked system was invented, coupled to a ball dispensing gate, which also featured using the released ball to fall and power the clock by impacting a paddle on the pendulum. This clock is considered to be free-fall and closed loop timed, rather than pendulum regulated, with the pendulum serving as an inertial mass to smooth the immediate cycle or swing. An interesting feature of this pendulum-assisted ball dispenser is in the release gate, which consists of a pair of alternating action pieces of stiff wire (or pins), which alternately block and release a line-up of steel balls in a sloped dispensing tube. This special feature involves precise positioning of the re-insertion of these two blocking pins for control of friction and for reduction of a weight back-lash effect. Specifically, the spacing is such that it is less than the diameter of one ball.

In a first dispensing action, when the first pin is being withdrawn, releasing the first ball, the second pin is being re-inserted by way of a slot in the side of the sloping dispensing tube. This blocks ball #2 and all others in the dispensing line-up. An advantage is that this second pin does not encounter insertion resistance, at least until the line-up of balls in the dispenser tube starts moving, as the first ball exits the tube. Essentially, the goal is to have the second pin inserted and in-place, just before the line-up shifts down slightly against this second pin. This is for avoiding having the insertion action acting against the back-load weight of the ball line-up from the feed bin or reservoir.

The second or opposing action is reloading, where the first pin is re-inserted and the second pin is withdrawn, causing the entire line-up to shift down, so that the former ball #2 occupies the first position, in preparation to be the next released ball.

This pendulum-assisted clock is useful for small systems, but has a disadvantage of requiring precise adjustment and low back-loading. The slope of the dispenser tube must be the absolute minimum and the penetration of the two gate pins must be precisely adjusted or the clock has a tendency to stop running. It is a form of escapement, operating on the ball-mass line-up, timed by the closed loop delay, and also self-powered by the drop of each new ball.

3. Torque Wheel Clock

The above pendulum-assisted design provided the ideas of closed-loop and free-fall for self-regulation. The torque-wheel design improves on these ideas. For issuing multiple balls together the dual alternating pins are replaced by a cylinder that has semi-hemisphere depressions in multiple lanes. As this cylinder turns, it aligns with an upper dispenser so that five balls drop down into the cylinder surface. Most clearances are less than the diameter of a ball. This cylinder can then turn with clearance, as the five new balls are sunken down into the surface depressions. Meanwhile, since this cylinder has eight of these multiple rows of lane depressions around the circle, there are two other places that have steel balls occupying depressions, thus creating a torque that tends to turn the wheel into a next position. Unlike a water wheel, which turns continuously with substantial inertia, this is a start-stop wheel used as a gate but also obtaining motive force from the drop of the weight of the steel balls.

Described using conventional terminology, a ratchet is released, and the cylinder turns a few degrees until, at the 12 o'clock position, a new set of empty surface dimples turns directly under a dispensing box having five lanes and with each lane having a round outlet hole. Before the dimples align, a steel ball in each lane simply rests on the surface of the cylinder, poking half-way down, out of the upper dispensing box. The cylinder turns due to the torque of the dead weight of the five balls captured in the dimples at approximately a 1 o'clock position and the five balls captured at a 3 o'clock position. Somewhere near the end of 45 degrees of travel, the cylinder ratchet re-engages and stops the movement. Also, meanwhile, the above mentioned row of steel balls formerly at the 3 o'clock position is rotated enough to dump at approximately the 5 o'clock position.

This dump or release, is the prime dispensing action. Four of the balls carried down and incrementally released by the cylinder dimples are captured and guided into conduits to constitute the clock module output set. The fifth ball released by the multiple lane cylinder is used to activate yet another incremental rotation. There may or may not be a free-fall distance added to the closed loop delay. While more advanced and stable, this torque wheel method has many areas which introduce miscellaneous variable frictions.

5. Free-fall Clock Regulator

A free-fall regulator is combined with the above described Torque Wheel Clock. By inserting this free-fall regulator into the fall path, between the dispensing cylinder and the ratchet releasing lever, the effective closed loop is controlled solely by the regulator. Arranged in a stiff box, a lower lever set is impacted by a falling ball, causing a symmetric upper lever set to open, dropping yet another waiting ball, to repeat the process. The above Torque Wheel Clock mechanism serves to feed the regulator, but now can do so at highly variable rates, as long as it keeps up with demand. The regulator passes the ball, from the lower lever set, to the ratchet release lever, as described. Examination of this situation shows that this arrangement must be initially primed, so that the special series of devices already has a ball when the system is started up. To start this system clock, it is necessary to load balls into the lanes of two of the rotary positions, by hand turning, or by two specially dropped balls onto the ratchet release. Then, the free-fall regulator must be primed by dropping a third ball, so that the cylinder delivers or dumps once, thus priming the regulator upper lever set with a ball. Finally, a ball is dropped, activating the ratchet release, and initiating normal continuous clocking. With the dimensions of the current embodiment, the time period of each of these clock emissions is approximately 840 Msec.

### Brief Functional Introduction to the CM-1 Supervisor Sub-system

### See Ref. 104 in the Block Diagram, FIG. 8

The system Bus Supervisor for the CM-1 binary computer is the first dispatcher of each of the newly arriving clock impulses. Using a conventional flag, called CPU-BUSY, with a simple first path split the Bus Supervisor resolves whether an instruction is running, or if a new instruction needs to be fetched. For the case of a new instruction fetch, the supervisor contains what could be termed a “RE-ENTRANT SEQUENCER”, meaning that each new clock pulse is routed or dispatched into a single fetch control sequencer input. This sequencer is initiated elsewhere, by a separate process, and simply routes each new clock impulse to a sequential set of outputs. The first impulse is connected to cause a fetch request to the memory sub-system.

Subsequent clock impulses are connected to interrogate a flag gate, called NB, or next byte, signifying the completion of the requested memory fetch. (The memory module will write this data to a read-up semaphore transmitting device.) A second portion of the sequencer is then entered.

This portion of the fetch control sequencer then can copy down from a semaphore receiver, the next instruction byte. This CM-1 processor has a minimal instruction set which is first based on nibbles (partitioned into 4-bit chunks.)

The following OP-CODE map indicates the scope of this four-bit system:

TABLE 2
First nibble of CM-1 instructions (b = option variable 0, or 1)

| nibble | instruction |
|---|---|
| 000b | SKIP Z or SKIP NZ |
| 001b | SKIP C or SKIP NC |
| 010b | LDA (PTR1) or LDA (PTR2) |
| 011b | STA (PTR1) or STA (PTR2) |
| 100b | MVI REG (0-15),# or MVI REG (16-31),# |
| 101b | LDA (0-15) or LDA (16-31) |
| 110b | STA (0-15) or STA (16-31) |
| 1110 | CLC (clear the carry flag) |
| 1111 | EXTEND (to an additional OP-CODE nibble) |

A first glance at this CM-1 instruction set reveals the bias for prioritizing access to the scratch-pad area, over the general purpose memory in POD 102, as there is no instruction for direct access in this first tier. Pointers, however, do access the general purpose memory in this first tier (see the above LDA (PTR 1.) This implies that any direct access instruction can exist, but must be in the second tier, having multiple OP-codes (instruction operation codes.)

As is apparent from this table, a first OP-CODE nibble is copied down, essentially to a one-of-eight OP-CODE decoder, while the option selecting bit is also copied down to various places, according to use. This arrangement of using a basic 3-bit OP-CODE is especially convenient, as an extra bit is left to combine with an additional nibble, to make the basic 5-bit address needed for accessing the low and high register banks, locations 0 through 31.

A good example is the instruction:

### MVI 19, #7

This assembly-language instruction line indicates an action of moving a constant to register location 19 (this is in the upper block.) This generates three nibbles of object code; the above OP-CODE for MVI (or MOVE-IMMEDIATE-DATA), a second nibble containing four bits of low address, and the constant (7 in this case.) Due to the high complexities and many details this disclosure does not attempt detailed coverage of such a multiple-word fetch system, explaining only the process of obtaining the first word fetch. But it would be obvious to a skilled (electronic) chip designer that the following would play a part, (assuming the same, above instruction example, of MVI 19, #7.):

1. Of the first nibble, the first three OP-CODE bits would be copied down to a main sequencer/decoder. The fetch sequencer then must determine how many additional nibbles must be fetched.

2. The last bit of this first nibble is combined with the second nibble to create a 5-bit path address (this defines location 19.)

3. The third nibble is the constant (of value #7) for sending down to the path accessed device at location 19, via the system data BUS. Due to the complexities of having a mixed four and eight bit system, the lowest of the mentioned 5-bit address is for an even/odd determination, so that for location 19, an odd address, the source of the constant to be sent down is connected to the low 4 bits of the (8-bit) system data BUS.

4. After the copy-down of the instruction to the decoder and any additional buffers, and doing other initializing, the fetch sequencer can then relinquish control by setting the instruction BUSY flag, as mentioned above.

5. The fetch sequencer must also accommodate any latent lag times. This means that there can be cases of as many as three clock impulses running down through the fetch sequencer portion of the system supervisor, even though the function has finished or expired. The cascaded devices used to create internal sequencers in the mechanical computer simply have empty (or No-op) or do-nothing connections used as pad times.

This introduces the fetch portion of the supervisor. If the instruction is fetched, sequencers are initialized, and the busy flag has been set, an execution sequence is entered by each new clock impulse. As described above, the first path split in the system supervisor will determine this busy mode, and in response will route the set of four balls directly to the execution unit.

### Brief Functional Introduction to Address/Path Setting Pod 106

Before completing discussion on the supervisor and execution units, it is helpful to understand what is actually being controlled, which to a high degree is the path setting devices in the various computer data busses. Much of the activity of the execution sequencer is concerned with BUS path set-up, which is then followed by actual data transfer actions.

Observation back to FIG. 5 shows address/path pod 106 with internal devices mounted in a classic binary pyramid form. At the very top level is one device, which is set-up using the highest weight bit of the destination address. Level two has two devices, level three has four devices and level four has eight devices. (Level four is un-seen, inside pod 101.) This binary pyramid is actually presented in an introductory symbolic form. In actuality, the two level two devices can be chained, for using the second-highest destination address bit. By the time level three is reached, however, there are four switch devices, and so chaining the third-highest address bit becomes impractical.

This is where it is helpful to the reader to keep the vertical dimension in mind, in the design and layout phase. It could be said that the mechanical computer invention is most challenged by the need to conserve vertical space (or vertical run.) Critical to vertical space is the layout of vertical stacking, or cascading of components and especially the extra run space taken up by simple interconnections, conduit stress relievers, and brackets. This disadvantage is offset by running two or more separate sub-systems side-by-side using a common frame and enclosure as the runs of components are usually long and thin. For example, FIG. 5 was described, showing sub-system PODS cascading down the system tower, in a spiral or helix manner. While not shown, it is possible to incorporate a second set of cascading PODS on the same frame, to be used for expanded memory.

Resuming discussion on this FIG. 8, larger binary tree sub-systems tend to take up a lot of vertical space and horizontal space and it can be observed that each successive level downward has twice the number of binary path gate devices. Thus it would be inefficient to send the register addressing to every gate in the binary tree, and forcing a serial chain, or re-use connection between every gate on each level causes a drastic increase in the above mentioned vertical run space (as well as increased delay time to act on each address bit.) On the other hand, it would severely impact the overall instruction execution performance time if paths were to be set up one bit at a time. Options on these path devices include keeping a separate input BUS for address (switch positioning) and for data. A workable compromise has elements assembled to create a two-level module having separate internal BUS paths. Externally, this path setting module or switch shares one input BUS.

On this CM-1 machine register path sub-system embodiment, a single multiplexed or time-shared input BUS is used, first for addressing or positioning the path switch using two input bits, and then as a static data-transparent path, established in a binary tree. By the parallel ganged switch, this is logically eight bits wide, although physically there are two switch housings, each with four bits, or parallel commutating channels. Using this same compromise scheme, the memory path unit can access up to 256 locations, using an 8-bit address sent down in four separate transmissions of two-bits each.

### Brief Introduction to the Instruction Execution Sequencer

### See block FIG. 8

Much of the execution sequencer is concerned with the set-up of the data BUS path, essentially an address function (FIG. 5 showed a view of binary tree devices internal to the address/path module.) In the present embodiment of CM-1, the address/path arrangement must be spoon fed, in chunks of 2 bits at a time. For each level, there is a selection/initialize impulse, a two-bit address transfer, and then a de-select which causes a transparent connection to the next level down. Physically, there are 16 registers, each optionally used as two separate addressable four-bit registers, such as A and B, so that there is an address/path binary pyramid structure, having four levels. What is not detailed in this disclosure is the complexities involved in the conventional mix of sizes. This mechanical computer components invention disclosure describes the four-bit data transfers, such as for data calculations using the accumulator (also called the A register) while the internal BUS structures actually accommodate eight-bit transfers. In brief, a mapping scheme can accommodate such dual sizes. For instance, for an access to the low mapped areas, part of the address indicated can also determine the size of the data transfer and thus must affect the instruction sequencer to determine a four bit or an eight bit process. As shown in the register map (previous table 1), the instruction sequencer must therefore use a four-bit transfer for any address of 12 or above (hex address 0C h.) Another detail that will be more apparent in the binary device section, any of the transfers of eight bits are done in two cycles by the instruction sequencer even though the BUS can physically accommodate a simultaneous eight bit transfer. This is because the CM-1 machine sequencer has a four-bit path in this disclosed design.

Due to the aforementioned design choice for using 2 address bits at a time, selecting one of four paths, there needed to be two levels of modular BUS path devices. Thus the execution sequencer handles these sorts of signal details. For the messy system complexity of the inter-mix of both 4-bit and 8-bit operation, of the five address/path bits used, the lowest bit becomes a high nibble/low nibble select bit on the data source to the 8-bit system data bus.

In summary, the execution sequencer will initialize the BUS path selecting devices, send down four bits of address in two-bit chunks, select the low BUS nibble (location 19 is odd), select a WRITE mode on location 19, (via the data/control sending path), and finally, after sending down the actual data on the BUS, clear the instruction BUSY flag, to initiate another instruction. Readers are reminded that these internal sequencers are operating with four signals in parallel, or tandem as supplied by the clock module, and thus can do some of the above system control actions simultaneously.

The initial sequencing features of the current CM-1 embodiment provide a working platform from which various buffers and an instruction pipeline can be added. These features can get complicated due to the arbitration and suspension functions, which must take place. Specifically, suppose a CM-1 machine instruction will read a byte. The pipeline fetch processor also has pending memory reads, for obtaining more instructions. Thus there is a need for an arbitration and a suspension, so that each function can have memory accesses in turn. Also, accommodation of the asynchronous timing is necessary, so that a device or sub-system is not accessed for a read while it is being written to. These are system considerations, which are beyond the scope of this disclosure.

The next section describes FIG. 9, which has important features which speed up the processing of instructions.

### Introductory Description, Part II

### A Second Generation Machine—CM-2

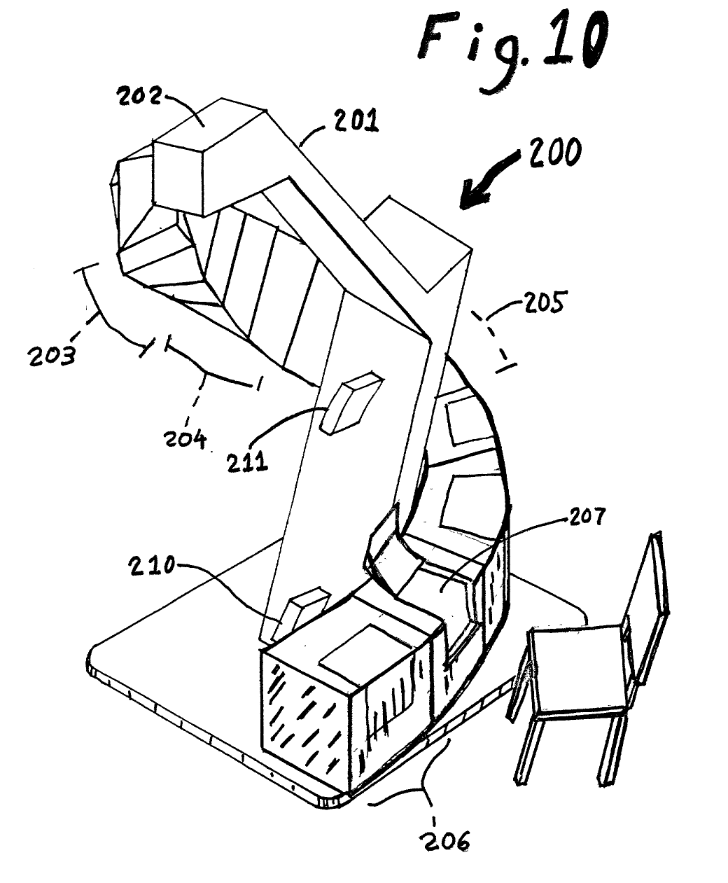

### See FIG. 1, FIG. 9 and FIG. 10

This preferred embodiment machine, CM-2, serves a need to accommodate a description of a second generation design of mechanical logic and system, which has a decimal data bus, and a higher performance ROM-CORE architecture. In brief, CM-2 (ref. 200), has an in-line architecture whereas the former CM-1 machine (ref. 100) is a side-by-side configuration.

The CM-1 conceptual binary mechanical computer 100 provided readers with a highly visible POD form in which to fit or place the novel binary logic components and helps indicate the composite or whole machine idea. The CM-2 conceptual decimal mechanical computer 200 presents a more formless or seamless frame and enclosure which represents an evolutionary step (above CM-1.) Thus, the spiral appearance of the CM-2 machine is more subtle, hinting of a downward flow that is characteristic in the mechanical busses and logic. (See the view of the CM-2 housing and frame, FIG. 10.) The performance is more complex, faster, and more capable, and the CM-2 frame and enclosure is a bit less accessible internally than the previous CM-1 model.

While the CM-2 enclosure has an externally seamless appearance, it is actually constructed of 12 segments. Tower 201 serves as the previous tower (107) that was described for the CM-1 machine. Contained within are the same moving belt elevators as in CM-1, which deliver quantities of steel balls up to a top-most reservoir. These elevator modules are not as obvious as in the previous machine, as they are simply internally mounted. Comparing FIG. 9 and FIG. 10, clock 202 is inside the top of tower 201. Moving downwards on either figure, the sub-systems are arranged for supervisor unit and fetch logic (ref. Item 203) in upper enclosure segments one through three (1-3 ref. 203), ROM-CORE in segments four and five (4-5 ref. 204), and with the data memory occupying segments 10, 11, and 12 (segment 12 is ref. 206.) This leaves segments 6, 7, 8, and 9 for the instruction sequencer unit.

Semaphore receiver 211 is shown, somewhat above segment 9, for transmitting down to the top of the system data BUS. This BUS top, or head, has multiple sources, all mixed into the one BUS, and with such BUS then connected down to the path determining devices. Another example of such a source is from the program stream, such as in loading a constant down into a register. While connecting hose conduit details are omitted from the view, the system controller/sequencer connects with one signal line to the top of semaphore receiver 211 and then there are ten semaphore READ data output lines coming out the bottom of the semaphore, which are run towards the back of CM-2 and into segment ten (the location of the system data BUS head, or top.) Semaphore sender 210 is shown partially obscured by the last enclosure segment (segment 12, ref. 206.) The sender is at the lowest point of all data handling components, for receiving data from all other system devices, when appropriate.

This CM-2 computer 200 enclosure serves partially as a test machine, by verifying that all necessary computer components can fit with a reasonable density and height. In this sense it is found to be overbuilt by about 30%. However, it is also intended to install a second subsystem, for advanced math such as for solving trigonometric functions such as SINE, COSINE, TANGENT, etc. These secondary, or add-on sub-systems can also be optionally placed into a second enclosure attached to system tower 201 with such second smaller enclosure having the same helical or spiraling shape as the main enclosure, segments 1 through 12. (This will produce a system as a double helix, reminiscent of the classic DNA structure.) Discussion of such math sub-systems takes place in the upcoming description of the WIDE-BUS CORE look up tables.

Aside from processing speed considerations the CM-2 machine is expected to eventually have approximately the architectural power of an early electronic microprocessor computer model such as the Apple I or the Radio Shack TRS80 models of the 1970's. Initially, the museum version will at first be about 4 meters tall (13 feet), and have 1000 words of memory storage.

Readers are helped by understanding overall basic CM-1 mechanical binary machine concepts formerly covered, since they are the nearly the same for the CM-2 machine, that is, there is a sequencing program, an instruction decoder, a system clock, a particle supply conveyor, etc. The difference is in the data transfer systems and in the decimal vs. binary internal math that is implemented.

### Specifically, The Advantages of CM-2 Over CM-1 Are

CM-2 clock and control only needs to be one signal, versus a four bit wide clock/control path scheme for CM-1. This will be discussed in detail in the respective sections, but briefly this is a consequence of the novel multi-state decimal operation of CM-2 versus four bit parallel binary in CM-1. Also, the CM-2 bus maintains separate discrete paths for reading or writing, so that active mode selection is not needed.

The CM-2 machine has program memory and data memory separate. The CM-2 program memory, or ROM-CORE is placed towards the top of the spiraling enclosure. No wait states are required because an instruction is simply read down to the decoder/sequencer. In contrast, the CM-1 memory is actually another complete computer, operating side-by side with the main computer. (See memory pod 102 in FIG. 3, and FIG. 8). A next instruction must be requested via a fetch request signal line, with consequent possible wait states.

### Size Guidelines

For this invention, initial design size guidelines specify single, uniform system-wide size standards as follows:

TABLE 3
Size Relationships of invention variations

| | | Particle | |
|---|---|---|---|
| System Type | System Height | Size | Nominal Delay |
| CM-1/CM-2 Table-top | 1.3 m (4 ft.) | 2 mm | 300 Msec. |
| CM-1 Classroom | 2 m (7 ft.) | 4 mm | 700 Msec. |
| CM-2 Classroom | 2.5 m (9 ft.) | 4 mm | 700 Msec. |
| CM-2 Museum | 4 m (13 ft.) | 4 mm | 700 Msec. |
| Hourglass Demo | 2 m (7 ft.) | 4 mm | 700 Msec. |

Note:
The hourglass demo will be introduced in a later section.

### Description of the Sacked Lever Module Family

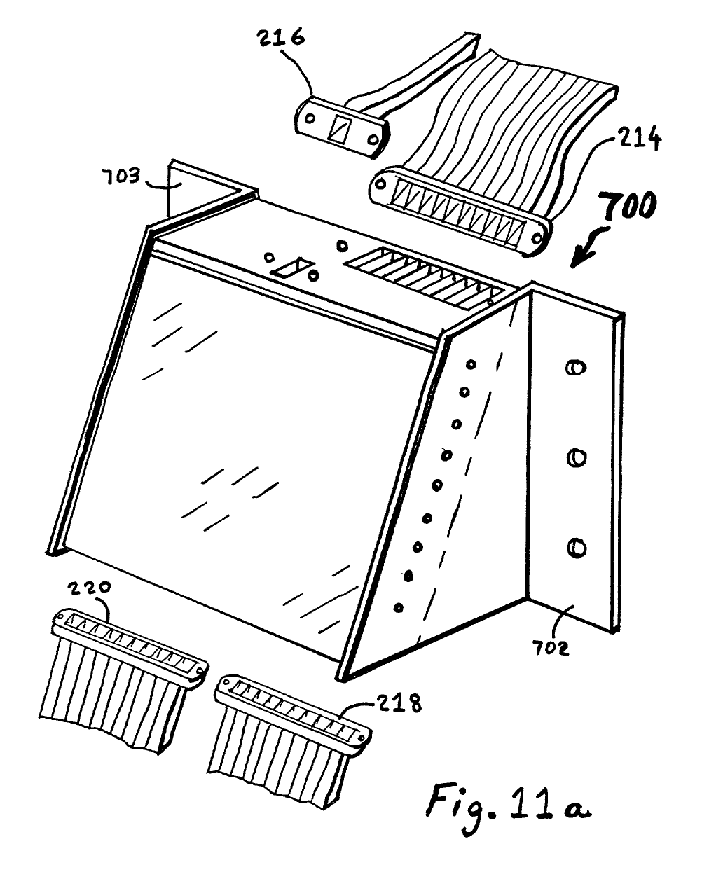

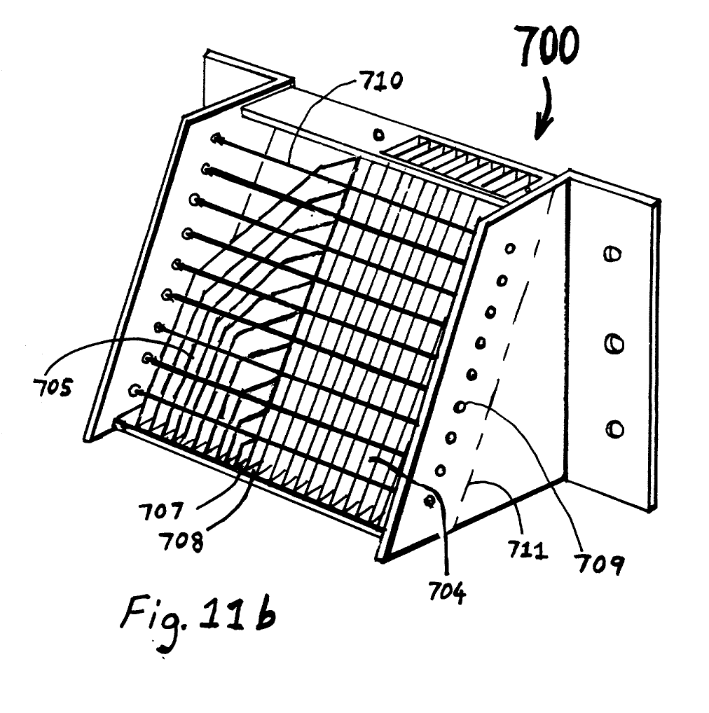

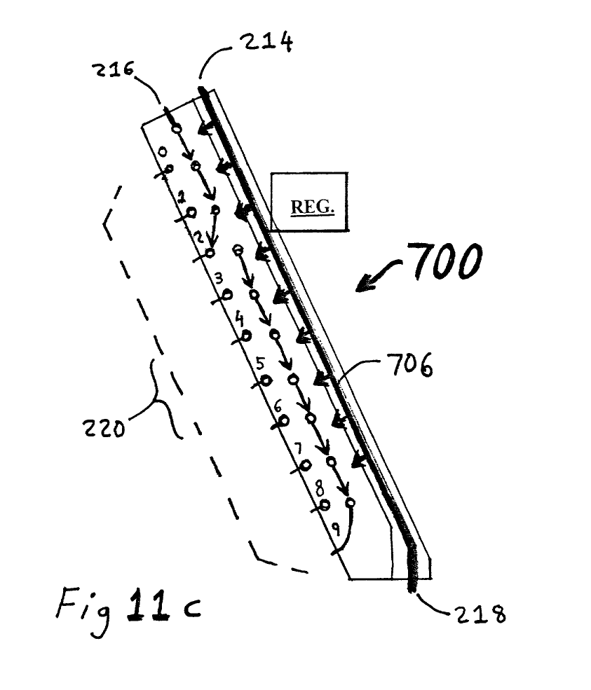

Stacked lever module 700 of FIG. 11a is a favored portion of the mechanical computer system.

Incoming WRITE BUS connector 214 and READ-SYNC connector 216 signal conduits are for connecting to the top of the register housing. Underneath (not shown), are two outgoing signal connectors, for outgoing WRITE BUS connector 218 and READ BUS connector 220 signal conduits. (Conduits are closely analogous to conventional electronic system cabling.) These various multiple conduit BUS interconnections, while flexible, place twisting and bending stresses on the register housing. Conventional construction details include various screw-down connector clamps, keyways, and thickening or reinforcing of the register housing. Often omitted, these connector related details are discussed when appropriate, as in, for instance, the upcoming BUS SWITCH MODULE discussion.

Right side mounting bracket 702 and left side mounting bracket 703 attach to the stacked lever module, and to a vertical mounting surface, such as the experimenter's rig, which is described later. The stacked lever module has many operational advantages, to be discussed shortly. Meanwhile, there are physical advantages apparent in FIG. 11b. The stacked lever module is a simple slanting clear plastic box, which facilitates observation, both of internal moving parts, and of internal computer BUS structures, and with brackets for an upright vertical mounting.

The visible structure of FIG. 11b is of multiple semi-vertical conduits or channels, shown with the internal front half portion of the register removed, to expose the back half portion clearly. The delineation of this cut-away portion of the view is parallel to the front and back faces. The line up of the pivot holes on the right side of the housing also shows this cut-away delineation, as along the plane defined by the array of shafts using such pivot holes. (See shaft #5 pivot hole 709.) This view of FIG. 11b shows an outline of the nine vertically stacked shafts which are supported by these left and right side plate pivot holes, but omits details of the large array of tabs attached to these shafts, pending later discussion on register 720, for clarity.

This back half of the register 700 housing is further sub-divided into housing quarters, with WRITE cavity 704, as the right side subdivision and READ cavity 705, as the left side sub-division. Each of these functional quarter sections contain ten vertical or semi-vertical and diagonal channels. The WRITE cavity signal columns, or conduits, are straight-through and down, while the READ cavity signal conduits all lead down somewhat diagonally from one central vertical conduit (which is READ selection column 707.) These READ signal output conduit walls penetrate all the way into this selection column, effectively creating rows leading down diagonally from the selection column and included are small curved ramps for guiding a steel ball through a right angle direction change (not shown) into and down one of these diagonal READ output conduits.

Because these multiple diagonal walls penetrate and connect with column 707, there is visible only the right wall of the column, shared as the left wall of the adjacent column 708. Column 707 has no left wall, but is defmed geometrically as a column space of standard width. This column, or column space, is adjacent, in a front-back direction, with the front cavity column used for the READ-SYNC or un-selected read control signal. Later, register 720 is described, showing column 757, having a similar purpose as the starting line of selected multiple output ducts or channels.

A unit or cell construction layout method is used in registers 700, and in the later described register 720. Moving from left to right in a register housing, there are units or identical spaced columns, starting with a spacer column on the left. Continuing to the right, there are then signal columns, with decimal register 700 having twenty of these integer signal columns, (FIG. 11b) or with the four state register 720 (discussed later) having eight of these integer signal READ/WRITE columns. The spacer column 708 serves no internal function, but is useful in separating the two bottom output or outlet connectors for the WRITE function and the READ function. Actually, this view is simplified, as there is usually more separation required, in order to provide sufficient connector thickness for strength. FIG. 14, and discussion has more details on the bottom outlet connectors, which connect directly to the internal conduits.

It was found in the development of the mechanical computer that a large portion of design efforts involved conduit management, due to the large number of interconnecting conduits. The physical advantages of the stacked lever module are that the task of managing multiple conduits is eased due to the parallel channel construction. These parallel signal conduit runs allow for greater logic density and ease of construction compared to the more random layout of the binary system components. The binary system will be described in a following section. In a way, this section describes decimal device construction as an improvement over the invention of the binary components and systems (rather than over some prior-art.)

The parallel organization of the conduits in stacked lever module 700 (FIG. 11b) and the orthogonal placements relative to the integer selection shaft assemblies, integer zero selection shaft 710 being the top-most, creates a modular structure which lends easily to additions, which are simply placed on the end of existing structure. This is in contrast to rotary commutating switch design, in which every angular relationship must be re-visited when designing to change a given capacity.

For example of this easy design change feature, and as will be made clear in the following details, a design for an eight-state module can be converted to a ten-state design by simply adding two additional vertical conduits and adding two additional (horizontal) selection shafts. The additional shafts will be different but will follow a simple tab placement scheme, and which does not change any pre-existing tab placements. By contrast, the expansion of a binary mechanical device, such as expanding from a four bit binary register to six bits, involves simple logical expansion but physically adds more somewhat random structure (conduits and channels).

The dashed lines defining the location of housing back panel (ref. 71 1, parallel to the front face) show how each register 700 module is shaped like a book. Later, this shape helps when combining ten registers together to form a slanting cube module, called a TEN-POD.

It is also appropriate to use other names and variations of the Stacked Lever, a generic family name. The term LEVER is used as a shorthand term for a shaft with numerous attached lever-like tabs, and generally the inclusion of this shaft assembly within a supporting housing, with associated guiding conduit channels. A typical stacked lever arrangement resembles an abacus, but with the horizontal pivoting shafts mounted in a semi-vertical stack (or actually a slightly diagonal plane.)

Other names for stacked lever module 700 are:

REGISTER DEVICE, MODULE, or UNIT,

and DIGIT REGISTER, or DECIMAL DIGIT REGISTER.

The preferred name used in this document will be DECIMAL DIGIT REGISTER 700, or simply, REGISTER.

Four other described devices using the stacked lever construction are;

BUS SWITCH, or DECIMAL BUS SWITCH,

WIDE-BUS ENCODER, or DIGIT EXTRACTOR,

DEMUX, or PULSE SEPARATOR,

and the CARRY PROPAGATOR.

Of these devices, the BUS SWITCH and WIDE-BUS ENCODER use the discrete BUS, while the demux, and the carry propagator give the reader a glimpse of functional elements or stacked lever assemblies not using the discrete bus rules.

### Register 700 Internal Schematic

### FIG. 11c

Due to the many novel aspects of the mechanical computing system, a temporary set of new schematic symbols will be presented, as needed. Comparing FIG. 11c and FIG. 11a, the right side portion of register 700 shows WRITE BUS connector 214 input, which flows straight-through and out as a chain output, WRITE BUS connector 218 output. This right side portion, or half of register 700 serves as the actuator or motor. (Actually, since FIG. 11 c is a left side semi-schematic view, this WRITE BUS 706 is shown against the sloping front face.)

It is called a WRITE BUS, meaning that BUS 706 is continuous from external BUS connector 214, through register 700, and out external BUS connector 218. The term WRITE implies that external conduits (like electronic cables) bring data in, and impress such data on the internal parts of the register.

In order to show this data impression, or motor action, internal WRITE BUS 706 has small arrows which point to each associated READ element. This indicates that each motor element represented by each small arrow is mounted on the same pivoting shaft as is each READ switch element. To help understand this novel schematic, readers can note that the READ switch element for a data state of the integer two (2) is selected. As FIG. 11c indicates, a previous integer two signal had passed through the register. In actuality, each motor element is a tab (or lever) on a shaft. All of the multitude of these WRITE motor tabs and READ switch element tabs are omitted in FIG. 11 views for clarity.

Also, the stacked lever register invention has variations of these tabs, which effectively create a set of rules for operation. In this disclosure, the tabs are for implementing the discrete BUS, which allows decimal operation. Future versions, however, will have different tab placements and varieties. Essentially, variations perform processing of incoming signals, as they become converted into a positional change in the register state. In this discrete BUS implementation this processing is a simple one-to-one latching. A simple alternate example of this is using the register to latch an integer value, adding two to each incoming integer. The important feature is that the WRITE signal itself always retains a unique identity, as it passes through the register. Processing rules for each individual integer signal are thus implemented by the shaft tab placements. This feature of processing with the incoming latching function (called a WRITE function) is a complement of the invention feature or ability to process during data transmission, or processing by bus, which does alter the integer identification. The processing by BUS feature will be described in the following data transfer section.

More complex examples of the use of a stacked lever register are for computing a fourier transform, and the addition of internal rotating elements such that the phase of rotation affects the outcome of processing of an arriving BUS signal. (These complex functions are not in this disclosure.)

Continuing this process, of comparing between the three views of FIG. 11, the left side READ section cavity shows the multiple commutating paths, where the READ-SYNC connector 216 signal is switched to one of the ten outputs of READ output BUS connector 220. This READ-SYNC signal moves down in a column within the front cavity, which is omitted from the view of FIG. 11b. Upon being switched, by the one shaft which is in a select position, the ball, or READ-SYNC, does enter the back cavity half, by passing through the plane defined by the stack of shafts.

Again, liberties are taken with the logical semi-schematic form by showing READ BUS output connector 220 along the back face, when it actually emerges from the housing bottom (as verified by FIG. 11b.) Readers should use such presented schematics for logical purposes, rather than for a literal construction description. Actually, later description on the BUS SWITCH shows that the BUS SWITCH is physically constructed in the manner shown, for running the READ output lines out of the back face.

The pre-switched READ control line, READ-SYNC, is located as a semi-vertical column in the front half portion of the register 700 housing, which is omitted from the view of FIG. 11b. (To be described in the following section on register 720.) In other words, the pre-switched READ-SYNC signal conduit is located in front of the array of stacked shafts.

READ OUTPUT BUS connector 220 has the useful quality of being capable of later issuing an identical copy of any written data, implying simple connection of one register down to another for data transfers. This is a key aspect of the invention BUS, which will be described in great detail. Indeed, register 700 is actually a supporting device, which enables the novel operation of the BUS and data transfer functions of this invention. Also, this is not a conventional binary coded BUS system, as will be apparent.

In most cases a schematic implies an upright orientation, so that all signals flow downward. Observation of the slightly diagonal sloping housing of register 700 shows a nominal 15 degree flow angle, from vertical. This nominal angle serves to re-introduce some consistent friction to the freely falling steel ball as it falls through the conduit means of the register (and system.) Thus, instead of unrestricted accelerating free-fall, and subsequent violent impacts on internal parts, the ball undergoes a more steady and predictable movement as a falling particle, both through conduits and while actively interacting with the device.

### Raw Grid Plate 801

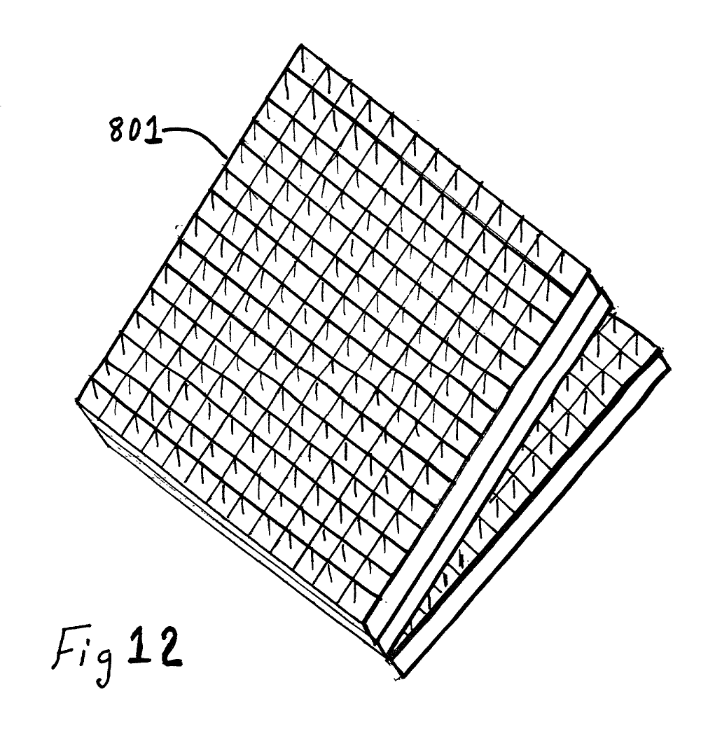

### FIG. 12

A raw grid plate material, FIG. 12, can be used either as a bracketing material for holding and bundling multiple conduit hose runs, or can be used by itself to construct square conduits. This is obtained as a conventional sheet, called an egg-crate light diffuser, from standard lighting and plastics distributors. For cases where components are used in displays, or teaching, the white translucent grid plate 801 has an attractive and tidy appearance.

Comparison back with FIG. 11a shows a resemblance to the register 700 input or inlet conduits, as a harmonica-like array or row of boxy or rectangular channels. This FIG. 12 shows three plates of the raw grid plate 801 attached together for handling a large array of conduit hoses (of 10×10 or larger size.) Various linear or square arrays of such grid plate material can be used in construction of components for the mechanical computer.

The following table shows the variety of devices based on the stacked lever. All have the same simple BUS interfaces, although some have multiples of such BUSSES.

TABLE 4
Stacked Lever family devices

| | TOTAL | NUMBER OF | |
|---|---|---|---|
| DEVICE NAME | SHAFTS | STATES | NOTES |
| Table-top | 4 | 4 + NIL | has display option |
| register 720 | | | |
| Decimal register 700 | 9 | 10 | most used |
| Decimal register | 10 | 10 + NIL | for FIFO buffers |
| Decimal-Plus | 11 | 10 + NIL + | flags BUS errors |
| register | | extra | |
| Decimal BUS | 18 | 10 | 11P, 10T switch |
| SWITCH 840 | (effec- | | |
| | tively 9) | | |
| WIDE BUS | 45 | 10 | 100 to 10 encoder |
| encoder 860 | | | |
| Carry propagator | 1 | 2 | processes carry flag |

### Description of Table-top Demonstrator

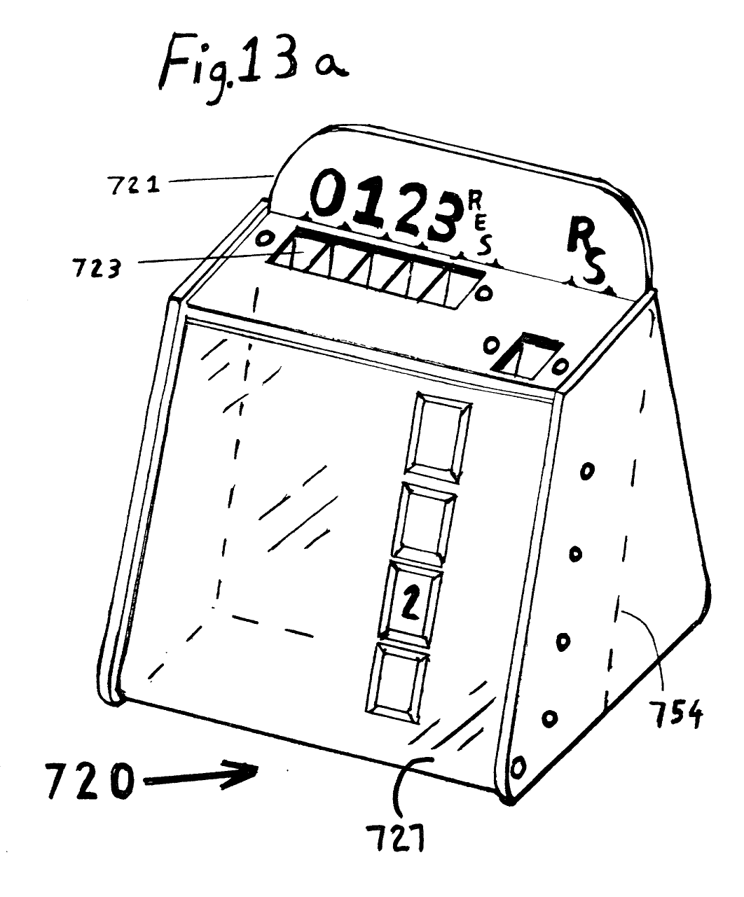

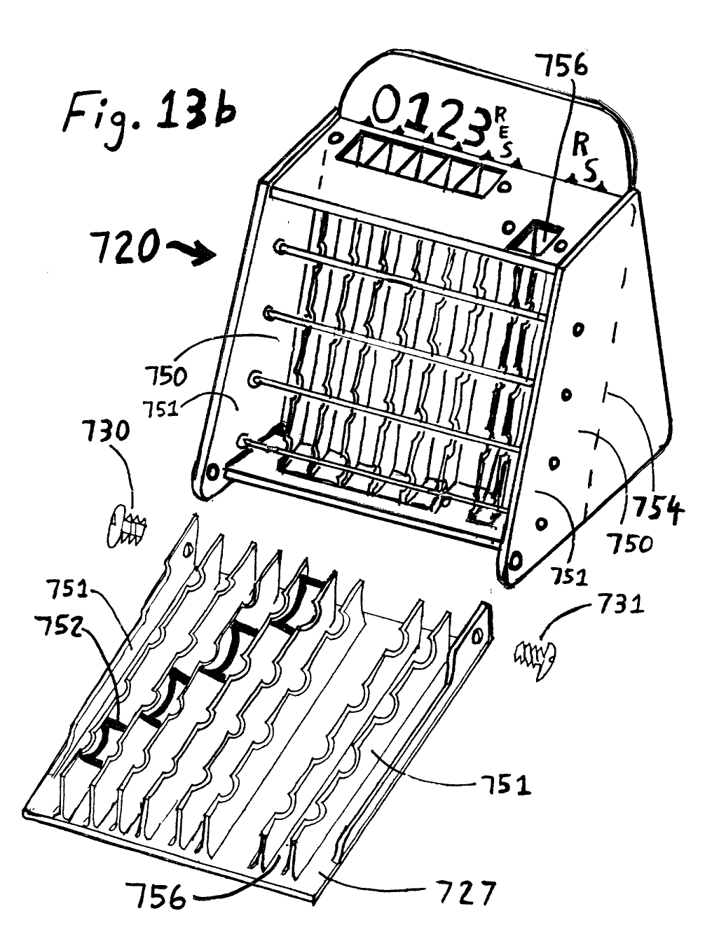

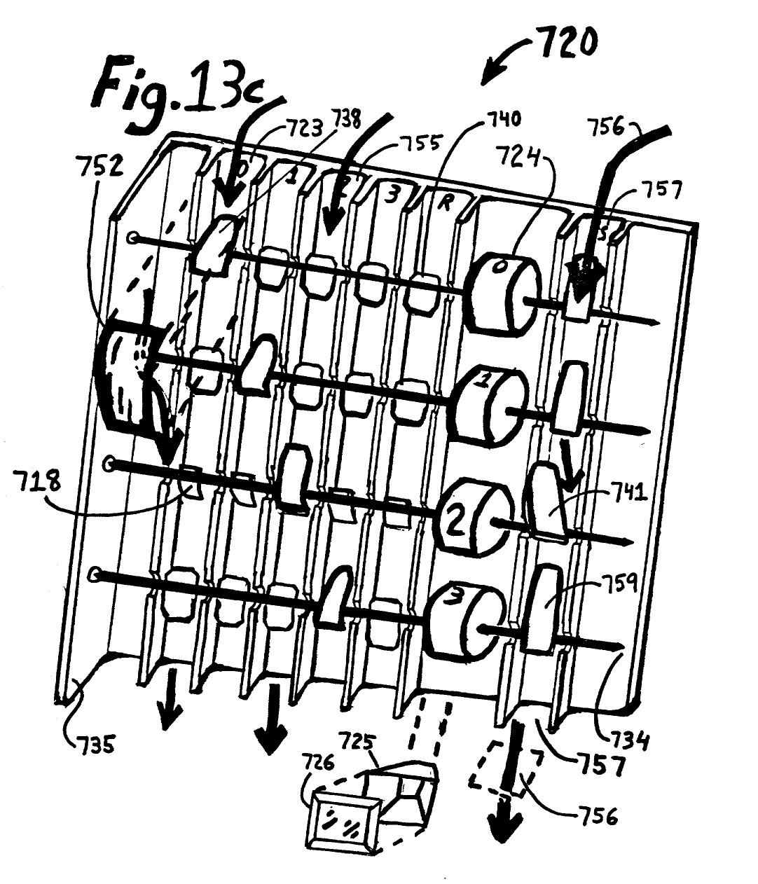

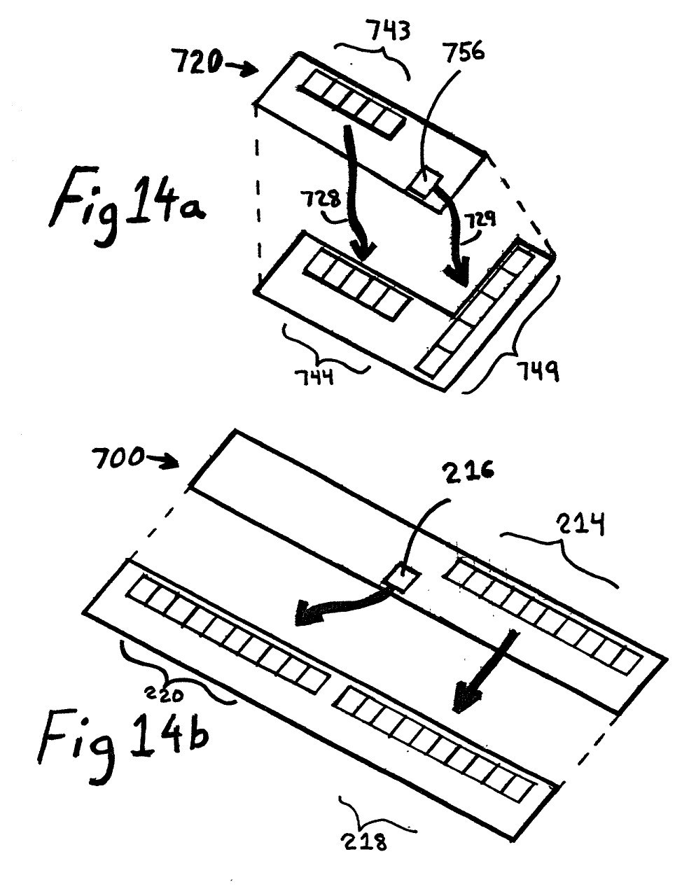

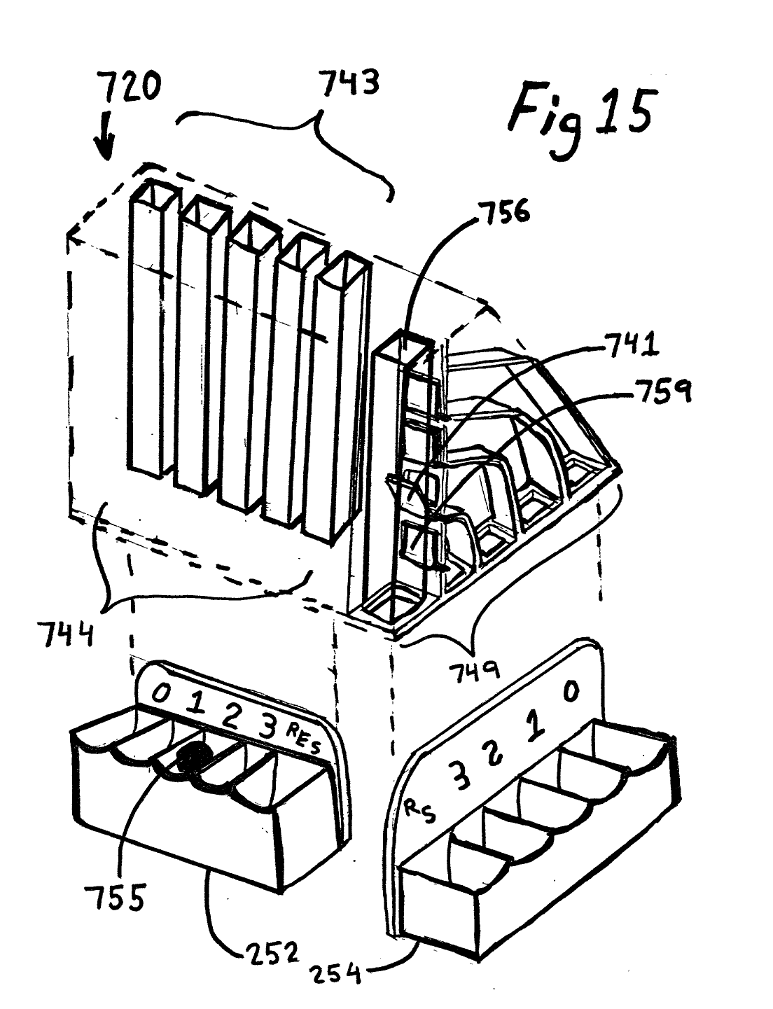

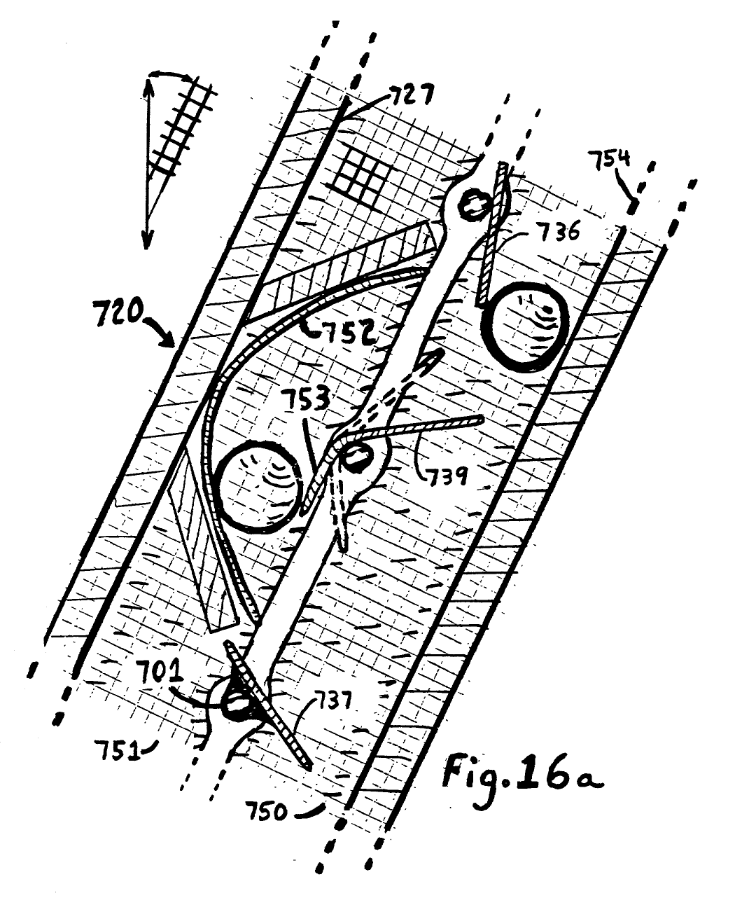

### FIG. 13a

Table-Top Demonstrator 720 incorporates the stacked lever construction concept, plus an optional visual data read-out section. Since this version has four shaft assemblies, and thus four integer data states, it is easier to teach construction and operation, rather than with decimal register 700 which has nine (or more) shaft assemblies. However, although there are expanded versions there are very few basic differences between the various types, except for capacity. Also, most decimal registers do not have the operator display means and visible input number scale that will now be described.

This variation of register has integer number scale 721 attached to the top plate of the register housing. The scale has printed on it the four digits of 0, 1, 2, and 3. Below this scale, and forward, is the top of the register demonstrator module 720 which has four conduit/duct openings. Conduit/duct opening 723 corresponds to the number scale marking of 0, and so on, so that each of the four conduit openings is identified in order underneath a printed number.

As in the previous discussion (FIG. 11b) on back plate 711 of register 700, there is here a dashed line shown on the right side of register 720 (FIG. 13a), back plate 754. This creates the same slanting book-like housing shape. Construction differs with register 720 having also a right side extension in the back, as will be shown.

### Interior of Table-top Demonstrator, Introduction

### FIG. 13b

The horizontal stacked lever shaft assemblies and interior of the demonstrator module are shown in FIG. 13b, with the module shown opened up for teaching purposes. Machine screws 730, and 731 act as left and right hinge pivots for the module to be easily opened and closed during a teaching or demonstration session.

The register interior can be described by reference to each cavity or internal volume area. The cavity division is with a front cavity, parallel to the front face, having almost exactly half of the interior volume, and with a back cavity, also parallel to the front and back faces and having the other half of interior volume. The dividing plane for these front and back cavities is the plane where the four pivoting shafts are mounted.

Back cavity 750, behind the plane of the shafts, contains four conduits for WRITES and one conduit for READS and is the main or primary cavity, for incoming data WRITE functions. Cavity 751, which is the front cavity of the register box, is the secondary cavity (shown folded out flat on the table with the register opened up.) Front cavity 751 has the same conduit layout, in mirror image to the conduit structures in back cavity 750. When operation is described, front cavity 751 will be understood to contain the path for the un-selected, pre-switched, or interrogating signal for the register data READ function. To avoid confusion, note that the READ function READ-SYNC conduit 756 is within the front cavity, but may appear as connecting to the back conduit columns, in this view, (FIG. 13b.) The top opening does not connect with the semi-vertical conduits shown in the back cavity. This READ-SYNC input does align as the top opening of conduit 756, shown in the folded out front cavity. When front face plate 727 is folded upwards or closed then the READ-SYNC inlet or input is directly above and continuous with the downward conduit 756, in the front cavity.

Readers are cautioned that reference items 750, and 751 designate large internal cavities and so are shown in multiple locations in FIG. 13b. As mentioned 751 is the front half of the register enclosure, and 750 designates the back half, using the plane of the pivoting shafts as the separator plane between these two cavities. Also, conduit 756 is identified starting with the housing top, and also identified in the front panel assembly, shown folded out.

For the incoming data WRITE function, the front cavity is for very temporary guiding of a moving steel ball. A falling steel ball that has been deflected, or scooped into the front cavity will be immediately displaced back into the former column, in back cavity 750 before encountering the next pivoting shaft assembly. A guide ramp 752, is in place in conduits of the front cavity and will also will be mentioned in step #3 of the following WRITE function operation explanation, as having the function of guiding the ball as it overturns the pivoting shaft, and then guiding the ball back to the back cavity. This structural feature acts to preserve the integer identity of the signal, as it ultimately remains within a single assigned column.

The secondary (front) cavity has the same four conduits positioned in alignment with the four main cavity vertical conduits. Each occurrence of an overturn tab has a corresponding guide ramp for returning a falling steel ball back to the primary cavity guided path. Guide ramp 752 is a simple thin curved slip that in some constructions can be made by cutting from a thin plastic sheet such as acetate and attaching to the conduit walls (walls are shown with semi-circular cut-outs.) These internal conduit walls can also be constructed or molded in a thin form. The register housing exterior can be constructed or molded in thicker more rigid form, resembling plastic boxes sold in hobby stores, providing a rigid base for supporting the thin conduit walls and attached guide ramps.

Other than the small guide ramp, there are no other stationary obstructions to either front or back conduit sets. The described tabs on the shafts can be close enough together that no other separators are needed to fully enclose each conduit for guiding a steel ball. In alternate register constructions, for wider spacing of the pivoting shafts, small thin slips of plastic sheet can be attached across the conduits, in the plane of the shafts, to maintain enclosure of each separate conduit. The front cavity conduit array, attached to the front face, is nearly identical to the back cavity conduit array. This helps facilitate using a single injection mold, by having as many common structural features as possible. Also, in keeping with the mechanical computer components being in kit form, the fully expressed but unused conduits of the front face and cavity lend to unspecified general future modifications by an experimenter. As seen in this FIG. 13b there are four so-called lever elements or shaft assemblies, each mounted horizontally in the demonstrator box. The elements are stacked in the sense that they are connected serially by conduits or ducts in a vertical manner. For reading, the switched READ outputs are run down through conduits in the right side of register 720. Another internal cavity is defined as in the right side, extending back from the register housing, to create an overall register in the shape of the letter L, which will be apparent in the next few views presented.

### Background on Commutating Switch Function

### FIG. 13c

When the operation is later described, the tab elements such as diverter tab 741 of the lever assemblies, in combination with the guiding conduit-like nearby housing elements, will be understood to be somewhat equivalent to Mechanical Transistors, or more accurately; commutating switches, each with a select output and a chain output. The terms stacked lever module, or stacked base-one lever/shaft assembly then can be loosely associated with the construction of mechanical flip flops, counters, and other interesting logic devices that operate in the numerical BASE ONE.

For multi-state reading, this stacking, or serial top-down ordering of shaft assemblies implements a series of two-state select/unselect switches whose cascaded connection creates a multiple selecting switch. In addition to operating individually in BASE ONE, this grouping of multiple selectable outputs implements logical operation in larger bases, such as BASE TEN for natural decimal math and for computer memory and register location addressing. Register 720, currently under discussion, implements BASE FOUR operation.

By way of introduction to the impulse bus, which is central to this invention, the stacked lever device as a commutating switch is for forming a path for a transmitted impulse, which is physically a moving or falling steel ball. As contrasted with electronic switching, there is no steady state or DC level conducted by the switch.

### Introduction to Pivoting Shaft Assemblies

Continuing with the stacked lever module shown in FIG. 13c, there are four lever/shaft assemblies. Each shaft has narrowed or tapered ends, for captive mounting between the two side plates, and to allow a small pivoting action to take place with reduced friction and binding. Left side plate 735 is shown, while the right side plate for pivot holes is omitted here for clarity. Tapered shaft end 734 is shown, on the right side of the lowest pivoting shaft assembly (logical #3.)

Each pivoting lever/shaft assembly is seen to be constructed with different variations of tab combinations. Since this table-top demonstrator register 720 operation is using the discrete impulse bus method the shaft assembly elements will be described with that in mind. The rules by which the register operates, are described in the detailed operation description. Each shaft is different but each has three reset tabs, such as tab 740 and one over-turn deflector tab, such as over-turn tab 738 and each shaft has these in a different horizontal placement on the shaft, according to functional design. Each of the four shafts also has a master reset tab such as tab 740, placed to the right-most of the WRITE portion of each shaft assembly.

For reading, each shaft assembly also has a READ diverter tab such as diverter tab 741 located as shown on the shaft assembly for the integer #2. By locating the READ output conduits, or BUS, against the right side of the table top register, the data READ function is made more visible, both from the observation of the passing signal, in the form of the falling ball, but also because viewers can observe the multiple channel structure. Two up-coming discussions on the data READ function will cover interior channels and operation.

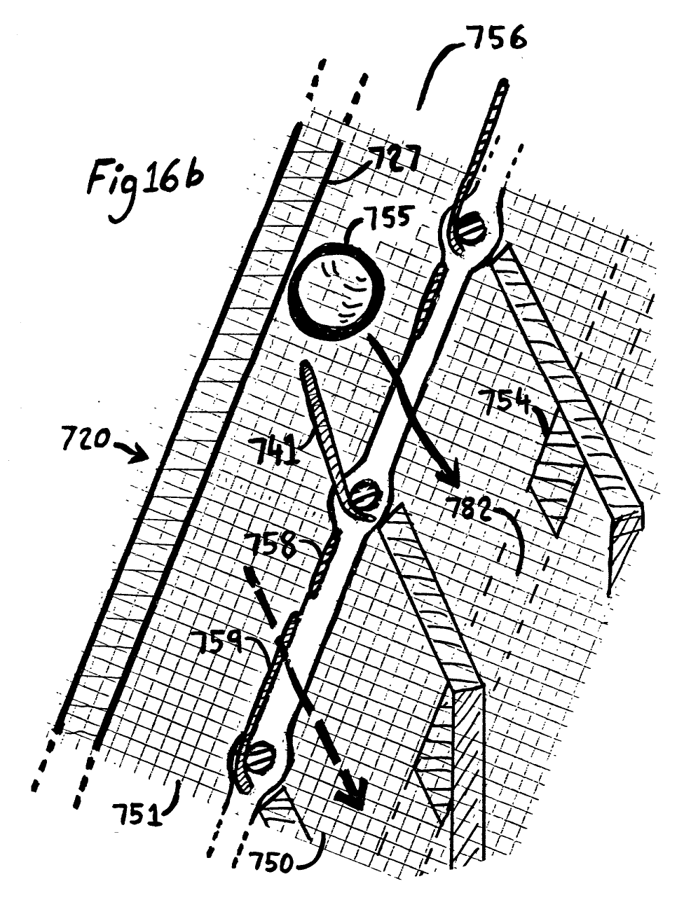

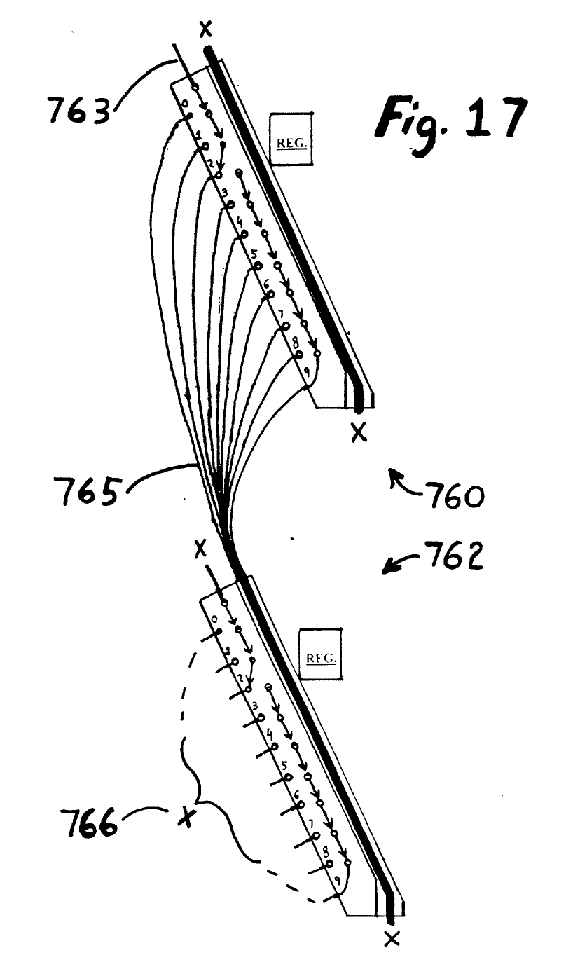

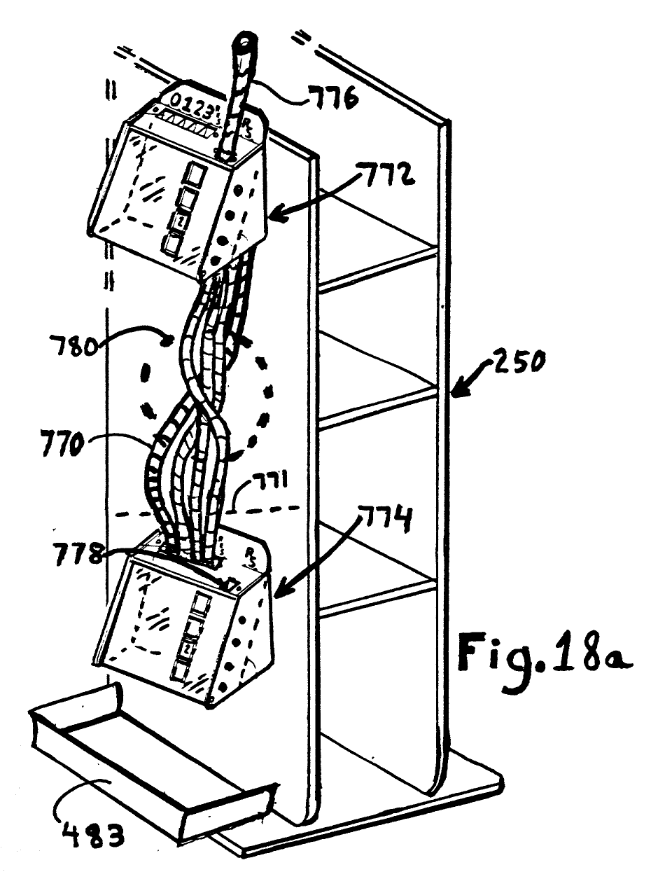

This diverter tab 741 is shown with an action or flow-path arrow behind, indicating that the diverter tab will guide a falling steel ball towards and through channel hole 782 (not shown), in the back panel of the register housing. Upcoming discussion on FIG. 15 and FIG. 16b shows this path diverting action more clearly. The thick arrow, reference 756, indicates the flow of the READ-SYNC signal inside conduit 756, (not shown), which is located in front of the series of diverting tabs. Conduit 757 is behind this series of diverting tabs, and is parallel to READ-SYNC conduit 756. Another way of explaining this is that READ-SYNC column or conduit 756 is in front cavity 751 (see the previous FIG. 13b.)

Observation of the two columns or conduits 756 and 757 can also be made at the bottom of the register interior (of FIG. 13c), where the thick flow-path arrow is shown exiting conduit 756 as the READ-SYNC chain output (labeled RS when seen in FIG. 15.) As the operation description makes further apparent, diverter tab 741 would have had to be un-selected for a ball to fall through conduit 756 and emerge from the bottom. On the shaft for integer #3, diverter tab 759 is shown, which allows the falling ball to remain within READ-SYNC conduit 756.

Specifically, the exact tab/actuator placements on each shaft are now listed:

TABLE 5
Tabs and actuators for Shaft Assemblies of Table-top
demonstrator (FIG. 13c)

| SIGNAL COLUMN: | 0 | 1 | 2 | 3 | RES | RS |
|---|---|---|---|---|---|---|
| SHAFT #0: | set | reset | reset | reset | reset | diverter |
| SHAFT #1: | reset | set | reset | reset | reset | diverter |
| SHAFT #2: | reset | reset | set | reset | reset | diverter |
| SHAFT #3: | reset | reset | reset | set | reset | diverter |

As shown in this FIG. 13c, proper operation of the register has one and only one shaft assembly resting in a selected position, in this case it is shaft #2. This mimics the dynamic signal transmission action on data BUS interconnection, where there is one and only one signal passing through one of a multiple set of conduits (I.E. a BUS.) The other three pivoting shaft assemblies, for the integer values 0, 1, and 3, show the alternate or non-selected resting positions, in respect to the internal stationary guiding conduits.

These two pivotal positions are shown with about a nominal 40 degrees of total travel, but pivot stops are not explicitly shown. Prototype development had the travel arc pivot stops provided by lengthening the tabs to stop against the housing.

### Output Display Wheels

FIG. 13c also shows an optional visual output arrangement that has display wheels (or drums) attached to each of the shaft assemblies, by way of a center hole in each wheel. Display wheel 724 indicates one of four separate wheels, each having a digit printed on the wheel cylinder surface, in a manner similar to a conventional speedometer but with only a single printed digit or other symbol. Each of these drum wheels corresponds respectively to the value of each shaft, which is 0, 1, 2, and 3. As later operation explains, only one of these numbers will be visible at a time, indicating the integer value stored in the register.

In the internal layout, there are two standardized column spaces for the display wheels, and then moving to the right, a column for the read function (conduit 757.) Lastly, there is the right side spacer column. The end spacer columns serve to give space to accommodate the taper on each shaft end.

Mask 725, and front panel lens 726 show how the un-selected printed numbers are excluded from view in the output display area. Each of four of such lenses will magnify the small print of one of the four numbers that can be displayed to the computer operator. (Also refer back to FIG. 13a.) Each wheel is positioned so that the printed digit is in the viewing field of the mask and lens, when that particular shaft is selected. Each lens is simply glued into a rectangular cut-out in the front surface of the register. In mass-produced versions of transparent construction this simple lens can be made as part of the mold. The separate opaque mask is constructed in strip form out of dark, thick paper and glued into place behind transparent front face 727 so that each of the four viewing ports has a lens for viewing the integer stored and a mask for covering the surrounding areas.

Alternately, similar larger register types can have more integer states and also a state called NIL. Specifically, a NIL state is simply another output used to indicate that the register is empty and is useful when chaining multiple registers for multiple digit FIFO type storage (First In First Out). If needed, an indicator function can be used deep inside the computer machine logic for useful purposes of diagnosing problems or monitoring the flow of integer data on a mechanical bus. Other possible indications besides integer numerals, are decimal points, plus and minus signs, and such symbols as BE, or BUS ERROR.

### Separable Mechanics Advantage

### FIG. 13c

The mechanically separable nature of a stacked lever assembly is apparent as each cascaded stage is shown with no linkages. Each separated stage, in the stack of stages, is interconnected only by the channels of the multiple, hollow conduits. The assembled stacked lever can be viewed as logic which has a processor for each possible integer data state, with this multiple processing means being the array of vertical channels and intersecting horizontal shaft elements. The processing means for any given integer signal is down along one of these vertical channels and includes select/unselect tab arrangements on each shaft.

This view shows the two types of tabs used in the WRITE section, one for set, or select action on a respective pivoting shaft, and another type for reset, or de-select action of a shaft. These two tab types have the feature of being in-line, meaning that the path of movement before and after the interaction is in a single conduit, rather than having separate conduits for set or reset. This implies that the tab types and placements determine the processing response of the mechanical data storage register, rather than the operating signal, which is not altered. Table 5 showed the scheme of this particular processing response, which is for operation of the data transfers as a discrete signal data BUS. As mentioned, these tabs acting as levers are the reason for the term used, of stacked lever device.

Although constituting simple set/reset or select/unselect action on each individual element, the overall effect of using multiples of such pivoting elements can be to implement more complex functions, beyond that shown in table 5. This embodiment, encompassing both registers 720 (four state) and 700 (ten state, or decimal), is a logical rotary commutating switch function utilizing a mutual exclusion rule for only one output selection at a time. In each of these separable, pivot-able elements, each rule set is different but similar. For example, the rule states that a particular bus signal column, such as identified with the integer three, will guide the moving steel ball down for a reset or de-select of all shafts except the same identified shaft, which is shaft#3 in this case (describing register 720.) The shafts are identified downward starting at zero, (shaft #0).

This mutual exclusion principal is part of the multiple, ten-state storage function implemented by decimal digit register 700, or by this four-state table top register 720. Other possible alternate rule sets include the function of custom translation of each individual input. For example, a variation of a stacked lever register module is defined and constructed which decrements, or subtracts one, to each input value or discrete state when stored, in other words, by alteration or manipulation of the storing function. Thus in the above example of integer column #3, the rule (for a decrementing processing function) is to reset, or de-select all shafts except shaft #2.

As seen in FIG. 13c, a conduit will guide a ball which might impact a protruding lever tab, depending on the following: The shaft will usually be rotated in one extreme of pivot or the other, which are called the selected position and the un-selected position. If a shaft is in a pivot position of selected, (as shown by the integer #2 shaft), reset tabs will then protrude into the channels, or particle raceways. For the RESET, or de-select function then, a moving ball is sent down through the channel and impacts this protruding tab causing rotation of the shaft to the alternate, de-selected position. If the shaft is already de-selected, or in the de-selected pivotal position, (as shown by the other shafts), then the reset tabs will not intrude into the channels and so no interaction with a passing ball will occur, nor is it necessary. Extending this simplified example to the general case, it is clear that each column-shaft intersection having such a reset tab will allow a signal (falling ball) in a column to de-select that horizontal shaft, or to pass if the shaft is already de-selected.

Channel or conduit 723 is the path of a ball for selecting shaft #0 (integer zero), and for subsequent de-selection of shaft #2. As seen, shaft #0, being de-selected, has overturn tab 738 protruding into the column #0 channel, conduit 723. Shaft #2, being currently selected, has reset tabs protruding into the other channels, (besides column #2 conduit 755), including the integer zero channel conduit 723. Shaft #0 overturn action happens due to a scooping action of overturn tab 738 and the guiding action of ramp 752 as detailed elsewhere (FIG. 16.) Briefly, the interaction of this ramp 752 causes the falling steel ball to be deflected back into conduit 723 and resume falling. As seen in this FIG. 13c, ramp 752 is shown pulled away from tab 737, for clarity. This curved ramp wraps around the upper shaft and tab 738. (FIG. 13b also showed the size of these small ramps.)

Placement of such an overturn tab at any column-shaft intersection will cause a select of that horizontal shaft, if it is currently de-selected, or no action if already selected. Table 5 (discussed previously) lists select and deselect tabs.

Channel conduit 755 is the path of a ball for selecting shaft #2 (integer two.) As seen by the two thick flow-path indicating arrows, a ball will fall straight down inside channel 755 and emerge out the bottom of the register housing. There will be no interaction, as shaft #2 is already selected as shown.

In a design or modification process, any desired number of stages can be stacked together without complicating linkages or other major design features that need adjustment. This stacked element concept is applied during design of any register device or module. In addition to placing a required number of pivoting lever/shaft assemblies a design process will decide the appropriate quantity and type of actuating tabs to go on each shaft. It is possible to operate each of the lever devices in concert, that is the sum total of all the devices, each with an understood individual rule set, produces a module which operates in a desired manner. In essence, any mechanical linkages, such as levers, strings, or gears, have been replaced by rule linkages by conforming to a universal rule set.

### Read Function Portion of Housing

Continuing with FIG. 13c, the table-top demonstrator 720 is a simple slanting plastic box resembling a small book. The writing function portions are in back cavity 750 (reference number shown in previous FIG. 13c), and are defined by the main box portion, bounded by the left wall and on the right bounded by the visual output wheels. Moving further to the right in relation to the shafts and output wheels, there were mentioned diverter tabs on each shaft for diverting a falling steel ball towards (and through) the back panel of the clear plastic enclosure box (see tabs 741 and 759.) Protruding from the back of the box, on the right, is a back cavity extension with a sloping back wall (not shown here), which contains the READ function parts of the register. The two housing portions intersect at right angles with the display portion and conduit 757 located at the intersection, creating a housing which has an L-shaped bottom profile.

To show these intersecting portions, or cavities, FIG. 14a presents a top down view. This view is a logical package foot-print, analogous to the electronic IC packages showing pin output assignments, and sometimes showing a logical block representing the internal logic. When using this foot-print or package representation of FIG. 14a (register 720), and also of FIG. 14b for the decimal register 700, it should be noted that the views are from above, so that the bottom connectors for the WRITE BUS output and for the READ BUS output are reversed or flipped as when viewed from an external perspective. Readers are encouraged to view these logical oriented diagrams from the standpoint of READ or WRITE functional sections. This is analogous to orienting electronics designs to logical terms rather than putting high priority on describing physical IC pin numbers, or physical wire lists. In this way, the two views of FIG. 14a and 14b are considered as logically close, even though register 720 and register 700 differ by physical placement of these particular READ sections and WRITE sections (and even though the two registers differ in base capacity.)

The thick flow-path arrow 728 indicates a WRITE BUS starting at input BUS inlets or inputs 743 and connected down to chain outlets or outputs 744. For the READ function, the thick flow-path arrow 729 indicates that register 720 is the source of a READ DATA BUS, starting at the inlet for READ-SYNC conduit 756 and connected down to READ outlet array 749. Accordingly, the order of the WRITE section vertical channels, and outlets 744, as seen from the front are then constructed to match the READ section. This makes for a simple plug or connector modular compatibility between multiple WRITE bus connections and multiple READ bus connections throughout the mechanical computer bus interconnections.

FIG. 14b illustrates in the same manner, the decimal register 700 WRITE BUS input connector for data cable 214, and chain output connector for data cable 218. For a READ function, READ-SYNC input connector 216 sources a READ DATA BUS, for the output connector to data cable 220.

This view of the input and output interfaces of FIG. 14 helps when comparing with the following discussion on the internal signal paths, FIG. 15.

### Interior Write and Read Function Areas of Table Top Demonstrator 720

### Flow-path Model

### FIG. 15

A glance at the flow-path model of register 720 makes it apparent that the WRITE logic portion is a simple BUS pass-through, omitting internal shafts in this view. The five WRITE section inlets, WRITE INPUT BUS 743, connect through to the private ducts or conduit channels and essentially straight down to outlets, WRITE OUTPUT BUS 744. Integer signal assignments are 0,1,2, and 3, constituting the invention discrete impulse BUS, plus a master reset signal. If the display option is not needed then register 720 can also be operated with a fifth data state, using the master RESET as an input for the integer value of four (4.) This deviates from the usual case by having all shafts in the de-selected position. From a BUS perspective, however, all of the discrete data BUS signals operate consistently, that is, there is always just one and only one active moving signal impulse at any given time, or none if the BUS is idle. This is the defined discrete BUS operation, regardless of the variations of internal logic options used to create such data BUS transmissions.

For a READ function this flow-path model shows a multiple path switch having one input, conduit 756, and five outlets, READ output BUS 749. The referenced conduit 756 includes the whole square duct extending down and then ending as an outlet chain output at the bottom of the register housing. This conduit 756 is the un-selected READ-SYNC channel and is one of the five conduits of READ OUTPUT BUS 749. These five outlets of BUS 749 are symmetric with the signal definitions given for the WRITE signal conduits, that is, the READ and WRITE BUS outputs of the register are functionally symmetric. If register 720 is to be operated with the five-state option, then a READ uses the READ-SYNC chain signal (labeled RS in catch-bin 254) as the output indicator of the integer value of four (4.) A signal on the RS chain output indicates that no shaft is selected, which is symmetric with the MASTER RESET (labeled RES in catch-bin 252) WRITE BUS signal which indicates that all four shafts have been previously de-selected. As mentioned, this description of register 720 also applies to decimal register 700, although without a display wheel option. The decimal register 700 operates using nine shafts, and, like this above register 720 discussion, operates using the non-selected default state to feature ten states for decimal data BUS operation.

While for clarity this view of FIG. 15 omits the four shafts and attached tabs for WRITEs, there is shown the four diverting tabs for a READ function. Since this view has the four-state register 720 shown in the integer state of TWO (2) diverting tab 741 is seen opened or selected for diverting a moving ball from the READ-SYNC channel or conduit. Another diverter tab 759 is shown on the un-selected shaft for the integer #3, in the alternate non-selected position of a closed or non-diverting position.

The inlets and outlets are for manual use, that is, they are to be hand fed any steel balls that are used to demonstrate the register operation. For connected machine uses, however, these are interface signals and INPUT/OUTPUT ports. For this purpose, hoses or conduits can be plugged in with friction fit in a manner that resembles electrical wire connection on bread board arrangements. Optionally, the indicated WRITE conduit ends 744 can be extended and fitted with shoulders for controlling the depth of insertion.

This friction fit connection resembles the line of boxy conduits which one blows into when playing on a hand-held harmonica. The material for this can be alternately obtained from the square channeled fluorescent lighting diffuser material, raw grid plate 801, mentioned under the previous special construction materials section. The grid plate material provides integral strength in all directions except the insertion direction for supporting any connected hoses which may otherwise introduce distorting stresses on the register housing. In many situations there are no connected hoses since a teacher or operator will be manually feeding such conduit inputs to register 720.

For the output, there can be an array of small catch buckets put below outlets for illustrating to students the outcome of a WRITE action or a READ action. This is a crude output indicator in which a teacher can then pick a resulting ball back out of an output catch bucket. For example, if a number of integer value of two (2) is sent through register 720 for latching, then steel ball 775, which represents this moving data signal impulse will drop into pocket #2 of WRITE BUS catch-bin 252. Later, a ball dropped into the input or inlet of READ- SYNC conduit 756 will emerge from the register 720 as one signal in the READ OUTPUT BUS 749 and drop into pocket #2 of READ BUS catch-bin 254.

Observation of FIG. 15 also shows how easy it can be to gang together multiples of the READ section for construction of a BUS switch, as will soon be discussed. A BUS SWITCH has more columns, each with an individual READ-SYNC inlet or input, and each with a multiple conduit READ OUTPUT BUS, as shown in this view for the single read section.

### Calculation Diagram, Register Interior for Write Function

### FIG. 16a

A side flow-path schematic or engineering view is useful in designing for reliable function. Mainly, each ball must pass through without binding or jamming, and each desired actuation must be complete. One type of mechanical actuation is where a moving ball completely pushes a tab and rotates a pivoting shaft assembly, completely to one first stop position, or completely to a second stop position. This includes the case where such pivotal position already pre-exists, and the ball simply passes by without any tab collision. Also, an actuation is when a diverter tab completely deflects a moving ball into a second flow-path, where normally the moving ball would have continued on a distinct first flow-path.

This FIG. 16a provides a view of the lever/shaft assembly with the diverter which extends into the main conduit channel and scoops the moving ball forward, into the temporary conduit or channel. Almost immediately, the ball is guided back into the main conduit duct by guide ramp 752. Since the shaft has a small tab 753, it is overturned by the passing ball. By this action, any one shaft is selected in any given data WRITE to register 720.

Select and un-select actions are considered to be elemental in the sense that only one pivoting assembly is involved (at a time.) Also considered elemental is a single deflection of a moving ball by one tab. This immediate discussion concerns these elemental physical actions, of one pivot action, or one ball deflection action. The view of FIG. 16a is presented with consistent shaft positioning shown, relative the other views, FIG. 13c, and FIG. 15.

The empirical starting point for these two design calculation diagrams is seen in FIG. 16a as a structure with two parallel plates, (front face 727 and back plate 754), with an internal cavity divided in half by the plane of the shaft assemblies. Seen in the left half is cavity 751, and in the right half is cavity 750. These are raceways, or flow-paths, which are enclosed as also seen and discussed in FIG. 13b. Grid squares, for a graphical design calculation purpose, have 1 mm. (millimeter) per square. The most literal and exact representation of construction is given, including the nominal 15 degree flow-path angle or lean which the register 720 housing has.

That means that the exact shaft diameters and the precise attachments of tabs are shown, so that any clearance conflicts become apparent in the drawing. Specifically, it is observed that tabs are offset from shaft centers and can be attached on either the left or the right side of the shafts (as viewed in this FIG. 16a.) Reset tabs are attached on the shaft right sides, while the overturn shafts are attached on the left, for best advantage relative to the particular ball and tab interaction.

This most-detailed analysis goes way beyond a basic function description but is necessary for a reliable design. For example, attaching the reset tabs on the other, left side of the shafts, (shown in cross section), using a dab of quick set epoxy resin glue would cause a shift of the usual reset tab location by almost 3 mm. That is a difference in location of half the diameter of the ball. Also, any such glue dabs can be visually checked for avoiding mechanical interfering with other moving parts.

The lowest shaft in this FIG. 16a view has a typical glue fillet 701, for attachment of the reset tab shown, (fillets are omitted for clarity on the other two shafts shown.) Details such as this glue fillet can be checked for possible interferences.

Comparison of reset tab 737 with reset tab 736 shows clearly the two possible pivotal extremes. Taken literally, if FIG. 16a is to be associated with the other views (I.E. the example integer two (#2) composite position of FIG. 13c), then reset tab 737 is the logical shaft #2 tab, and reset tab 736 is the logical shaft zero (#0) tab. This is for correctly viewing the FIG. 16a diagram as having shaft #2 in the selected position. Furthermore, overturn tab 739 is on logical shaft #1, which indicates that the ball-action path or raceway shown is of the conduit for logical column #1. In this sense readers are cautioned that FIG. 16b is not of the same shaft sequence. FIG. 16b is a separate calculation diagram showing a sample of several shaft assemblies and associated signal BUS conduits.

### Calculation Diagram, Register Interior for Reading Function

### FIG. 16b

Looking from the right side, FIG. 16b, each lever assembly is seen to have associated an individual channel which then connects down to the READ BUS output array of the register. This is outlet array 749, seen in the FIG. 15, flow-through diagram. The assignments of this linear array are the integer output values 0, 1, 2, and 3 in order from the back to the front. This corresponds with the order of the shaft assemblies, physically downward from low to high integer representation, (0, 1, 2, and 3).

FIG. 16b shows a sample close-up of three adjacent shaft assemblies. Steel ball 775 is shown falling down inside conduit 756 for deflection by diverter tab 741, which is in the selected position. As part of this detailed, worst-case analysis, the ball is shown having zero clearance with the bounding wall of front face 727. Diverter tab 741 must then protrude, as shown, to at least close enough to face 727 to assure deflection. This distance is assumed to be perhaps one-half the diameter of the ball.

This calculation diagram helps in evaluation of empirical, or trial and error optimizing. Specifically, FIG. 16b helps in evaluating performance expectations for an optional smaller ball size. Steel ball 775 is shown as 6 mm. diameter. For substituting a 4 mm. diameter steel ball, diverter tab 741 must be extended in length. How much is required is somewhat empirical. This calculation view shows the diverter tab as reaching into conduit 756 to leave a gap equal to one-half of a ball diameter, when practically this value could vary widely. For example, if the gap is made much larger, the ball in many cases is diverted just as flawlessly, but a point is reached where there can be some very intermittent malfunctions. A malfunction would take place, for instance, as a ball falling in a path to the extreme left of conduit 756, such that it would not be properly scooped by diverter tab 741 on the selected shaft assembly. This would then cause the register 720, in the example of integer data two (2), to send a data indication or output on the RS output, rather than the correct integer two output, on the READ OUPUT BUS.

The main purpose of FIG. 16a and FIG. 16b is for establishing wide tolerances for reliable computer functions. The conclusions brought by these two calculation model views are that physical tolerances are moderate, roughly approaching 1 mm., and that some areas require special attention and care for predictable function. Throughout these two views, it is conventional accumulated tolerances that need to be accounted for. This degree of construction accuracy required is only moderate, as compared to automotive machines, for example.

### Operation

### FIG. 13c and Views of FIG. 16

Table-top demonstrator 720 allows operation of a data bus in a novel way. Actually, it is this bus that is considered a prime part of the decimal mechanical computer system. Readers should recognize that the table-top demonstrator teaches a favored way of signal operation in the mechanical computer components invention.

The table-top demonstrator 720 teaches details of construction and operation that are then applicable to a whole family of devices. As mentioned, these are based on the stacked base-one lever type of design, which uses cascaded stages. (To understand the separable nature, or the stack-ability of the lever /shaft assemblies return to previous discussion, FIG. 13c.)

### Designing for Discrete Impulse Operation

One application of the operating rule set concept, is the operation of a discrete impulse data bus, using simple mutually-exclusive, or one-at-time signaling. In order to transmit or transfer data there is a conduit/duct assigned one for one with each represented integer number, or state.

Operation is designed to be mutually exclusive, that is only one of the lever/shaft devices is active, or selected at a time. Each pivoting lever/shaft element is two-state in that it has two stable equilibrium positions. In physical terms, there is a temporary transition time when there may be more than one lever selected, or none selected. This is due to the traveling, or guided falling steel ball, which acts on one lever assembly at a time.

The total of all the actions of the falling ball as it has potential interactions with each of the pivoting levers is designed to ultimately follow the mutual exclusion principal. This principal is the linkage between the moving parts of the stacked lever module.

### Bus Operation Concepts, and Device Variations from a Bus Operation Perspective

It is helpful to use a BUS operation or logical perspective in this description. Noting in FIG. 15, the register gives what it gets, from a black box view. A ball goes in, and is internally diverted to one outlet in the linear array of the READ OUPUT BUS. For a quick discussion of a completely different register device (not shown), a leaning toggle having stable positions was constructed, having three or five integral states, for writing in and reading out. This multiple resting state toggle has the same BUS operation (as registers 700 and 720.) The practical limitations are for a maximum of five states and having only one switched signal path.

The purpose of this discussion is to illustrate an interesting aspect, especially apparent in the views of FIG. 14 and FIG. 15. The multiple discrete integer signals of the READ linear output array resembles an analog range of real numbers, if the conduit separators are omitted from the output. Thus there is the suggestion that an analog register be built, having a smooth range of values in the hypothetical internal leaning toggle, and thus having smooth ranges of input (WRITING) and output (READING.) This so-called analog data register is anticipated but not fully described in this disclosure.

Also, this brief discussion on the hypothetical leaning toggle switch helps emphasize that operation here is now to be described in high-level logical terms, rather than purely physical mechanics (i.e. overturning or reset of a shaft.) These high level functions are primarily BUS interface and data transfer oriented.

Continuing this interesting discussion, it can be noted (see FIG. 14) that the digital or discrete state BUS operation is approximately analog, or actually literally step-wise QUANTIZED. A larger capacity register (or sub-system) can be used, such as having 100 states, for a BUS that has relatively small quantized steps in a near-smooth range. Also, such a near-analog BUS has the feature of using the same (strong) signal impulse (I.E. a falling steel ball) for any signal, regardless of analog value transmitted, feeble or strong.

### The Operation of Reading the Register

### FIG. 13c and FIG. 16b

Having previously discussed the elemental READ operations, (previous FIG. 16) the logical or totality of register and BUS interactively will now be detailed. The aforementioned example will be used, where register 720 is resting in the composite state of integer number two.

In a first resting position, a pivoting shaft is in a de-select mode and a READ-SYNC signal is then simply passed or chained down to the next shaft. The term READ-SYNC is an equivalent (new) mechanical computer term for a clocked read pulse similar to the electronic term of OUTPUT ENABLE (OE) or CHIP SELECT (CS). This analogy only goes so far from a physical signal standpoint because most electronic IC chips present outputs as steady state levels. In the mechanical computer invention the signal READ-SYNC represents an impulse used for interrogation of the register state. On a logical level however, READ-SYNC most closely resembles the electronic signal CHIP SELECT (CS) as most electronic CS signals are pulsed by the system controller even though the resulting chip outputs are presented as steady states during the presentation pulse interval.

As mentioned, a shaft assembly in a first resting position is de-selected and a passing falling steel ball will cross small gaps (FIG. 13c) between tabs, and then traverse down the front surface of each deflecting or diverting tab, such as tab 759. Each deflecting tab is shown parallel or aligned in the direction of signal travel (falling steel ball), until the selected shaft with deflecting tab in the protruding position is encountered. Until then, the falling steel ball continues to each next shaft assembly where this process repeats, that is the steel ball continues as a pre-switched control signal to interrogate the next stage (pivoting shaft assembly).

The shaft #2 assembly, being selected, is situated in the primary or first position. This is continuing the example of register 720 being in a state of integer number two (#2.) In this case the falling steel ball is caught or scooped by the back surface of active deflecting tab 741 so that the steel ball is no longer falling through the chain of deselected shaft assemblies. By this deflection, the steel ball has resolved or read the position of not only the current single shaft but has resolved or read the composite position of the register. The falling steel ball is now representative of DATA. This is directly due to the discrete definition of the impulsive bus where the falling ball is guided in an individual conduit (or plastic hose) which is identified with one of the multiple integer states of the bus system.

As seen in FIG. 15 the guiding conduits or channels from the selected outputs of each of these pivoting shaft assemblies forms an output set or bus which could alternately be embodied by the combination of a grid plate material 801 and a set of inserted hoses for downward propagation of the newly resolved data. When the register has been read the output comprises an integer digit transmitted on the output bus.

### Register Write and Timing

### FIG. 13c and FIG. 16a

In the example, the digit register has the number TWO (2) stored. This means that the shaft for logic state #2 is in the selected position. All the other shafts, that is for #0, #1, and #3, are in the de-selected position, as specified in the mutually exclusive operation of the bus and device.

Supposing a write data impulse is arriving with a value of zero (#0), as shown by the thick flow-path arrow for conduit 723 (FIG. 13c.) This will be expected to over-write the digit that is already stored in the digit register, that is two (#2). Readers should recognize that this similar to the TTL 7400 series functions and can refer to the 74LS192/74LS193 counter for details of electronic register operation. In brief, however, a binary four bit word and a LATCH -ENABLE signal causes the electronic device to store the new data. This provides the reader with a dynamic comparison by which to learn the function of the mechanical computer logic.

The bus for this described mechanical device is very much different from the conventional electronic binary bus. The similarity is that both computer devices will acquire and output approximately one decimal digit of data. This dynamic acquisition of meaningful data, and its processing, is the model of thinking that helps experimenters and students to visualize logic functions.

Continuing the discussion on the WRITE operation timing, this WRITE data impulse is arriving with the value of zero (#0). Of course, this simply means that an arriving steel ball is falling in the conduit hose for logical zero (#0) and will fall down into, through and out the bottom of the register, in the logic #0 column (also see thick flow-path arrow exiting conduit 723.)

The sequence for this example integer zero (#0) data WRITE is: (FIG. 13c)

1. An arriving logical column #0 impulse (conduit 723), in the form of the falling steel ball, will pass the shaft for logic zero (#0), and will interact with diverter tab 738, for a setting action. This is a special place in the 5 by 4 array (horizontal×vertical) of column and shaft intersections. That is because diverter tab 738 is both attached to logical shaft #0 and used with logical signal column #0. For setting a zero state, and alternately for setting a any of the other states using the other signal conduits, each such coincidence of same logical horizontal shaft with same logical vertical signal column needs to have a diverter tab for setting or selecting, as in tab 738, shown.

Table 5 also showed this diagonal pattern to the four diverter tabs in register 720.

2. This same impulse, continuing down logical column #0 (conduit 723), next encounters logical shaft #1 but passes with no interaction. As seen, shaft #1 is de-selected and so does not have a reset tab in the flow-path (of conduit 723.)

3. The steel ball then continues down to the shaft for logic state two (#2), or logical shaft #2. As can be observed, (FIG. 13c), the selected state of logical shaft #2 causes reset tab 718 to protrude into the logical zero column, conduit 723, which the moving ball will impact to cause a reset or de-select action.

4. Lastly, the steel ball encounters logical shaft #3, mounted lowest in the register 720 housing, and as in step #2, passes by without touching a reset tab.

In conclusion on the WRITE timing, there are two interactions, of ball and shaft, and two misses, having simple transit delays only. It should be apparent that these four possibilities occur in different orders, depending on which logical signal column is being considered. This example is called a new data WRITE, meaning that active changes to the positions of pivotal shafts will occur.

As mentioned, after the steel ball has passed through the digit register, in this case on the conduit for logic zero (0), the ball then can continue as the same signal for further use in a serial chaining to additional register devices. It is found, however, that most conventional computer data processing transfers usually have only one destination register or memory word. In that case the serial chain outputs from the register are routed for discarding, to a particle discard drain, such as drain 123, discussed in the system introduction section.

In various implementations it is useful to route an address, for path selection, to multiple locations, and it is for this multiple address distribution that serial chaining is useful. In electronic IC's (integrated circuits) this multiple distribution of logic output is called a FAN-OUT. (FIG. 15 shows serial chain output BUS 744, used in connecting for writing to multiple chained register devices.)

Taking a second example, an integer two (#2) WRITE sequence is now discussed, using conduit 755, shown in FIG. 13c. From a BUS signal perspective this integer two (#2) signal is preserved through and out of register 720, just as in the previous integer zero (#0) example. The large flow-path arrow shows that a signal on conduit 755 (a falling steel ball), will not touch any tabs on the four shafts. Thus this example could be called a repeat data WRITE, meaning that no changes of shaft pivotal positions are required.

### Continued Discussion of Write Timing

For each write function, of states zero through three, (0,1,2, and 3), there will then normally be either two interactions, or none. One interaction will be the de-select action on the old state, and another interaction will be a select action on the new state. If the new state being written to the register is the same as the data already there, then there will be no interaction as the steel ball passes through the register. FIG. 16a showed in close-up the elements involved in selection and de-selection.

Since the two interactions mentioned above give an approximation of logic propagation delay, this could be used by other parts of the system design when considering timing. By incorporating a proper delay before reading, specifically in relation to initiating a READ-SYNC impulse, after a previous WRITE has finished.

In other words, the system, after issuing a WRITE data to a register, can use the register in a READ as long as a logic race does not occur. Thus if, for instance, a system READ path is shorter, and therefore faster, than the WRITE path then additional delay or wait states may have to be added to assure that the WRITE is finished before any READ impulse reaches the register.

### Read Timing

### FIG. 15 and FIG. 16b

The composite, or whole state of the register is what is important. This means that even if there is one shaft in the selected position, the system depends also on the other shaft assemblies being in the de-selected position, and thus pass the signal properly. In the digit register, the READ section consists of a deflector tab on each of the shaft assemblies and serial chaining of the un-deflected signal to each successive shaft assembly.

Thus by dropping a steel ball into the path of this chain of deflectors the register composite state, and thus the digit stored, is read. This ball, or impulse, is the signal impulse READ-SYNC, and could be thought of as a synchronizing clock or as an interrogation pulse.

A READ then, will introduce a propagation time delay of just one deflection, no matter the register size. The interaction robs the moving particle of some inertia, which is exchanged with the deflector 741, (FIG. 13c or FIG. 15), and causes some sideways motion in the particle path. In addition, each passage past a shaft assembly that is de-selected adds a simple transit distance time delay, and some extra friction, as opposed to a simple smooth conduit. FIG. 16b helps show the surfaces which the falling ball rubs against and rolls against.

This simple transit delay varies according to the digit stored, since there is an order from top to bottom. In the TABLE-TOP DEMONSTRATOR (register 720) shown, and most registers, the digit sequence is low to high, (0, 1, 2, 3), and so digit three (3) has the longest transit time along the un-selected path. Many of these considerations of timing can get complex due to variations in the mechanical bus paths through the various elements of a system.

The logical digit that is read is then dispensed, or transmitted into a conduit set that connects to the bottom of register 720. This is considered the READ bus output of the register. The conduits are assigned in like manner between the WRITE section inputs and outputs and the READ section outputs. This means that a read will reproduce an identical bus image of the signal that previously arrived on the WRITE bus.

### Data Transfer System

### FIG. 17

This description applies to the stacked lever register type, and the discrete bus logical transmission type. Decimal Register 700 is the preferred embodiment, with some apparatus shown using the smaller Register 720 (having four states, described in the immediately previous discussion.) Separate reference numbers and views will be given, to reduce confusion.

In FIG. 17 is shown a block connection schematic diagram of two identical copies of decimal register 700, which are vertically mounted. Register 760, the upper register 700, will be the sender, or data transfer source in this example. Lower Register 762 will be the data receiver. READ and WRITE portions of the two registers are interconnected, (749 down to 743.) Because the bus standard is the same, that is the identification of signals is the same, the upper register READ bus outputs can simply be directly connected down to the lower register WRITE bus inputs.

For the stimulus, or strobe impulse, READ-SYNC signal 763 is connected down from an origination controller means (not shown.) For after the data transfer, Register 760 WRITE outputs connect down to the discard drain (not shown.)

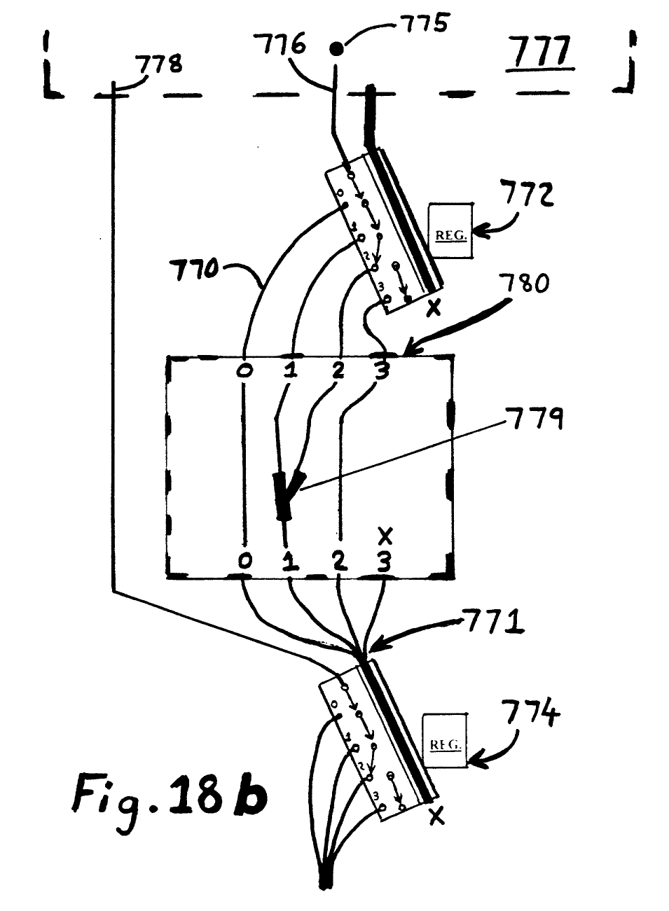

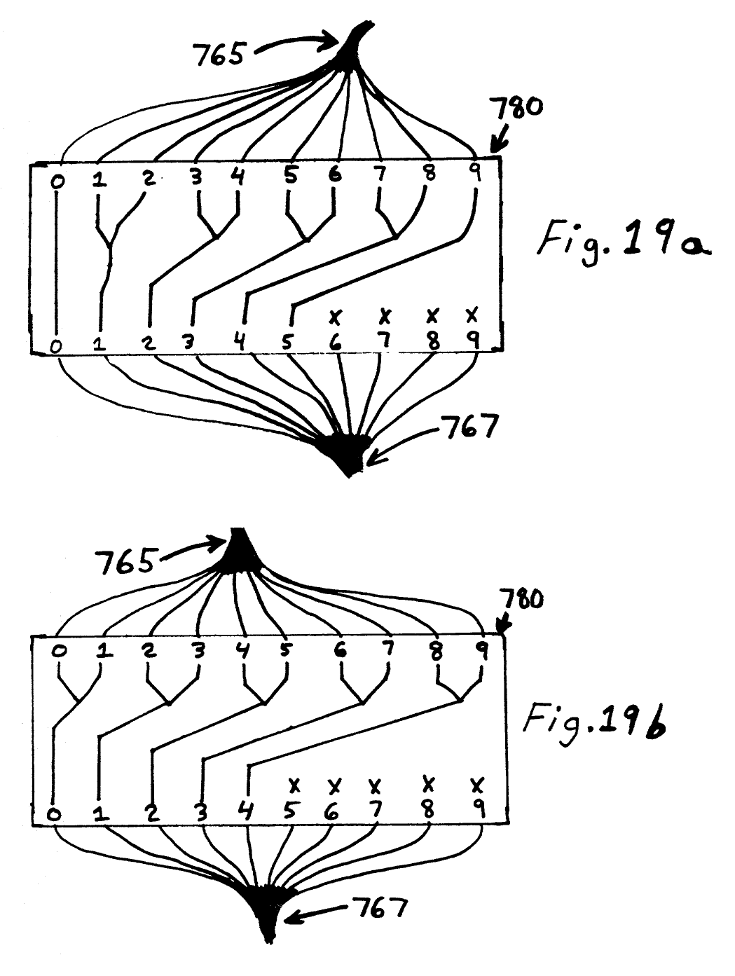

For implementation of this block diagram, but now with the physical substitution of the smaller Register 720, for clarity, FIG. 18a shows experimenter's rig 250 having two parallel rectangular sheets of rigid material which are mounted vertically or upright. As mentioned previously for the CM-1 machine there are numerous pre-drilled uncommitted holes which are used for mounting the sender and receiver registers using conventional #6 machine screws, washers, and bolts.

Continuing discussion using the four shaft register, conduit hoses 770 are placed individually by hand by inserting approximately 12 mm (½ inch) into each respective register outlet or inlet, such as hose 770 for the integer zero BUS signal. Hose bundle, data transfer BUS 771, is the data BUS input for writing to lower register 774. The system controller issues the READ-SYNC 776 signal (ball 775) down to the devices to perform a data transfer. Only the downward direction of data transmission is shown, omitting a READ-SYNC connection to the lower register (778.) For a data transfer BUS, transparent hoses run down diagonally from upper register 772 READ section, which is in the right side extension of the register housing, and then down to lower register 774 WRITE section, which is situated in the left half of the register housing. A friction fit is sufficient to hold these hoses fast but optional conventional hose brackets can also be added (not shown.)

BUS processor 780 is an indication of a general region or volume for data transfer and for processing of the moving signal, by way of some general change in the position or flow-path. Loosely, data transfer BUS 771 could be termed as the output of BUS processor 780.

### Operation of Data Transfer

### Using Decimal Register Connections, FIG. 17

Operation for register-to-register data copy is simple. The origination/control means can be a machine instruction sequencer or it can be manually issued by a teacher or demonstrator. Data transfer is initiated by the sourcing or dispensing of a particle (steel ball 775) to the system READ-SYNC conduit 763. By flowing or falling through the upper register READ section, steel ball 775 could be said to acquire positional encoding, which may also be called horizontal modulation. This encoded signal is simply conducted down, via BUS 765, as the second or lower register WRITE input bus, where the encoded integer signal state is copied as previously described in the section on register WRITE function and timing. (Note that the housings of the four-state register 720 and the ten-state register 700 have the BUS locations in physically different places, but are logically similar.)

After the signal passes through the second, or lower, receiving register 762, it is discarded using signal combiner 766. Since the signal is a single ball, there is no possibility of a jam-up in the Y signal combiner. In other words, discrete BUS operation by definition is only one signal at a time, in only one of the multiple signal conduits. In function, bus 765 constitutes a one-to-one multi-element look-up, or translation table by hardware connections. This example merely applies a unity function which gives no change of encoding during the transmission position.

### Simple Bus Processing

Examination of FIG. 18a reveals an interesting opportunity to re-arrange the lines of the data transfer bus 771. By mounting or rotating by 90 degrees the upper register for aligning its READ section outputs directly over the lower register WRITE inputs, or bus port, it becomes apparent that there could be a direct free-fall downward port-to-port connection.

With this arrangement of FIG. 18a there is a huge range of possible useful connection variations which essentially perform a look-up translation table function on the transmitted integer. For example, a transfer function with saturation effect can be made by the connections of FIG. 8b, which implements the following translation from upper transmitting register to the lower receiving register.

TABLE 6
BUS PROCESSING BY LOOK-UP TABLE (FIG. 18b)

| input integer | output integer |
|---|---|
| 0 | 0 |
| 1 | 1 |
| 2 | 1 |
| 3 | 2 |

The next example assumes data transfer BUS operation using at least two decimal registers, (register 700), identical in connection methodology and operation to the four state device just described. The examples of divide by two with rounding and of divide by two with truncation will now be listed:

TABLE 7
VARIOUS TYPES OF LOOK-UP

| | output integer, rounded | output integer, truncated |
|---|---|---|
| input integer | (implemented in FIG. 19a) | (implemented in FIG. 19b) |
| 0 | 0 | 0 |
| 1 | 1 | 0 |
| 2 | 1 | 1 |
| 3 | 2 | 1 |
| 4 | 2 | 2 |
| 5 | 3 | 2 |
| 6 | 3 | 3 |
| 7 | 4 | 3 |
| 8 | 4 | 4 |
| 9 | 5 | 4 |

The subtle differences of these two transfer functions, are shown in FIGS. 19a and 19b. The T combiners are used in the hose connections when any two or more input lines merge to cause a same output line to carry a signal. Any pre-calculated real number function can be used. For example, a table could be generated for a transfer function which divides by 2.3 (two point three) and then rounds to the nearest integer (not shown.)

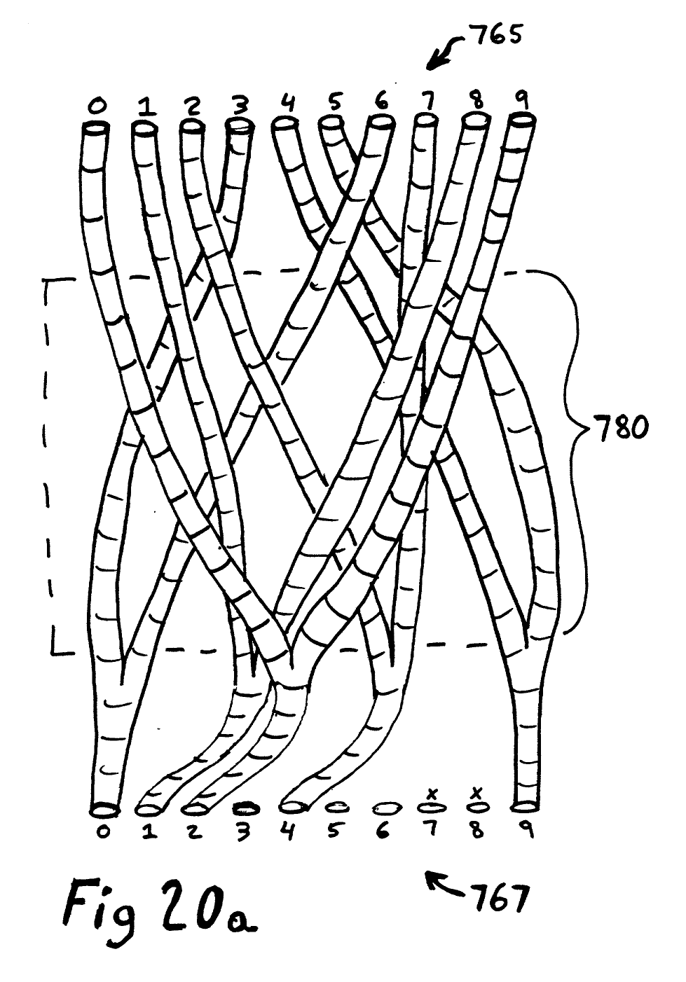

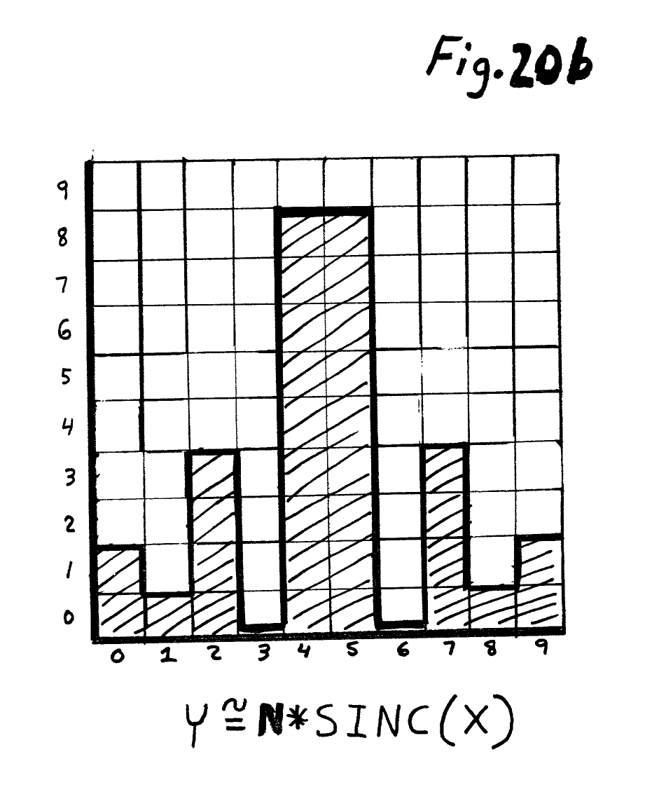

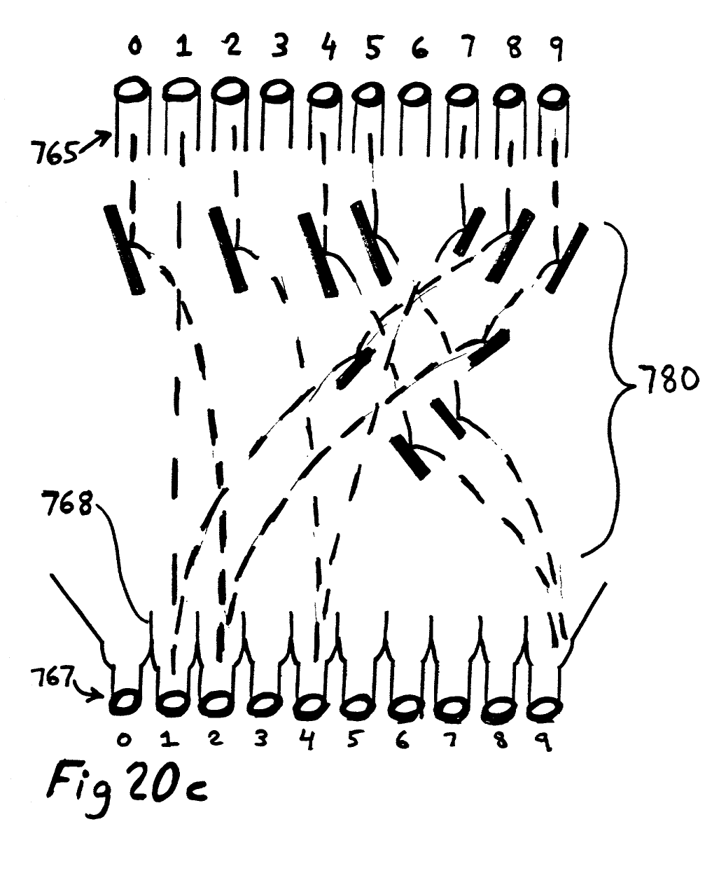

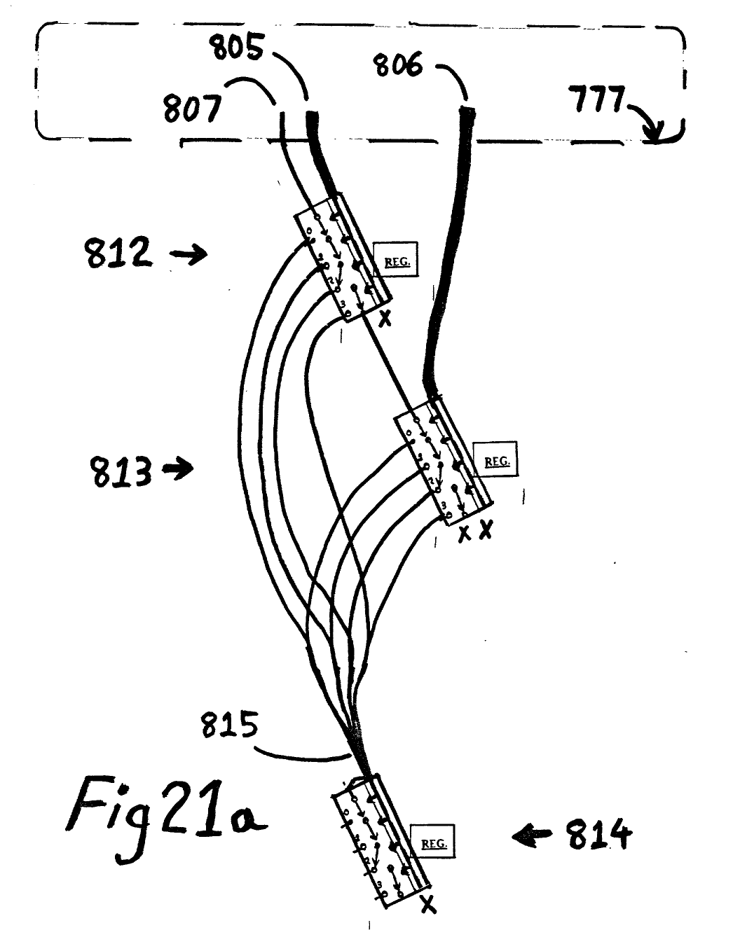

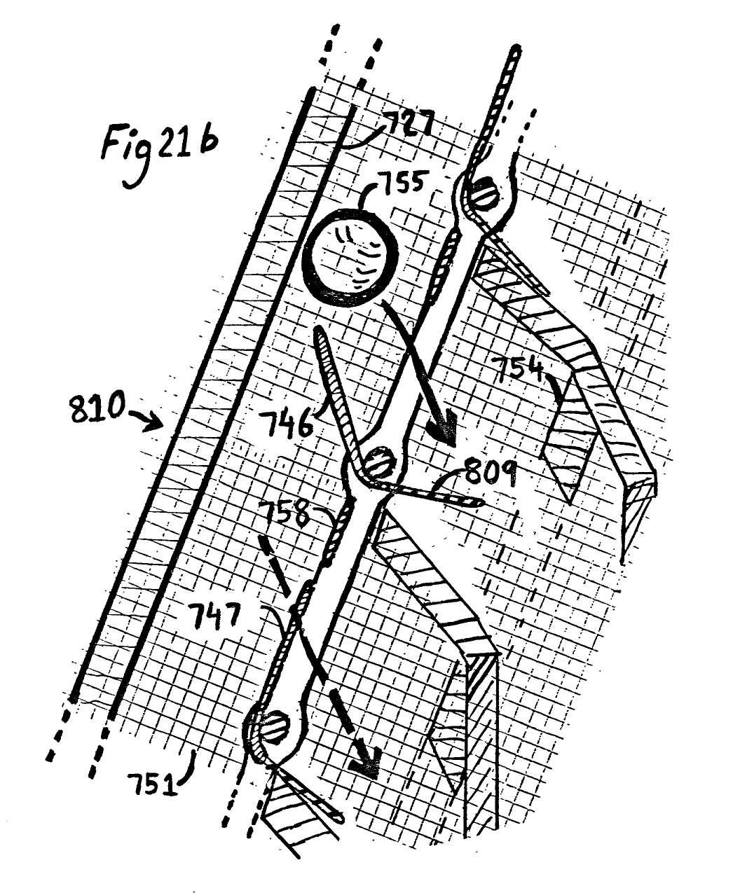

Most interesting, and novel, FIG. 20a bus connections implement a conventional mathematical transfer function, SINC (x), which is the function 1/COS(x), see FIG. 20b. In each example the register devices are operated by issuing a READ-SYNC to read the upper register and send the data into what can now be called a look-up table, or a BUS processing means.

Further implications of this functionality of processing during transmission includes the elimination of the actual conduit guiding walls which changes the nature of the signal to a free-fall analog bus transmission. This is a very novel aspect, which has no electronic equivalent, except for the parasitic electromagnetic bus cross-talk noise of conventional electronic computers. Because the bus signal itself retains its digital signal qualities, all signals, regardless of represented analog value, are full strength. There is a simultaneous capability for combining a static, pre-determined look-up table function with a dynamic real-time physical interactive potential. In other words, there can be a table function where each element can be modified in real time.

In comparison with FIG. 20a, FIG. 20c shows a conceptual view of such a free-fall processing means (generally ref. 780, which is later described as a plug-able CORE), which was designed to closely match the function of the connections of FIG. 20a. Many possibilities remain to be explored regarding free-fall processing, including methods of fault-tolerant data transfer, and the implementation of sine and cosine functions by real-time variation of the input and output bus scale sizes and angular relationships. Admitting the moving steel ball impulse back into a conduit bus constitutes a re-sampling or threshold function to change the real number back into an integer (ref. to snubber 768.)

Later, the WIDE-BUS is described, extending this bus processing concept to a device with 100 lines, for one percent resolution, approaching the calculating resolution.

### Construction of a FIFO Register Stack

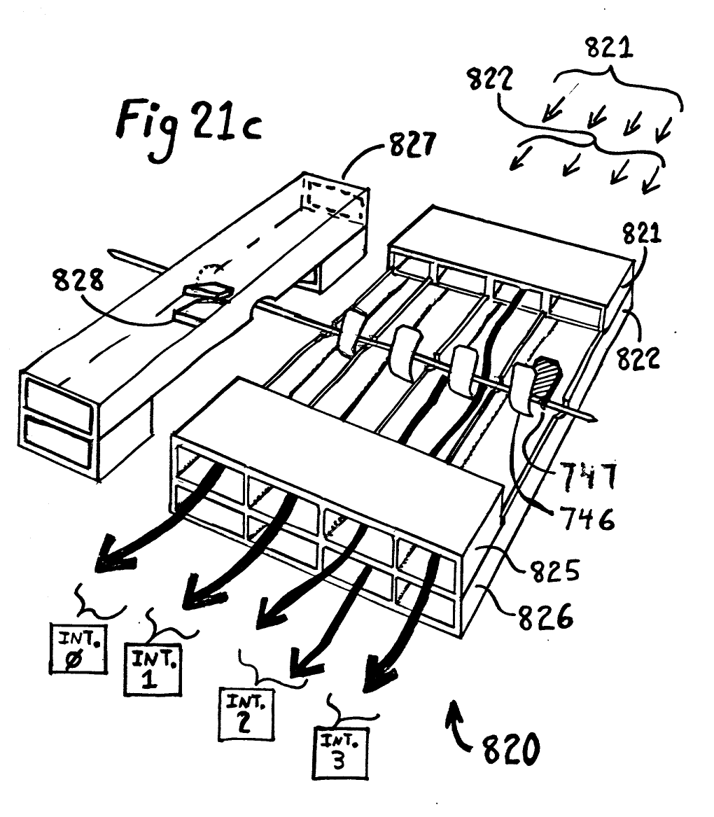

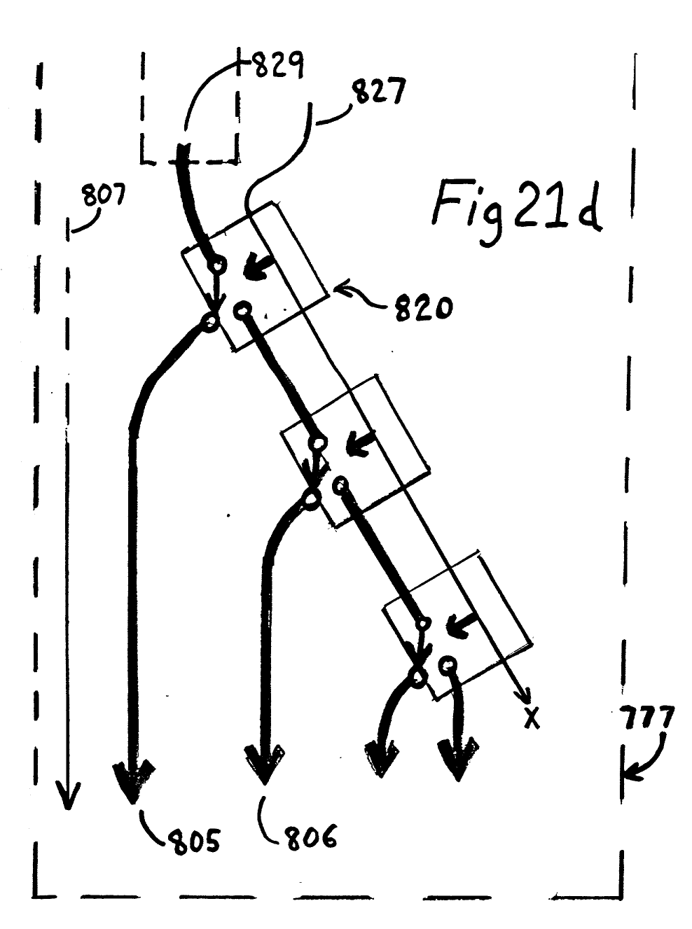

### FIG. 21

A data storage sub-system is now described which helps explain the role and use of the READ-SYNC signal in a multiple first-in and first-out (FIFO) data buffer. Also, this description is soon transitioning to a detailed coverage of BUS SWITCH construction, which requires an understanding of the modified register device (820), and requires understanding of three dimensional housing construction, and of logical operation. In FIG. 21a, there are two upper example data registers as the FIFO. In operation, this FIFO will send consecutive data digits down common BUS 815 to lower register 814. As has been a previous method for clarity of presentation, the four state register is used, although a decimal arrangement is preferred. Register 720 housings are re-used to implement a four state FIFO data storage system component. This can be done by dis-assembling a register 720, removing the shaft assemblies, and then substituting other shaft assembly types, before re-assembly.

For this application in a FIFO buffer, de-selection after READ (called READ and clear), will cause a chaining of the READ-SYNC after one READ action. This READ and clear functional modification of register 720 will be described soon. A first READ into register stage 812 will cause a normal data output on the READ OUTPUT BUS, to common BUS 815, via BUS Y combiners. A second, or subsequent READ, however, will cause a chained output of the stage 812 READ-SYNC signal through and out the register, rather than a data output. This chain output is useful for repeating the data READ for each next stage of the FIFO (stage 813 in this case.)

This is a self-sequencing feature. Multiple cascaded registers are serial chained by connection of each device READ-SYNC output to the next device READ-SYNC input. All register outputs are parallel merged into one BUS. In this example (FIG. 21a) a first READ will cause the first register stage 812 data to be sent down, and then a second READ will cause the second register stage 813 data to be sent down. As is apparent, data transfer BUS 815 is time multiplexed for these multiple data impulses. The lower register stage 814 will first be written with the first digit data, and then later over-written with the second digit data. This is a sample destination showing the general action of the WRITE BUS and also represents a general complex system having multiple or addressed destinations.

Also seen in this FIG. 21a are the labeled outputs of general controller/sequencer 777. First and second FIFO WRITE BUS connections are 805 and 806, respectively. For reading, READ-SYNC conduit 807 is for sending impulses down for multiple actions. In this example, controller 777 will separately send down two such reading impulses.

### Important Notes on Time-multiplexed System Bus Operation

As further description will make apparent, the mechanical computer is addressed through a pyramid or BUS path-tree, which makes full parallel addressing impractical. Considering the example of a one thousand digit storage sub-system, there would be a three digit pointer, with range of 0 through 999. The first address pointer digit of a location, such as 642, the digit six (6), would be written to one path switch, the second digit, four (4) would need to be parallel written to ten switches, while the third digit, of value two (2), would have to be parallel, or simultaneously distributed to 100 path switches in the tree structure.

In strict mathematical terms, common multi-digit everyday numbers are decimal coded so that each digit has a different weight, just as in a conventional binary coded system. The discrete decimal BUS operates this way and could be considered as a parallel decimal BUS, although the physical signal is always only one impulse in the form of a falling or field accelerated steel ball.

For practical time-multiplexed decimal system operation then, each of the above three digits are instead sent in three consecutive cycles, each to a consecutive stage in the decimal addressing pyramid. This way, only three path switches are accessed. Each next address digit can be thought of as penetrating one stage further down (the pyramid tree), establishing or extending a path for subsequent digits to be sent down. Finally, a WRITE access or READ access will be made down to an addressed location.

To frame this three digit decimal address set-up process in conventional computing terms, the reader can imagine a four-bit binary coded electronic system where a twelve bit address comprises 3 nibbles, sent in three separate cycles to a memory system address pointer. This electronic example has, in rough terms, the same range as the mechanical decimal addressing, of 4096 locations vs. 1000 for this described mechanical system.

These operating considerations make the following discussion on the FIFO example especially important, for understanding of general system addressing and data transfers. The important self-sequencing feature is covered, as well as more advanced arrangements of conduits and conduit arrays.

### A Crucial Sequencer Element for Read and Clear Register 810

### See FIG. 21b

A simple and useful construction on the pivoting lever assembly has a special READ tab that first diverts a ball, and then is de-selected by the passage of the ball. For each shaft, tab 809 is added to, or actually extends tab 746, to the design structure of previously described READ diverter tab 741, in the former FIG. 16b. In order to reference this construction modification, the READ and clear register is numbered as register 810. To construct register 810, an identical register 720 housing is used, but with the modified READ tab area for each shaft. This allows for re-use of plastic injection molds and for a common housing part to manufacture, stock, and inventory.

This FIG. 21b view also shows a slight modification of FIG. 16a by lowering of the conduit walls for the READ output BUS, for clearance of the new overturn tab 809. (Many reference numbers are re-used between the two views.) This slightly different housing is still totally useable to construct either a register 720, or this register 810. If a comparison is now made back to FIG. 16a it is apparent that this new overturn tab 809 has the reverse logical function of (the former) overturn tab 741, that is, it scoops a moving ball from a front conduit into a back cavity or conduit, and also immediately overturns the pivoting shaft assembly to a de-selected position by way of a second tab. The former overturn tab 741 was shown to scoop a moving ball from back to front and then overturn the shaft to a selected position. Mechanically, however, both overturning actions have the same dynamics.

It is apparent by following the various ball flow-paths, as before, that the passage of the first ball past tab 809 will cause de-selection of the shaft. Also, as in register 720, the mutual exclusion operation constrains the register to having only one such selected shaft. This has the effect of clearing the register to a NIL state. This ultimately results in a second or subsequent ball emerging out of the READ-SYNC chain output, indicating no selected shaft was subsequently encountered. Conversely, readers may recall that conventional use of clear implies a binary clear to the number value of zero, without any explicit way of identifying the validity of stored data. In this mechanical computer component, storage of the value of zero has the same action as any other integer value.

### Controller/Sequencer 777 Details

For sequencer control of data sent down to the FIFO buffer, BUS sequencer element 820 is now introduced (FIG. 21c), where identical multiples of the above READ and clear tabs (809) are mounted or ganged in multiple identical conduits, for a BUS-WIDE switch element. Just as the former tab (809) is crucial to a single READ and clear functionality on one signal, the BUS sequencer shaft assembly and housing (stage 820) is a BUS impulse separator.

Using the methods of the previously discussed package foot-print model (FIG. 14), there are two grids, or arrays. The input array is five-wide by two high (5×2), of which only the first input BUS, row 821 is used. To clarify, the positioning signal 827 is included in this row having a five input footprint. The second row of conduits, (ref. 822), simply are un-used portions of the pre-manufactured rectangular conduit array. Both reference numbers (row 821 and row 822) are indicated twice in this view, to reference the pair of stacked rows.

As shown by the middle portion cut-away and by the flow-path arrows, this BUS sequencer stage 820 can be constructed from two identical housing haves, each having notches for shaft clearances. In the orientation of this FIG. 21c, which is looking straight up through the register housing bottom, the housing is laid down somewhat, from normal semi-vertical operation position, (as on an assembly table) so that in this view the front row appears above the back row. The front half of this assembly in this view has orientation shown as front half above the back half. This front half includes the input rows 821, output rows 825, and the cut-away portion, shown with tabs penetrating from the shaft assembly.

Continuing this five by two (5×2) input and output footprint model, after switching by the pivoting shaft, shown in the middle cut-away, there are two BUS outputs. The second row of output conduits (ref. 826) is logically the separated BUS output, while first row (ref. 825) is logically the BUS chain output.

As seen in this footprint model, each BUS is four-state, or BASE FOUR. Loosely then, it can be assumed that integer BUS assignments are 0, 1, 2, and 3, left to right, and thus the flow-path arrow for the first separated output, row 826 shows the integer value of two (2.) Since each subsequent BUS transmission is another general integer value, the row 825 output (or chain output) is shown with all four possible path arrows.

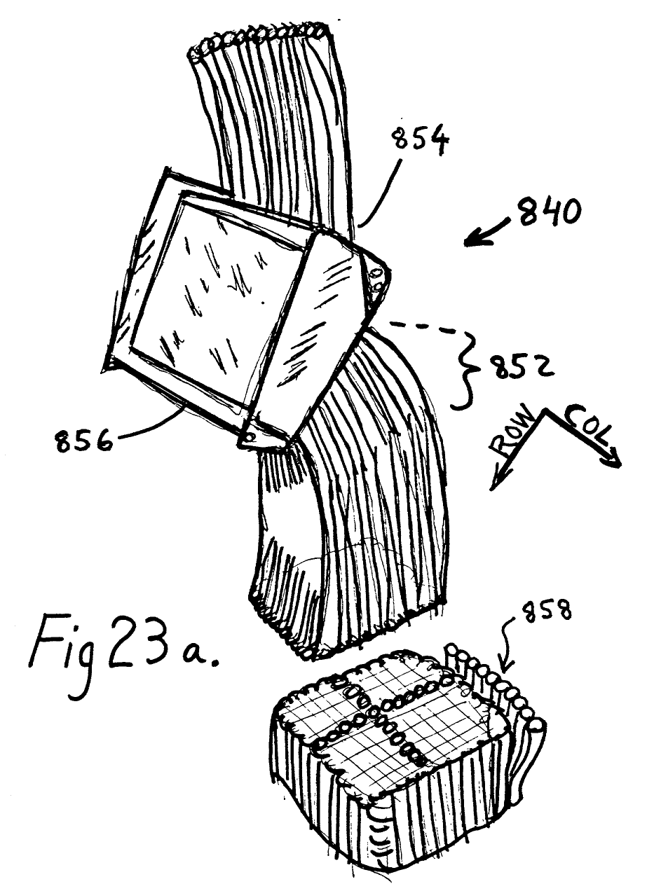

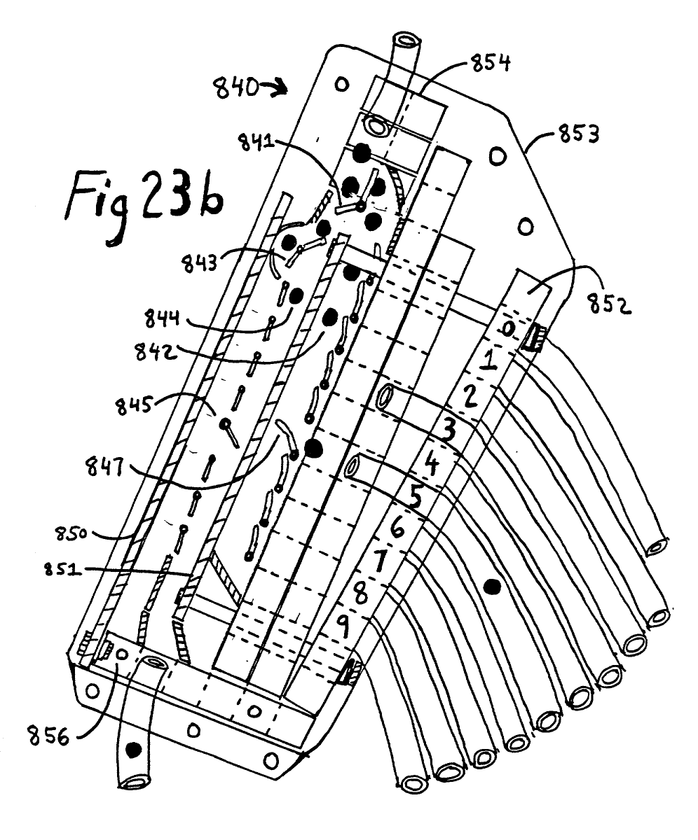

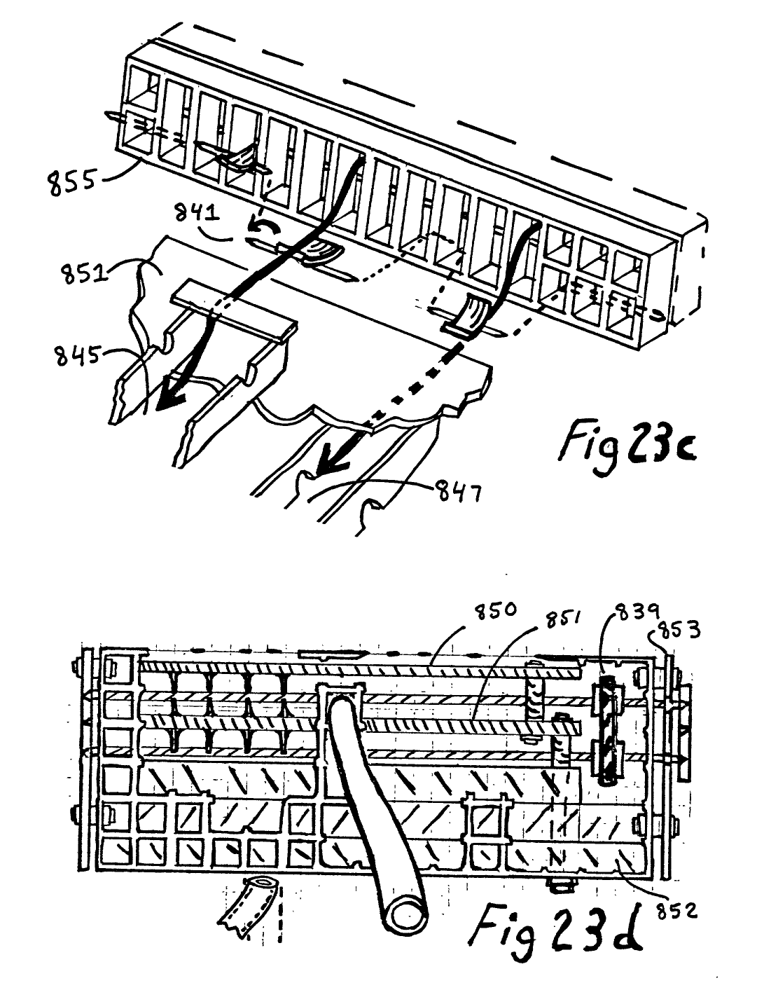

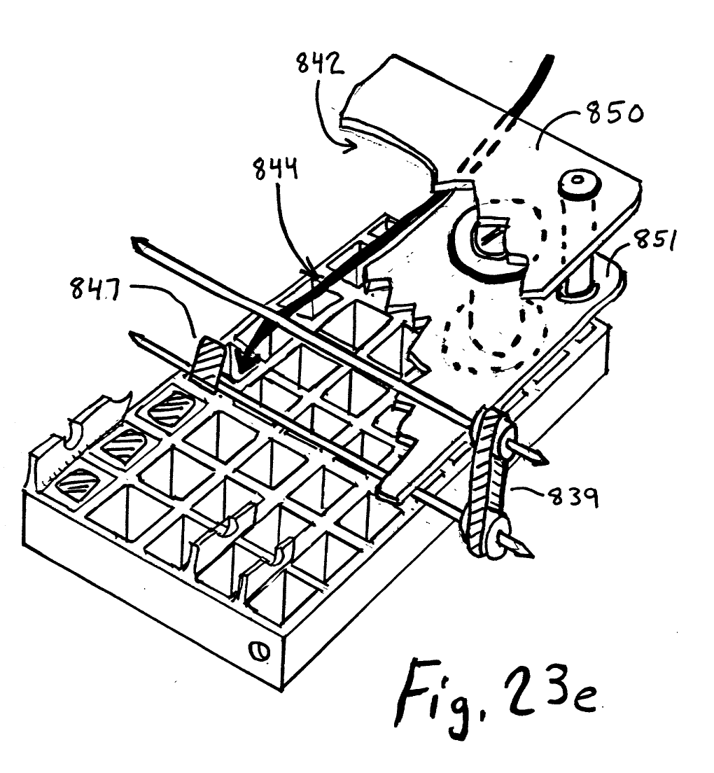

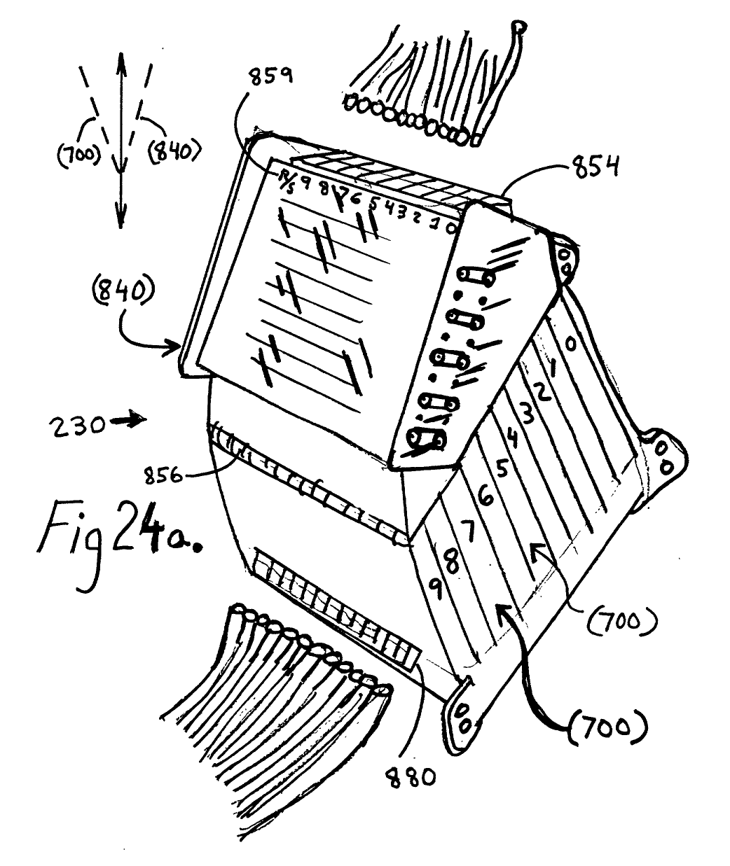

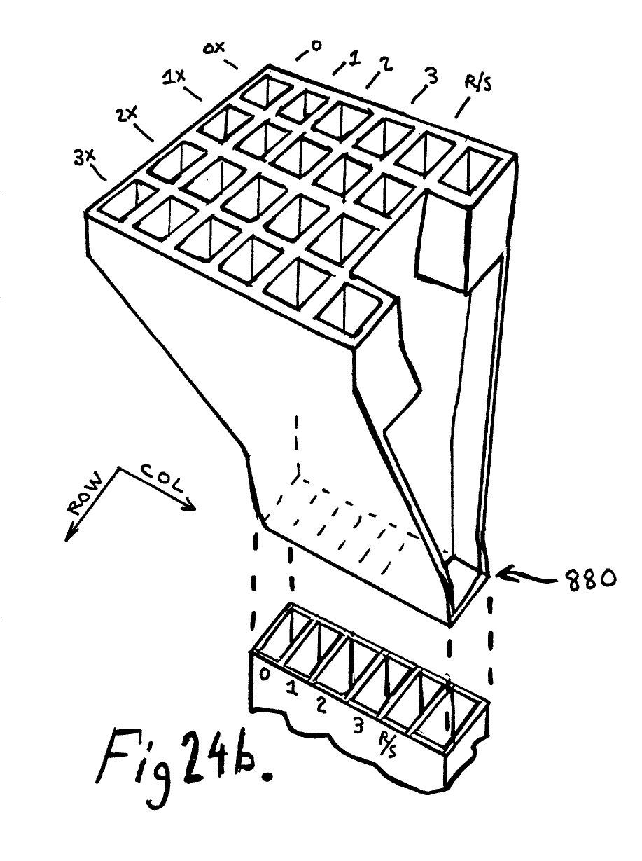

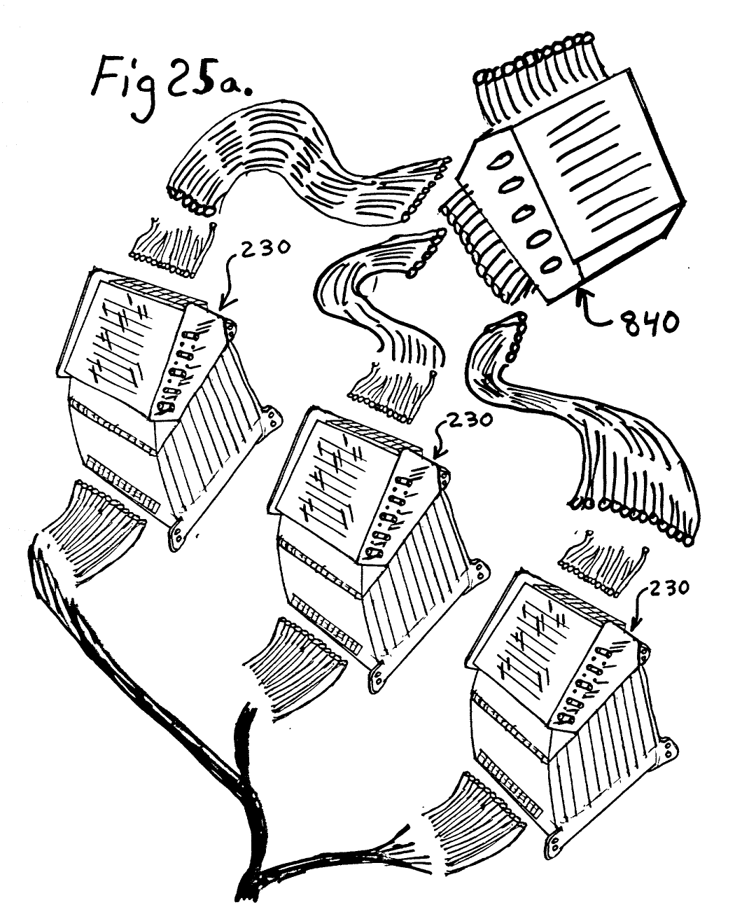

One sample of alternate pivotal position is the hatched view of read and clear tab 747, which was shown in closed position in FIG. 21b. It is apparent that a ball entering the stage 820 assembly via row 821, will continue on to exit via row 825, assuming that the shaft assembly has been moved to the alternate pivotal position shown by the hatched area. In other words, the overturn tab 809 is shown opened, or selected, while the same type of tab, (747) shows one instance of the alternate case for all four conduit pairs, where the rigidly mounted tabs all lay down into the middle plane separating the two conduit rows. Not shown is the hatched representations for the other three tabs, and also omitted are the thin enclosing slips that maintain separation of front and back rows. (See FIG. 23c for a view of separating slips.) For additional reference to primary and alternate pivotal positions, refer back to FIG. 21b.

Moving over to the WRITE section, or mechanical positioning section, it is seen (FIG. 21c) that a simple single actuator tab 828 is placed on the pivoting shaft, for setting, or selecting action when a steel ball is dropped through input/output selection conduit 827. This is a preparatory, or sequencer initializing action. The view shows the shaft in a selected position.

### Construction of a Bus-wide Sequncer

Moving on to FIG. 21d, pulling all the recent discussion together, this view shows implementation of a BUS sequencer within controller 777. Shown are multiple cascade connected BUS sequencer elements.

A brief pause to glance back to FIG. 21 c makes it apparent that conduit assignments make it easy to cascade multiples of stage 820, or to integrate multiple stages into one long multi-shaft assembly or module, with an external appearance as a five by two conduit array resembling a straight multiple chamber tile water drain. Selection conduit 827 is obviously extensible, as is row 821 (and 825), as these conduits maintain relative array positioning. The selected output, row 826, is simply directed as a set of conduits out through the back of each stage (820), using simple diagonal ramps and appropriate openings. (Also see FIG. 16b for a view of the READ output BUS showing similar openings for a path through the housing back.)

Returning to FIG. 21d, the selection conduit 827 is now identified as passing into and through each stage. Chained data BUS 829 also cascades through each stage. With connection as implied by the FIG. 21a FIFO, controller 777 sends a first data digit on BUS 805 and then a second data digit on BUS 806. Readers can place the two views together, FIG. 21d above FIG. 21a, to obtain a more complete view of a FIFO sub-system. This completes the description of all interface components necessary to operate the FIFO buffer of FIG. 21.

### Multiplexed Bus Switch Module 840

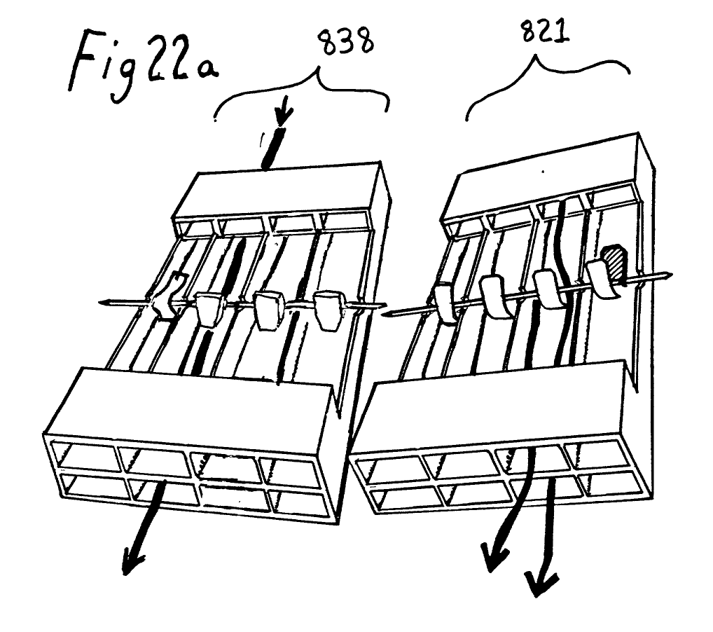

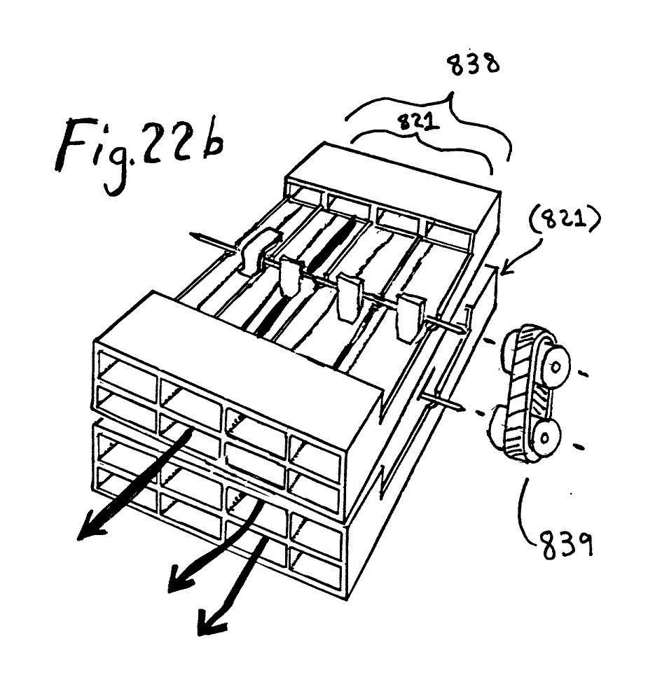

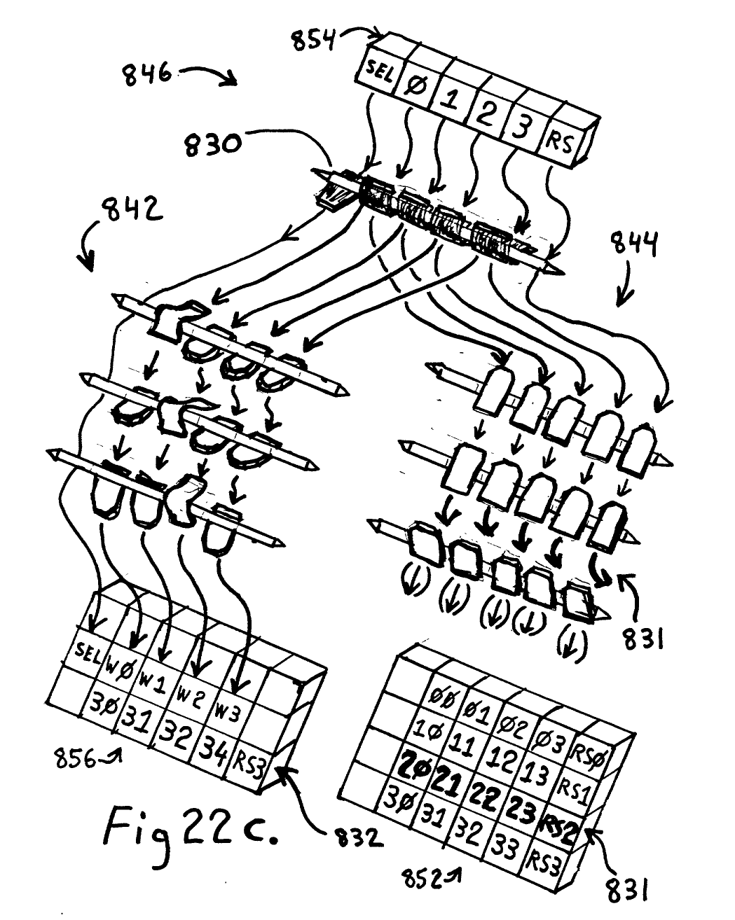

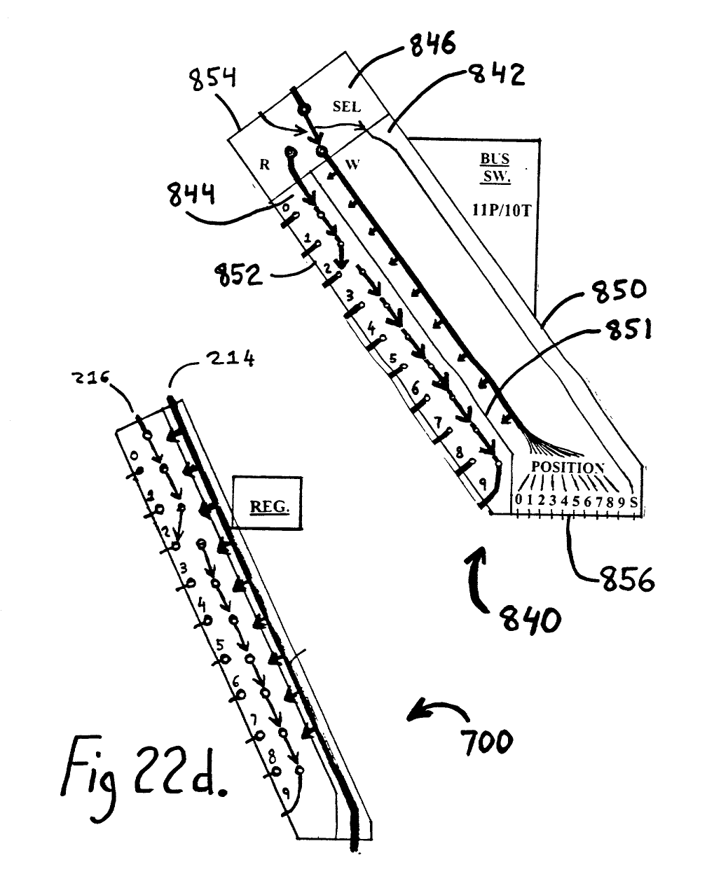

### Introduced by FIG. 22

An expansion of the concepts introduced in the previous FIFO section leads to construction of a BUS SWITCH, which has a decimal bus input and ten separate decimal bus outputs. Each decimal bus has eleven signals: ten discrete integer signals plus a READ-SYNC signal. One of these ten bus outputs is selected at any given time by the positioning of the switch module elements. The logical operation of positioning the bus switch is identical internally to the previously described decimal digit register. The bus switch is an expansion in the sense that digit register 700 (discussed with previous FIG. 11), had just one signal that was switched or diverted, where this bus switch has 11 bus signals that are switched in tandem. If this were an electrical switch it would be termed as an 11P10T device, which signifies an 11 pole/10 throw switch. This device is operated or controlled in a multiplexed and sequenced manner which is not to be confused with the ultimate functional purpose of the module and outputs, which is for selection or de-multiplexing. Soon, readers will appreciate how the bus switch is actually a key enabling component of the mechanical computer without which it would be impossible to construct subsystems for transferring data among components for practical use.

FIG. 22a shows expansion of a BUS sequencer element (820), taking out the unconditional initializing setting, or select action. The conduit 827, (former FIG. 21c), for setting is replaced with a full WRITE BUS 838 arrangement, using the common shaft. The input BUS, reference 821, is re-used as a generic indicator of the logic. It is most consistent to use the same size BUS throughout, so both BUS arrangements, (READ and WRITE) are presented with the four-state option. This means also that there must be multiple shafts for this four-state operation, with three shafts needed for four selected output sets for this description. (Readers can recall that the last output on a stacked lever register assembly is obtained by default, and thus only three shafts are required.)

First, before the multiple stage aspect of BUS SWITCH construction is shown, one logical stage element is shown in a view where the READ and WRITE portions are on separate parallel shafts (FIG. 22b.) This separation of READ and WRITE housing portions, and shafts, has the benefits of making a more compact module, but also has an important geometric advantage for READ and WRITE function distinction, or selection. This is because the two functions are then on adjacent rows, which makes it easy to construct another pivoting de-mux (de-multiplexer) or BUS SWITCH element for routing of the input BUS.

Unless otherwise indicated, the range of motion of the pivot is roughly 40 degrees for most of the family of stacked lever devices. The two pulleys with connecting elastic band 839 used for each shaft pair simply convey this pivotal motion so that each shaft pair behaves as one. In the upcoming discussion on the WIDE-BUS encoder this mechanical interconnect is used to interconnect five multiple shaft sets which also pivot in unison, for logical tracking.

### Internal Sections (842,844,846)

### FIG. 22c

Putting into place the (three) multiple shaft pairs, or stages of this BUS SWITCH, FIG. 22c, has READ/WRITE BUS selecting shaft 830 which selects between the full set of three shafts for a WRITE, or the three shafts for a READ. This view omits the BUS SWITCH housing with internal cavities for input DE-MUX (846), for WRITE functions (842), and for READ functions (844.) This de-multiplexing selection shaft 830 allows multiplexed operation of the BUS SWITCH by sharing of the incoming BUS. In the manner as in the previous FIFO buffer discussion, a select signal is first sent to initialize the BUS input to accept a WRITE in address positioning mode (not shown.) Also, as in the FIFO controller 777 of FIG. 21d, with read and clear tab on each individual BUS signal, as in the BUS-wide sequencing element or stage 820, this selection shaft at the head of the BUS SWITCH will overturn with the passing of the switch positioning digit, for an automatic switching to transparent READ mode (also see 809, in FIG. 21b.)

While the physical housing for multiple shafts or stages has not yet been presented, the previous FIG. 21d showed logically the multiple instances of stage 820. To obtain an image of this described BUS SWITCH, these multiple 820 stages would be merged into one seamless housing, and the single selection or initializing signal (827) would become the positioning WRITE BUS, and thus 827 would become a thick line in the schematic symbol. FIG. 22d shows a useful schematic symbol of decimal BUS SWITCH 840. Readers are continually advised that discussion always ultimately reverts to decimal, while the 820 device is more easily illustrated and understood.

The novel terminology in this discussion can be confusing regarding READ and WRITE functions. Specifically, WRITE is used because the BUS SWITCH position is affected, or is the destination, as most literally a WRITE of an address to the switch. Similarly, this terminology calls the transparent use of the BUS SWITCH a READ, because multiple physical READ or diverting elements are used, just as in the single diverting element used in data registers 700 and 720. (See cavity 831, FIG. 22c.) Most literally, an incoming discrete BUS impulse, READ or WRITE, is transparently routed or commutated to one of multiple BUS destinations. This means that the signal passed is of no immediate interest or definition, as long as operation is mutually exclusive, that is as long as the positioning impulse is one and only one signal on one of a multiple of conduits comprising a BUS. Mutual exclusive operation is required because of the READ and clear aspect of the sequencing.

There are three logical switch sections: a WRITE section or front cavity 842, a READ section or rear cavity 844, and an upper de-mux 846 section, containing a front end BUS switching element, shaft 830. The general terms are for either version, currently for the four state reference numbers, but the cavity terms apply in analogy to a larger, decimal device. Not shown here is the decimal version of the cavities. It helps to switch back and forth between the views of FIG. 22c and FIG. 22d. Below top bracket plate 854, and de-mux cavity 846, are the WRITE bus inputs, in the same manner as previously described, in the previous section on decimal register 700, (or also 720) which operates a multiple or stack of levers or pivoting shaft assemblies in front cavity 842. Transparent front panel or face 850, and transparent middle plate 851 which are similarly rectangular-shaped parallel plastic acrylic sheets which form this front or WRITE cavity 842. This is a book-shaped cavity.

The other main section, READ section, or cavity 844, is the back cavity portion defined by back port array grid plate 831 and by middle plate 851, so that the READ section is also book-shaped, and shares inner face 851 with the WRITE section, the second face separating the two cavities. Each corresponding or analogous reference for the decimal version is 852, 848, 856, etc. As with the above WRITE section, the READ section has a READ bus input below de-mux shaft assembly 830. The positioning BUS, or WRITE BUS is output (as the WRITE BUS chain output) via bottom output grid array 832.

Following sections will discuss DE-MUX shaft 848, which is the decimal equivalent to shaft 830, the shaft for a general four-state system of this discussion. The same scheme for BUS sharing is later presented, in FIG. 29c, for adding functionality to the READ and WRITE register 700, and in the binary device section, for the same ultimate purpose. The functions added are for decimal register increment, or count up, and for decrement, or count down.

Consistent with this discussion, a full four-state BUS would literally have a fifth signal, the READ-SYNC. Readers should note that this full discrete BUS, for READS and WRITES, is most correctly shown in FIG. 22c, while the FIG. 22a and FIG. 22b views actually omit the fifth commuted BUS conduit for the READ-SYNC, for clarity of presentation. Also the SELECT, or BUS operation initializing signal will be increasingly visible as an important part of multiplexed operation. The following are the two basic BUS operating definitions:

### Bus Signal Interface Definitions

Definition of DISCRETE decimal data BUS: (11 signals)

10 discrete WRITE BUS signals

1 READ-SYNC signal

Definition of DECIMAL MUX-BUS: (12 signals)

1 DISCRETE BUS

1 SELECT signal

An interesting aspect of this is that the READ-SYNC signal could almost be considered as an eleventh state, as a member of the 11 signals of the READ and WRITE BUS. This is directly due to the nature of each of the BUS signals in that a data state is transmitted in a self-clocking actuator impulse form (rather than an encoded state.) It is possible, (while not shown), to also buffer, or latch, the BUS READ-SYNC signal, in an eleven state register arrangement, (see the similar data transfer view of the former FIG. 17.) By modifying the register 700 design with an additional (eleventh) state, and re-routing an incoming READ-SYNC to the WRITING BUS, the modified register will latch the READ-SYNC impulse. (The WRITE section of the modified register will then have 11 inputs.) This is useful because the entire functionality of the BUS can be latched. Later, a READ of this specially modified register 700 can exactly reproduce the earlier BUS cycle. If the earlier cycle was a WRITE, then the BUS buffer register will simply transmit this data, integer range 0 through 9. If the earlier cycle had been a READ then the special BUS latch would issue a READ-SYNC, as had earlier arrived. This literal cycle latching is useful for diagnosing system bugs.

### Mixed-mode Bus Operation

### Discrete with Conventional Binary

In the housing view, FIG. 23a, the BUS SWITCH can be interfaced so that it is controlled or positioned by a WRITE from a decimal sub-system, using ten lines from the DISCRETE BUS, following the usual initializing select impulse. After this positioning action, BUS SWITCH 840 can then be used for switched commutating for a BINARY BUS style of data transmission. (Having the ten BUS signal lines for path switching, where eight lines are used for a conventional byte, and two BUS lines are un-used, or are used for controls.)

The reverse situation, however, can be more problematic, as the decimal BUS SWITCH requires a discrete style of BUS for positioning the internal stacked lever switching arrangement. For controlling the decimal BUS SWITCH using a binary BUS, it would be necessary to only send binary bytes having a single bit set, simulating the discrete values of zero through seven. This mixed mode capability allows this single BUS SWITCH 840 design to be useful in multiple system types.

Generally, aside from BUS SWITCH 840, problems arise when, for instance, attempts are made to sequence data signals on a conventional parallel binary BUS, using the read and clear features. Unless all bits arrive at the gang of read and clear tabs at the same precise moment any shaft using read and clear can jam or collide improperly with late arriving bits (steel balls.) More likely, one of the binary bits (a logical one), would arrive early, overturning the shaft, and then if additional binary bits arrive (set to a one) then these late arriving bits could either cause a jam-up on the shaft, or could cause an erroneous transmission down into the data mode section. It is suggested, but not discussed in detail, for mixed mode operation the read and clear aspect can be replaced with an explicit impulse and tab placement, to explicitly place the input de-multiplexing shaft into data mode, rather than with automatic overturn that is a benefit of discrete BUS operation.

Continuing on to the current BUS SWITCH 840 description on FIG. 23a, BUS SWITCH Module 840 has a multiplexed input bus for address and data, via top bracket grid plate 854. An address digit is specifically only for the positional control of the switch itself, but the term of data bus refers more generally to the bus signals to be switched. These signals are simply passed on by the switch, with no concern for the actual use or definition of such signals.

This FIG. 23a view of the BUS SWITCH housing and connected hose or conduit sets shows how the rows or sets are vertically arranged to form a square mass of 110 hoses (11 by 10.) In this description the vertical and horizontal organization is in reference to back grid plate 852. As seen, this square mass of hoses or conduits runs down in a gradual curve to orient to a straight-down output direction, comprising a near 90 degree direction change. A cut-away of this mass of hoses shows a cross-section, and also suggests how aligned conduit connectors can be optionally used (the cut-away view has logical row 0X , ref. 858 shown separated.)

### Principle Design Guidelines for Construction

Before details of construction and operation are discussed it is helpful to understand a few construction guidelines. FIG. 23a presents a housing view, for discussion of problems solved by the construction in the current embodiment.

MASS CONDUITS—This bus switch must handle a large number of mechanical signal outputs (11 bus signals and 10 positions for a total 110 outlet conduits) and is thus considered to be mainly a conduit management device. The purpose of the bus switch structure described is to bring in a set of input signal conduits via bracket 854 into the areas, or volumes for switching or diverting elements and areas, or volumes for the positioning elements. The bus switch structures then handle a massive number of conduits for outputs via grid array 852 from these diverting or switching areas. While each individual signal path is certainly important and crucial to overall function, it is the mass bundling or organization of conduits that determines primary design and shape.

A grid plate material 801, previously discussed in FIG. 12, is used in construction for providing the rigid conduits for internal signal guiding and enclosing surfaces which must be effectively smooth, continuous, and of consistent downward slopes. Also, the total connected conduit count may exceed 134 plastic hoses which accounts for significant twisting and sideways elastic forces. This mandates use of brackets to take the stress from the mass of connected flexible hoses. The same grid plate material is used as square hose bracketing elements for confined support of each inserted round hose. This creates a very finished looking and orderly bundling or structuring of the various hose arrays.

The plate array component used in the bus switch is 15 by 13 squares for a total of 195 individual square elements, of which approximately 134 are used for signals.

PIVOTING SHAFT SUPPORTS—A second guideline for construction is that side plates be reasonably stiff and of consistent and uniform parallel separation. This is because the side plates support, or contain pivot holes used for supporting each shaft end. These left and right side plates must not bend or flex significantly in relation to the pivot holes so that the shafts can move freely without binding. An option for more convenient assembly is the use of separate plates which attach to the side plates as a separate assembly step which includes positioning of each shaft assembly into the respective pivot holes. The left and right side plates are also the attachment points for mounting the switch module as seen in this FIG. 23a.

### Introduction to Connected Use

### FIG. 24a

As the former FIG. 23a implies, the mass of conduit rows can have each row separated as needed for device connection. However, these connections can be manually tedious in situations where kit form mechanical computers are being used. In FIG. 24a, there is much tedium eliminated by supplying a pre-constructed memory unit, shown in upright perspective towards the front face and right side.

Ten-pod, or formally register block 230, comprises a BUS SWITCH (840) with integral copies of register 700 attached, each for storage of one digit. Although not shown in detail, a frame combines one BUS SWITCH 840 with ten separate registers (700), and also has ramp accommodations for positional interface modifications needed. This interface is a simple shifting or diagonal re-routing of the BUS conduits, altering the spacing. For the BUS signal positions, the package foot-print of the BUS SWITCH 840 extends across the whole housing (see inlet bracket 854.) This visible spacing also exists for the back output rows and columns, which are not visible in this view of the front face and right side of the TEN-POD (register block 230.) Register 700, however, has tighter spacing and other package foot-print differences. (See FIG. 13 for register 700.)

### Details of Bus Switch Module 840 Construction

### FIG. 23b

First, the inputs or inlets and some related internal parts, and then the outputs or outlets will be described, followed by more details of inner internal stationary and moving parts of separate WRITE cavity 842 and READ cavity 844. Then, the section on operation further discusses the actions of the moving parts of the BUS SWITCH MODULE.

Beginning at the top of the BUS SWITCH MODULE there are three input grid plates used to bring in the 12 vertically arranged input conduit hoses. Top bracket plate 854 guides these hoses at a slight angle into the next two attached bracket plates, which are mounted for increased hose run angle relative to vertical. This successive angular offset sequence of the three bracket plates serves to gradually transition the flexible plastic hoses from a straight down vertical direction to the nominal flow-down angle for internal guiding of the moving steel ball. This nominal flow-down angle (17 degrees from vertical) was previously discussed with decimal digit register 700. This secession of grid plates is also partially an active conduit array and the beginning of the internal portions of the BUS SWITCH MODULE. Bracket plates have appropriate stop ridges for controlling further insertion.

The identification of these incoming hoses includes the ten decimal bus signals 0 through 9, multiplexed for writing data, a data bus READ-SYNC signal for reading data, and a non-bus signal SELECT. The non-bus SELECT signal is solely for operation of the BUS SWITCH. The ten decimal signal conduits are both for switch operation by positioning the switch internally (an address) and also are used for conducting the signals which will be switched (as data). These ten signals are thus time-shared. The identification of all of the input signals is simply the ten integers 0 through 9 on the incoming multiplexed bus, plus the eleventh signal READ-SYNC which is not multiplexed. For chain output, the positioning signals are then identified as W0, W1, W2, W3, W4, W5, W6, W7, W8, and W9. The convention used is left to right order when facing the front of the bus switch module.

In DATA mode, these 11 signals: as ten decimal WRITE data conduits and a READ-SYNC conduit, actually have no context in relation to the BUS SWITCH MODULE and may be re-defined by the connected use. They are simply 11 signals being switched or commutated to one of ten output ports. These signals are actually defined in a following section on a REGISTER FILE SUB-SYSTEM or by any other general memory sub-system use.

Continuing down, from a signal or moving steel ball point of view, the input grid plate bracket then abuts selection conduit pen 855, which is a modified section of grid plate material seen in FIG. 23c. This selection conduit pen 855 is so-named, resembling livestock fence pens, because it guides or encloses on two sides (right and left) but allows extra travel room for a moving steel ball into each of two distinct or vertically articulated (nominal) downward flow directions. This is physically similar and logically identical to sequencing element 820, discussed with FIG. 21.

Observing de-mux shaft assembly 848 (FIG. 23b) the selection between these two distinct flow directions is made by movable pivoting action, with attached tab 841 partially enclosed by selection conduit pen 855. This conduit pen has one wall of the square grid array removed for each of the switched signals (10 places), creating a rectangular guiding conduit segment for the short distance through the depth of the pen. This allows the moveable, pivoting de-mux shaft enough free space to switch a moving steel ball in a nominal front to back direction for selection of front or back cavities. Actually, due to the previously mentioned flow slope of nominal 10 to 20 degrees, selection pen 855 is tilted slightly so that pivoting de-mux switch 848 output is not purely between front to back, but rather slightly diagonal but in most cases the device can be discussed as if the signal flow is straight down. The READ-SYNC signal is switched by the de-mux, with a READ-SYNC as the next impulse after SELECT going down and out of the auxiliary or chain outputs of grid plate 856, for cases of single READ-SYNC chaining. Also, this signal does a read and clear overturn of de-mux 848, just like a data WRITE would. As is consistent with the other BUS signals, after the SELECT and first impulse, the READ-SYNC is transparently switched as part of the input BUS, to one of ten ports.

Note that part of this design methodology is to accommodate the pre-manufactured (or off the shelf items) with priority over custom cut or molded parts. As opposed to the former description of tab 741, (FIG. 16b) which together with a custom cut slip creates a continuous separator plane between conduits, the selection pen structure keeps this same plane separation. This described selection pen maintains the separation without requiring an extra custom cut separator sheet. The continuity (of enclosing or guiding) is maintained due to the adjacent plates which abut the middle of the selection pen for a continuous separation plane.

### Write Cavity

### FIG. 23b

Backing up to the earlier description point and now describing the WRITE section, and assuming alternately a selected flow direction down into the WRITE section cavity from the selection pen, the structure, which is seen with pivoting STACKED LEVER elements is nearly identical to previously described decimal digit register structure with two exceptions:

First, the nine stacked lever elements have no directly attached READ elements or diverters, and second, there are small pulley wheels on each of the shafts of each stacked lever assembly element and with each shaft being longer than in the decimal register (see FIG. 23d.) For communication of shaft positions, and thus the effective overall positioning of the BUS SWITCH MODULE each of the nine stacked lever elements has a pulley wheel in direct connection to an adjacent, corresponding pulley wheel in the READ section cavity. An example is the use of elastic band 857 to co-connect a WRITE shaft assembly for maintaining positional tracking between the two shafts. Each of the nine shaft pairs are individually co-connected by such pulleys and elastic bands.

Back or output grid plate 852 is stacked long side vertically (H×W=15×13 squares) in comparison to the other two output grid plates, which are attached long side horizontal (H×W=13×15 squares) (FIG. 23d). This gives clearance room for the pulleys and elastic bands in the approximate plane of first output grid plate 852 which is also the plane of all of the READ section pivoting shaft assemblies, while supporting attachment of right side plate for the ends of the shaft assemblies. The second and third output grid plates, which are wider than the first plate, have holes positioned for machine screw mounting of right side plate 853. On each side of the module one vertical column is allocated as space for the tapered ends of each shaft so that these two outside columns have no active signals or tabs.

An additional, auxiliary signal output or BUS outlet area for signal chaining has bottom grid plates (as in 856) which are for connecting the positioning or WRITE BUS signals flowing down out of WRITE cavity 842. This is the switch positioning or addressing signal BUS, identified as W0 through W9.) The last outlet bracket is placed at an angle for the same hose direction transition as mentioned so that the positioning signals also flow approximately straight down.

### Details of Read Cavity Construction

### FIG. 23e

Continuing on, for a selected flow down into READ cavity 844 the structure has the 9 pivoting lever elements for reading which resemble previously described decimal digit register 700 READ section. Each pivoting lever element for reading includes 11 identical tabs for switching of diverting an entire bus. (Readers will recall that decimal digit register 700 had only one tab for switching or diverting one signal.) This pivoting shaft assembly was shown in FIG. 21c, although using the four state analogy. The moving steel ball, guided on right and left sides by stationary conduit walls, and guided by the second or middle plate 851 on a third side, will roll or fall guided mainly by the surface of one tab on each shaft in a (nominal) vertical direction perpendicular to each horizontal shaft (FIG. 23e is in relation to just one shaft pair for clarity.) Also, each of the side column walls stop short of the shafts, and even have semi-circular cut-outs so that there is freedom of movement.

Each of these identical tabs is sized so that there is only a small gap so that conduit function is not compromised and the running surface down these tabs makes the fourth wall of the running conduit. These small gaps between tabs do have an effect on system timing since there is a slight wash-board effect as the moving ball encounters these multiple small gaps. In the worst case delay the steel ball will encounter nine of these gaps if all nine shafts are in the unselected position. All of this previous paragraph is very similar to the previous FIG. 16 description.

Back output or outlet grid plate 852 is situated to accommodate these bus signals (each signal a moving steel ball), which have been switched or diverted into individual square grid elements. Thus each horizontal line or row of these grid elements represents one bus for output and corresponds to a shaft assembly, except for the last output which is by default rather than an actual shaft assembly. Output or outlet numbering was shown in back view, using the analogous FIG. 22c. This view is shown in reverse as a through the back view. The numbering scheme, (assuming simple expansion to full decimal, which is not shown) has each bus as a decade and also includes a READ-SYNC signal for each bus. For example, R4 stands for READ-SYNC to the fifth bus output. (Numbering starts at zero so that the bus order is 0X, 1X, 2X, 3X, 4X . . . etc.)

Thus back port grid array 852 has 11 horizontal positions, or columns, to represent the eleven signals being switched, and has 10 vertical positions, or rows, to represent the 10 positions of the switch. Actually, it is simple to route the last BUS output, for the 9 X decade, out of the bottom plate (856), as the default when none of the nine shafts are selected. However, for interface purposes it is desired to place small diagonal ramps for routing out of the back plate, for consistent bundling along with all the other output decades (0 through 8.)

Returning to FIG. 23b, in a manner similar to the previous discussion of input grid plates, (854), back grid plate 852 joins a second back grid plate and a last output or outlet bracket plate. This last outlet bracket is placed at an angle for gradual transition of the direction of outlet hoses to approximately straight down vertically, while also there is a somewhat gradual transition from pure grid plate conduit to purely a bracket for containing round conduit hose, for external connection.

Overall, the BUS SWITCH MODULE is then seen to have 12 input hoses entering vertically downward into the top, and 110 output hoses exiting diagonally downward out of the back, these 110 hoses being arranged in a 11×10 rectangular array. Hose curvature on these exiting hoses causes the whole bundle to quickly assume a straight down direction for connection to the next logic devices in a system.

In the mechanical computer, all flowing steel balls must be accounted for eventually so that most outputs or outlets will require a conduit. In the case of the bus switch module some of these outlets may be connected down to the discard drain, previously mentioned. If the bus switch is not to be chained for expansion then the auxiliary outlets, bottom plate 856 must be connected down to the discard drain. This comprises WRITE chain outputs WO through W9.

A last miscellaneous or auxiliary signal, SELECT, is guided by entering through a conduit hose in the top input grid plate, (top bracket plate 854) moving through selection pen 855 to activate or set the position of the de-mux shaft and is then made to exit through the back outlet grid plates along with the data bus conduits. This SELECT output signal may also be chained if needed in a system, or routed to the discard drain, (also see previous FIG. 21c discussion.)

### Additional Details of the Write and Read Cavities

FIG. 23d shows the two conduit arrays for guiding signals moving down through WRITE cavity 842, which are virtually identical in function and dimensions to the previous structures of decimal digit register 700. Readers are referred back to that discussion for more details but briefly there is a main conduit cavity and a temporary signal conduit with the shafts of the stacked lever elements in between. Previously, for register 700 these were cavities 750 and 751. Specifically, all of the following are a group of parallel planes:

The back grid plate is in one of these parallel planes. Transparent front face 850 is located in a parallel plane, as is middle face 851. Lastly, each of all the pivoting shafts (both WRITE and READ cavity sections) is located in a parallel plane. Also, each of these shafts in this group of parallel planes is orthogonal to the conduits created by thin parallel vertical separator walls. This structure can be seen to be a variation or extended version of the previously described decimal digit register 700. All of these shafts, of same length, are longer than on the basic decimal digit register due to the massive scale required in the BUS SWITCH MODULE. As in the previous register, this grouping of parallel planes implements, or separates, from front to back, the temporary WRITE cavity with 10 parallel vertical conduits, the main WRITE cavity, again with matching separated vertical conduits, and lastly the READ cavity vertical conduits for the 11 switched signals. Each of these cavities are of generally shallow rectangular box or book-like shapes nearly upright but leaning with the characteristic flow-slope of nominal 10 to 20 degrees from vertical.

It is to be noted that separate parts for these structures are implemented relatively easily using modem plastic molding techniques. Examination of FIG. 23d shows middle face 851 with the parallel vertical separator walls which implement three sides of the signal enclosing conduits. A feature of this part is the use of both sides of the second face sheet for attachment or as part of an injection molding of these conduit walls; for the WRITE main cavity on one side and for the READ cavity on the other. Similarly, front face 850 is a separate molded plastic part implementing attached conduit walls on the inner face of the sheet. FIG. 23d also shows how these two parallel face plates are attached together and to the whole module assembly using simple machine screws and stand-off hardware.

### Moving Parts

There are three types of pivoting shaft assemblies involved in implementing the BUS SWITCH MODULE. For a WRITE function, which positions the switch in total, reference to the previous decimal digit register 700 is again valuable since the BUS SWITCH also is basically a logical decimal digit register, although not intended to simply store data. The BUS switch could be considered to hold a static address.

Readers may recall that the in the decimal digit register there was one type of shaft and tab configuration for each of the ten states to be stored or latched into the register. This described BUS SWITCH has the arrangement of nine varieties of the shaft for positioning the device (see FIG. 16a.) As before, it is not necessary to include a tenth shaft to obtain ten different logical output positions or states as the last one is made available by default (no shafts in a selected position). And, as mentioned in this section, the BUS SWITCH MODULE 840 does not have any tabs for a READ function located on the WRITE function shaft.

For processing of each individual signal, each of the pivoting shaft assemblies includes 11 separate tabs which work in conjunction with the aforementioned three sided stationary conduits to scoop or divert a moving steel ball as it cascades down one of the separated vertical channels if the shaft is selected, or to allow the moving steel ball to pass along to the next shaft assembly if the shaft is de-selected. Thus each tab on each of the nine shafts forms a fourth conduit wall when de-selected or a scoop when selected. This is identical to the action of the single tab for reading that was described in FIG. 16b for each shaft of the decimal digit register.

FIG. 22c shows a view of the four-state version de-mux shaft 830 in a SELECT position. With the shaft in the SELECT position, there are 4 tabs which are shown in a position to scoop or divert an incoming digit signal (moving steel ball) down into the WRITE cavity section. The read and clear feature will now be mentioned, compared to the previous decimal digit register. De-mux shaft 830 also has attached to each diverter tab an overturn tab which causes a subsequent de-select of the shaft assembly by way of the traveling impulse. In other words, the SELECT position of the de-mux shaft described is only for scooping or diversion of the first arriving impulse down into the WRITE section with any subsequent impulses traveling down into the READ cavity portion of the BUS SWITCH MODULE. This implements the operating sequence in the section to follow.

FIG. 23b shows a purely right side elevation view of de-mux shaft assembly 848 with overturn tab 841 for implementing this one time or pulse separator feature. (Other described devices in this disclosure make good use of this pulse separator feature). The diverter tab is also shown which is mounted at a 110 degree angle relative to the overturn tab. This relative angle is such to allow a steel ball to be correctly diverted to first activate the overturn tab before proceeding down into the WRITE cavity for positioning the switch. This FIG. 21c omits the view of the tab for clarity (discussed a few lines down).

In logical terms it could be said that the diverter tab constitutes a means for reading the position of the shaft which if selected then causes the overturning or flipping of the shaft to the alternate position. This closely resembles a T or TOGGLE type of flip-flop action, with the additional feature of being one sided or acting only on the first arriving steel ball (after the shaft had been moved to a SELECT position by a previous SELECT impulse). Borrowing from electronic terminology this is informally called a ONE-SHOT pulse separator.

### Connection and Operation of Bus Switch Module 840

FIG. 22d shows a block/schematic of how the bus switch module 840 is connected for selection of one of ten output busses for further use by a system. A new symbol, representing bus switch 840, shows bus paths with a thick line representing 11 separate signal conduits, and shows singular control conduits as thin lines. The control line SELECT is shown as affecting positioning of the first part of the bus switch: the de-mux.

As seen schematically, the de-mux switch element when switched to the alternate position will switch or commutate the incoming bus to the positioning controlling bus 838 input portion of the bus switch. In other words, the de-mux, when activated by a SELECT impulse, will connect the bus input path for diversion to the WRITE portion of the switch. Continuing either of the SELECT line, or the position controlling bus 838, the schematic symbol contains arrows indicating chain outputs 856, which are useful for connecting additional logic in a system. These two arrows represent the intact transmission of the SELECT or the positioning impulse through the module to the chainable outputs. In some cases these signals simply connect down to a discard drain as shown. The positioning signal is actual a decimal BUS, of ten signals, thus is shown as a thick line.

Note that there is no control signal opposite to SELECT, as bi-stable de-mux switch element 820 does not require two positioning signals. This is because the pivoting, bi-stable de-mux element is self-switching, as previously described in the pulse separator specification section. Specifically, (FIG. 21c), the passage of a bus impulse itself causes overturn of the shaft assembly, by way of a tab, so that only the first impulse is commutated by the de-mux to the first de-mux output (to the positioning section.) All subsequent bus impulses (unspecified data) are thus commutated into the multiple pole/multiple throw section of the bus switch.

The control operating sequence for the selection of one of ten output busses comprises the following simple steps:

1. Issuance of SELECT.

2. Issuance of ADDRESS digit.

3. General use of accessed device or bus. This general use can be one or more unspecified data signals sent via bus switch to a target device or bus. These signals do not have an immediate meaning or definition relative to the bus switch and can be data, address, or control signals, to be sent down to additional logic.

### Implications of Bus Switch 840 Use in a Mechanical System

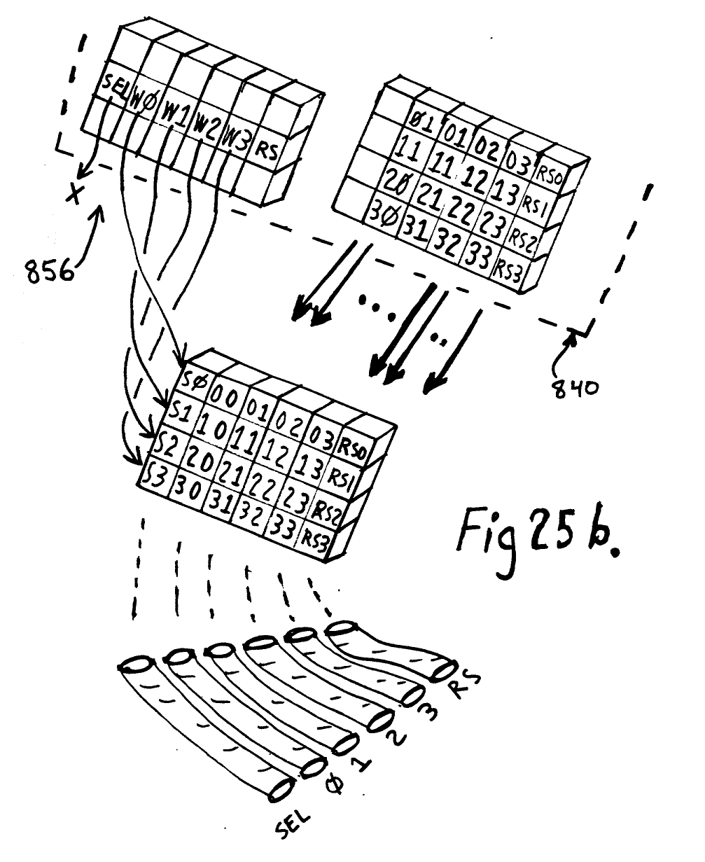

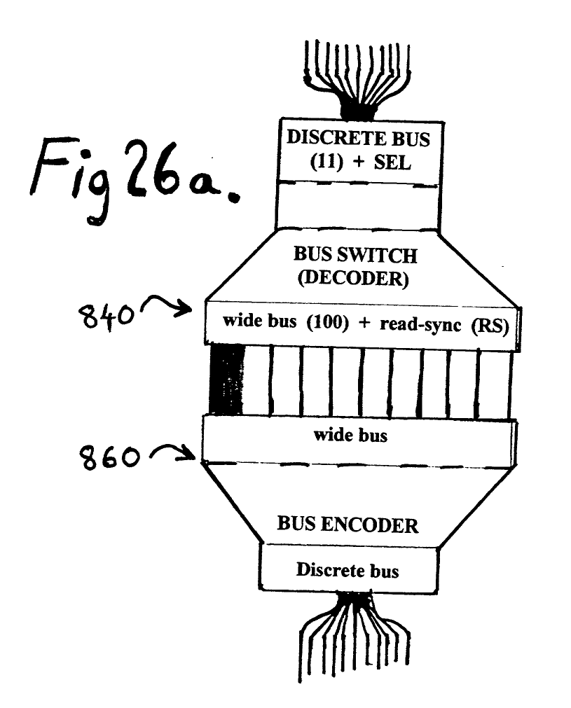

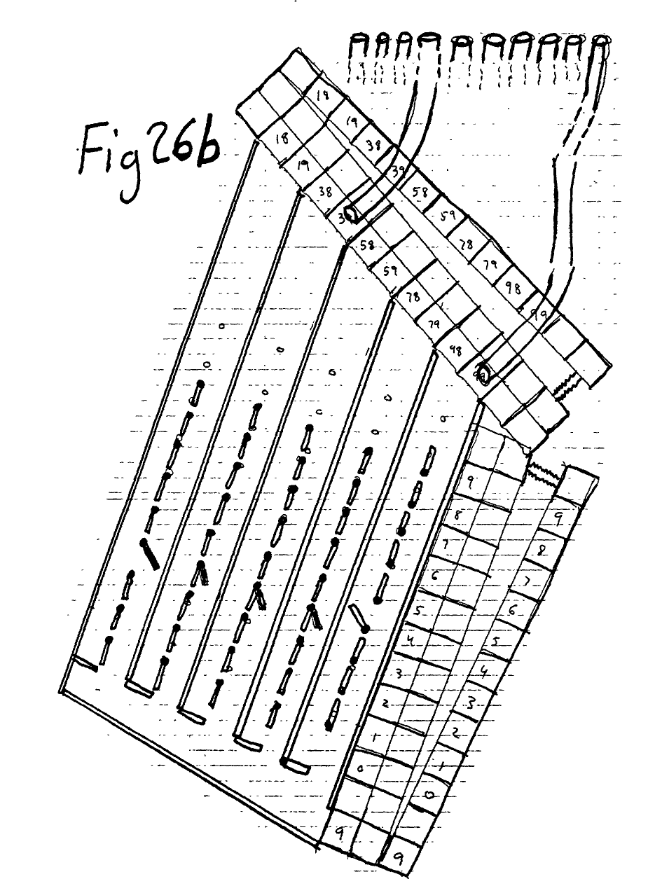

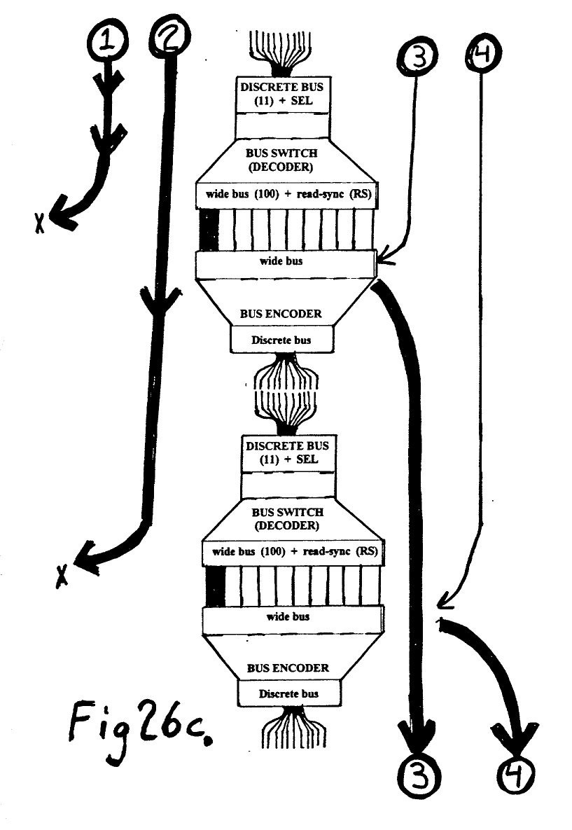

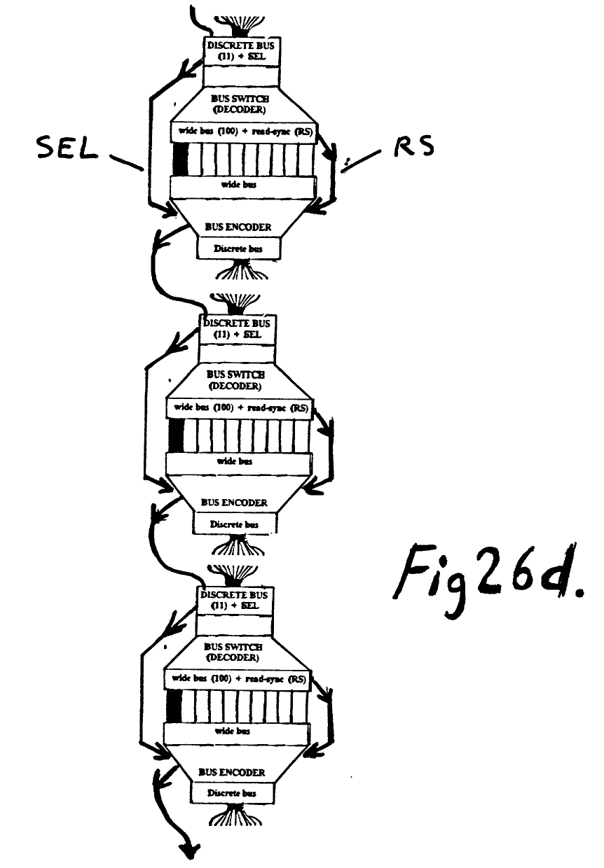

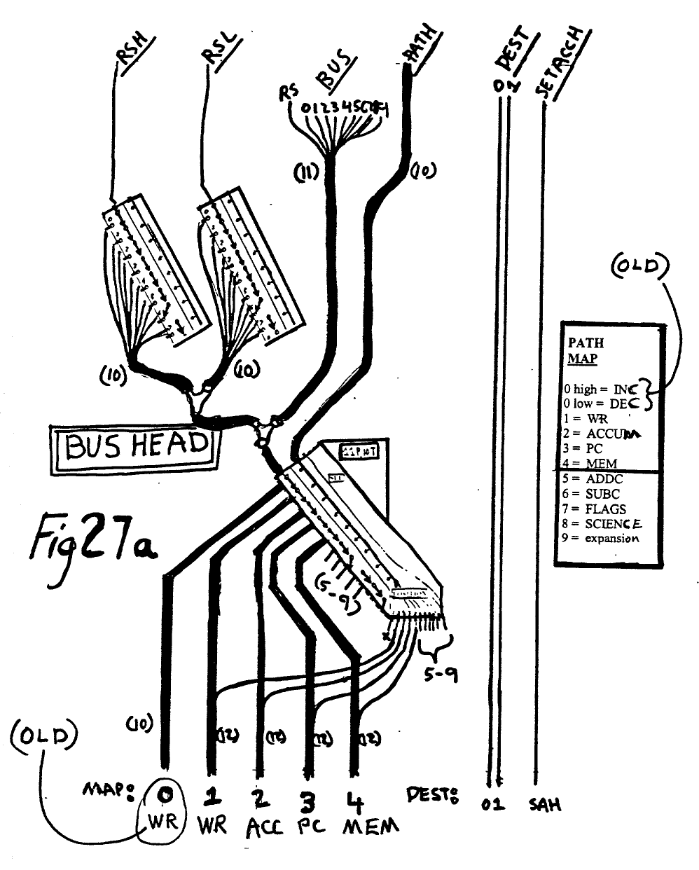

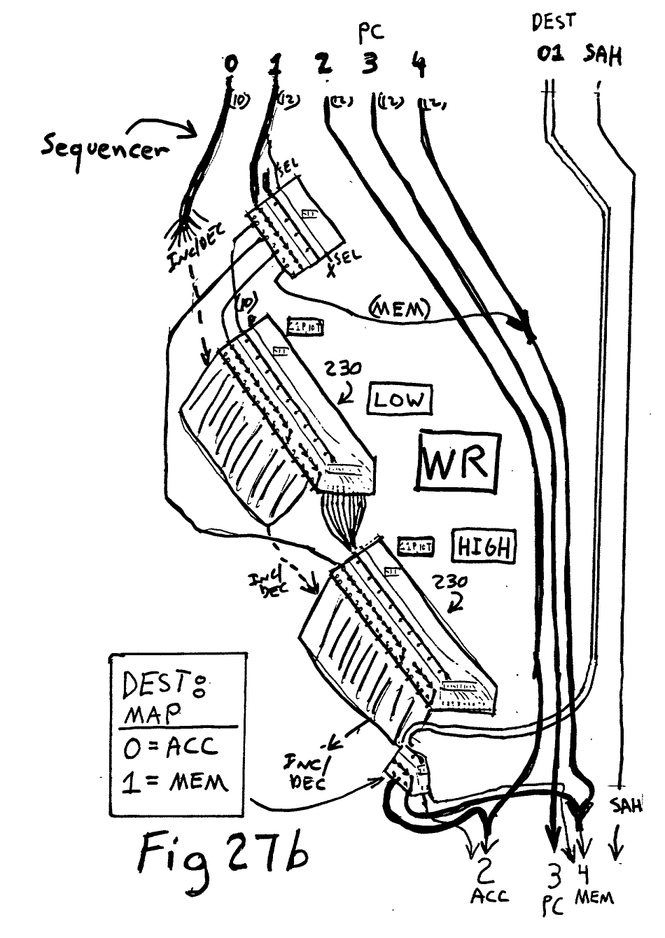

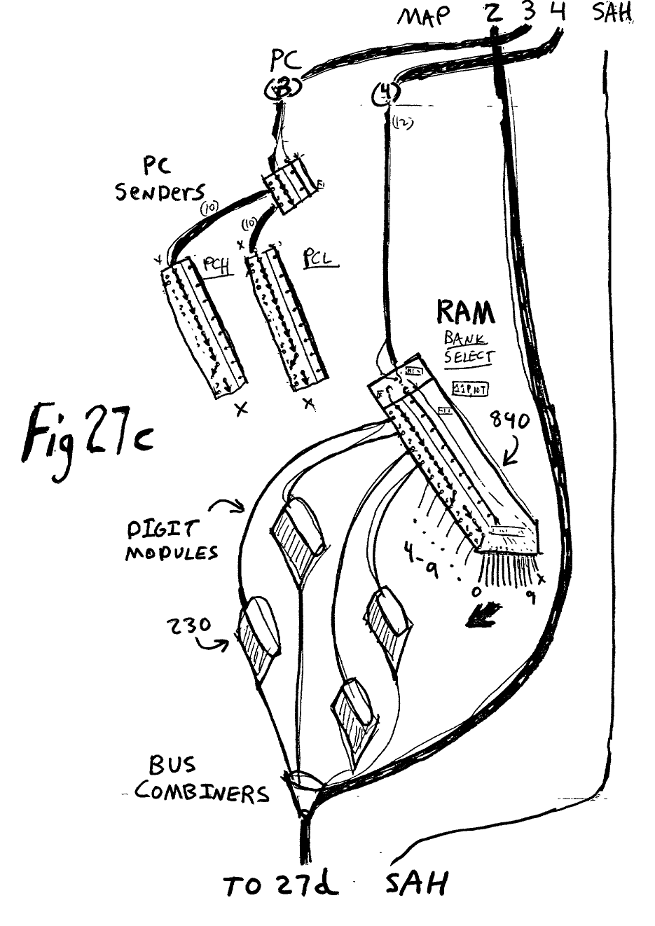

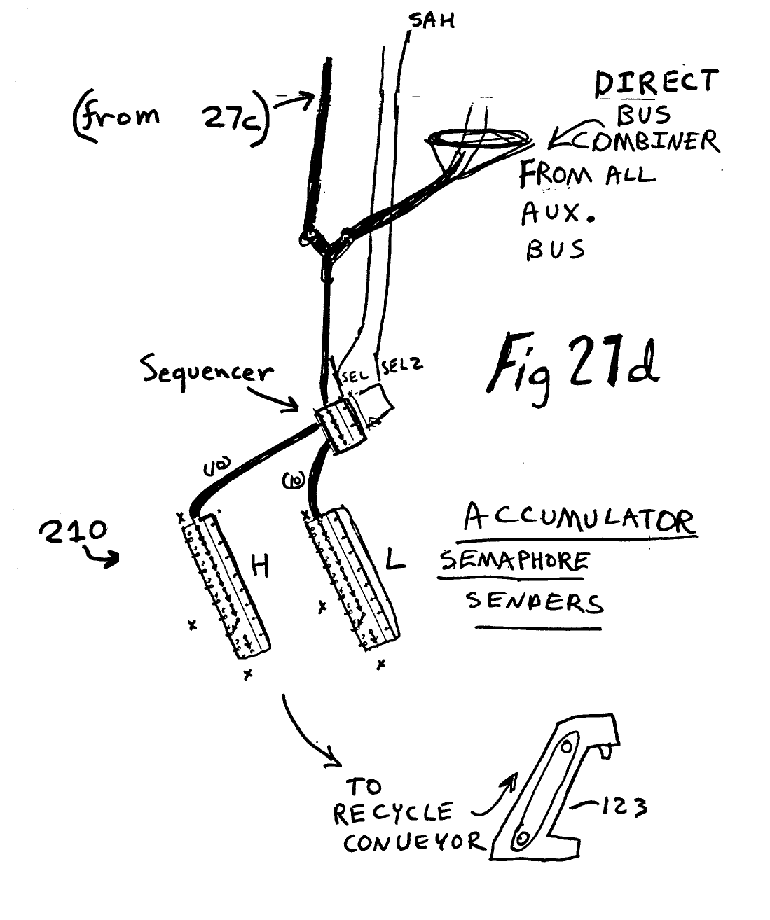

Examination of FIG. 25b shows that each bus output is, by definition, a one for one match to the bus input, containing the eleven defined signals for data WRITEs and READs. Furthermore, each chain output from the positioning selection WRITE section may be combined with the corresponding bus output to become a new SELECT for the next connected device or system. This resembles a collated document, where two copied stacks are vertically un-bundled and re-distributed horizontally. For example, if the fifth bus is selected (bus 4) the digit that did the selection or positioning of the bus switch is output as an impulse on the discrete chain output W4. If this output is then bundled with bus 4 then the total can be considered as a complete BUS having discrete SELECT signal, a WRITE data bus, and a BUS READ-SYNC signal.

This is the self-connectable feature that becomes very useful as will be seen in the following section on the register file. Each of the ten positioning signal chain outputs are similarly bundled with the respective selectable bus so that the outputs of one bus switch can be serially connected directly to ten lower level bus switches and thus indirectly to various general multiple serial connected additional stages, each containing a bus switch. No other logical connections are necessary. In this manner, the bus switch modules facilitate assembly of systems in a building block manner which more closely resembles block diagrams rather than detailed random logic diagrams. The practical power of this approach is that a system can be expanded with no consequence, change or alteration to the existing connection topology of bus switches and connected devices and the mapping of such existing switches and connected devices. The sequencer or controller must, of course, be modified to accommodate a system expansion by adding or supplementing new path accesses.

Also, the bus switch can be connected for expanded use, to an array of ten decimal digit registers to implement a register block or a data memory digit block. In fact, the embodiment in FIG. 24 shows the bus switch as an integral addressing portion of register block 230, being in the top portion for switching an incoming bus to one of ten integral digit registers for reading or writing. Further, a maximum of ten of these register blocks can be connected to another bus switch which is connected for decade selection as will be seen a following section showing the expansion to 100 outputs and a further expansion is shown in the description of the register file subsystem. First, however, the expanded use of the bus switch for simple path selections for a register block will be discussed.

### Register File and Data Memory System

This specification will now begin to discuss modules connected as system components, the first being a means for implementing ten working registers and a 100 digit block of data memory which can exchange data with a main accumulator register under program control. This means that descriptions will be deal less with internal functions and details and more with interconnection.

### Register Block 230

### FIG. 24

The row outputs of BUS SWITCH 840 match the row inputs of digit register 700. That means that up to ten identical copies of register 700 can be attached, or even integrated together, for an interface ready module that can be plugged in with only the 12 signal lines of the MUX-BUS, by way of input grid 854. As is the style with a MUX-BUS system, the output coming from register block 230 is a mix of each of the ten BUS sets coming from each register, shown with the reference for an internal BUS combiner 880. FIG. 24b shows the internal BUS combiner 880, although the figure is simplified to show a smaller data BUS.

For generating multiple MUX-BUS select signals, the positioning signal can be re-used. That way, register block 230 generates as it gets, that is the register block can completely control any data cycle on MUX-BUS devices connected below it to the output BUS. This view of FIG. 24a is general, for output of either an 11 line discrete BUS, or for operation as a MUX-BUS by chained output of SELECT. The auxiliary output 856 (FIG. 24a and 25b) represents the positioning BUS chain output and can be re-used to generate a set of SELECT's, in cases where the register pod needs to operate each register in the MUX-BUS manner. This is the case for working registers, needing at least an increment function. In FIG. 25a is shown the case for re-use of positioning chain outputs into the generation of multiple select signals for generating ten separate MUX-BUS plug-able output sets. In this case, three of the ports are used for selection, or bank switching of the BUS, to three duplicate register blocks (230.)

In summary, BUS SWITCH 840 can be used either for simple discrete BUS outputs, or can be bundled with a SELECT signal for each output, as a defined MUX-BUS. In mechanical space terms, this bundling forces an extended run of each BUS output conduit, due to the bundling of each SELECT coming from the bottom bracket plate 856.

### Introduction to the MUX-BUS; Operation Expansion Example to Output 100 Busses

### FIG. 25

A lot of attention is paid to the novel BUS definition, for the MUX-BUS signals SELECT and READ-SYNC (both discussed already.) As described for BUS SWITCH 840, a SELECT will initialize, for positioning, the commutator, and is then output for optional chaining. If all of the 110 output lines of BUS SWITCH 840 go to one place then the (single) SELECT chain output conduit can be combined, or bundled with the mass of switched conduits. This literally is the creation of a 102 line, or BASE 100 MUX-BUS. This novel BASE 100 MUX BUS is exactly the same logically as the decimal BUS as the following three lines show, with each listed BUS having a variation of size of WRITE BUS, which is a BUS sub-section:

1.) A four-state MUX BUS has 4 WRITE BUS lines (0 through 3) plus a READ-SYNC and plus a SELECT line (6 total BUS lines.)

2.) A ten-state MUX BUS has 10 WRITE BUS lines (0 through 9) plus a READ-SYNC and plus a SELECT line (12 total BUS lines.)

3.) A one hundred-state MUX BUS has 100 WRITE BUS lines (0 through 99) plus a READ-SYNC and plus a SELECT line.

The MUX-BUS origination arrangement can be seen in FIG. 25b.

Returning to relating to decimal logic (in CM-2), while the ten signals of the WRITE BUS are easily understood to be simply routed or commutated by BUS SWITCH 840, a lot of the following explanation covers the details for operating the MUX-BUS, using the system interconnected MUX-BUS READ-SYNC and system interconnected MUX-BUS select. Generally, a MUX-BUS device or module must have a front end means for responding to a select input, and internally interconnected means for re-generating or originating such defined SELECT to send to the next device, or in multiples to originate multiple MUX-BUS outputs to multiple locations.

In the more common case, BUS SWITCH 840 outputs run to multiple, separate devices or modules (up to ten total.) The problem arises, that only one SELECT chain signal is available, but with as many as ten separate locations to control. The solution comes neatly, out of the mutually-exclusive and DISCRETE nature of the (0 through 9) decimal WRITE BUS, that is, from the chain output BUS. This BUS is the discarded (digit) signal that positioned the BUS SWITCH, and so it is perfect for splitting apart for individual re-use for each of the zero through nine (0-9) integer signals (also see output grid 852 in FIG. 23a.)

For example, if BUS SWITCH 840 is used as a DECADE select, or actually for any one-of-ten BUS, BANK switching, and for an example 3X decade selection, then the discard BUS output signal will be a three (integer #3), meaning that literally there is a steel ball falling down through the fourth (logical #3) conduit. If this single conduit is then routed with, or bundled with the 3X decade switched output BUS, an 11 line discrete BUS, then the (12 line) MUX BUS functionality is achieved, that is, a process of two or more BUS transactions will be initiated by SELECT.

Use of the self-connectable feature (of the MUX-BUS) has a pyramid address decoding structure implemented with each switch potentially connecting down to (a maximum of) ten switches on the next lower level. In FIG. 25a, there are three lower levels shown, each having ten locations, addressed by a units or lowest decimal digit. This resembles a classic binary pyramid addressing structure but with more power due to the width of decimal operation. With only two levels, a range of 0 through 99 bus ports can be selected. With only three levels, a decoding range of 0 through 999 ports can be obtained, each for accessing by READ and WRITE to a register or to yet more path switches. The best access used in the CM-2 machine is using the 12 line MUX-BUS almost everywhere there are multiple digits for data transfers and other functions requiring shared BUS operation.

It is noted that the relationship between capacity, in a sub-system like FIG. 25a, and module parts count is somewhat linear:

The relationship between capacity and parts count are as follows:

For addressing ten busses: total 1 switch (See block 230)

For addressing 100 busses: 1 switch, level 1, plus 10 switches, level 2; total=11 (FIG. 25a shows 30 ports used, out of 100 maximum)

For addressing 1000 busses: 1 switch, level 1, plus 10 switches, level 2, plus 100 switches, level 3 ; total=111

The control/operating sequence for the selection of one of 100 devices or output bus ports comprises the following simple steps:

1. Issuance of SELECT

2. Issuance of high ADDRESS positioning digit for selection of decade output (level 1.)

3 Issuance of low ADDRESS digit for selection of units output (level 2, via level 1.)

4. General use of accessed device or bus output, as previously discussed (level 2 port.)

In a later following section, a system called WIDE-BUS will be discussed which uses one bus switch to operate a 100 element bus. This can be done as a direct advantage of the discrete signal nature of the basic bus, which combined with a bus switch can implement this 100 element bus as operating in BASE 100. Extending the discrete BUS concept, this WIDE-BUS is most correctly operated by having a path internal to BUS SWITCH 840, for the incoming READ-SYNC, where the READ-SYNC is guided out as a chain, down through bottom grid plate 856. This relates only to the READ-SYNC coming in during the positioning portion of operation, as normally a WRITE impulse (of 0 through 9) would be expected. For consistency, this READ-SYNC also causes overturn of the BUS switch input de-mux 830, although this feature is not used.

This WIDE-BUS READ-SYNC signal is important for the operating step of retrieval of a low result digit, in the following details on a novel BUS encoder.

### Wide-BUS Encoder 860

### FIG. 26b

Before a system is described a detailed description of the encoder device is now presented:

This encoder device could also be called a digit extractor as it obtains, or latches a copy of a portion of the WIDE-BUS integer data impulse. Thus, out of the 100 inputs, the extraction of the units, or ones value is made. The encoder has a resulting integer state with a value range of zero through nine (0-9). A second functional portion of the encoder then combines the 100 signals in such a way as to produce a TENS, or decade digit signal output.

A schematic of the WIDE-BUS encoder shows the upper main section (FIG. 26b.) The upper section is shown with 5 latch sections which all operate in tandem, using interconnected pulley wheels across the five compartments, for each of the nine logical shafts. This discussion is brief, but there are 20 signals, or two decades run to each shaft. There is a size relation of two input rows to each cavity, or compartment, so that the inputs interleave onto each shaft. A lower combiner section combines signals ten at a time, as in FIG. 24b, to produce a decade digit, which emerges from the encoder output. This is basically combiner 880, turned 90 degrees, so that the resulting output is a divided by ten, or decade result. For example, all 3X decade conduits, 30 through 39, are all combined together to generate an output BUS integer three (3.)

### Details of Construction of Wide-bus Encoder 860

Continuing now on the side view of the WIDE-BUS encoder, FIG. 26b shows the five latch cavities with side views of the stacked lever arrangements in the first four cavities. The last cavity however, shows a side view of the reader portion of the encoder module, which is situated at the very ends of the stacked lever elements. All of this construction is virtually identical to the previously described modules including decimal digit latch register 700 and bus switch module 840 (previous FIG. 13 and FIG. 23.) This WIDE-BUS encoder simply has more elements and sections operating together. Overall, the WIDE-BUS encoder resembles a toaster appliance with angular shape.

In FIG. 26a is a series of MUX-BUS plug connected processing units, each comprising a one hundred step look-up table having a two digit look-up result or answer. This table look-up results from dispatching a steel ball, according to an upper BUS SWITCH 840, and re-arranging each of 100 flexible conduit hoses for variable answer results. These results are then re-converted by partially latching and by partially transmitting, the resulting two digits. Encoder 860 does this, resulting in a diagram appearance that widens, after the narrow MUX-BUS input, processes the signal, then narrows back to a MUX-BUS. This process can be repeated at will, by serial connection of multiple sets, as in FIG. 26c. The schematic form shown has the downward conduit lines darkened to show the location of the first decade, of values zero through nine.

The action arrows indicate that a first ball will position the upper sending decoder 840, then is discarded. A second ball passes through, getting an answer, and then immediately becomes a first ball into the second stack. A third input ball reads the second answer digit, from the top stack, and this whole process repeats down the stack, so that this third reading ball becomes yet another answer. It is apparent that each new connected stack only adds one ball to the required control sequence.

Although physically the stacks become cumbersome after about two sets, (FIG. 26d shows three), it is useful to have two sets, one possibly used as a pre-scaler to the main function, such as cosine or tangent.

### CM-2 Physical Hardware Introduction

In FIG. 1 was shown the CM-2 Mechanical Decimal Computer frame or chassis. A service tower supports the circular computer enclosure, which is a downward flowing helix-like series of 12 box-like segments. Each enclosure segment is loosely associated with a section or portion of mechanical computer hardware, although the boundaries are actually somewhat arbitrary. Since each end of each box-like segment narrows or restricts slightly internally due to the framework ring of structural tubing it is simply easier to mount components and organize sub-systems for mountings identified by segment. Each segment has two such framework end rings which are joined by structural tubing to create a box-like frame, with sheet metal or plastic skin, for each segment.

It is to be noted that expanded (and reduced) versions of the CM-2 machine are also planned, with a very large machine having 16 or more segments and standing over 15 meters (18 feet) tall. This machine would, as mentioned under the objects and advantages section, have a capacity to contain and address up to one thousand decimal digits of data memory and several hundred decimal digits of read-only program storage (or ROM), plus have the option of running programs from a storage memory containing a downloaded program or compiled software routine. Obviously, the intent of such a large system will be for use in a museum or large university setting where the investment can be useful and justified.

FIG. 10 shows a service tower which contains five belt drive particle elevators, each cascaded or feeding the next higher elevator for delivery of steel balls to the very top of the CM-2 machine. This is the same function and internal design as the elevators previously described for the CM-1 machine (see FIG. 7). Also, READ-UP semaphore sender 210, is supported along with receiver 211. Sender and receiver are connected by 9 pairs of light nylon tension lines, this being the sole means for upwards transmission of static data states or signal states (as opposed to the impulsive transmission characteristic of the particle bus invention).

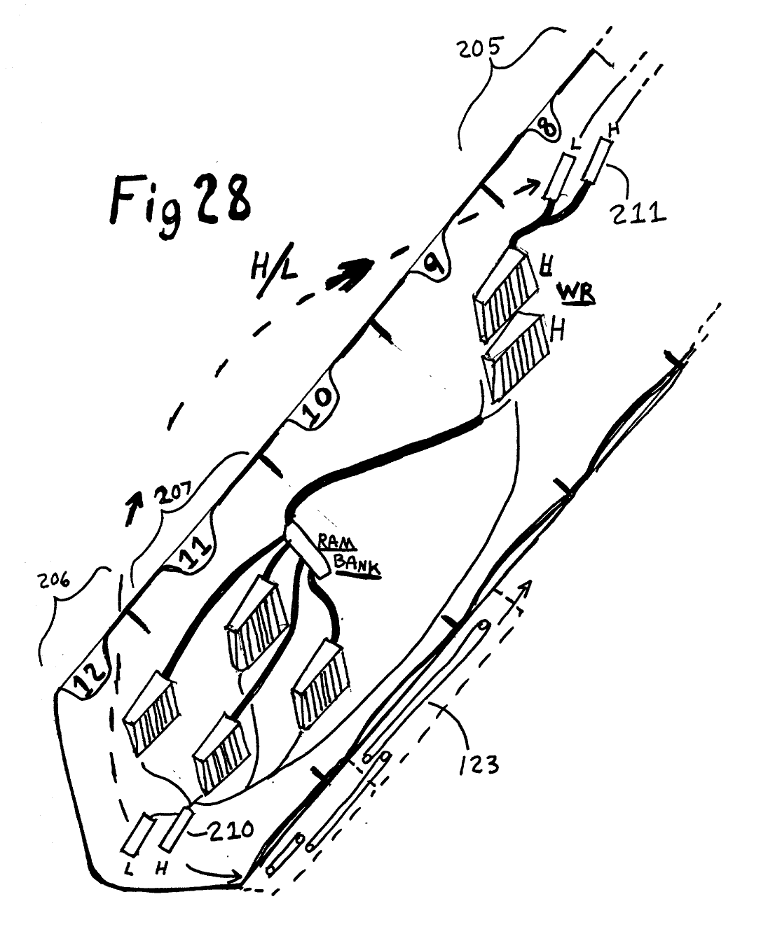

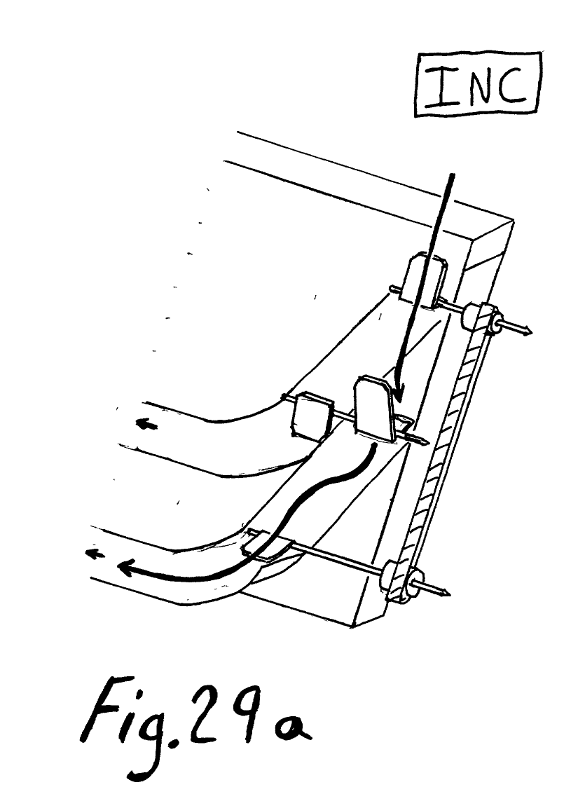

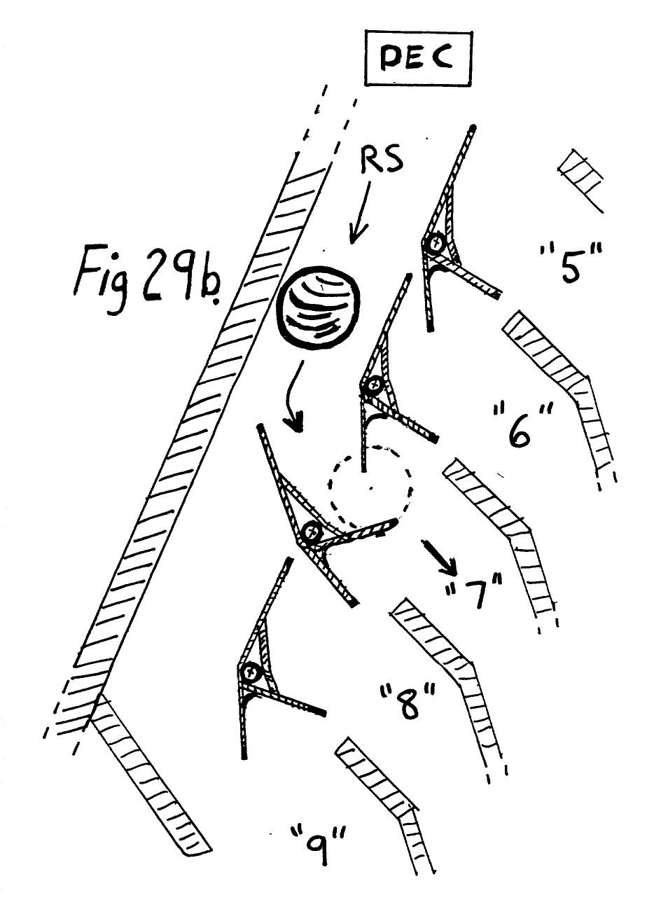

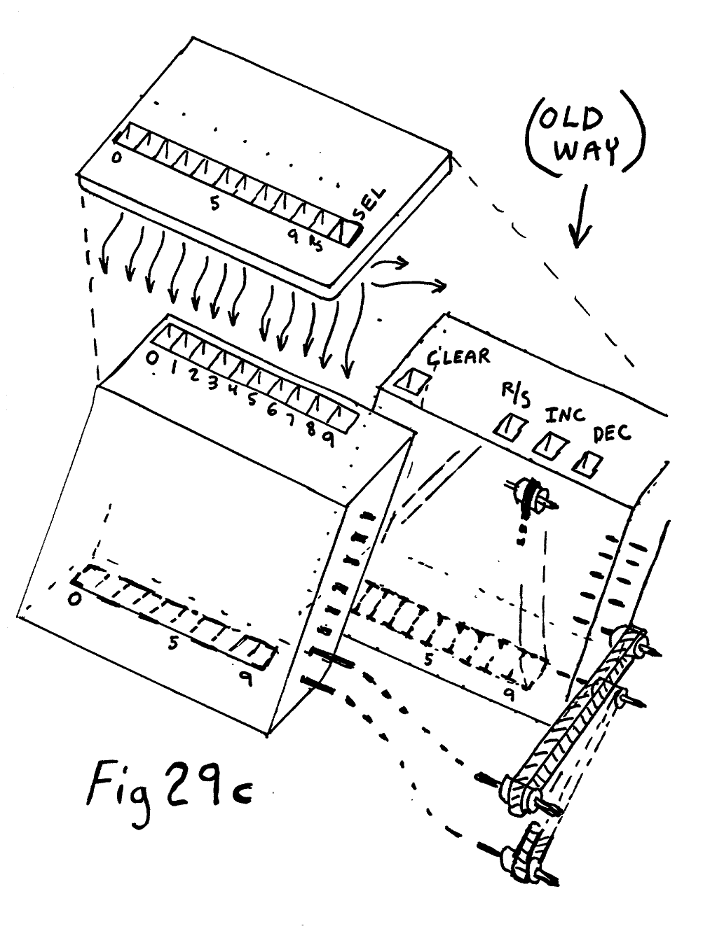

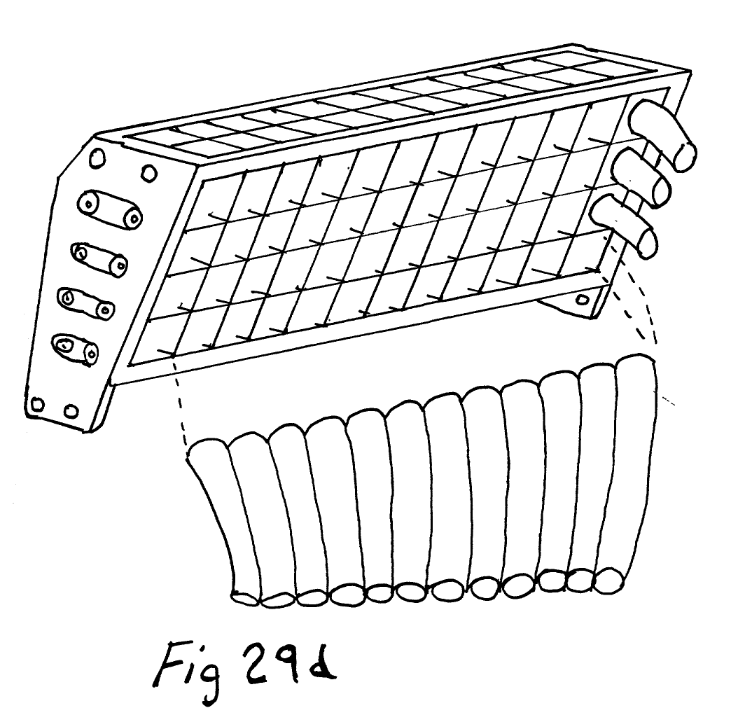

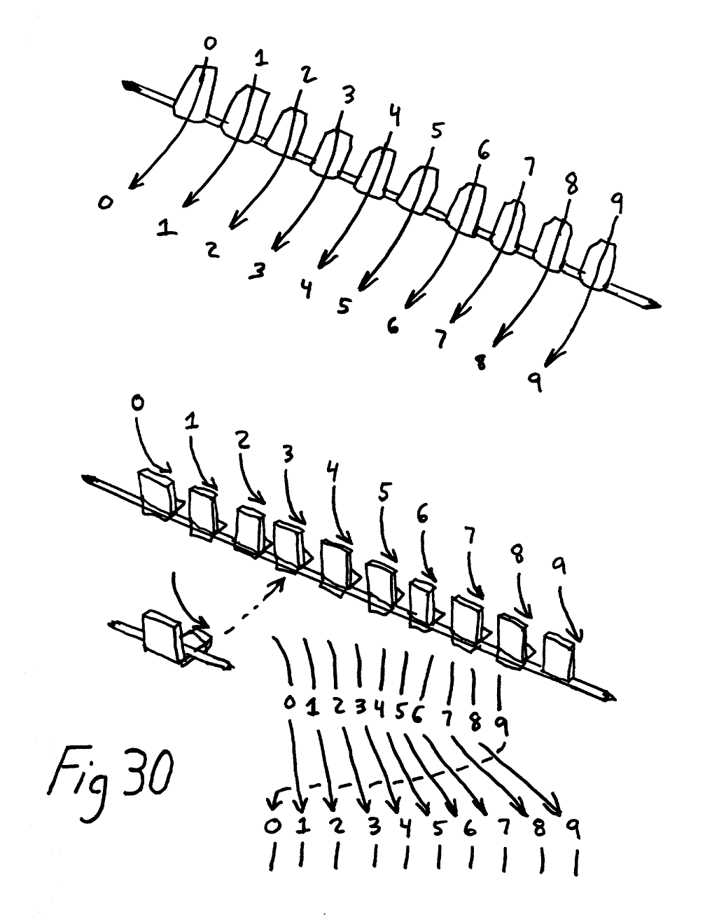

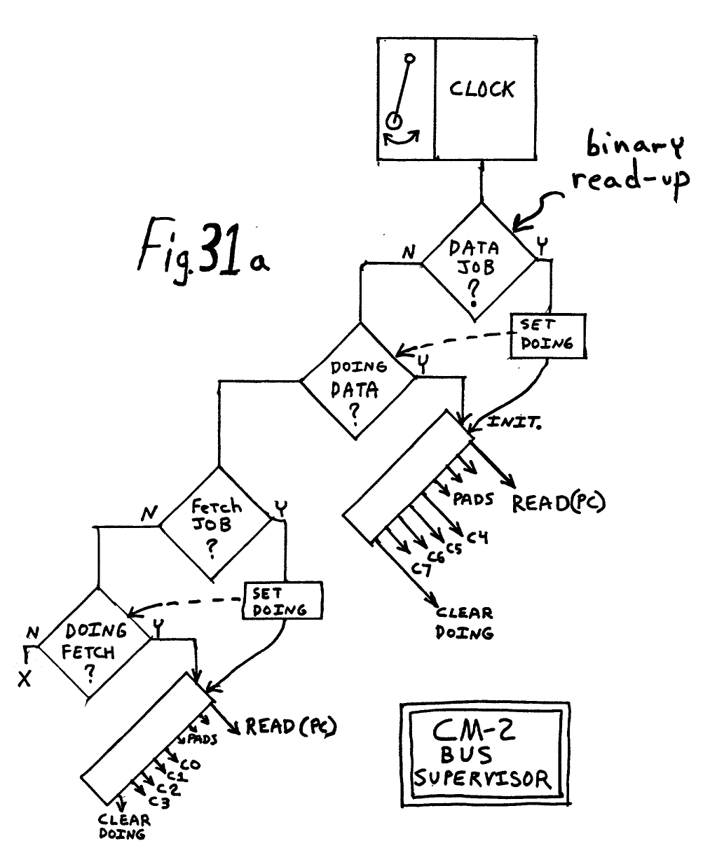

For internal mechanical placement details, readers can refer to FIG. 28, showing internal component placements, for the bottom, or resource half of the machine.

Considered in order of function, which is from top to bottom, the control components, in the upper CM-2 machine half are:

Clock Unit,

Supervisory Pulse Generator,

Program ROM-CORE,

Program Governor,

and Internal Sequencer Core.

At this point in the downward flow are the signals and hardware of the computer resources, as seen by the programmer or user. The resources, also discussed later, include:

Main Internal Bus Head or Top, (FIG. 27a),

Read Data Accumulators, (receivers 211, FIG. 27a)

Primary Bus Path Switches, (or PATH=), (FIG. 27a),

Working Register Set, with Destination Switches, (FIG. 27b),

Data Memory Array, (FIG. 27c),

and Write Data Accumulators, (or HL), (senders 210, FIG. 27d.)

On other connection paths, roughly parallel and alongside with the working register set mounted inside the CM-2 enclosure are included the direct bus, and the addition I subtraction hardware. The direct bus is simply a downward run of 11 transparent plastic hoses or conduits, which connect down to the sender semaphores of the accumulator. Another parallel downward path (not shown here) is for an optional science unit, to be contained in a separate attached or auxiliary enclosure and terminating near accumulator semaphore sender. The SCIENCE unit contains multiple modules to perform functions, such as for SINE or COSINE conversions. The Science unit connects to the main CM-2 chassis just below the main internal switch outputs. (See FIG. 27a, or FIG. 27b.)

### Background

It was originally conceived that mechanical signal connections would resemble electronic computer chip logical interconnections and thus have a strong analogy factor. Due to the novelty of the present invention, however, each new sub-system and large module demanded various innovations for implementing a mechanical computer that was software compatible from a micro-code or assembly language function approach. Much of this novelty arises from the impulsive bus operation of the present invention, which is a fundamentally different method from synchronous clocked electronic devices and busses.

Virtually all of existing electronic computing has internal logic which is binary based. It is likely that there is an entrenched viewpoint that there is an inherent advantage in binary systems. On the other hand, some early computing efforts (1900-1950) did use a pulsed signal approach for data transfer and direct decimal logical processing, but these early systems lacked the practicality and massive scale of today's development environments. A good way to illustrate this somewhat vague point is the comparison between the INTEL 8008 and the subsequent INTEL 8080 processor chips in regards to memory pointer addressing.

Users of the early 8008 complained that simple routines and block functions were burdened because of the availability of only one memory pointer. The INTEL 8080, on the other hand, represented such an improvement with the inclusion of additional memory pointers that many new programmers were able to participate in the on-going computing revolution. It is to be noted that this improved development environment was not necessarily due to fundamental innovation but perhaps more due to the incremental feature expansions made to the INTEL 8080 design.

At all times in development of the present invention it was desired to implement a system that would have a large degree of familiarity to the existing body of programmers, hobbyists, and computer scientists world-wide. This compatibility would take the form of familiar instruction sets and architectures specifically tailored to the popular electronic micro-processors including:

6800 processor family, including the popular 6502 (Motorola and others);

INTEL 8051 and derivative family;

Zilog Z-80 micro-processor;

and the currently popular PIC 16F84 reduced instruction set processors manufactured by Microchip Corp.

The following describes the implementation of a direct decimal sub-system which combines novel decimal signal operation (i.e. the impulse bus) with the above ideas of software compatibility of instructions for data transfers and processing. Additionally, various ideas relating to the instruction set composition are incorporated in this design. This introduction to the instruction set of the mechanical computer CM-2 helps to put a functional overview in place for the reader to understand the structure of the internal resources. The resources of the CM-2 computer are now listed:

The A register; A single digit accumulator which is the main source and destination for data transfers and processed data results.

The HL register; A double digit accumulator which includes the A register as the low digit, with L being an alternate name and another digit as the H or high digit. (Ref. 211, FIG. 27a and 210 FIG. 27d.)

The PC register; This is the program pointer to the user program steps (FIG. 27c.)

The WR registers; There are ten double digit working registers. Each WR can be used as a data memory pointer using indirect addressing.

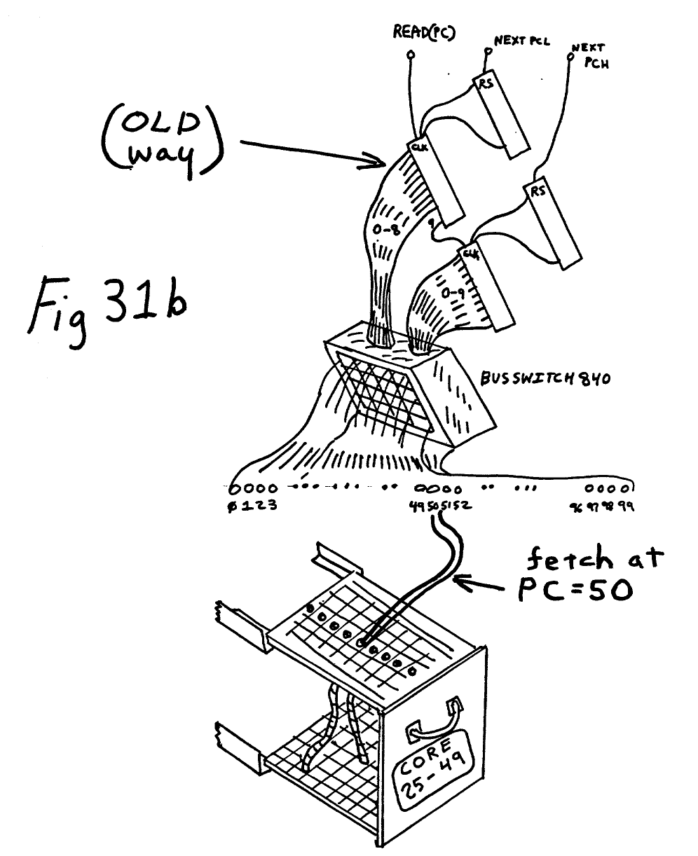

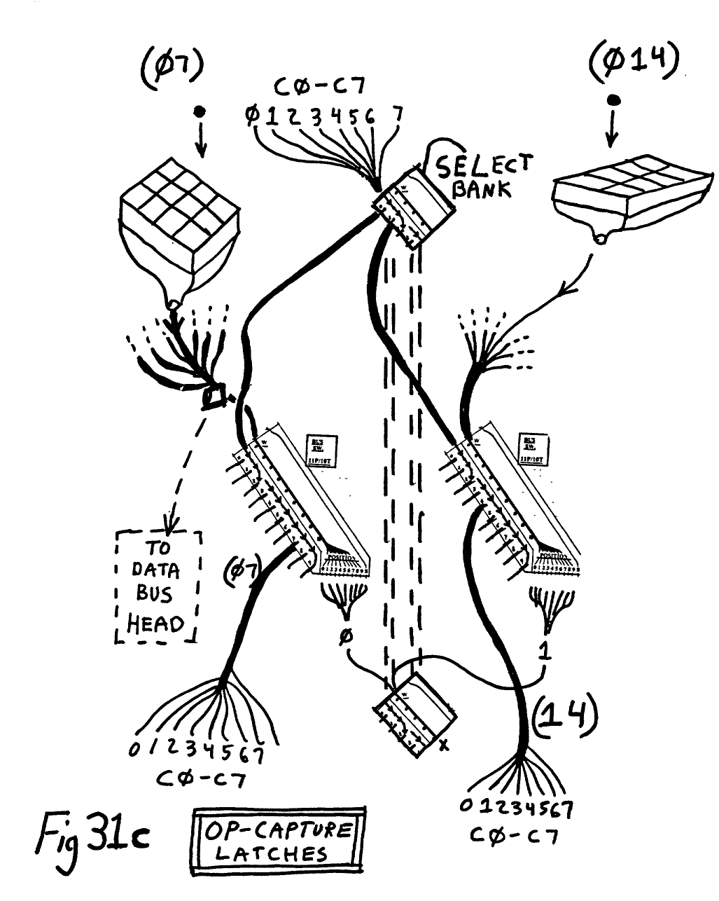

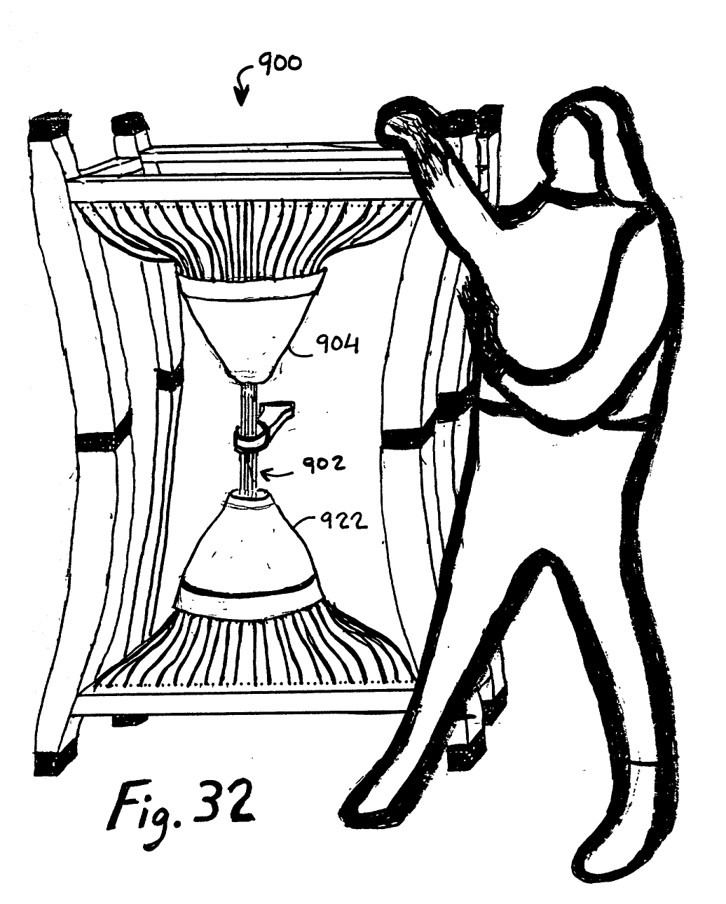

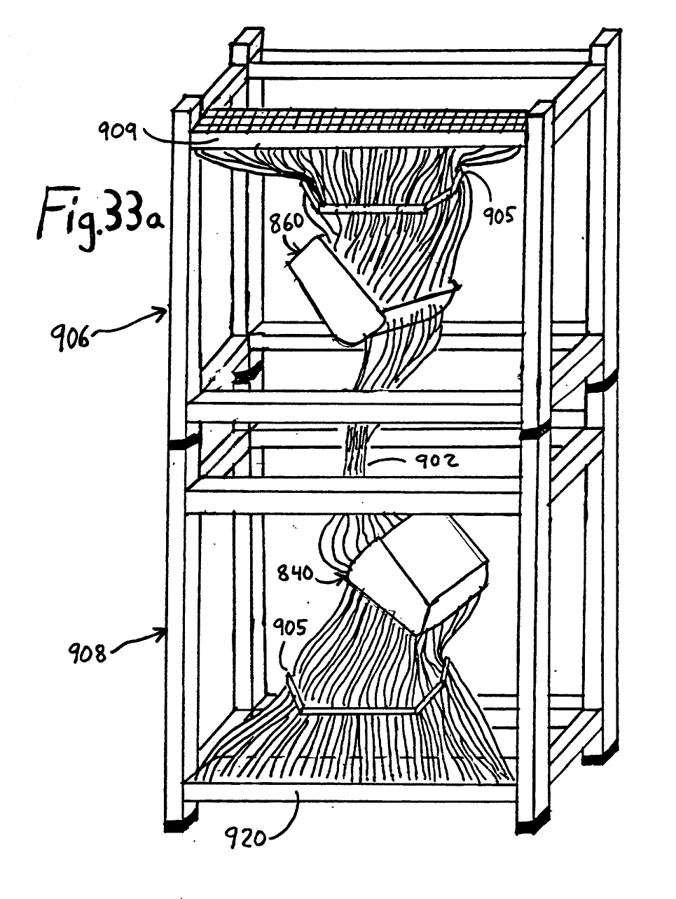

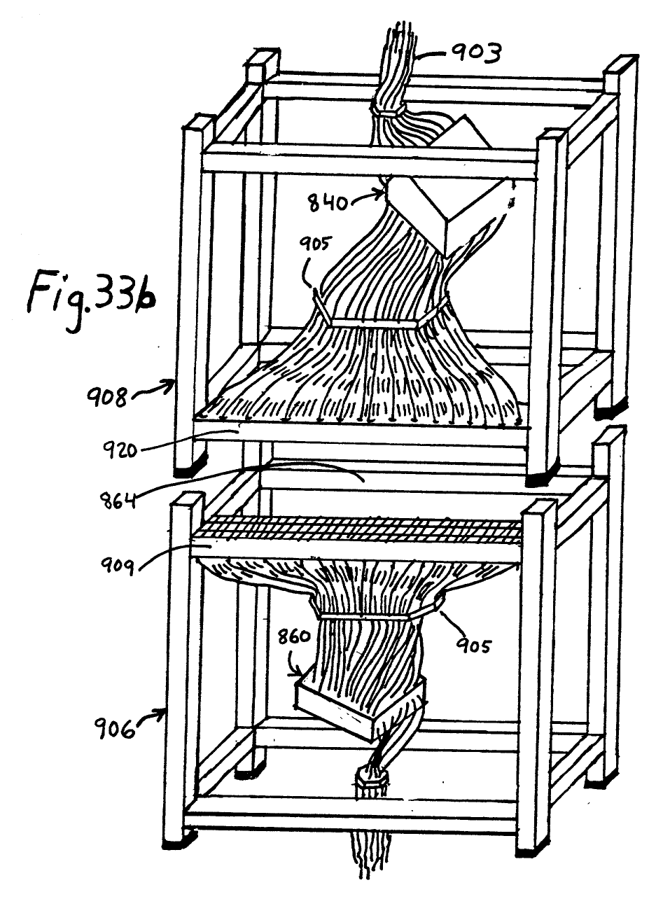

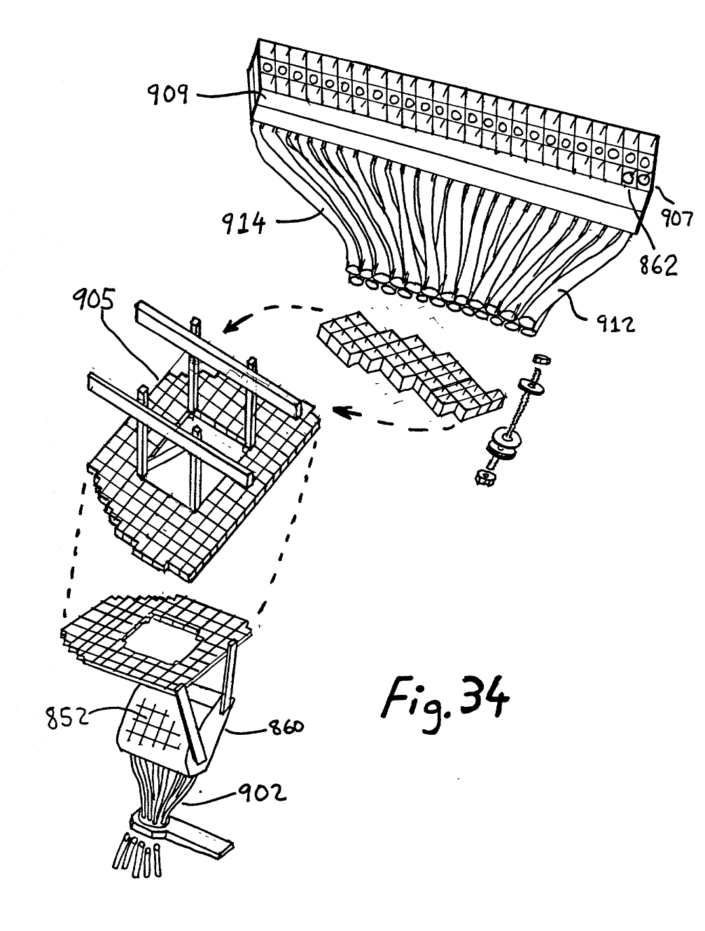

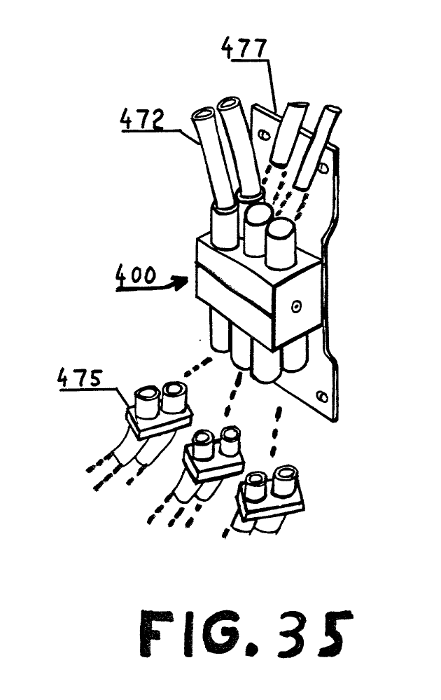

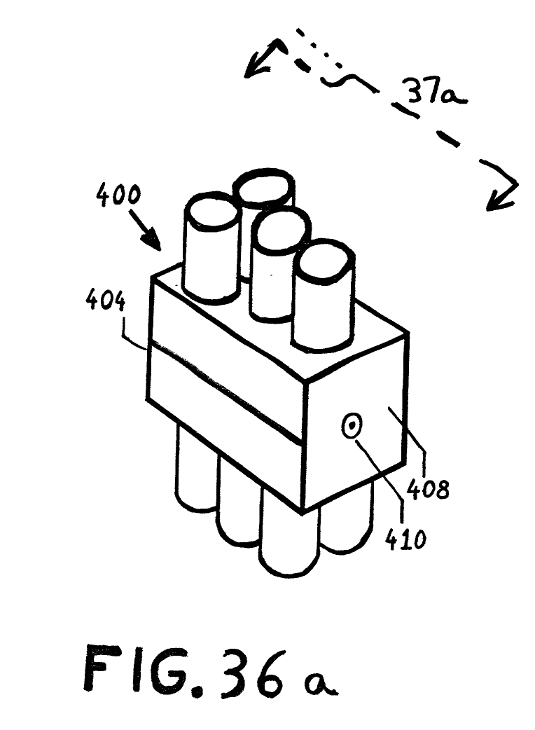

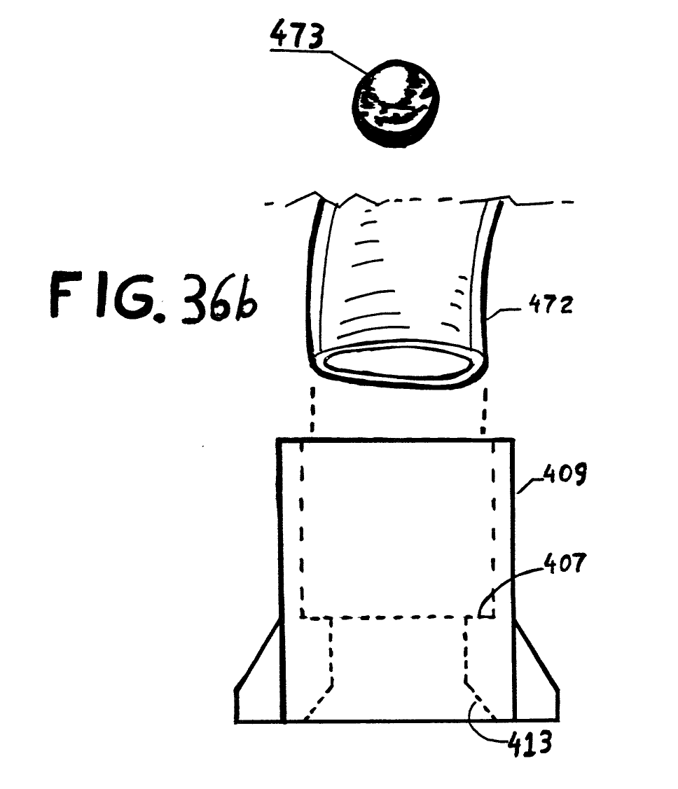

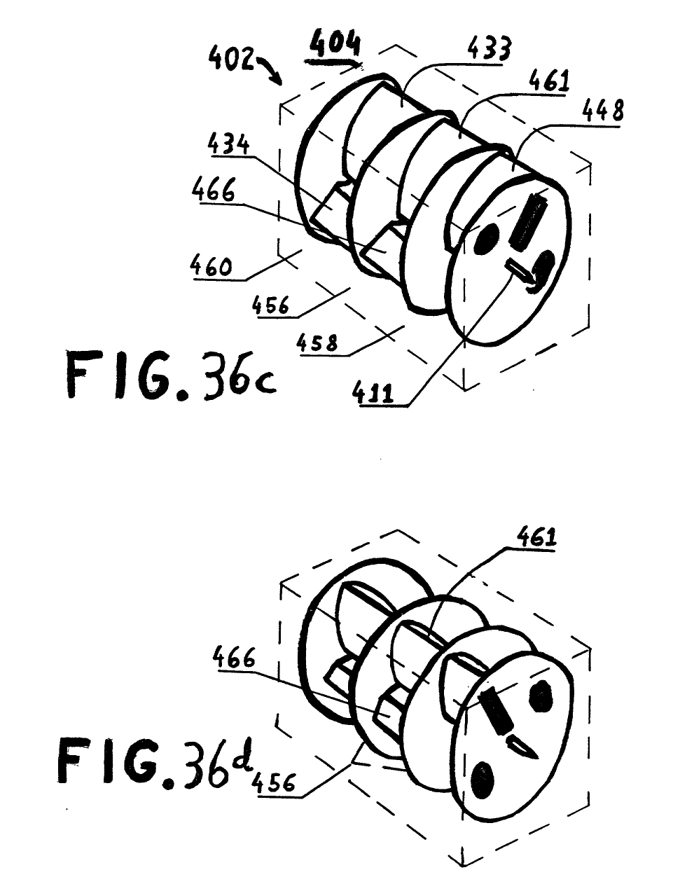

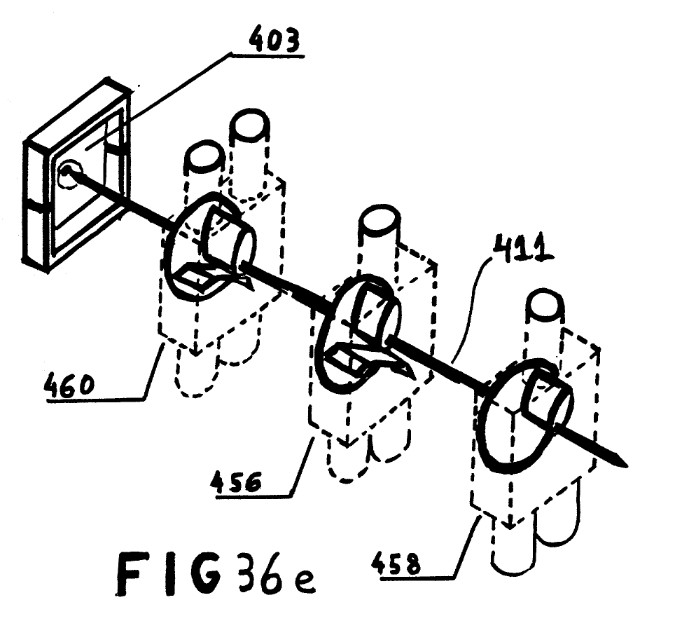

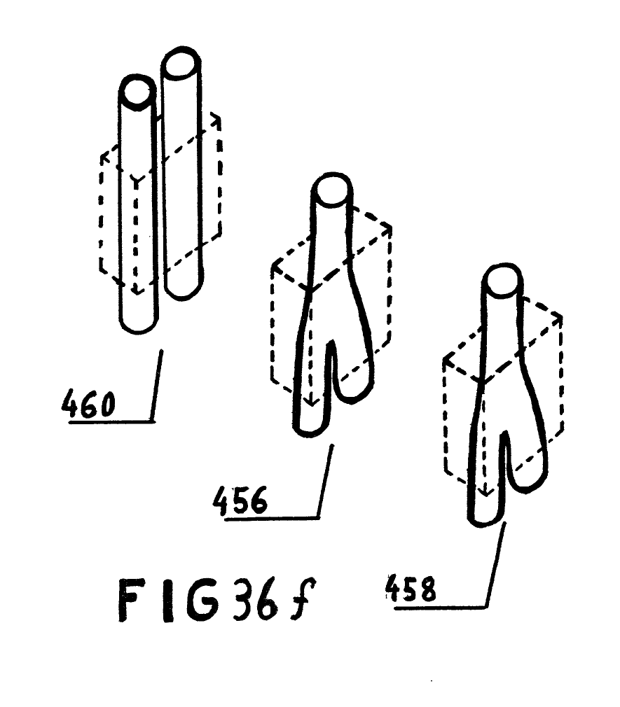

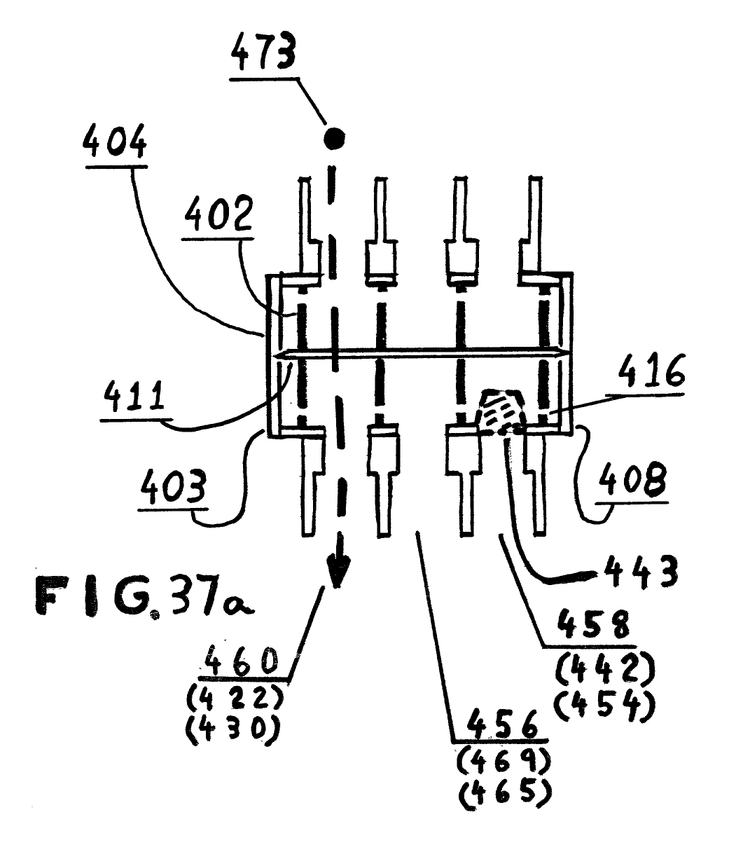

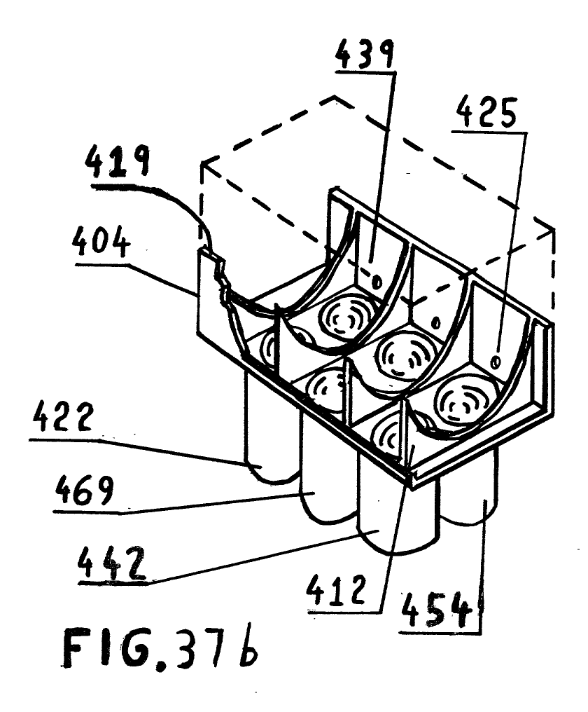

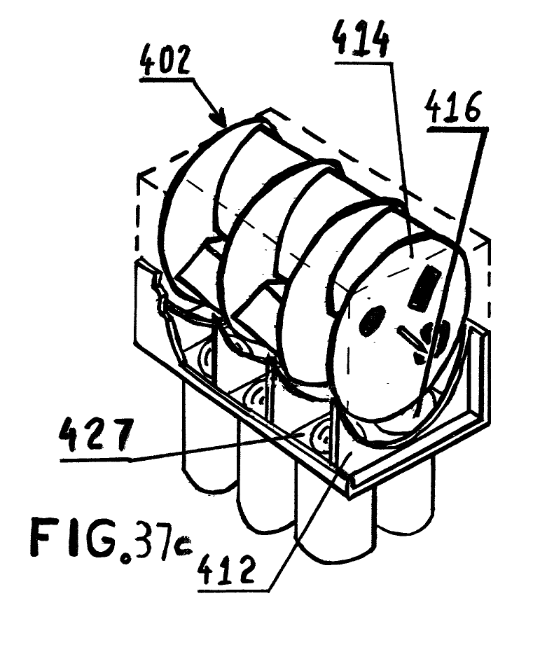

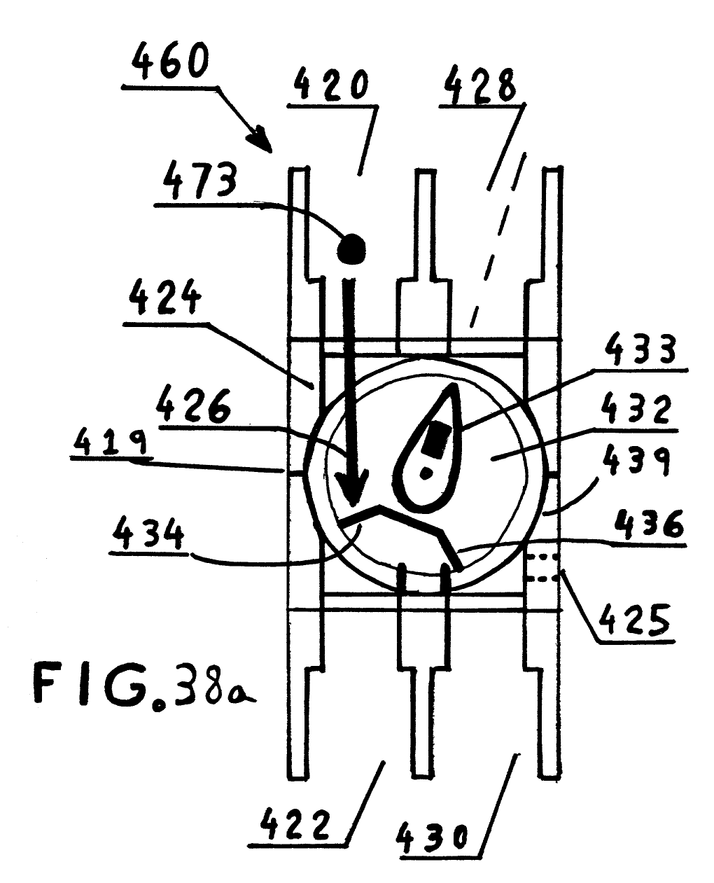

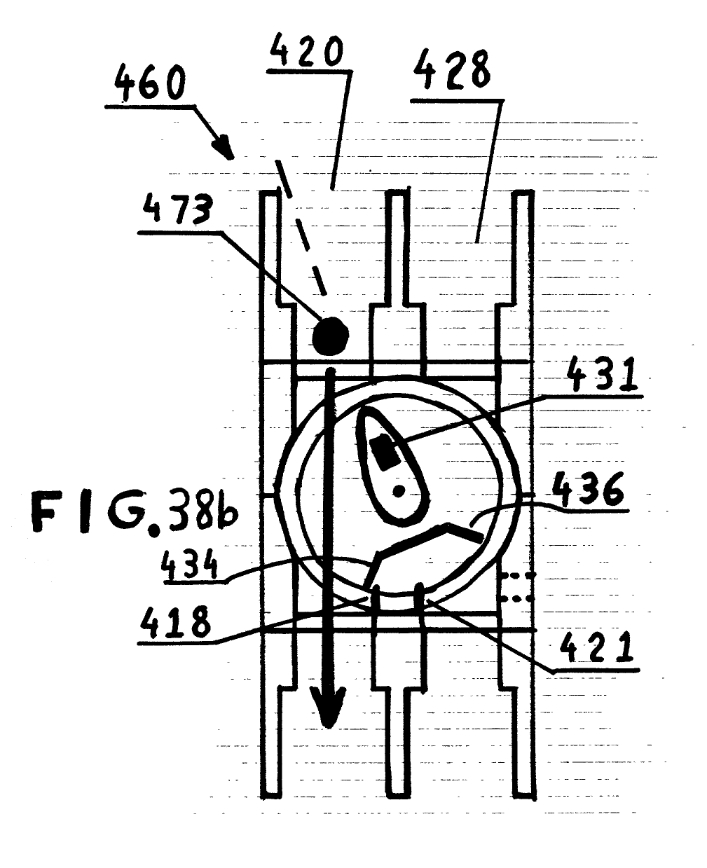

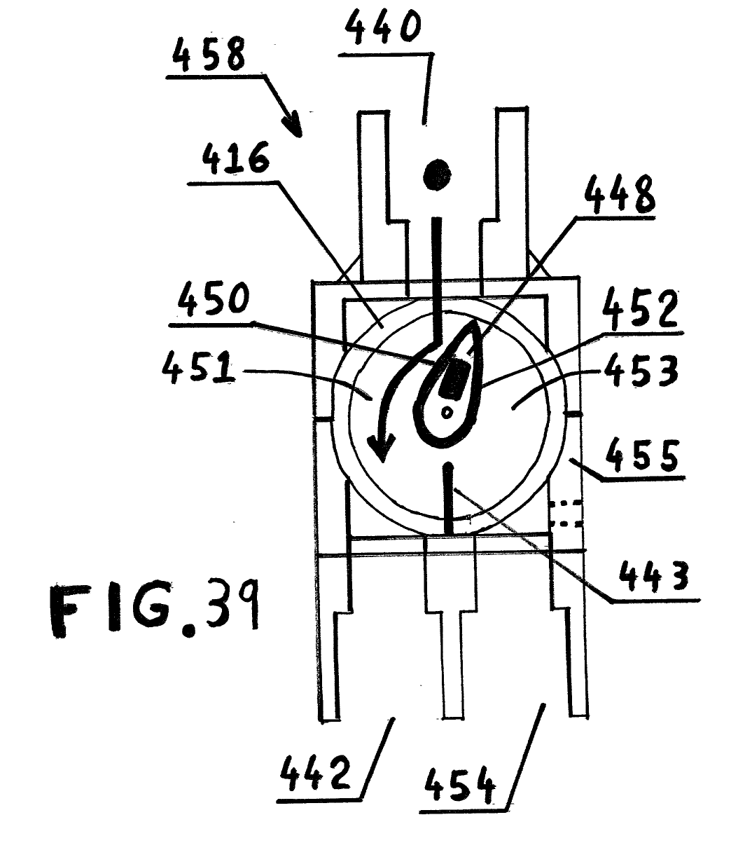

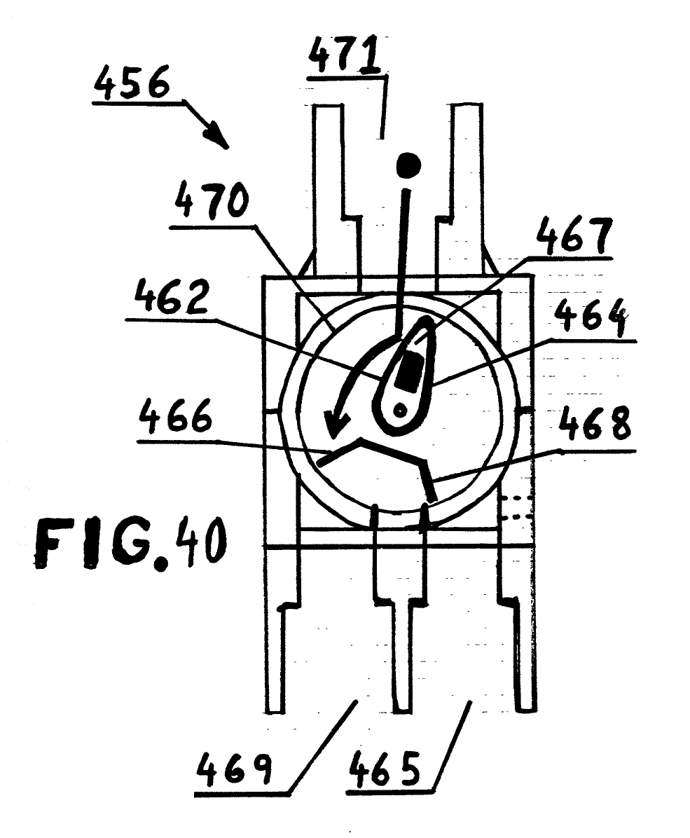

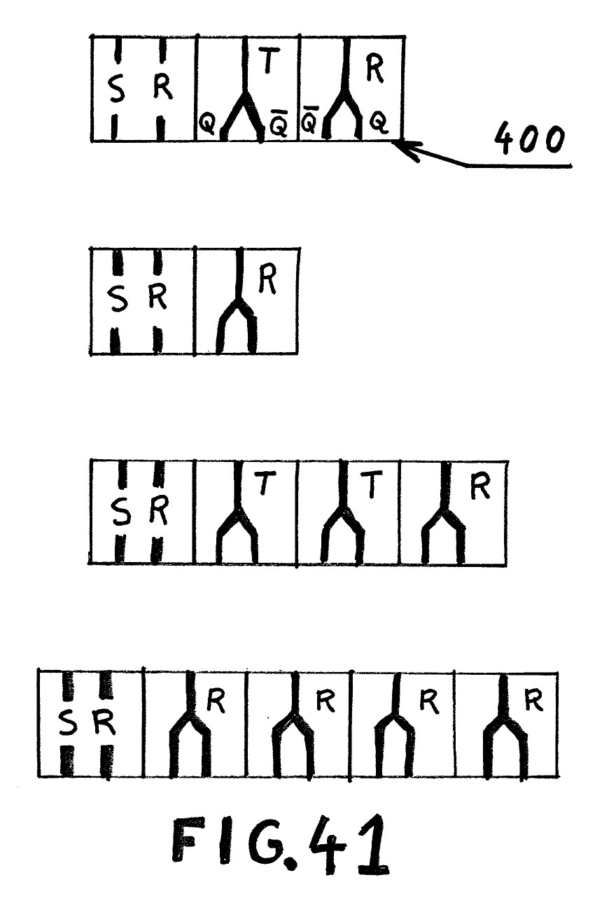

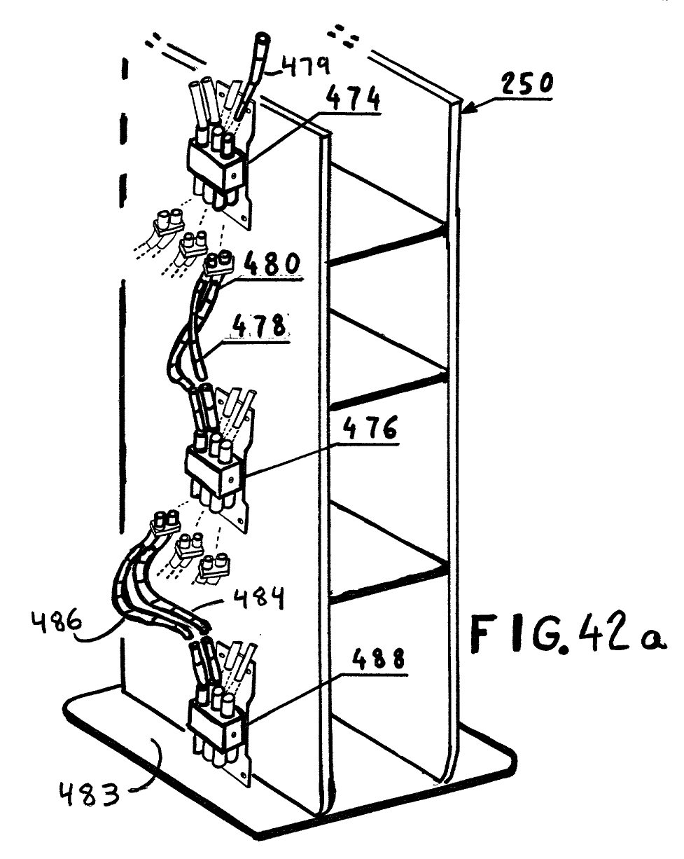

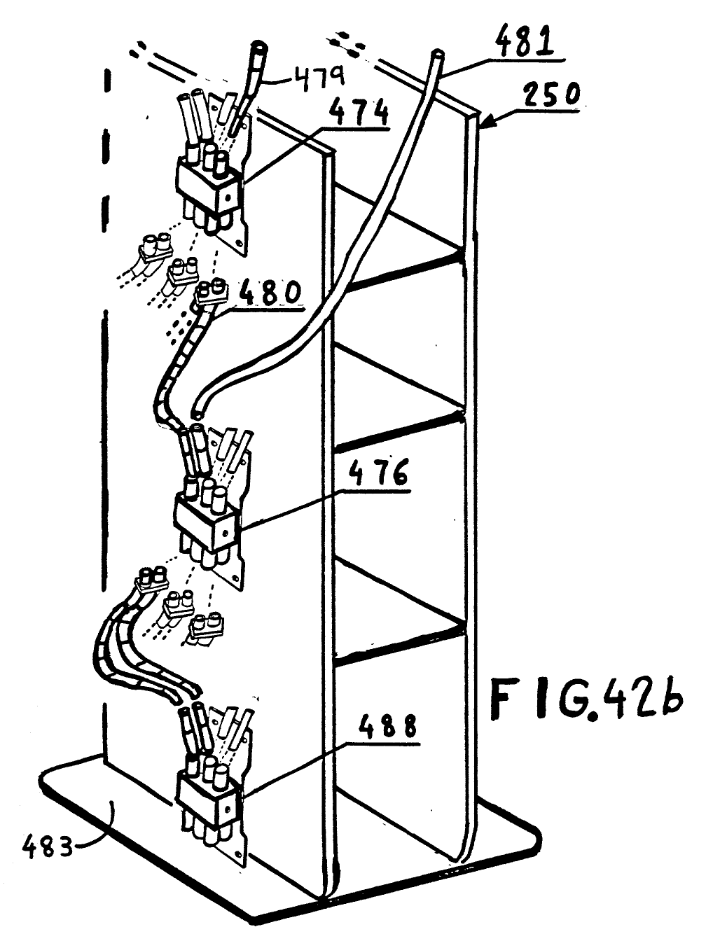

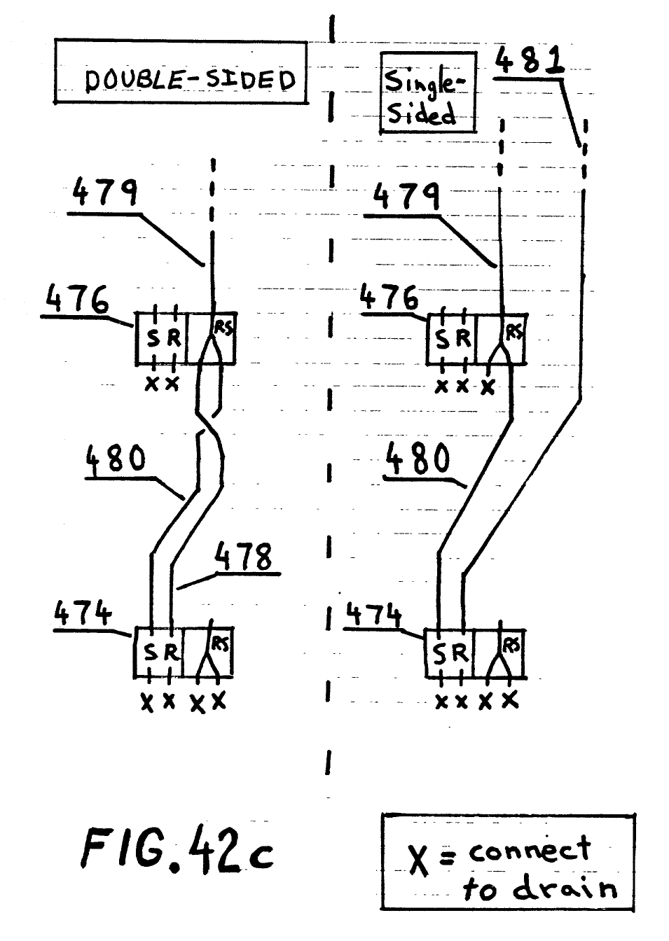

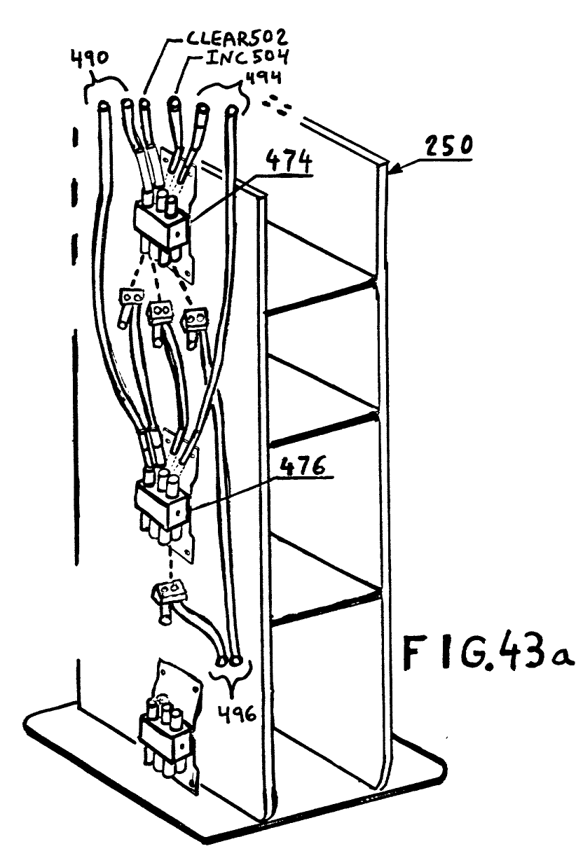

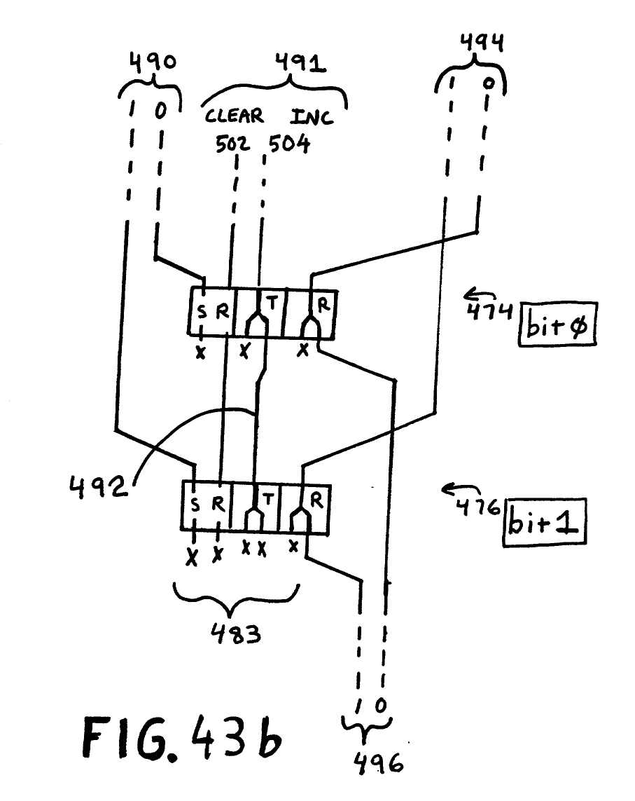

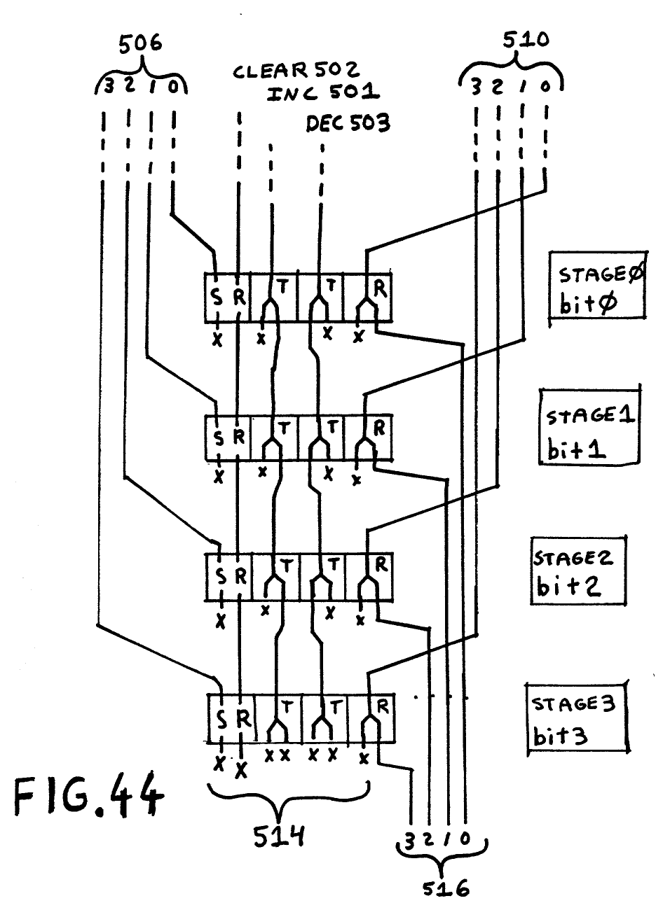

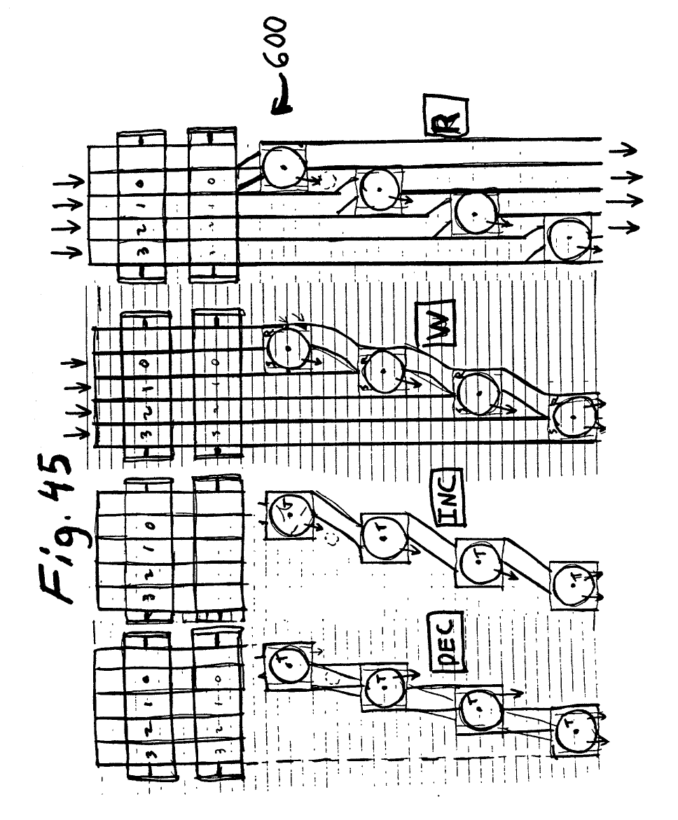

The MEM registers; There are up to 100 general data memory digits for storing strings, tables and other general data used or stored by the running program. (See FIG. 31c.)

### Decimal Instruction Set of the CM-2 Mechanical Computer

The tier structure presented in the following list of the CM-2 instruction set is a bit of a mismatch in the sense that it is structured for a more conventional word-stream type of program. In the conventional (electronic) sequential stream form of bytes or words the first word is decoded, which can then specify expanded or extended decoding, then requiring a fetch and decode of a second word (or OP-CODE). This prioritizes instructions so that there are short and long variations. In this embodiment however, the use of the ROM-CORE program system allows parallel, discrete output of each instruction or data term due to the unrestricted routing or output connection possibilities. In other words, an electronic system using a byte-wide ROM (Read Only Memory) for program storage is restricted to 8 bus signals or 256 decoded possibilities. In this embodiment of mechanical computer the ROM-CORE is essentially a 1 bit output device, but can be connected to invoke innumerable functions or instructions. This is because there is no defined bus output restricted to a certain word size. The term core is used by resemblance to the usage of the term for automobile parts, such as an alternator or radiator core, for replacement compatibility, that is one core program can be replaced for another.

Thus the instructions shown as extended to 1X, 2X, or 3X are not actually used, as the ROM-CORE output at any particular program step can be connected directly to a desired instruction sequencer. (See FIG. 31b). However, this instruction set retains the tier, or prioritizing structure to maintain continuity with planned future mechanical computing systems.

TABLE 8
DECIMAL USER INSTRUCTION SET AND INTERNAL SEQUENCES:

| | (Column 2 has the internal sequences |
|---|---|
| | issued by the system controller) |
| First Tier: | |
| 0 = EXTEND to 0X | (not used in this embodiment) |
| 1 = EXTEND to 1X | (not used in this embodiment) |
| 2 = SWAP | PATH = 4, RSACCH, RSACCL |
| 3 = SKIP Z | PATH = 7, DATA = 0 |
| 4 = SKIP NZ | PATH = 7, DATA = 1 |
| 5 = MVI A,# | PATH = 3, DATA = # |
| 6 = MVIDD PC,#H,#L | DEST = 0, PATH = 2, DATA = #H, DATA = #L |
| 7 = MVIDD WR,#H#L | PATH = 1, DATA = WR#, DATA = #H, DATA = #L |
| 8 = LDA WR | DEST = 1, PATH = 1, DATA = WR#, RSH, RSL |
| 9 = STA WR | PATH = 1, DATA = WR#, RSACCH, RSACCL |

Second Tier User Instructions (0X):

| | |
|---|---|
| 00 = MVIDD A,#H,#L | PATH = 3, DATA = #H, DATA = #L |
| 01 = LDA (WR) | DEST = 2, PATH = 1, RSDATA, RSDATA, RSDATA |
| 02 = STA (WR) | DEST = 2, PATH = 1, RSDATA, RSDATA, RSACCL |
| 03 = SKIP C | PATH = 7, DATA = 2 |
| 04 = SKIP NC | PATH = 7, DATA = 3 |
| 05 = ADDCI | PATH = 5, DATA = #, RSACCL |
| 06 = LDA (#H,#L) | PATH = 2, DATA = #H, DATA = #L, RSDATA |
| 07 = STA (#H,#L) | PATH = 2, DATA = #H, DATA = #L, RSACCL |
| 08 = INC A | |
| 09 = INC WR | PATH = 0, DATA = WR# |

Third Tier User Instructions (1X):

| | |
|---|---|
| 10 = DEC A | |
| 11 = DEC WR | PATH = 0, DATA = WR# |
| 12 = MVI (#H,#L),#I | DEST = 2, PATH = 2, DATA = #H, DATA = #L, DATA = #I |
| 13 = SKIP FL | PATH = 7, DATA = 4 |
| 14 = SKIP NFL | PATH = 7, DATA = 5 |
| 15 = SCIENCE | PATH = 8, DATA = SC#, RSACCH, RSACCL, RSL |
| 16 = ADDIDD | |
| 17 = SUBCI | PATH = 6, DATA = #I, RSACCL, RSL, copy carry |
| 18 = ADDC H | PATH = 5, RSACCH, RSACCL, RSL, copy carry |
| 19 = EXT | |

### Methodology of the CM-2 Decimal Instruction Set

The previous TABLE 8 of the CM-2 computer instruction set is the result of much study and empirical experimentation. It was desired to use a data traffic model first and a computing or processing model second when assigning and prioritizing functions, in possible disregard of established cultural or industry viewpoints. This is because it is found that in most coded microprocessor programs about one-third of the instructions comprise about two-thirds of the work done, with most work being traffic related for simple data transfers. Thus it was considered a higher priority to move data around than to actually process or change it. With this scheme the volume or bulk of a program could be minimized, with an attendant increase in speed and efficiency. Instructions such as;

MVI A, # (move constant to accumulator),

LDA 19 (load contents of memory location),

and STA 17 (store to memory location),

were thus given higher priority over instructions such as ADD or SUBTRACT. Also, some attention was given to loop functions since efficient looping is important. Although not present in this described embodiment, it was desired to incorporate a powerful loop function, resembling the block functions of the Zilog Z-80 or Intel 8080 as follows:

Upon first encounter of a LOOP op-code or instruction the computer will obtain a loop count (from the program stream), and then save a copy of the program counter (PC) as the start of loop. The computer then performs the general instructions in the loop. Upon encountering a second LOOP op-code or instruction the computer will automatically decrement and test the loop count and if not done will restore the PC to the start of the loop. This is an example of the experimental possibilities provided by the mechanical computer invention, since all internal workings are accessible by the user.

Another powerful loop function, a block move, could be implemented in the decimal mechanical computer by assigning working registers WR1 and WR2 as source and destination pointers and assigning WR8 as the loop counter. This automatic block move instruction would have the mneumonic MDR, or move-decrement-repeat and resembles the Zilog Z-80 or Intel 8080 LDIR (load increment repeat). Increment refers here to the source and destination pointers which for the electronic Z-80 are the HL and DE pointer registers.

Other instruction set features considered important are OPEN/READ/WRITE and RE-SAVE, where OPEN (WR4) indicates a data transfer channel for reads and writes which will cause each read or write statement to include an automatic post-increment of the WR4 pointer after each access. This resembles the functions of post-increment that are featured in the Motorola 68000 processor. The RE-SAVE is a particularly helpful instruction as the following code fragment illustrates the savings from reducing a redundant address;

| | | | | |
|---|---|---|---|---|
| LDA | 19 | replaced by | LDA | 19 |
| ADDI | #3 | replaced by | ADDI | #3 |
| STA | 19 | replaced by | RESAVE. | |

As will be made apparent in the attached claims, many of these instruction set features are still under development at this time of first filing, but are nevertheless included to provide a valuable gauge of potential and anticipated functions of the CM-2 mechanical computer. It is intended that users can compile programs on a conventional personal computer (PC) or workstation (such as manufactured by Sun Microsystems) for download to the mechanical computer. The CM-2 machine would then be used in a similar manner as existing electronic micro-controller experimentation, that is a commercially available assembler/compiler would produce object files for down load. (Actually more likely a commercial assembler/compiler will need to be customized for the CM-2 instruction set, which resembles the work needed to modify the compiler for a device like the INTEL 8048, or the PIC87F8.) It is anticipated that the CM-2 users will also be able to use the currently popular tiny models of the BASIC and C languages similar to the INTEL 8048 experimenters and developers. Much of this mode of use depends on the features of the instruction set.

In the present state of development these modes of use are not completely developed.

(Readers may note that the CM-2 is currently described using the alternate ROM-CORE method of getting a run-able program loaded in the machine.)

It is anticipated that a PC interface will be designed that will be electrically and electronically based, using a solenoid to release each steel ball to operate an input on one of the mechanical impulse devices of the computer, as input. The CM-2 computer, meanwhile, will have a monitor program running. These monitor programs, typically used for conventional electronic computer software development, when used in the mechanical computer will monitor the input device using a conventional parallel computer port methods such as Present Next Digit (or PND, also refer to generally to Centronics parallel interface). As is typical of these monitor programs, the CM-2 monitor will use an INTEL HEX file format, which typically contains location information along with a transmitted object file.

For example, a user, having just compiled an 80 digit program on a PC, will then start up the CM-2 monitor program, with a digit receiving loop that waits for each new character of the INTEL HEX download file to arrive. After this the user then activates the down-load from the PC. The actually time to send the 80 digit, or character, object code file will be on the order of 30 minutes.

Another point regarding instruction features involves yet another cultural viewpoint or attitude that a computer must be Boolean, that is it must have each Boolean function for operating on data or cannot be a computer. Actually this is only somewhat true in the context of program flow, where a branch constitutes a binary decision. This is a distinctly different function from explicit Boolean data manipulation. Readers can note that the decimal instruction set of CM-2 has no Boolean data operators, as they have little or no meaning in a non-binary system. (Although the CM-2 machine does have the traditional program flow modifiers, such as SKIP Z or skip on zero flag set.)

### Data Transfer Module of CM-2

The four views of FIG. 27, can be placed together and have the major internal data paths showing top to bottom paths for data transfers between the accumulator, working registers, and data memory, and including paths for data coming from the program stream (such as for putting constants into a register or memory). This FIG. 27 represents the bottom half of the CM-2 machine, with the top half of the enclosure occupied by the system controller and program ROM.

At the top of the FIG. 27a diagram is shown the various signals coming down from a system sequencer (covered in FIG. 31). Generally, the sequencer issues about 6 impulses to set up paths and execute a data transfer instruction. Later, it will become apparent that most data processing instructions are also heavily based on a data transfer model, where simply sending or transmitting data through a math or other unit will cause modification of the data during transit. This can be referred to as processing by bus (or connection).

### Split Accumulation Portion of Register File and Data Memory Subsystem

A scheme must now be described to complement the one-way nature of signal flow in the mechanical computer, since the system is gravity (or accelerating field) driven. While it is possible to perform WRITES from an upper accumulator to a lower register or data memory location it is required for READS that an accumulator also be below any register or data memory. To resolve this structural conflict a backwards or upwards transmitting channel was invented to logically connect the two halves of a split accumulator.

A READ-UP arrangement is for upwards logical signal connection. With the use of simple tension lines the pivotal positioning of lower accumulator sender 210 elements are transferred for co-rotation to corresponding receiver elements in upper accumulator receiver 211. In the present embodiment the function of the READ-UP is static, discrete, and two-state. It is discrete and two-state in that each pivoting element has a selected and a de-selected position which is communicated by a tension line pair between each lower element and corresponding upper element.

For decimal systems, this scheme is implemented for each discrete digit state, 0 through 9. Thus, decimal accumulator 211 in FIG. 27a has a total of 18 tension lines which mechanically connect lower and upper registers as sender/receiver. As previously mentioned, only nine of the ten integer states need be communicated as the last integer state, nine, exists by default when all pivoting shafts are in the de-select position.

Using the FIG. 27 block diagrams as a basis, an internal or private language can be defined which is the actual physical operating or lowest level machine language. In electronics this is commonly known as the internal or on-chip micro-code and is usually un-accessible to programmers and users as there is usually no provision for alteration of internal chip timing functions and signal sequences. (This is not to be confused with the machine language routines and programs compiled by users and burned into an on-chip ROM, as this is the next level up in the hierarchy.) It can be stated that the four vertically linked views of FIG. 27 form the operating goals for the sequencing controller in the three linked views of FIG. 31.

For the Mechanical Computer invention TABLE 8, the CM-2 instruction set list gives a list of each such internal or private sequence that will be invoked for each instruction in current effect. These sequences are referred to as internal or private so that users do not feel obligated to learn this aspect of machine function. Actually, if desired, any instruction internal clock state, order of signals or other extra functionality can be added to the CM-2 machine hardware if the user cares to go to the extra trouble of designing such modifications. In other words, internal or private sequences are hardware level details that can be ignored by users wishing to stay with more conventional assembly language development.

The set-up of main or primary source path switch determines most of a functional path. For some instructions a secondary path switch is set-up for determining some destination paths. A particularly useful aspect of this arrangement is that data can be routed from any of the ten working registers to the data memory to be used as an address pointer commonly referred to as an indirect addressing mode (FIG. 27b and FIG. 27c.) An interesting aspect is that while the physical path obviously exists to simply send or transfer data from a working register directly to data memory this type of transfer always instead involves the accumulator as there is currently no defined instruction in the CM-2 machine for a direct store. This is a trade-off that exists on many micro-processors because otherwise including every possible function would put an excessively large and inefficient burden on the instruction set size. Therefore to save a working register to memory requires two instructions such as;

LDA WR4 and then STA 19, for example.

For extended uses, such as for the instruction group called SCIENCE, other secondary switches can be chained at will on to any of the multiplexed busses (each called a MUX-BUS for short). The instruction SCIENCE is operated in the standardized MUX-BUS method, that is a SELECT is made, to be sent by the primary destination path switch (or PATH for shorthand in the table lists) by virtue of the selection of the SCIENCE MUX-BUS. Then, further path switching is done by sending a SCIENCE selector digit, such as to specify a trigonometric tangent function conversion. Then, repeating this MUX-BUS functionality, this SCIENCE selector causes the SCIENCE switch to issue a SELECT down to the actual tangent processing hardware. This process of multiple MUX-BUS accesses down through a path tree can be repeated according to the architecture of each system design, until ultimately a target device or subsystem can be accessed for read or write.

A bus switch is used for selection of one of ten SCIENCE functional modules, which are determined by the look-up functions embodied in the core of each individual module. If for example, a user wants a customized table for conversions they will build a core by inserting conduits as described and sliding or installing the core into a docking receptacle (FIG. 31b.) Most CM-2 machines will probably only use a few of the ten possible functions as each module is somewhat bulky. As previously mentioned, each module for each function consists of a bus switch, connection table core, and a re-encoder. The bus outputs from each of these modules runs to BUS combiner 880 and is sent down the accumulator semaphore read-up.

The BUS path map scheme is only loosely presented in this document, due to the simplicity of the MUX-BUS interfaces. In this scheme, there are input/output ports which connect to a few simple switches, for a CPU test panel having numerical input of zero through nine, and a few control buttons such as READ, WRITE, SINGLE STEP, HALT, etc. as is convention in micro-code system de-bugging. Up-coming input/output routines (tables 9 and 10) have path access by the system sequencer (FIG. 31) where the main BUS switch is positioned to PORT 9 (science), where the port output runs to another secondary switch, which has the buttons and display elements mapped as individual data registers. In fact, it is easy, but not described here, to modify a register 700 for button inputs, where a push button with a spring can effect the pivotal positions of the stacked lever elements. For output display, register 720 has already been presented, having one single digit to display, of zero through nine. A bank of four registers 720 can be connected to four ports on the secondary BUS path switch. The user program step in process, for output display of one digit, will first position the main BUS switch, then will position the secondary BUS switch by sending down the selection digit, as specified by the instruction in process. Thus the user program supplies the selection digit, according to the output display map, and the internal or private program handles the various other switches needed to process the instruction (see table 9.)

### Introduction to the Processing Module for CM-2

Having just discussed the prioritizing of the instruction set for data traffic, the data processing features of the CM-2 decimal computer will now be described, including incrementing/decrementing and decimal math.

The working registers (WR0 through WR9) each have an input for incrementing, and an input for count decrement. This is a special accommodation, requiring extra means in each register for causing an internal state change to the next integer value. Internal details of these increment and decrement functions are shown in FIG. 29a, where a ball will fall into the conduit for the current integer value, or state, and then will impact the next shaft shown, to cause a select pivotal action, and in FIG. 29b, where decrement is done by special arrangement to cause a flip or select of the shaft that is above the current shaft. In the last cases, increment of number nine will first cause diversion of the ball down into the integer nine output conduit, and then a band connected shaft (and tab) causes select of the top-most shaft for integer zero, while decrement of a zero (FIG. 29b) will cause the next ball (decrement clock) to fall all the way down, to select the bottom-most shaft for integer nine, as the next counting state.

FIG. 27b shows the distribution of each increment and decrement signal from the primary bus path switch, an older design that pre-dated the total multiplexed (MUX-BUS) interface to each working register. This older way is useful to show an advantage of the discrete bus of the invention as there is no de-coding necessary. The sequencer simply makes the number of the desired register (or WR#) available by writing it to down to the write register block (WR0 through WR9). By writing the WR# via the main path switch the specified register is incremented, and similarly decrement, although another port would be needed.

### Arithmetic Processing Means

### Using Main Port 5,6, and then AUX 8

The main method for processing or altering data utilizes the bus processing feature that was previously described. A process cycle involving single or double operands uses the previously discussed methods of alteration during transmission or processing by the bus. By sending or transmitting a pair of numbers, or operands, through a bus processing means the answer or result is made to emerge or be output. The data accumulator, or A register, is always the data source and destination for processing functions.

In this CM-2 description accumulator is used as a general term because both single and double digit functions are available, with the lower digit (or L) being just another name for the main single digit accumulator (or A). Two size types are used for math functions. For addition, subtraction, multiplication and division there are two input operands, each of a single digit, and currently all math function embodiments supply one output operand of two digits. (This resembles way that a general binary computer uses both 8 and 16 bit function size variations.) For the USER SCIENCE functions, including trigonometric functions such as sine, square root, and including any other table translation function, there is one input and one output operand, each consisting of two digits.

The source in the case of either of these size types can be either the accumulator or can be immediate data from the program. Immediate data addition uses as the sources single digit A register (also called L) plus a single digit transmitted on the data bus. Register addition uses as the sources the single digit A register (or L) plus the single digit high accumulator (or H) register. This is simply a convention established by the instruction set currently in place and embodied in each specific instruction sequencer. Math functions, being in table look-up form, always present a double digit result which is transmitted down to HL (ref. 210.)

### Interface the Processing Means

In the block diagram FIG. 27a, b, c, d, including a working register file, digit memory, and interconnecting buses, the bus processing (or table look-up processing) means, such as an addition module, there is always the same pulsed bus interfacing. One or more pulses are used to set up a specific path to an addition module and for the carry or overflow function. From the point of view of any given math module, there is received from the multiplexed bus a SELECT impulse, a high or decade digit data input impulse and then a low or units digit data input impulse, which is internally transformed and emerges as the high data digit of the result. A final impulse, a READ-SYNC, is issued on the bus to cause the math module to issue a low data digit of the result. (See also discussion on FIG. 26.)

The math functions are all logically similar in results to a conventional electronic computer arithmetic logic unit (or ALU), with the stipulation that this description is for decimal digit math, not binary.

In FIG. 26a is shown a means for the addition of two single-digit numbers. Essentially, the device implements a table look-up, with a bus switch 840 for decade selection. As previously described, the combination of the setting of the decade bus switch with the discrete, un-encoded form of the units bus impulse produces a discrete source (or WIDE-BUS) of an integer signal of the value range of 0 through 99. This bus is then routed or connected to the 100 to 10 encoder 860. It is this routing that determines the answer or output value.

For addition, an answer table is built up comprising the range of 0 to 18. Consider the following example:

9+3=12

The first single digit, 9, is sent to the bus switch (by way of the multiplexed data bus input, and after a SELECT.) This positions the decade. Then, the second single digit, 3, is sent, resulting in an impulse on the hose or conduit for the integer within the combinatorial or logical input range of 0 through 99. The construction of the answer table then dictates that this discrete impulse (of look-up table input integer 93) must be routed or connected to give an answer of 12. Thus the output impulse must exit the connection core on the hose or conduit for the integer value of 12. (FIG. 31b shows a similar core.)

A core 780 is the volume in the computer enclosure where the answer hoses or conduits connect as per the answer connection table, as introduced in FIG. 20. Each of the 100 output hoses are combined to eliminate redundant results such that all additions of the two input digits result in a valid answer. This answer or output value is then sent down to the connected 100 to 10 encoder module. In brief, a 100 input encoder will save a copy of the units digit and send on a copy of the decade digit. Thus, in the above example, the addition result of 12 is sent down to the 100 to 10 encoder, which then saves the low or units digit (2) and then sends or transmits the high or decade digit (1).

In keeping with the accumulator based processing model, the high and low accumulator digits provide the first and second math operand digits respectively. For an addition instruction, the path to the adder is first established. Then, the accumulator high digit, which can be simply identified as H, is sent down, a data transfer which is initiated by sending down a READ-SYNC to the H register (signal identified as RSACCH). (See the block diagram, FIG. 27a).

Following this high, or H accumulator register digit transmission the accumulator low, or L digit is transmitted down by sending a READ-SYNC (signal identified as RSACCL). As this then causes the answer to pass into the encoder, the high result digit then emerges from encoder 860 (FIG. 26a.)

For other examples of math requiring two digits of result, such as multiplication, this high result digit will be saved down to the high accumulator digit, H. For the above addition example, having an answer range of 0 through 18, the high digit is simply used to provide a logical carry or addition overflow and is instead sent to the system carry flag, using a two position BUS switch as a diverter (not shown.) The routing of one-bit high addition result digit will cause a set or reset of the system carry flag. As in well-known electronic microprocessor instruction set usage, the CM-2 mechanical computer has program tests of a carry flag and a zero flag by providing various forms of a SKIP instruction, although this disclosure does not detail the skip function execution. Simply, a skip flag is set by the test of a SKIP instruction, for use by the subsequent instruction, which fetches program digits regardless of logical SKIP state. Then, each active portion of an instruction must test the skip flag, as a condition of actually sending the control signals down, to effect the resources, or FIG. 27a. In other words, for a WRITE instruction, the path is set up, by the data strobe to send data down will be diverted by a two-state switch (a BUS SWITCH may be conveniently used to mass switch the control signals.)

Examination of the CM-2 user instruction set in TABLE 8 shows lists of internal (or private) sequences which implement each individual user instruction. For single operand math, such as for the trigonometric function of SINE (X), the internal instruction sequencer uses the two digit accumulator HL as the function input representing a degree value in the integer range of 0 through 89 degrees. After resolving a two digit answer through the look-up table, or CORE, the normalized answer in the integer range of 0 through 99 is then copied down to the accumulator digits HL, by way of the accumulator semaphore. The high digit comes out as the result of sending in the input data impulse on the input bus to the math hardware section that is for doing the SINE (X) function and this high result digit is copied to the H register semaphore. Then, the instruction control sequencer sends down a READ-SYNC to read the low digit result from the SINE function hardware (with the general bus signal called RSDATA). As usual with math, the SINE function hardware consists of a bus switch with custom (or look-up table) connections to an encoder and combiner. (Also see the section on WIDE BUS operation, FIG. 26.)

Also seen in FIG. 27d, is a small BUS SEQUENCER for operating the double digit accumulator sender 210, with the present figure omitting the control lines. This is part of the dual size design. Presently, the sequencer connects directly up to the controller for positioning, and so does not require a SELECT. A zero input signal will position the sequencer for the low, or L register, and a one input signal will position the sequencer for the high, or H register. With consistent use of devices, the small BUS sequencers will also have the READ-SYNC signal, but this is not used, as the accumulator semaphore senders 210 are write only devices. In the same light, the upper accumulator semaphore receivers 211, being read-only, have a WRITE BUS input that is un-connected, simply because the register 700 housings are used.

FIG. 29c shows the scheme for multiplexing or sharing the input BUS for operating not only a discrete BUS for data READ and WRITE, but also for having a second path for incrementing and decrementing. As seen, a top DE-MUX shaft will first be positioned by a MUX-BUS SELECT, and then a BUS signal can be an increment, a decrement, or a switch to data mode, for subsequent access to the back sub-module shown. This actually produces a working register package that is mechanically ackward, having twice the suitable thickness for interfacing easily with the BUS SWITCH. Currently, prototypes of the working register set only have five, out of ten possible.

One interesting feature is that each counter drops any carry (integer nine data) down back into the system BUS, for chaining a count to the next register block (similar to ref. 230), which has also been pre-positioned. This carry comes into the next register as a count up, or increment, just as in the upper register (logical low digit.) The same process allows a borrow to be chained from block down to block, using the shared MUX-BUS for sending the overflow or underflow counts.

FIG. 29d shows what appears to be an abbreviated BUS SWITCH, and it is, but is more like the sequencing BUS SWITCH of FIG. 21, etc., rather than the randomly positioned BUS SWITCH 840. Seen are the upper input grid, for a SELECT (not a mux-bus select), which sets all of the shafts in the module. This is the sequencing switch seen in FIG. 27d.

### The Carry Propagator Logic Module

### FIG. 30

The Carry Propagation Unit shows how the stacked-lever element can really shine in solving processing function design problems. As many programmers are aware, a Motorola 6800 type of assembly language or machine language addition instruction always implicitly incorporates the system carry flag, along with the two various addition operands. (The 6800 or 6502 addition instruction has the symbol form of ADC.) Thus in some single number situations programmers will include an additional instruction to clear the carry flag (with the symbol CCF) for doing straight addition without a propagated carry that would be useful in multiple number digit situations. The electronic chip manufacturers had various motivations for omitting an add instruction without the carry. Like-wise, the CM-2 mechanical computer always incorporates the carry flag as addition process input and output.

Originally, this carry propagator logic design had filled a page full of logic gates, conduit runs, and other special mechanical accommodations to first include the system carry when adding and secondly to copy or write any new carry result back to the actual system carry flag. Later, it was realized that a single, special, stacked lever element or shaft assembly could perform all of the logical processing necessary to handle or propagate the carry. First, when all logical input and combinations and output outcomes were considered it was realized that the following operating rules could be established:

1. If there is no current carry then numbers or digits pass or propagate through using the No-Carry bus output path, which causes no alteration to the data passing through. This digit is then added as one of the operands.

2. If the carry propagator has a carry then numbers or digits pass through using the Carry-Set bus path, which causes an increment due to the bus shift connection arrangement. If the transmitted integer digit value to be incremented or added to the carry is in the range of 0 through 8 then the carry propagator must be cleared by the passage of the digit, and also result in continued propagation out of the carry unit as the shifted or incremented digit with result in the range of 1 through 9. This digit is then added as one of the operands.

On the other hand, in the case of the input digit being a 9 (and carry set), the connected conduit in the Carry-Set path produces the proper result digit of zero, and there is also a special case of omission of the reset tab for column 9, so that the carry state of the propagator remains as Carry-Set. In other words, if carry is set and a number in the range of 0 through 8 passes through, the carry is cleared. For the special case of the digit 9 the pivoting shaft position of the carry propagator is not altered.

This accomplishment of complicated logic using just one pivoting shaft assembly is a good example of a less-is-more design feature and is one of many direct advantages of the discrete impulse bus of the invention. The key is observing that the shaft tab position for the integer number nine has no overturn tab, while the other integer locations do.

### ROM Core User Program Module

### FIG. 31b

The ROM-CORE is the first of two control sections in the Mechanical Computer. By the routing, or connection of each of a mass of 100 flexible hoses or conduits the core exchanges a sequential input for a random set of outputs and thus comprises the means for a look-up table style retrieval or read-only memory (ROM). It has the feature, as mentioned, of not being restricted by an output bus width and so, in the case of the extended tier instructions, can be routed directly to the target integer input of the instruction latch. To drop down, or fetch a next instruction, the supervisor sequencer simply sends down one ball which does many things. First the ball reads (and internally increments) the low PC digit register, emerging with any value that is read as zero through eight. For an integer nine value, internal increment to zero implies a ripple carry, and so is sent down to clock the BUS switch to the next decade, which acts as a PC high digit register. Lastly, the output from the clocking action is also in discrete bus form, and so can be used as the first output of each decade, replacing the integer zero BUS output that would normally be used.

All this causes a selected (0 through 99) signal to fall through the ROM-CORE and be routed according to the current step in the pre-built program contained or embodied by the interchangeable ROM-CORE program storage device (FIG. 31b.) The next instruction has been resolved or fetched into the instruction the instruction request collector. (FIG. 31b shows as examples, instruction 07, and instruction 14.)

### CM-2 System Control Sequencers for Instruction Functions

As mentioned above, a single impulse will read the current user program counter position (or PC), and send this position to the USER program ROM-CORE. The ROM-CORE is a special, plug-in module which slides into a receiving dock (FIG. 31b). The 100 inputs at the top represent the program sequence, using a grid plate (801) square header with a small gap, for changing by pulling out the current ROM-CORE and sliding in another, and there also is a header with a gap for the bottom of the sliding core, which aligns with the headers.

Users can construct a program consisting of up to 100 decimal digits using plastic hose segments. The ROM-CORE module can be set on table-top, or bench, and opened up for hand connection of each individual hose. Also, a teacher or museum presenter can utilize a set of useful ROM-CORE modules, each containing a program.

Output from the ROM-CORE is a set of conduits from signal collectors which are the result of the semi-random connections of the 100 program-sequenced hoses. Each conduit represents, and invokes a particular instruction as intended by the programmer. A signal on one of these lines will cause the latching of the current instruction into the Program Governor. This is a result of one impulse sent by the Supervisory Pulse Generator.

Returning attention back to the FIG. 31a ordered sequence, impulse 0, (the first impulse, called READ PC,) is for reading or fetching the instruction from the ROM CORE. After waiting for two more impulses to allow for time delay for internal switching, the program governor is ready to be used or accessed. Supervisory impulses C0 through C10 provide a novel way of actually operating or sequencing the current instruction.

Readers should understand that these impulses are originated in the controller, FIG. 31a, and simply count via the BUS, into one of many selectable BUS ports, this representing the current instruction. While not shown in detail in this document, the method is to connect, for any given instruction, a signal sequence, (from the bottom of FIG. 31c), containing positioning of the main path switch (FIG. 27a), and containing connected signals activating any other controls (see the waist area at top of drawing.) As in conventional micro-processors, the terms outputs from all the instruction sequencer connections are gathered into one common set, which here is the waist, or system controlling and data input set.

### System Control of Internal Sequences

The sequential signals that operate any given CM-2 instruction are best understood by examination of the system diagrams of FIG. 27, and FIG. 31. These are obtained from the sequencing clock states, labeled C0 through C9. Generally, each instruction will usually select a primary signal path for data transfer, and in some cases will set-up a destination path (FIG. 27b). Then, if needed by the current instruction, one or two digits of location information impulses are transmitted down for a selection. Lastly, either data read impulses or a data write impulses are sent down, resulting in the action specified by the programmer. Each such transmission is down into the bus head which is the top of what has been termed the computer resources. This bus head or top is the end of the control system and the start of the resource area (from the programmer viewpoint). The bus consists of the 12 lines of the MUX-BUS, which includes the ten write data lines and the READ-SYNC line of the DISCRETE BUS.

The READ-SYNC line, labeled as RS, means read digit, as already described. As seen, the primary bus path switch is operated or positioned by direct connection to the sequencer, having no front end DE-MUX (shaft 848, see FIG. 23a.) Strictly speaking, then, the main BUS SWITCH of FIG. 27a is not a MUX-BUS input, but still is a DISCRETE BUS, lacking the MUX-BUS SELECT signal and multiplexed BUS input. The main switch does, however, generate MUX-BUS outputs, see the port outputs for the re-combination, or collation to the 12 line MUX-BUS, for each port that then runs down to the inputs of the next figure, FIG. 27b. Informally, this is called a headless version of BUS SWITCH 840, having no input DE-MUX, but instead using the two WRITE and READ BUS inputs separately by the upper controller.

It can be stated that most of this specification leads up to FIG. 27, as the most developed system diagram, or schematic. Then, the figures FIG. 28 through FIG. 30 have miscellaneous details on implementing FIG. 27, and so the text relates to these system details, perhaps in random order. FIG. 31 then provides the controlling means for the resources of FIG. 27. It could also be stated that these two halves of the CM-2 machine are somewhat interchangeable, although they are large sub-assemblies. Observation of the top of FIG. 27 shows a waist, which refers to the narrow connection between the upper controller (FIG. 31), and the lower resource area (FIG. 27.) This waist has the approximately 28 system controlling signals, including the top of the data BUS. (Most programmers only work with the computer resource area.) The conventional use is made of microprocessor control section terms collection, which puts all like signals together, such as READ-SYNC, and data traffic. For example, any instruction variations doing MVI, or move immediate data constant, of the example digit value of three (integer 3) will have conduits, which are combined into the BUS head conduit for the integer number three.

One special type of instruction uses an indirect addressing mode. As seen in TABLE 8, for the instructions LDA (WR#), and STA (WR#), show the above described sequential control with an additional data impulse at the end. This shows the contents of a specified working register (or WR#) being sent to data memory via the destination selector, followed by an additional data read or write impulse to perform the indirect action desired by the programmer.

As seen in the working register sheet, FIG. 27b, there is a BUS sequencer for sequencing the two digits of a register, when writing in data or reading out data. For indirect, a special last path, from the WR BUS sequencer, connects down to memory, for a path of the two register digits as an address, for a WRITE or READ between memory and the accumulator. These are done via the accumulator semaphores, which are assumed to be the primary place where the static accumulator data is held.

TABLE 9
Display Output Routine (There are no
patent reference numbers in this table.)

| ;/ Display three digit data with tenths, located at 50 through 52, in low to high order. | | | | | / |
|---|---|---|---|---|---|
| ;/ Format will look like; 41.2 Stored in data memory as 2,1,4 | | | | | / |
| ;/ Assuming sequential object digits, | | | | | / |
| ;/ (Generated object in this column) | | | | | / |
| STARTDISP: | | | | | |
| | MVIDD | HL,0 | 0,0,0,0 | ;/ clear high digit | / |
| | MVIDD | WR4,50 | 7,4,5,0 | ;/ point to lowest stored digit | / |
| | LDA | (WR4) | 0,1,4 | ;/ get it | / |
| | EXT | 0 | 1,9,0 | ;/ display it as tenths | / |
| ; | INC | WR4 | 0,9,4 | ;/ next digit | / |
| | MVIDD | HL,10 | 0,0,1,0 | ;/ load a decimal point | / |
| | EXT | 1 | 1,9,1 | ;/ display the point in second pos. | / |
| | MVIDD | HL,0 | 0,0,0,0 | ;/ put back to numeric 0 through 9 | / |
| ; | INC | WR4 | 0,9,4 | ;/ next digit | / |
| | LDA | (WR4) | 0,1,4 | ;/ get it | / |
| | EXT | 2 | 1,9,2 | ;/ display ones digit | / |
| | INC | WR4 | 0,9,4 | ;/ next digit | / |
| | LDA | (WR4) | 0,1,4 | ;/ get it | / |
| | EXT | 3 | 1,9,3 | ;/ to display tens digit | / |

;/ end of routine /

TABLE 10
Button Echo Routine

| ;/ range: 0000 through 9999 | | | / |
|---|---|---|---|
| ;/ Echoes each button directly to the digit display above it. | | | / |
| ;/ | map: | 3 2 1 0 = DISPLAY | / |
| ;/ | | 7 6 5 4 = BUTTON SETS | / |

ECHOLOOP:

| | | |
|---|---|---|
| EXTRD 4 | ;/ read low digit | / |
| EXTWR 0 | ;/ to display | / |
| EXTRD 5 | ;/ second digit | / |
| EXTWR 1 | ;/ to display | / |
| EXTRD 6 | ;/ third digit | / |
| EXTWR 2 | ;/ to display | / |
| EXTRD 7 | ;/ fourth digit | / |
| EXTWR 3 | ;/ to display | / |
| MVIDD PC,ECHOLOOP | ;loop back for continuous repeat | / |

| | |
|---|---|
| ;/ note that the above move double digit data to PC also has the form of JUMP (NN) | / |

;/end of routine /

### A Novel Sub-system Called Wide-bus

### FIG. 32

Advantage can be taken of the previously described features to create a novel bus of extreme size. The following describes the use of the decimal bus switch, associated impulsive bus methodology, and address and data multiplexing to achieve a 100 wide data transfer bus. This bus then operates locally in BASE 100 but can be accessed with MUX-BUS data transfer operations (a new generic term), using multiplexed digits in BASE 10.

Two systems will be described; HOURGLASS DEMONSTRATOR system, also FIG. 33a and a FREE-FALL demonstrator or signal processor system, FIG. 33b. The HOURGLASS system, in FIG. 32, has an encoder unit shown stacked on top of a decoder unit. The FREE-FALL system has a decoder unit stacked on top of an encoder unit (FIG. 33b.)

The WIDE-BUS encoder 860, having 100 inputs, does not actually encode an input, but rather it acquires a portion of the integer value. Most accurately, the device is called an encoder because it is part of an over-all multiplexing scheme.

The two identical frames are built separately and are stacked vertically using conventional dowel pins and reinforcing plates (not shown), for securing the four vertical members or legs of each frame together. Only the components mounted on the semi-circular header connector are variable. As seen in the FIG. 33 views, one frame is vertically flipped or reversed in the stack of two frames.

### Design Overview of the Generic Wide-bus Frame

As an overview, in the description of the identical generic frame, the organization of the 100 conduit hoses is the first major design task, partially due to the extreme novelty of the WIDE-BUS concepts and apparatus. Questions arose concerning the huge quantity and sizing of the conduit hoses as there was no immediate model or similar prior art to reference or improve.

There was no large mechanical data bus, or even any known prior art bus using conduits that could be used as a starting point in this design. Would it work without extending to unreasonable heights such as 4 meters high (12 ft.)? Would there be sufficient hose spacing to allow manual assembly with access to all bus elements, or would the bus and header structures be impossibly impractical, from a size and fit basis? In answer to these questions on practical construction, these prototype or proof-of-concept WIDE-BUS machines turned out to be easy to design and construct once the initial starting point of the novel apparatus basic shape was established and thus the framework shape and size.

Care had to be continually exercised in staying within the practical limits of physical construction of the 2 digit/100 conduit bus. If, for example, a 3 digit/1000 conduit bus was required the apparatus would have to be approximately the size of a train locomotive (14 meters or 45 ft.) and probably prohibitively expensive. On the other hand, the bunk bed size scale of this 100 conduit bus version is very suitable for audience or classroom viewing. It is apparent in FIG. 32 that an integer number scale, (not shown), across the top-front of range 0 through 99, is scaled well for the reach of outstretched arms, with the left to right dimension being scaled roughly proportional to human height. (Only every fifth hose is drawn, for clarity.)

For an expanded version, according to this stacked lever design, there would be required 1000 shafts for a full version of the next higher WIDE-BUS, which effectively limits the motivation behind such a machine. It is practical in some settings, however, to build a 300 wide system, if only to create a much larger and thus more visually intriguing display for large museum use. For an example 300 wide system there would be three separate sub-systems, as above, and with additional logic to later interrogate for which encoder sub-system had received the input ball for the museum or classroom demonstration. It is suggested that encoders for each logical hundred set, covering the range of 0xx, 1xx, 2xx, each can be read twice, and that such constructed copies of encoder 860 would have an interconnection arrangement to operate a MUX-BUS invention standard output.

For creating or origination of a three digit MUX-BUS, for each of the above encoder 860, one for each hundred incoming signals, it is suggested that each encoder have a modification to add one element, for the signal or state called input trigger. Each such trigger output will be run or arranged together in a parallel run, into a so-called hundreds BUS, and such BUS is then normally merged into the common BUS, for transmission. To clarify, under this decimal operation the hundreds BUS and the common BUS are always ten lines. This means that up to ten of these hundreds encoders can be arranged together, with each contributing one representative output signal. For generating this trigger output, it is suggested that there be a serial cascaded string arrangement, where a controller (or human demonstrator) originated READ-SYNC falls through each encoder 860, and out of a trigger in-active chain output, until an encoder is encountered that was triggered. When this active triggered sub-system is encountered the steel ball will fall down out of the above hundreds indicating conduit. This serial arrangement is acceptable for the large 300 hose hour-glass system, as there are only three encoders to cascade down through.

To complete this discussion on a large, up to 1000 line, demonstrator, for the two remaining digits to be originated for further transmission there is suggested that each encoder 860 be modified with an additional latch, (as in register 700), so that each encoder 860 saves both encoded digit locally, for future read-out of the decade (tens) and then the unit (ones.) This discussion illustrates the flexible nature of the logic in planning system logic expansions. Description of the 100 line embodiment, FIG. 33, will now resume.

### Details of Construction of the Wide-bus Frame

### FIG. 33a and 33b

This description, of course, assumes the downward flow of a particle (steel ball) in a conduit representing an impulsive data or control signal as in most elements of this disclosure. In the upper frame assembly, the encoder, is seen semi-circular input header 905 which connects up to conduit hoses which one by one connect up to linear input header 909. In the other, vertically flipped lower frame assembly, the decoder, it is then seen that the difference between the two assemblies is in which type of sub-assembly attaches (or plugs) into the semi-circular header (905 on either frame.)

The rectangular box-like generic frame is built using simple wood members attached together with carriage bolts, which allow for simple disassembly for transport. When the two generic frames are stacked together the structure resembles a bunk bed in size and shape.

Each frame is approximately 2 meters (6 ft.) in width and 1.5 meters (4 ft.) in height so that when an identical second generic frame is vertically flipped and stacked on top and secured by dowel pins the whole machine is then approximately 2 meters (6 ft.) wide and 3 meters (8 ft.) tall. This is the size seen or presented to a viewing audience, lab, or classroom of students. The generic frames and thus the machine occupies a depth of approximately 50 cm. (1½ ft.).

As will be apparent when the HOURGLASS DEMONSTRATOR operation is described, the entire freestanding machine can be rotated a half-circle for exposing the inner workings from the back. This can be done by two persons who grab and walk the machine around using leg mounted wheels.

In FIG. 34 the 100 conduits of the generic mounting frame are organized in four sets of 25 each, which facilitates easy disassembly or repairs. The view shows header 909, having 25 hoses in the segment, and with the connected hoses shown gradually forming a double row. Each of these sets has conduits which start from a linear arrangement and are gradually organized or bundled into a circular arc shape. Each set of 25 conduits then ends in a shape to match a portion of semi-circular header 905. This header acts as an intermediary between linear array 909 and the ultimate destination of conduits, that being the encoder 860 device. Since either connected device, encoder or decoder, is interfaced in a square grid form this intermediary shape of semi-circular header 905 is an approximate halfway shape between the linear array and the square array of conduits. This square (ten by ten)mass of conduit hoses (omitted here) runs generally from the encoder module back grid plate (852.)

FIG. 33a shows the use of the egg-crate grid material (801)) to form linear array 909. Two layers are used so that each hose of the conduit hose array has sufficient friction fit and gives space for tolerances in the lengths of each hose. The insertion depth into the two layers of the egg-crate material of linear array 909 is for each hose end to be approximately in the middle of each top grid element. Thus when a steel ball is dropped into the linear grid element there is a capture zone or length of one half an element. Correspondingly, each conduit hose occupies approximately one half of the top grid element plus the whole length of the lower grid element.

For clarity, shown in the FIG. 33 views are approximately 40 hoses when really there are 100. In FIG. 32 only every one of every five hoses are drawn, in order to keep clarity in copy reductions. In the full view, students or museum patrons can observe a computer BUS that has the interesting sheen of a plastic shower curtain and has many light reflecting elements (vinyl hoses.)

The device or module to be mounted in the center of each generic frame, the encoder 860 module, or the decoder 840 module, has a set of two mounting arms and a small sub-frame, which is for attaching to the generic frame (FIG. 34.)

### Details on the Encoder 860 Assembly Half

### FIG. 34

For the stack of two frames, one frame has decoder 860 connected to semi-circular header 905. This encoder 860 device could also be called a digit extractor as it obtains, or latches a copy of a portion of the WIDE-BUS integer data impulse. (See also the previous discussion on FIG. 26.) Out of the 100 inputs, the extraction of the units, or ones value is made. The encoder has a resulting integer state with a value range of zero through nine (0-9), which can be read with a standard mechanical computer BUS READ-SYNC (see 907, in FIG. 34). A second functional portion of the encoder then combines the 100 signals in such a way as to produce a TENS, or decade digit signal output. This is the process of reduction or truncation described in FIG. 24b. The BUS combiner is attached directly to the bottom grid plate of bus encoder 860, as in FIG. 24b.

### Hour Glass Digital Demonstrator 900

### FIG. 32

This demonstration system 900 is an hourglass-shaped apparatus supported in an open frame set, previously described as the generic WIDE-BUS frames. The system comprises a top encoder section and a bottom decoder section, using the two generic frames.

The purpose of the hour-glass digital demonstrator is to visually teach computer data bus operation and to challenge and engage an audience or classroom of students. For those who still do not fully understand the teacher's explanation the demonstrator still has value as a motivational instrument. Most older high school age students should need about 30 to 90 minutes of lecture and study time to understand how the demonstrator uses the multiplexed data bus. It is likely that these students will carry the momentum of interest so that all students will enjoy and remember the session involving the computer demonstrator machine.

From an audience viewpoint, the demonstrator has many inputs and many outputs but the volume of space in between (narrow neck 902) appears to be impossibly tiny or narrow. This is because the demonstrator operates in a multiplexed fashion which only requires transmission of one decimal digit at a time.

In FIG. 32 the STAND-ALONE HOUR GLASS DIGITAL DEMONSTRATOR 900 has 100 hoses running down into a first funnel 904 and emerging as 10 hoses. The 10 hoses then go down out of the top generic frame, into a second funnel 922 (in the second or lower generic frame) and re-emerge as 100 hoses at the bottom of the demonstrator. Some reference numbers are re-used, when appropriate, since the items are identical, such as semi-circular header 905, which appears mounted in both generic frames although the views of such mounting are upside down relative to each other. To distinguish, the encoder frame is given the reference 906, and the decoder frame is reference 908 in the view of FIG. 33a or FIG. 33b.

On the top of the encoder section is a linear marked scale, (not shown here),which is a clearly labeled number line from 0 to 99. The construction scaling of the demonstrator is determined somewhat from the impulsive particle size, which is somewhat large at approximately 6 mm. (millimeters), or ¼ inch. Using this size steel ball produces adequate inertial forces for the encoder 860 internal workings. The encoder 860 requires these special higher forces because of the quantity of bus signals which require special wide shafts, or many interconnected shafts.

Returning to the top inputs, (FIG. 33a, or FIG. 34 for close-up), the sizing of the impulsive particle being 6 mm (¼ inch), the clear plastic conduit hoses leading down from the scale are then appropriately sized to about 15 mm. outer diameter. Shown reversed, from behind, conduit hose 912 is the left side of the number scale, and represents the integer number of zero, while conduit hose 914 on the right side represents the integer number 24 (FIG. 34.) The total span of the 100 conduits, side-by-side, is approximately two meters (6 ft.). Advantage of this is taken to contrast with the narrow size of the conduit hose bundle in the neck or narrow portion of the hour-glass shape. The conduit bundle or neck-down 902 in the narrow neck section is only approximately 8 cm. (centimeters, or 3 inches) in diameter, which approximates a human wrist in diameter.

Returning to the top frame assembly (the encoder unit), and from the top-most component, an input header, these conduits running down from the input are gradually shaped or organized into a circular clustering to match circular funnel 904. In the gerneric style of the frames, conduits are gathered together in pairs which successively slip behind for gradually forming an arc that is two hoses thick, as a whole to form a half circle, so that from the front a viewing audience may assume this is a full circle, and from the back an audience can see into apparatus without being blocked by the hose bundles.

Inside, (FIG. 34 close-up), observable through a rear open area, the 100 conduit hoses assume a rectangular organization via the semi-circular header 905, and plug into encoder module 860, which has already been described in detail, (see encoder section, and FIG. 26.) The 100 outputs of this encoder module, which are the chain or discard outputs, as the encoder has already obtained a value representing the low digit of the base 100 number passing through, run directly down into an adjacent confluence BUS combiner which combines the ten conduits from each decade. This means that conduits for 0 through 9 run together to produce a decade zero conduit, conduits for 10 through 19 run together to produce a decade ten conduit, conduits 20 through 29 run together to produce a decade twenty conduit, etc. for a total of ten combiner output conduits. In this description these conduits and combiner are of transparent plastic construction and appropriate conduit hoses for a ten element bus exit the combiner. The identifying nomenclature for these is 0X, 1X, 2X, 3X, 4X, 5X, 6X, 7X, 8X, 9X.

These ten combiner output conduits, or hoses, then emerge downward from funnel 904 as the narrow neck 902 section of the hour glass shape. This narrow neck can be considered as the signal transmission section of the DEMONSTRATOR, and continues down from top encoder 860 frame (906), into bottom decoder 840 frame assembly (908).

### Operation of the Hourglass Demonstrator

### FIG. 32 and FIG. 33a

The demonstrator is useful not only for teaching specific data transfer functions but also generally engages and challenges an audience or classroom of students. Basically a teacher can ask the audience, or class, to give a number 0 through 99 which is then transmitted down through the system. The number is sent by the action of dropping a steel ball into the collection port on linear input header 909. First though, a separate signal called SELECT is sent down by dropping a steel ball into select conduit collection port, decoder select input 907 which initializes the system for a demonstration. (See FIG. 34 for close-up.)

As an example, suppose a #42 will be sent by selection of collection port #42 (this is not an item number) for dropping the steel ball. The ball, representing data movement, falls down to encoder 860 via conduit #42 (again this refers to the integer identification, not an item.) By moving through the encoder the steel ball will set the encoder state to the number two (2) representing the units or ONES digit portion of the original number (integer value #42.)

Furthermore, after passing through the internal write section of the encoder the steel ball passes immediately into the output combiner section of encoder 860 and emerges on encoder output conduit integer #4 which is the decade or TENS value of the number integer #42. This signal representing the integer value of four (#4) is transmitted down through the narrow neck portion of the hourglass and is observable as such (see 902 in FIG. 32.)

After passing down to decoder 840 or bus switch, the steel ball positions the decoder to the integer number #4X decade. The teacher then announces that the machine has learned the number. A subsequent read action, which can be repeatedly done, will cause a steel ball to pass down through the machine and drop out of the position for integer #42 on output header 920. This read action is initiated by the teacher dropping a steel ball in a special top input conduit called READ-SYNC (input 862.)

From the audience point of view the two actions of dropping a first steel ball into the collector for the integer #42 and then dropping a second steel ball into the READ-SYNC collector does not seem sufficient somehow to convey a whole integer value. The machine has appeared to somehow manage to operate in a range of 0 through 99, but with less than a dozen interconnecting conduits. Furthermore, there is no apparent computing chip or serial data mechanism that could operate in only two cycles, referring to the above two steps. The audience asks: “How does it do that?”.

The teacher can, at this point, ask or challenge the audience if anyone can invent or devise a mechanism which will function in the same manner. It can be stated that the main parts responsible for the trick reside in the two funnels; upper funnel 904 and lower funnel 922. It can then be explained that the upper device, encoder 860 stored the low digit, and then separated the high digit and sent it down to be stored in decoder 840. As was discussed, the BUS combiner performs a process of reduction, rather than explicit division, when it combines integer terms to essentially throw away the low digit of the two digit number on the 100 line BUS. This reduction process resembles how one byte of a 16 bit binary number can be thrown away, in a process that resembles division.

When it is time for an explanation, the entire machine may then be rotated so that the back view is presented to the audience. This is done by having two persons grab the machine and walk it around in a circle, by having small wheels mounted on each leg (not shown.) The teacher then may proceed with explanations of the two devices in the context of the trick which the machine performs, which is actually a multiplexed digit data transfer operation. Other materials, such as former FIG. 13, and FIG. 23, may also be needed to teach the fundamentals of how the two devices work. It is hoped that many students will find valuable motivation in the observation of this type of teaching session.

### Wide-bus Signal Processor Demonstrator Machine

### FIG. 33b

FIG. 33b shows a novel method of changing or altering an impulsive signal (falling steel ball) during transmission. The free-fall portion of this sub-system operates exactly as in the previous description in the section on FIG. 20. In that previous description the free-fall area had a width of 10 signals for a decimal bus. This section describes a larger bus which operates with a width of 100 signals. Although this is literally BASE 100 it can also be interpreted as two digits in BASE 10.

The previously described free-fall bus could be termed low resolution, having 10 steps of resolution of input and output. When operation of the WIDE-BUS signal processor is described, it will be apparent that this sub-system performance could be considered moderate resolution in that there are 100 steps of resolution of input and output.

### Wide-bus Signal Processor Construction Details

Reference back to the section on the WIDE-BUS HOURGLASS DEMONSTRATOR SYSTEM will give most of the details of construction for this section. Specifically, as previously mentioned and now shown in FIG. 33b, the stacking of the two generic frames, with one being vertically flipped is swapped, so that the decoder frame assembly now rests above the encoder frame assembly, for a short distance of free-fall. (Also see the similar previous FIG. 20c showing a free-fall arrangement.)

Additionally, since the center area now has free-fall region or volume 864, there are tighter constraints on tolerances such that there is a reliable one-to-one match between elements of the upper input header and the lower output header. Relative twisting or longitudinal offsets of one linear scale to another could cause a mismatch and the data (falling steel ball) could literally fall onto the floor. This arrangement gives a simple one-to-one data transfer function having no signal alteration.

### Operation of the Wide-bus Signal Processor

This system provides an alternate use of hardware that is admittedly and purposefully large and un-wieldy. Taking a next step with more advanced students, the generic frames of the previous HOURGLASS DEMONSTRATOR can be re-stacked and then operated as a second type of machine. This operation is more complex and can be used to teach students who have mastered the previously described concepts of the data bus and of the powerful multiplexing features.

This system is also somewhat the reverse of the HOURGLASS DEMONSTRATOR, which operated with discrete inputs and outputs and with multiplexed transmission. In contrast, this system of WIDE-BUS SIGNAL PROCESSOR operates with multiplexed inputs and outputs, called MUX-BUS, and with discrete bus transmission between upper and lower devices.

The FIG. 33b view shows these multiplexed inputs and outputs. In order to initiate a data transfer, which includes transmission through free-fall region 864, a SELECT signal is sent by dropping a steel ball into the incoming MUX-BUS 903 (see FIG. 34 for close-up.) This puts the bus switch 840 de-multiplexer into an address or positioning mode, as previously described, so that a first arriving digit will position the bus switch.

Next, this first decade select digit is sent by dropping a steel ball into input bus 903. As an option, the ten conduits of the multiplexed input bus can be spread out (not shown) with large catch buckets for easy access to students. In a third action, the second, UNITS or ONES digit is also then sent by dropping a steel ball into the same input bus 903. This second digit steel ball, representing the ONES digit, in combination with the effect of the decade switch, effectively becomes a representative impulse of the total range of integers 0 through 99. This is because the BUS SWITCH effectively stores the upper or decade value, and the lower or units value comes as an incoming BUS signal or digit. This is then the free-fall impulse that emerges from upper frame 908 and falls down into lower frame 906.

In the lower frame assembly, the encoder has no requirement for initialization so the arriving impulse is simply encoded as previously described. The encoder 860 is simply a register with 100 inputs, albeit a jumbo. Also, as previously described, the decade value that immediately emerges from the encoder can optionally be used immediately, or can be latched in a decimal register 700 (previously described) for later use.

It is to be noted that this same steel ball has changed its meaning or representation as it has flowed down through the machine. The steel ball started by arriving as a ONES representative, (in the third above action), conveying a value of 0 through 9, then became a BASE 100 discrete representative conveying a value of 0 through 99, then became a TENS or decade representative impulse, representing a value of 0X through 9X. This is an interesting and quite novel feature.

Finally, assuming a decimal register 700 was used to latch the decade digit, a pair of READ cycles can at any time later retrieve the resultant value of the integer data that has been transmitted through the free-fall region. To do this, a simple READ-SYNC must be issued to each of the encoder 860 (low digit), and the accessory latch, decimal register 700 (high digit.) The order of these two READ actions can be either way, that is either LOW-HIGH or it can be HIGH-LOW.

It should be apparent that proper manual operation of these functions is considerably more complex than in the HOUR-GLASS DEMONSTRATION machine. This provides ample challenge and advanced achievement opportunities for students.

### Binary System Section

### CM-1 Binary Computer and Subsystems

Readers will gain an advantage by understanding the materials presented previously on the decimal logic and CM-2 computer, as there is a large analogy factor, especially in the discussion on instruction sets, which will not be repeated here in great detail (mainly due to the large burden of detail already present). This section covers Binary logic and the CM-1 computer system, as an alternate invention embodiment. The same pattern or hierarchy of construction that was presented for decimal computer CM-2 exists as follows:

1. A binary flip-flop element,

2. an assembly of four flip-flops to make a four-bit binary register device,

3. expansion of a single binary flip-flop element for switching a multiple parallel signal or bus, to one of two paths,

4. assembly of multiple bus switch elements to construct a binary bus switch module, having a selectable bus output, out of a multiple of such bus sets,

5. construction of a Register File and program/data memory subsystems,

6. sequential operation and control of binary subsystems, for the CM-1 Mechanical Computer, and

7. the all-important minimized Binary instruction set with 28 instructions.

The fundamental components are fully described; flip-flops, Boolean logic, data transfer bus, and the machine frame and overall method of operation. However, some details on a complete CM-I system are omitted as design work is in progress at this filing time. A specific example is the memory-processor bus arbitration logic and scheme of operation of such arbitration controller. Suggestions will be presented, according to the current development, which at least anticipates the totality of the CM-1 machine.

### Binary System Flip-flop Count and Density

The higher-density use of mechanical flip-flops for data storage will use about 1200 wheels, providing 300 words at four bits each in a system using sub-modules. The CM-1 machine needs this memory storage for holding small user defined down-loaded programs. The medium density use of flip-flops is for sixteen registers. Lower logic density is actually an advantage for the construction kit form as it allows such special working register features as increment and decrement counting, and allows access to various signals for customizing or modifying a computer processor design. Readers may recall that the CM-1 register and memory pod or chassis were introduced, which is where most of the machine data flip-flops are housed.

(See early discussions regarding FIG. 3 through FIG. 8)

According to these flip-flop counts, use can be made of medium count runs of molded plastic parts to produce the flip-flop wheels and housings. As is consistent with most of the mechanical computer logic components, these flip-flops can be made of transparent plastic so that operation action can be observed by students or experimenters.

### Binary Logic as the Alternate Embodiment

This section on binary mechanical computer logic represents an alternate embodiment on the invention, based on mechanical impulse signaling. Such signaling, implemented by a set of guided, falling particles or steel balls, is used for a multiple parallel element bus. This parallel binary data signaling bus (CM-1) bears a closer resemblance to existing electronic computers, than the multiple-state bus (CM-2) that has been described up to here in this disclosure. CM-2 is unique in that only one (discrete) signal impulse travels through one of a multiple of bus conduits.

However, although the following described subsystem and bus operations are truly logically binary, and the flip-flop wheel operates physically in binary as two stable states, the bus still operates fundamentally in BASE ONE. This signal or data transfer methodology is at the heart of most of this invention disclosure, as this invention builds systems for base two, and for decimal base ten (previously described). Other logic, mostly for internal control, operates in any other base (or otherwise called RADIX) which simply refers to a range of possible device output states. In a purely binary system these other base systems must be emulated using a classic multi-state binary tree having a multiple of selectable outputs. For example, a four stage binary tree has 15 separate branch elements (logic path switches), and delivers sixteen outputs, of which one is selected by virtue of the path down through the tree.

In addition, the binary type logic has features not heavily used in the CM-2 decimal machine, including all Boolean operator functions (such as logical XOR). The most prominent advantages of the binary (or CM-1 binary computer) are the implementation of conventional up and down counters using T or toggle type flip-flops and the simple fact that there is much existing marketplace know-how regarding electronic binary logic and systems.

### Introduction to Flip-flop 400

### FIG. 35

FIG. 35 shows flip-flop 400 mounted in a working arrangement with external interfacing conduits and upright mounting bracket 477. This assembly is useful both for mechanical computer internal logic and also for desk-top or lab hands-on demonstrations of binary logic principals. Readers should note that flip-flop 400 is here introduced from a bus or signal perspective, that is, various conduits are seen connected to the top of flip-flop 400 for inputs, and also other conduits are for connecting to the bottom for outputs. (See dashed lines.)

Four separate conduits are seen entering on top of flip-flop 400 and there are six conduit receptacles exiting through the bottom of the flip-flop housing, organized as three pairs. Generic conduit hose 472 is one of the four input hoses shown at top. The following sections will explain in detail how this hose 472 is part of a bus input set or group of the four signals seen, and generally how the flip-flop functions with such bus input, or group of signals. Also explained will be how flip-flop 400 operates its own bus outputs, in the form of three pairs of conduit hoses. Hose pair 475 is a pair of generic conduit hoses bound by a simple spacing bracket, such that the hose ends coincide with the flip-flop outlet receptacle pairs.

In this view, only the front outlet receptacle pair is fully visible, while the middle outlet pair and back outlet pair only show the left side receptacle of the pairs. (Later, the view of FIG. 37B will show all six receptacles.) The term of “BUS” is used somewhat loosely to indicate any self-contained or functionally complete grouping of signals. In this sense, each of the three pairs of conduit hoses individually comprise a separate BUS. Also, the total of all of these three pairs of conduit hoses comprises a complete bus output encompassing all of the functions of flip-flop 400.

### Othagonal Grid Qualities of Flip-flop 400 Physical Interface

The BUS interfaces to flip-flop 400 are best understood by observing signal channel placements. A horizontal plane and grid system (not shown) is placed over the output portion of FIG. 35, directly over the three conduit hose pairs, (including hose pair 475.)

A first grid axis runs from the front hose pair to the back hose pair (475), and a second axis runs left to right. Moving along the first axis selects function (one of three) and moving along the second axis selects from one of the two paired data signals. This 3×2 (three by two) output grid is an example of the positional encoded nature of the flip-flop 400 output bus. Generally, binary flip-flop 400 has the three functions of READ and WRITE and COUNT each separately interfaced as a pair of BUS output signals. Readers will be helped greatly by using BUS interface concepts to understand the following sections describing flip-flop 400.

### Binary Flip-flop

### Overview FIG. 36 Views A through F

The six varied views of FIG. 36 show basic construction of flip-flop 400 with the three functional sandwich layers (READ, TOGGLE, and WRITE, or RTW). Additional following views also show details for discussion.

FIG. 36A shows an upright perspective view of the entirety of flip-flop 400, having housing 404, and front face 408 with visible end bearing 410. The front and back faces each have these simple bearing elements for inserting the pointed or needle-like tapered ends of the flip-flop wheel shaft. For most light duty plastic construction the bearing is simply a conventional round, thickened area (for reinforcing) around a tapered hole in face 408, in which the pivoting tapered shaft of the flip-flop wheel assembly is inserted. An assembly process involves insertion of a pivoting wheel assembly into the pre-molded housing, inserting one shaft end into the proper end bearing, followed by gluing or attaching an end plate to the housing, for the other end of the pivoting wheel assembly. A side plate can also be left off to facilitate this assembly process, with attachment after proper installation of the internal wheel has been made.

Flip-flop 400 has conduit means on top for inlets and guiding of a falling steel ball into the housing internal conduits and has, on the bottom, outlets for guiding a falling steel ball out from internal conduits. Internally, flip-flop 400 will be seen to also have, attached to each of the discs of the pivoting wheel assembly, conduit structures for guiding the falling steel ball through each of the movable sections, or segments and these conduit structures are continuous with adjacent stationary conduits. Thus a steel ball is guided internally for the purpose of interacting with the movable armature with attached disc sections or segments.

### External Conduit Interface Receptacle

### FIG. 36B

A close-up is seen of one mechanical conduit connector arrangement, for constructing various external logical signal interconnections by hand. Reinforced conduit receptacle 409 has an inner diameter just sufficient for clearance, yet holding by friction fit, a pliable plastic hose, constructed out of conventional transparent vinyl or other commonly available plastics. Hose 472 is inserted by hand, one end down into an input or inlet connector receptacle and the other end (not shown) is inserted in a similar manner into an outlet of some other, general upper, logic signal sending or originating device. This signal or data transfer sending or origination device could be another flip-flop 400, or some other similar logic. Also seen is arriving steel ball 473, shown falling down into receptacle 409 via plastic hose 472.

This hose connection activity is closely analogous to making one electrical wire connection on an electronic breadboard. One example analogous conventional classroom or laboratory connection activity would involve wire interconnecting between electronic flip-flops such as the TTL74SN7474, which is a medium scale integrated circuit having four separate flip-flops.

### Theory Related to Transport Raceways

The function of conduit receptacle 409 is more important than appears initially. It is critical to maintain a clear path for the moving or falling steel ball 473 which will be guided via receptacle 409 in a transition between flexible conduit hose 472 and the guiding means internal to the flip-flop housing. Also, the reverse is true, that a conduit receptacle is also used as an output or outlet to transition from an internally guided duct or conduit, to a connected conduit hose.

A parasitic effect is one in which energy is robbed from proper desired motion and given to an undesired mode of motion. This effect can be especially un-wanted if it is highly variable and intermittent as to cause an occasional hard to diagnose computer malfunction.

Specifically, several parasitic motion behaviors have been observed (in such conduit transitions) as follows:

1. Ball will bounce off ledges. There must be no ledges or other excessive shoulders, or other ridges that cause impacts with possible backwards rebounding movements. (See shoulder 407, which is small enough to only stop the conduit hose.)

2. Spiral or rotational parasitic motions. Any funnel shaped or tapered structures associated with conduits or internal guiding must be designed and tested carefully, as some shapes can cause substantial rotational or orbital travel around the central vertical axis. This spiraling parasitic motion robs the falling steel ball of downward momentum, transferring energy to a rotational, orbiting velocity that has a much reduced downward component. A tightly bound resonance-like interaction appears to occur which has not yet been fully investigated. It is believed that there can be a resonance effect relating the period of rotation of any particular orbit (inside a funnel shaped conduit), and also relating to the mass of the steel ball, and the inner surface friction of the funnel.

When a falling steel ball gets into this spiraling, orbital motion there is a great increase in the propagation delay of the signal through the discussed conduit or connection fixtures. The shape used for hose connection receptacle 409 (FIG. 36B) does not show any parasitic motion effects.

Receptacle 409 of the view of hose insertion in FIG. 36B is also relevant when viewed upside-down because it is a connecting means both for inlets (upwards facing), and for outlets (downwards facing). It is the case of use as an outlet that the above discussion of parasitic orbiting motions applies, although this particular receptacle 409 has just a small flare in the guiding shape (see flare curve 413) and so doesn't show a problem. Design care and testing is in order, however, as the larger constructions of funnel shapes are more likely to show parasitic motions, such as when multiple combining of many conduits creates a larger funnel structure.

### Construction of Flip-flop 400 Overview

### FIG. 36C and FIG. 36D

A visual comparison can be made to the similar appearance and structure of common small electric motors in that there is a housing with two end bearings containing a movable armature structure. What is different, compared to an electric motor, is that armature shaft 411 pivots between two resting positions, shown in the two different views of FIG. 36C and FIG. 36D.

In FIG. 36C and FIG. 36D, housing 404 (shown in dashed phantom lines) is square in cross-section and contains pivotally mounted armature shaft 411 which has three various segments attached, each segment being a distinct type but each having a similar overall shape and rigid mounting arrangement relative to the armature shaft and total rigid moving assembly. This entire shaft mounted assembly is identified as wheel assembly 402. Just as seen in a common conventional motor structure, the internal armature shaft of flip-flop 400 is mounted or secured by the end bearings on the two faces, front and back, of the housing. Also, as is known in electric motors, flip-flop 400 has a small gap for clearance between the movable shaft with attached discs and the stationary internal items. (This gap resembles the gap in motors between armature wire coils and stationary permanent magnets). Since, as mentioned, flip-flop 400 in an educational setting is constructed out of transparent plastic, wheel assembly 402 is partially visible through the box-like housing 404. However, while the intent of this apparatus is for showing the movement or flow of data and the attendant interactivity with the logic functions of flip-flop 400, it is not expected to always be totally obvious because the steel ball is fast moving.

As stated, the armature in binary flip-flop 400 only pivots in a limited range of about plus and minus 17 degrees, from top center, as opposed to the continuous rotating shaft power output of an electric motor. Top center is the armature position when the vane elements point straight up, (see vane 433). This flip-flop pivoting action is comparatively very brief and transient, as actually most of the logic and bus of this invention is passive, with an occasional read or write occurring.

FIG. 36C shows the first pivotal resting position, called RESET, or zeros' state, and similarly FIG. 36D shows the secondary, data SET or ones' state position of the shaft mounted flip-flop wheel assembly. Physically, there is a third, statically balanced but dynamically unstable flip-flop position of top dead center which is not of concern. This is the position, half-way between rotation stops, when the upright vanes of the flip-flop wheel point exactly upwards. Flip-flop wheel 402 is over-balanced enough, and has low enough bearing friction so that a mechanically balanced meta-stable centered resting position does not occur. Also, an optional overbalancing weight may be placed inside of any of the vanes, above the pivot point or axel mounting center.

For purposes of more detailed discussion, a vane is considered as the combination of both left and right side deflectors. Moving counter-clockwise around the reference items of FIG. 36C are additionally seen:

WRITE segment left paddle 434. Left Paddle 434 is for impacting by a steel ball.

TOGGLE segment left paddle 466. Left paddle 466 is for impacting by a steel ball.

(Thus the TOGGLE segment has a positioning function.)

WRITE segment 460. W segment 460 function is for positioning through actuation.

TOGGLE segment 456. T segment function is for flipping the position, useful for binary counting.

READ segment 458. R segment function is for non-destructive read-out (to a data bus line).

ARMATURE SHAFT 411. Each disc segment is mounted rigidly on the shaft, to make an assembly.

READ segment deflector vane 448. R segment deflector vane 448 is for actuation of the moving steel ball, by controlling or deflecting its path horizontally.

TOGGLE segment deflector vane 461. T segment deflector vane 461 is for actuation of the moving steel ball, by controlling or deflecting its path, horizontally as above, performing a local READ function, within the TOGGLE segment, with the result path going towards a T segment paddle for overturn or alternate flipping action.

WRITE segment deflector vane 433. W segment deflector vane 433 is unused as a logic function, but included to simplify the molding process by having each segment as similar as possible. Thus the TOGGLE and WRITE segments can use the same segment construction. (The housing will be seen to be different, however).

The two stable resting positions, left and right leaning positions representing flip-flop logical state, result from wheel assembly 402 turning until stopped. The vertical vanes or deflectors on wheel assembly 402 point up with a lean of 17 degrees either to the left or to the right.

There are three functional sections, or layers: a section for writing data to the device by moving or positioning the wheel (W, or WRITE), a section for non-destructive reading of the static data held by the position of the wheel (R or READ), and an optional section that toggles or flips the wheel to an alternate position (T, or TOGGLE). (Also see wheel segments 460, 458, and 456, respectively representing W, R, and T functions.)

FIG. 36D, one's state wheel position, shows paddle 466, on the TOGGLE segment (in toggle layer 456), in a lower position than the previous view (of the zero's state position), due to the counter clockwise rotated position of wheel assembly 402. Similarly, the upward pointing vane in the TOGGLE segment of the wheel has the left deflector of vane 461 shown leaning to the left, as opposed to the previous view showing a lean to the right, again due to the counter-clockwise rotation of the wheel assembly to the extreme of travel or resting position.

FIG. 36E shows an exploded view of flip-flop 400, with the three separate RTW layers, or segments. On each side of these sections, or layers, are the front and back housing faces, including back housing face 403. The front housing face is omitted in this view, so that the tapered end of the shaft is seen. Each separator wall is in a plane parallel with these front and back faces, so that each layer is parallel, sandwich-style and each segment is perpendicular to the shaft. This exploded view helps the reader to understand that there are three compartments which are considered conduit cavities, that is, for guiding and enclosing. The other two walls in the housing are the two end faces, which serve to hold the end bearings.

Each layer on the wheel assembly has a corresponding functional disc segment type, which matches the housing layer type R, W, or T. This makes for a modular approach discussed later as it is possible to have many different combinations of disc types and quantity, such as RRRRW (4R, 1W), which is a five layer bus switch device having a segment for positioning and having four data path switching segments in tandem. While this description uses a layer terminology (as in strata layer) throughout the entire flip-flop device, the term of SEGMENT specifically applies to the movable (or pivoting) portions, generally of same size or thickness as a corresponding housing layer. In other words, the layered structure of the housing is continuous into the layered, movable structure on the pivot-able shaft, except for a small gap.

### Flow Model of Flip-flop 400

A helpful way to remember overall flip-flop structure is shown in FIG. 36F, a conduit based separated, exploded internal flow-model of flip-flop 400, which partially ignores the movable portions. This modeling is justified because the mechanical computer logic invention is heavily based upon the signaling and bus concepts of operation. WRITE layer 460 is a simple left or right flow-through, from a system perspective. Both of the R and T sections (READ or TOGGLE), each consist of an internal path which is an inverted Y, causing an internal path split or logical path determination. TOGGLE layer 456 also has means for overturning or flipping the flip-flop wheel assembly, but in this FIG. 36F flow-model it is only the inverted Y path structure with the left and right outlet pair that is of interest. This is the position-encoded bus and signal conduit methodology.

All three layer or segment types, RTW, have symmetrical sets of left and right outlets, each set identified with conventional Q-TRUE (logical Q-P or positive data), and Q-NOT (Q-N or negated data) binary state outputs (FIG. 36F). In the flip-flop operation description, to follow, it will be made apparent that these two separate paths each represent a signal channel operating in BASE ONE. The total or composite of the any of the paired channels shown, left and right outlets of a particular functional layer, is an output set or BUS that is capable of transmitting both values of a binary state or number.

### Detailed Description of Flip-flop Device

### FIG. 37 through FIG. 40 Views

As previously described, wheel assembly shaft 411 has the three functional sections, RTW, mounted so that wheel assembly 402 moves as a rigid or semi-rigid whole (previous FIG. 36C and FIG. 36D). These three sections, or layers, correspond with the three layers created by enclosing housing 404 (previous exploded view, FIG. 36E). Discussion will now continue with views of the stationary housing, housing with superimposed pivoting armature (wheel 402), and then with detailed cross-sections.

### Plastic Injection Mold Details for Housing

### Views of FIG. 37

FIG. 37A shows a simplified left side engineering view of the gap arrangement between pivoting wheel assembly 402 and stationary housing 404, with indicated reference line 402 shown touching the back disc-shaped separator wall, in a side view. As mentioned, the construction has each housing wall co-planer and functionally continuous with each of the four corresponding disc-shaped separator walls on the wheel assembly.

After joining or bonding two main halves, of housing 404, one or both of the end pieces can be glued or bonded to complete the housing assembly. (See back face 403 and front face 408.) This side view shows about 6 mm clearance from the tapered ends of shaft 411, (or the end face pieces), to the internal segments. Another clearance shown is example gap 416, with similar gaps between each of the other segment separator discs and the housing. Both clearances shown allow the pivoting wheel to move without interference from the stationary housing. Gap 416 also has a deliberate feature of being minimized in order for the separator walls to contain and guide steel ball 473. In other words, a falling steel ball should stay within an assigned compartment, R, T, or W, without straying sideways through gap 416 into an adjacent compartment, and enough gap clearance should be maintained for free movement of the pivoting wheel.

In this left side view of FIG. 37A the three vertical conduits or channels through each compartment are emphasized for clarity by omitting the vanes, paddles, and stop tabs, which are then described in following views. In this view, focus is on the arrangement of shaft, and mounted discs, in relation to the vertical raceways. In the back or rear compartment is seen a path arrow, indicating the vertical path of travel or raceway, of ball 473. It is to be noted that this FIG. 37A is an imperfect flow model schematic, rather than a pure cross-section view. Liberty was taken in including the WRITE section receptacles, in this cross-section style view, as if they were aligned with the receptacles in the other two sections (TOGGLE and READ.) This view is actually to show a side view of any vertical channels visible through the transparent plastic of the housing, rather than an actual cross-section.

Steel ball 473 is shown with a path or raceway arrow through WRITE layer 460, and as shown passes on the left side (towards the viewer) of shaft 411. Thus this arrow is in the cavity or conduit designated for the SET function, input or inlet 420, and outlet 422. This side view of WRITE layer 460 has the superposition of the two outlets, left outlet 422 and right outlet 430, each shown in parenthesis. Similarly, the TOGGLE layer 456 and READ layer 458 also have indicated superimposed pairs of receptacles, each which appear as a single receptacle in this side view.

Front face 408 shown is identical to back face 403 which are simple square plastic sheets with the discussed pivot holes in the center for the wheel assembly shaft ends (shaft 411). An injection plastic mold can be used with a conventional half-split or two- piece scheme, separately molding the housing into an upper half and a lower half. Shaft 411 is located in the horizontal plane of the discussed housing split, where the housing halves are to be joined or bonded.

Also in this FIG. 37A, is middle separator tab or wall 443, with spacing so to not interfere with the pivoting discs of the wheel assembly. Also, while omitted from this view, there are two stop tabs (418 and 421) which also have similar attachment and clearances as wall 443 so as not to rub or interfere with the pivoting discs (see following FIG. 38B.)

FIG. 37B, lower half-housing shows the suggested half-housing molded part. The upper housing part is similar, (not shown) but is different by having one left/right pair and two center inlets, (receptacles), while this lower half-housing has three pairs of outlet receptacles. Left side outlets 422, 469, and 442 are respectively part of outlet pairs for WRITE, TOGGLE, and READ. The left and right output polarities of logical operations (Q-TRUE and Q-NOT) are not always consistent relative between functional layers as will be discussed in the operation section. The WRITE and TOGGLE layers define Q-TRUE as on the left, (422 and 469), while the READ layer is reversed, so that Q-NOT is on left outlet receptacle 442.

The shape of this lower housing part shown allows vertical disengagement of the two molding negatives (or masters) after a factory injection molding cycle. A lower mold master can produce the receptacles while an upper mold can produce the enclosure walls and compartment walls. A similar process can produce upper half housing parts (not shown). Joining or bonding upper and lower halves produces most of housing 404. (Most of bonding seam 419 is omitted due to wall cut-away in this view (FIG. 37B).

The manufacturing assembly process involves first bonding one end piece to the housing (see back face 403, FIG. 37A) followed by insertion of wheel assembly 402 properly into the housing and, finally, insertion of shaft 411 into the end bearing. The second step involves placing and bonding front housing face 408, while properly aligning the wheel shaft for insertion into the front end bearing.

Continuing discussion on FIG. 37B the molded bottom half-housing of housing 404, has some cut-away shown exposing a view of the housing left side bottom outlets, which resemble funnels. (See previous discussion on conduit receptacle 409). As the moldable bottom half shows in detail, there are the three main compartments, plus two short end spaces of about 6 mm., which allow for the shaft to taper down to the ends and allow clearance for the inner compartment wall which is one of the conduit separators having a round gap surface. Also, the end spaces create some clearance of the wheel away from the end bearings.

The half-circular arcs seen are the internal compartment walls, such as READ segment separator wall 412. There are four such inner walls, all considered part of the general internal conduit means, indicating a main functional purpose of guiding and containing. These compartment separator walls are, in effect, square, with a large round hole or cut-out. The diameter of this circular hole in flip-flop 400 so nearly approaches the square enclosure housing size, or width, that merely the comers of the square-shaped wall remain.

The guiding functions in this structure described are simple enough that the reader can picture various alternate designs having variations such as having the round hole be smaller in comparison to the square box shape of flip-flop housing 404. This alternate calls for extra means for guiding actions on the sides of the raceway.

Also seen in FIG. 37B is hole 425 in the right side of the housing for screw mounting to a bracket. FIG. 35 showed this bracket.

In this embodiment, flip-flop 400 housing side walls also do double-duty as conduit guides, by keeping or restricting the downward raceway to be through the wheel, instead of around the periphery. This is a feature of using a round wheel size closely approaching the maximum allowed by the enclosing square housing. The indicated restrictor area, with right side restrictor 439, is a special area of the side wall of the housing which is thickened at the lower part, also seen with a machine screw hole. (Later views of FIG. 38 show a side section view of this thickened area 439.)

FIG. 37C shows the aligned placement of wheel assembly 402 relative to the housing. Round-shaped front disc 414 is at the end of the READ segment. Round-shaped gap 416 is shown between the pivoting disc of wheel assembly 402 and stationary wall 412 of the housing. READ segment front partition wall 412, as part of the housing, has a proper circular cut-out to allow the wheel assembly to pivot. Gap 416, shown between the stationary partition wall 412 and read segment circular front separator disc 414 allows this pivotal range of motion but is also small enough to maintain guiding or enclosing conduit function. This gap is a circular or near-circular form so that pivotal motion does not change the effective gap. This gap is currently about 2 mm.

Each of the functional sections, RTW, has this gap arrangement, which is about one-half of the diameter of a typical moving steel ball used in the mechanical computer logic. Stationary separator wall 412 and pivoting separator wall 414 are co-planer, which is typical, and a similar arrangement can be seen separating each of the three segments. The rigid mounting of same size generic segments creates a consistent if not standardized or modular construction approach. This potential modularity is not always shown directly, as flip-flop 400 is here presented as injection molded and/or permanently glued together.

Reference numeral 427 shows a potential flow snag or ledge in raceway path, a problem area, as previously discussed for receptacle 409. Although FIG. 37C shows this area, a corner, as a flat ledge for clarity, the surface of each comer actually slopes downward into each receptacle. This is so that a steel ball falling down through the wheel assembly will not bounce or be deflected on any protruding ledges.

### Modularity Features

### FIG. 36 and FIG. 37 Views

It should be noted that a prototype RTW flip-flop version, of a design also originated by this inventor, of very similar construction to this described plastic moldable flip-flop 400, had the feature of easy disassembly/re-assembly. The modular or generic interchange-ability of the segments (R, T, or W) of flip-flop 400 allowed rapid re-configuration. For example, the TOGGLE segment was taken off of shaft 411 and replaced with a READ segment, each segment having the same size central mounting hole. (Actually, the prototype shaft was threaded for rigidly attaching such various generic segments.) the resulting flip-flop was then of the type RRW, which is useful for one-bit data storage, and especially useful for tandem switching multiple lines (two in this case) such as for a bus.

While external segment generic characteristics are uniform, a major exception to this modular design principal will be apparent in the following discussion. The exception is that flip-flop 400 has two variations of housing layer type, and corresponding segment type. Thus this discussion of generic interchange of parts only goes so far. For example, it will be seen that it is not possible to practically change a W (WRITE) housing layer to a R (READ) housing layer, although the change could be partially made on the pivot-able shaft assembly by exchanging segments.

It should be noted that various features which improve the user's ease of construction are still in development, such as providing general snap-fit or quick connect hardware. The modularity that is more immediately useful in this specification is as a design modularity, rather than as a means for continual disassembly and re-assembly of parts. In other words, a design process can place various multiples of generic disc segments without redesign of the segments.

While it is also a goal of this invention to provide low-level modularity or internal parts re-use, it is more practical to provide a user (student or teacher) with a set of higher functional modules that are re-used without internal modification. Thus such construction kit form includes various flip-flops, bus switches, and sequencers. This helps save a user's time and internal details might eventually be less interesting anyway, than higher forms of logic.

The variations of each of these generic segment types, R, T, or W, are expressed internal to the segment. In all cases, however, each disc segment is primarily constructed to be a conduit for one or more paths and so always passes a (single) moving particle (a steel ball) without permanently holding, blocking, retaining, or excessively delaying the flow. In this manner, the mechanical computer logic components resemble the means in a fluid computer. Opposed to this continuously flowing liquid or fluid concept is the actuality of this specification, which pertains to a singular moving particle, and thus has a quantum or quantized signaling or actuation characteristic. Nevertheless, the internal paths also appear to switch or commutate a flow of fluid (or gas).

### Write Functional Layer Details

### FIG. 38A and FIG. 38B

FIG. 38A and FIG. 38B focus on the W, or WRITE layer 460, with FIG. 38A showing a first position that represents a zero's state, and with FIG. 38B showing a second position that represents a one's state. FIG. 38A shows a dashed line from vane 433, indicating a 17 degree lean to the right from vertical. FIG. 38B shows this dashed line, with the vane leaning to the left.

As FIG. 38 views show layer 460 in section, this W layer has a view of the symmetrical left and right features. The cross-section is shown cutting through the center of the flip-flop write layer 460. On the left side of the housing is top SET inlet 420 and bottom SET outlet 422. As previously described, these two receptacles for inlet and outlet hoses have inner diameter clearances and inner stop shoulders for friction fit connection of such conduit hoses. Also seen in FIG. 38A is hole 425 for machine screw mounting to a bracket (see FIG. 35).

Observation of left side guiding wall 424, and right side guiding wall 439 shows a common shape, although vertically reversed. This common shape consists of a circular arc-shaped narrowing of the wall so that the wall wraps around or closely conforms to the round shape of the enclosed wheel. This narrowing is adjacent to the housing bonding seam (see left side bonding seam 419), and allows the round pivot-able disc to be surrounded by a round gap clearance (gap 416 will be discussed in the following FIG. 39.)

Either wall, 424, or 439, helps confine the action raceway (see arrow) to either within left side raceway 426 or right side raceway 432 of the pivoting wheel. This duct, of left side raceway 426, is nearly continuous with the ducts or guide-ways of upper inlet 420 and lower outlet 422. Symmetrically, right side raceway 432 is continuous as a duct with upper inlet 428 and lower outlet 430. While the lower guiding wall 439 is more critical, for keeping the moving ball in the paddle collision area, the upper wall section 424 shape is consistent with the construction of an upper molded housing half, joined to the lower half as seen by left side bonding seam 419. These thickened sections are in four places in each compartment, so that with the three R,T, and W functional compartments there are a total twelve places with thickened wall areas.

Comparison of the diameters of 4 mm steel ball 473 with the smaller 2 mm gap between the circular disc and compartment wall shows that guiding conduit or raceway 426 (see arrow) will completely contain a moving ball. The circular disc shown represents a straight-on engineering cross section view without perspective. The actual working structure of the wheel shown has two such discs, each determining either end of the WRITE segment in WRITE layer 460. The paddles shown, 434 and 436, extend or bridge between the two discs which define the two ends of the WRITE segment of the rigid wheel assembly. Each paddle is for being impacted by a moving ball.

In modular construction each of the wheel segments, W, T, and R, can be molded separately, with each segment having one disc. Each next segment is bonded or glued, with the disc shared, for also providing the second or end disc for the previous segment. Thus four discs create three partitioned segments. (FIG. 36E also showed this segment structure.)

### Writing Binary Data States to the Flip-flop

The write segment, and thus all the other rigidly mounted tandem segments as well, reflects the logical position of the flip-flop. If the flip-flop is positioned in a RESET position (FIG. 38A) then a ball traveling down the SET path from inlet 420 will impact left side paddle 434 to exchange momentum and/or to exert a static weight force on the paddle, causing rotation of the pivotal positioning to the SET resting position. If the flip-flop is already situated in the SET position (FIG. 38B) then the ball travels through the left-side guiding raceway of the flip-flop without hitting or pushing on paddle 434. In this case any ball-paddle collision is merely a glancing blow, rather than the formerly described perpendicular actuation.

The symmetrical situation exists for the right side, that is if the flip-flop is resting in the SET pivotal position (FIG. 38 B) then a ball falling down from inlet 428, the RESET path, will then impact right-side paddle 436, and cause the flip-flop to rotate to a RESET position. As was the case for the left side, if the flip-flop wheel is already positioned in RESET (FIG. 38A) then the falling ball in the right side raceway travels through the raceway without impacting a paddle. FIG. 38A shows a view of this right side raceway, although this view actually literally shows the steel ball and path involved with the left side elements.

Noting in either FIG. 38A, or FIG. 38B, vane 433 and both of the paddles are mounted perpendicular to the discs of the W segment. In this view, discs are parallel to the plane of the paper, thus the view is of sections of left paddle 434 and right paddle 436. There is also an attachment angle to the flat paddles, relative to the vertically falling steel ball, somewhat empirically designed. The pivotal position of the flip-flop wheel affects the relative angle of the left and right paddles relative to vertical.

Also seen in FIG. 38B is optional overbalancing steel plug 431, which can be molded inside the vane.

### Optimizing the Write Layer Actuations

Turning back to FIG. 38A, in the case of an arriving steel ball, which would be for a SET action, the left side raceway and left paddle 434 show an arrangement for optimizing a collision interaction, as a left side moving steel ball will impact left paddle 434 nearly perpendicular, or normal to the paddle surface. Also, this impact is for causing counter-clockwise wheel rotation and thus ball-paddle collision force is approximately normal to a radius line drawn to the pivot and so is nearly optimum, being close to a tangential force impulse on the wheel.

Thus the paddle mounting angles shown gain some mechanical advantage in imparting a rotational or angular impetus when struck by the falling steel ball. To better describe this mechanical advantage, or maximizing of force of actuation, consider a similar early design, by the inventor, in which the left and right paddles were flat, or horizontal in relation to the pivoting wheel, and thus presented a nearly horizontal surface to the falling steel ball. Examination of this initial flat mounting design (not shown) revealed that the force of collision was not along a tangent, since the paddles in that case were mounted along a line much below the pivot point of the wheel. The improvement to optimize the paddles generally mounts the left and right paddles by dropping the outside paddle blade or edge in relation to the inside paddle edge such that extension lines drawn from the impacting surfaces will very nearly intersect the pivot point.

In addition, it helps to further relax this paddle angle downwards towards the outside of the wheel (disc). This is for operation, or action that also can use just the dead-weight force of the moving particle of the computer (a steel ball) rather than inertia or velocity related force, relaxing the paddle angle downwards allows a more glancing blow, or shove-aside interaction to occur, as the ball moves past the paddle.

### Write Layer Range of Motion Stops

FIG. 38B shows left stop 418 and right stop 421. The respective left or right paddles on the wheel WRITE segment will rest on either of these stop tabs. Although not shown in detail the tabs bridge between the two separator walls of the housing WRITE layer, similar to the paddles bridging between the two separator walls, or discs of the corresponding WRITE segment. Thus the tabs act to limit the range of pivotal motion to about plus or minus 17 degrees from top center. As mentioned, the previous FIG. 37A had these two motion stop tabs omitted, in order to clearly show and discuss the vertical channels or conduits of the three functional compartments without appearance of obstruction of the raceways.

### Invention Qualities of the Flip-flop

Now that the reader has been given a detailed explanation of the WRITE portion it can be stated that the WRITE layer has two invention qualities. The first or highest level quality is the methodology nature of the bus and WRITE function signals interfacing with flip-flop 400. More information on this methodology will be supplied under a following operation section.

The second subject or quality is the actual construction of apparatus to perform according to the bus and signal methodology. This is considered by the inventor to be strongly related to material or pellet handling machines of all sorts. For example, a farm grain elevator has many mechanical components and conduits related to transport and processing of small pellets. In addition to the actuating of pellets, the mechanical computer must have components which are activated by the moving pellets (or steel ball).

These two qualities, of signal impulse methodology and particle-interactive apparatus, can also be differentiated as the logical and the physical aspects of the mechanical computer components.

### Read Functional Layer Details

### FIG. 39

The R, or READ layer 458 has symmetrical left and right features plus a middle feature (see FIG. 39, which shows the RESET logical position.) In the top middle of the housing is strobe inlet 440. On the left side bottom is READ Q-NOT outlet 442. The serial path combination of the top inlet, left deflector 450 of upright vane 448, and left side READ Q-NOT outlet forms the confinement path for a data false, or zeros' data state. This confinement starts in the top inlet of the housing, crosses gap 416, extends through read section 451 on the pivoting wheel, again re-crosses gap 416 to get back into the stationary portion of the READ layer, and exits at lower outlet 442. (See action arrow indicating ball movement raceway.)

In a similar manner to the previous discussion on the left side path confinement, the right side confinement will now be discussed. By applying left-right symmetry it can be reasoned that the top middle inlet 440, right deflector 452, raceway path 453, and the right side Q-TRUE outlet 454 form the READ function confinement path for a data true, or one's state path. This confinement path is active or selected when the wheel assembly is in the second, or SET pivotal position (not shown.) Reference to the view of FIG. 38B vane portion shows a better clear view of this secondary position, which cannot be clearly shown using conventional dashed lines. As seen, there is a total left and right symmetry of SET and RESET pivotal positions and resulting left and right guiding actions of the movable vane.

Separator wall 443 is seen which simply keeps the left and right guiding conduit portions of the READ layer separate and is structurally a continuation of the separation performed by vane 448. (FIG. 37A also showed this tab shaped separator wall 443.)

### Read Segment Design and Theory Notes

The design of the deflector shape is somewhat empirical. The top surface of the vane is for splitting a path for the falling steel ball. The lower half of the vane is empirically shaped to minimize any turning torque as the falling ball grazes the surface of the vane. Thus there is only a minimum of material that is below the pivot point. This is especially important for preventing a READ function from overturning the pivoting wheel, as the leaning of the upper portion is correct for proper deflecting, but any lower vane portion will extend into the READ raceway, which could cause an incorrect actuation, and overturn, or partial moving of the wheel away from a stable resting position.

Other suggested conventional measures can be taken to affect the reliability and resistance of the machine to vibrations or bumps, by using various known materials such as a conventional rubber friction pad for damping the wheel actuations and increasing the resistance to overturning during a READ function (not used in this design). Conversely, since the freely turning pivoting wheel is overbalanced it will tend to correct any small actuations by falling back into the stable resting position, assuming a low enough bearing friction. These opposing concepts regarding wheel pivoting friction use conventional mechanical concepts and some testing is needed to check that a given design will not malfunction under extremes of some designed operating conditions.

For uniformity in the plastic molding process a feature of the WRITE layer, path restrictor 439 (shown previously in FIG. 37B), is duplicated in shape as restrictor 455, and included in the FIG. 39 sectional view of READ layer 458. This has no function for READ, but allows for increased uniformity of plastic mold design between the housing types.

### Toggle Layer Functional Details

### FIG. 40

The third layer to be discussed is for an optional TOGGLE or wheel position flipping function. The housing for T, or TOGGLE layer 456 is identical to the R, or READ layer 458 housing, just described. (These two reference numerals were also shown in FIG. 36F.) The TOGGLE segment on the wheel assembly has a feature combination which borrows from both READ and WRITE wheel segments. Left deflector 462, right deflector 464, left paddle 466, and right paddle 468 are each located on disc 470 in the same relative positions as previously described, relative to the separator discs.

What this means is that the left and right deflectors on the TOGGLE segment of the wheel assembly are mounted the same as on the READ segment, and the two paddles on the TOGGLE are mounted the same as on the WRITE segment. Thus the toggle combines a read function or deflection, followed immediately by a write function (as the ball falls through), by use of impacts on the adjacent paddle. It is the logical opposing or inverting relationship of these two adjacent functions that causes a toggle action useful for counting functions.

### Toggle Flipping Action

Observation of the TOGGLE segment in FIG. 40 shows (in a RESET position) these elements for deflecting the ball and overturning the wheel. The right-leaning (RESET position) of vane 467 will be overturned to the SET or left-leaning position as follows:

The ball enters inlet 471 as a logical clock, and is deflected to the left by left-side deflector 462 with path as shown by the solid arrow. This is a READ action. Then, as shown, paddle 466 is impacted, causing counter-clockwise overturn of the wheel. The ball then exits out of outlet 469. The inverse action, of flipping in a clock-wise manner back to the first, or RESET position happens in a totally left-right symmetrically way. This second case does not have a path arrow shown, and readers can refer to FIG. 38B for a view of the alternate position of the wheel within this TOGGLE layer, although the housing shown in FIG. 38B is for a WRITE layer. Although FIG. 38B shows a WRITE segment, in the alternate position it is identical in construction to any TOGGLE segment. Due to the simplicity of the left and right symmetry, and to save nearly duplicate drawings in this large specification, the view of the secondary position within the correct TOGGLE housing layer is omitted.

The ball enters inlet 471, is deflected, this time to the right, by right side deflector 464, impacts right side paddle 468, and exits out of outlet 465.

### Logical Operation of Flip-flop 400

The impulsive nature of the falling steel ball makes each flip-flop function operation easy. As opposed to the static logic methodology of most electronic bus operation the impulse bus of this invention is self-clocking which also means that a signal can be viewed as a command or actuation request, with the request being in exact form to perform the physical, (or mechanical) actuation. Thus to write a SET or RESET state to the flip-flop an impulse is simply sent to the respective input to cause the desired re-positioning. Internally, this impulse, or falling steel ball, then impacts either a left side or right side paddle, mounted on the pivot-able disc or wheel as described in the preceding paragraphs.

To read the flip-flop state, or physical pivotal position, a steel ball is issued down to strobe inlet 440 (FIG. 39 and various previous figures, FIG. 36 or FIG. 37) and the ball then falls through the described confinement path, according to the pivotal state of the wheel or flip-flop disc assembly. This internal action is considered to be a conversion of the control input, usually called READ-SYNC in this invention disclosure, to an output which is position encoded, meaning that a ZEROS' and a ONES' state conduit path is defined which gives a multiple-state output. In cases of a conventional style bus there is only a single state used, usually the logical ONE'S output, while the logical ZEROS' output is either discarded or recycled by an elevator means.

If both output sides of the READ section are used, Q output 454 and Q-Not output 442, then the flip-flop is considered as having a PN bus connection. The downside of using the PN or multi-state connection is that any path switching will need to be double-wide to switch the two signals in tandem. It turned out that this PN or multi-state bus is the same as the discrete bus of the invention. (Also see objects and advantages section.)

If only a single sided connection is used, often preferred in a general data register or memory system, then only the binary ONES' state can be transmitted or transferred to other logic. This is a direct consequence of the BASE ONE nature of the invention and bus. Thus a controlling means must precede any potential transfer by first sending a RESET, for defaulting the receiving device to a ZEROS' state. Then, if the state being transferred is a ONE, this state will be transferred through any system path switches to the receiving device.

In cases of multiple bits, such as a four bit bus, a register device can chain this single default RESET in order to clear all register bits, in preparation for an arriving data word which may then contain signals to SET some or all of the four binary register bits. Later sections discuss this. The signal term of CLEAR is used to indicate this multiple chained RESET. In an upcoming section, (on multiple bit data register 600), it will be shown that this default RESET can be generated as a result of some other related action that the system controller initiates. Specifically, a controller action to cause a WRITE mode generates a discard impulse, or chain output, which can be connected to cause the multiple default RESETS needed for single sided data transfer. This feature, of WRITE mode path selection causing a pre-transfer default CLEAR is part of the SELF-CONNECTABLE nature of the mechanical computer logic.

### Toggle Operation

### FIG. 40

From an external viewpoint, a T or TOGGLE type layer is also simply an R or READ section, that is, the outputs Q-TRUE 469 and Q-NOT 465 respond accordingly when a strobe input or clock impulse to a T layer input reads the flip-flop positional state. Internally, a toggle type layer will use this positional differentiated signal destined for output at Q-TRUE or Q-NOT. Before exiting the flip-flop, the falling steel ball causes a re-positioning, or flipping actuation by impacting either the left or the right side paddle. This left or right SET/RESET actuation is differentiated by the immediately previous read action of either deflector 462, or 464.

Thus the TOGGLE layer 456 outputs the flip-flop data state which was present before a toggle or flip of the internal wheel occurred. To correct for this old data state output the outputs or outlets of flip-flop 400 are defined in reverse of a READ layer (458, shown previously.) This way, the TOGGLE layer outputs literally reflect the current, correct, data state.

The Q-TRUE output, or outlet 469 issued impulse (moving steel ball), then has the meaning that, if an impulse is issued then the TOGGLE section and flip-flop data state were just changed from a zero to a one. Such an indication can be used as data or as a count-down borrow to send to a next binary counter stage. Symmetrically, the Q-NOT output, or outlet 465 usefully indicates (inverted) data or can be a count-up carry to send to a next counter stage.

### Summary of R and T Functions

This T or toggle layer was an original novel component of the mechanical computer, but is hindered somewhat due to having only a TOGGLE function, requiring destructive reads and the complication of having controls and data using the same path means. The improvements of separate READ sections and WRITE sections from the original TOGGLE section allows more flexible flip-flop operation, such as using non-destructive READ. Also, a key feature of separate layers is the separation of the output, or outlet impulses as well, so that the three functions of READ, WRITE, and COUNT (TOGGLE) can be performed without cross-function interference. For example, READ output Q-TRUE can be separately connected to a data bus, while TOGGLE output Q-NOT is useful as a count-up carry chain output. Other outputs such as for RESET (WRITE layer) can either be chained or can be connected to the discard drain for re-cycling.

### Schematic Forms of Binary Flip-flops

FIG. 41 shows variations of flip-flop construction, in the sense that the multiple layers are varied in functional use and quantity, for which the flip-flop housing is elongated or shortened. The schematic symbol for flip-flop 400, as previously described, is indicated, showing the three function layers W,T, and R (S and R for WRITE, T for TOGGLE, and R for READ.) The flip-flop output polarities for flip-flop 400, show the left and right reversal of the READ layer from the other layers, W and T, as discussed previously. Other variations show a two layer W and R flip-flop, used in many cases for simple or high density data storage logic, a four layer flip-flop WTTR, having a T layer for counting up (INC) and another T layer for counting down (DEC). A five layer flip-flop, WRRRR or 1 W4 R, is useful as a four bit wide BUS SWITCH element.

### Connection for Data Transfer

In FIG. 42A is upright flip flop experimenter's rig 250 which provides separate areas for the mounting of up to four individual flip-flops. Two flip-flops are mounted for experiments, with a third, optional flip-flop shown for a chained connection. A teacher or student connects from one flip-flop to the next, as seen with example hose 478. The hoses are considered to be either control signal propagating conduits, or as multiples of data bus conduits, depending on connection arrangement. Note that flip-flop receptacles have reference numerals shown and discussed in the previous FIG. 37-40, for clarity not shown again here (items 438 and 428).

Each flip-flop shown was identified previously as flip-flop assembly 400, and will have a nearby stage location reference numeral, indicating the flip-flop and local stage interconnections. Hoses, on the other hand, are shown by location reference alone, (omitting the previously used generic hose 472 reference numeral, not shown), with pieces cut of such standardized diameter hose segments of any length, for interconnections between components.

For clarity, only the discussed functional connections are shown. As shown, the unconnected flip-flop outputs will, if used, result in the dropping or spilling of a steel ball after it passes through, only a minor inconvenience. If, for example, the second stage (476) flip-flop is used for a READ or COUNT then there are four possible receptacles which may then emit an output ball, each without a connected hose or conduit. Users can either use a tray, (catch pan 483) to catch such free-falling stray balls, or can connect a short run of conduit to each flip-flop outlet, again to be run down to catch-pan 483.

### Case 1

### Double-sided Data Transfer Version

### FIG. 42A

On the first, or upper level, stage 474, clock/control input hose 479 is used for dropping a ball, called the READ-SYNC control impulse, which enters the READ inlet of the flip-flop (see inlet 440 in previous discussion.) First level data output Q-NOT outlet is attached down with conduit, or hose 478 to second level RESET control input, or inlet, stage 476. (The plug-in from stage 474 is shown in dashed lines.) This provides a through confinement path, or conduit, from the very top of the experiment rig 250, for a control signal moving down through the first level flip flop device and then as data moving down to and through the second level flip flop device via the RESET inlet and outlet. (Inlet and outlet reference numerals were shown in previous views.)

After emerging from second stage 476, the discarded data signal pair (hose 478 and hose 480) could then be ultimately termed as a control pair again, and is connected as shown in dashed lines, for re-use as a controlled RESET or SET of third stage 488, although it is not strictly necessary to be so formal with terminology. It is a feature of the mechanical computer machine that as long as there is vertical travel space left, there can be multiple re-use of the traveling or falling steel ball. Thus any function performed in an upper module or sub-system, can be made to supply a re-use cascade or chain output with the feature that such output can be either with a definition or temporarily without definition (as a pure clock.) This enables a multiple process system to be implemented. In this example the re-use could be called a chained double-sided data transfer to stage 488, timed by the discard from the action of the first data transfer, from upper stage 474 down to second stage 476. It would be consistent to also consider this discard signal (moving ball) as a control and clock, which indicates completion of the previous data transfer.

With the upper, or sending flip-flop in the RESET position, the confinement path, discussed in the previous two paragraphs, is continuous and un-interrupted through the movable, reader means of internal pivoting wheel assembly 402 (not shown here). The only possible interruption of this confinement path or conduit is in the case of the upper stage 474 flip-flop being in the SET position. For that case the Q-TRUE output of the first level output is shown attached down with hose or conduit 480 to second level SET input, or inlet. This provides a through confinement path, or conduit, from the very top of the experiment rig 250, down through first stage 474 flip-flop device and down to and through the second stage 476 flip flop via SET inlet 420 and SET outlet 422. (Numerals 420 and 422 omitted in this view.)

These two confinement paths are completely left and right symmetrical. A standard approach was created to consider the left side confinement to be a logical SET or ones' impulse path and the right side to be a logical RESET or zeros' impulse path. As previously discussed in FIG. 36 views, the primary direction of these confinement paths is down, as is the falling motion of each particle. (Most diagrams and views of the mechanical computer components invention are of an upright, or face view.) Secondarily, some diagonal variations in paths occurs as each individual particle traces a path through the mechanical logic of the flip flop devices and their hose inter-connections on experimenter's rig 250.

So it is apparent that the previously described READ function is implemented to create a bus signal source in the upper flip-flop of stage 474, and the WRITE function means is implemented by the bus connection to the lower flip-flop, stage 476.

The bus signals, chained for causing additional data copies to be made, are connected by conduit or hose 484 and hose 486, to continue the two data signal paths from the second flip-flop, stage 476, down to the optional third flip-flop (stage 488). Hose 484 (Q-N) is for the RESET data state, and hose 488 (Q-P) is for the SET data state.

It should be noted that at any given time most of the apparatus is passive or in-active, with activities taking place mostly in proximity to the moving particle. A moving particle flowing down through the devices is both acted on, by path manipulation, and also acts on movable portions inside of the stationary flip flop devices that the particle flows through. The flip-flop structure could be viewed as a selecting or commutating valve. In all cases in this specification this valve function acts on one individual moving particle at a time.

### Theory Relating Physical and Logical Connections and Methodology for Computer Assisted Design

Much of the following discussion relates to clarifying the claims, for both a free-fall and for conduit guided data BUS for both transmission and processing. Some portions of the mechanical impulsive data BUS place more emphasis and importance on the free-fall and positional encoding of the moving particle, and other processes that occur in between devices, in what is usually or conventionally considered a transit region, rather than an active processing region. Most conventional computing logic involves interconnected devices, but with the system functions generally happening internal to such devices, an exception being the classic electronic WIRED-OR, constructed by simply joining together multiple wires or logic chip outputs.

Actually, it is the active processing by BUS that is a key to the strength of this invention, where devices for register storage and computing are reduced to comprising an interchangeable means for implementing the novel mechanical computer invention BUS by providing interfacing. For these reasons, the following explanations relate heavily to input and output GRIDS and position defining axis, where such grids are physically defining the spatial processing occurring as a signal traverses down-field through the devices (for processing), and also down through the BUS areas for processing.

Orthagonal grid 485 is meant for relating to the outlets of stage 474, and generally to show the positional encoded bus structure of the invention. There are left and right side identifiers on the grid, and there are three identifiers for the W, T, and R sections of the flip-flop 400 outputs. Thus relating this grid to hose 480 and hose 478, they are seen to be in the R, or READ section of the positional encoded outputs. Further applying this identifying grid to the bus connection from upper stage 479 down to stage 476, it can be said that the connection shown crosses from the upper READ section to the lower WRITE section, or layer. The reader is reminded that this connection is a hose pair, although any given signal uses only one path at a time.

Further observation of the connection from stage 476 down to stage 488 shows that the conduits forming a bus connection (484 and 486) stay within the WRITE layer. In addition, these two conduits maintain the same logical meaning, that is, the Q-NOT signal conveys a ZERO'S state to the stage 488 RESET and the Q-TRUE signal conveys a ONE'S state to the stage 488 SET input. This illustrates how logical positional encoding integrity is maintained by the conduit hoses even though the physical positioning varies seemingly according to the same encoding. The trick is to continuously re-create the proper definitions (of the axis origin) for consistency at any point in the three dimensional space of the mechanical computer. In other words, it may seem confusing that positional offsets are the basis of signal definitions, but yet such conduits as above (484, and 486) are allowed to create such (horizontal) offsets, and still the signal definitions are intact when connected down to stage 488. This implies that a CAD/CAM system tracking mechanical logic and BUS designs should incorporate both a physical offset and a logical offset in a total axis coordinate system, forced by the enclosing effect of the physical conduits (they enclose or preserve the logical meaning of a signal but allow positional changes along the length of the conduit.)

If the stages were to be positioned directly vertically aligned then the data transfer could occur without conduits, that is, in a free-fall connection, and consideration could be given to totally eliminating housings and conduits altogether, aside from necessary pivot mounts for the moving parts. This sort of interplay between the physical and logical encoding can be incorporated into a CAD/CAM (Computer assisted design) system, where design engineers can deal directly with logical designs and let the CAD/CAM system track the physical design. In other words, the CAD/CAM system would automatically do a positional offset, re-orientation or re-definition which maintains the logical definition during a transit down through a diagonal hose run.

This difficult to understand point can be clarified by observing that the connection from stage 474 down to stage 476 does indeed do a logical translation by crossing from a READ layer to a WRITE layer. Although not shown, the lower stage flip-flop could be mounted turned 180 degrees around and aligned directly below the upper stage flip-flop. In that case there would be no physical translations at all, as the connections would be straight down. There would only be just the logical crossing over of the connecting BUS from the upper READ layer to the lower WRITE layer.

Another way to illustrate this point is in the physically inverting data transfer connection which must be made to preserve the correct logical connection between stages 474 and 476. As has been discussed the READ layer logical definitions are physically reversed from the WRITE layer. If the two hoses (480 and 478) had not been crossed (not shown), then there could be a straight-down connection having no physical translation, but having a reversing logical translation. (This is actually a useful inverter, as will be discussed in the following ALU section.)

For the above reasons, this invention is said to have the ability to process by BUS.

### Case 2

### Connection for Data Transfer, Using Single Sided Bus Version

### FIG. 42B

FIG. 42B shows a single data transfer connection between upper stage 474 and lower stage 476. Conduit hose 480 is shown connecting the Q-TRUE, (or Q-P), output from the sending stage, upper stage 474 to the receiving stage 476 SET inlet. This connection is the same as in the above double-sided case.

Comparison with the previous FIG. 42A shows the current figure to represent half of the connected PN pair, thus the term single sided connection. Functionally, this single-sided connection (FIG. 42B) allows transmission of a ONES' state. Also in FIG. 42B is shown a conduit for sending a default RESET or pre-conditioning CLEAR to a ZEROS' state. Conduit hose 481 is for the transmission of this default RESET to the receiving flip-flop, stage 476.

A controlling means, or system, must supply the two signals necessary to perform the discussed single-sided binary data transfer. First, the default RESET is sent via hose 481 and second, the READ-SYNC signal is sent via hose 479, which causes a READ of stage 474, resulting in transmission from upper stage 474, to the connected bus (which is then connected down to the second flip-flop stage.)

As mentioned, discard hose connections are omitted for clarity, so as shown, a ball used for SET or RESET of upper stage 474 will simply fall out from flip-flop outlets, and free-fall down to the drain catch-pan 483.

### Data Transfer Schematics

FIG. 42C shows a pair of schematic views to correspond with the data transfer physical connections just discussed. Due to the complexity and abstract nature, it is more useful to present logical schematic diagrams as this discussion progresses. The left side schematic shows a double-sided connection for data transfer while the right side schematic shows a single-sided connection. Respectively, these two schematics correspond with the views and explanations of FIG. 42A and FIG. 42B.

### Operation of Data Transfer

### Views of FIG. 42

### Two Cases

1. Data transfer case 1: Both state data signals are connected for the DISCRETE BUS type of transmission. (FIG. 42A)

To prepare for this demonstration the state of the first, or upper flip-flop can be SET or RESET, as described in previous sections, by dropping a steel ball into the proper inlets 420, or 428, respectively. (References 420 and 428, were shown previously). As seen in the previous case, the chained bus connection to the optional third stage is made with hose 484 and hose 486. This illustrates the use of a double-sided connection for chaining, even though the original data transfer is single-sided from first stage 474 down to second stage 476.

There is only one simple step involved in initiating a data transfer from the first device down to the second (and an optional chained third flip-flop). A teacher or student drops a ball into the top, READ-SYNC inlet (440, shown previously) of the first, upper flip-flop device, via hose 479, stage 474.

If the first or upper flip-flop is in a RESET condition, then the ball will be deflected internally by the left deflector of the internal wheel assembly into the Q-NOT data path, hose 478 and then continue down to cause a RESET action on the second flip-flop, stage 476.

The path for the ones, or SET state data transfer has the ball deflected internally by the right deflector of the internal wheel assembly, upper stage 474, into the Q-TRUE path for hose 480 and then the ball continues down to cause a SET action on the second flip-flop, stage 476.

An obvious inverting action is seen in the crossing of the two hoses, hose 478 and hose 480, which acts to preserve the logical correspondence between any logical ZEROS' states and any RESET actions, and between any logical ONES' states and any SET actions. This means that a ZERO, or RESET state on the first flip-flop will be correctly copied down to the second flip flop via the RESET input, and symmetrically, a ONE or SET state on the first flip flop will be correctly copied down to the second flip flop via the SET input.

These two hoses form a PN pair in which complete data transfer functionality exists, that is either a ones state or a zeros' state can be transferred remotely. The term PN bus comes from the terms of positive and negative assertion, which are due to the fact that the N, or Q-NOT output of the flip-flop is a negated or inverse copy of the P (positive) or Q-TRUE output.

For the chaining functions, the pass-through qualities of the mechanical flip flop SET input and RESET input confinement paths allow preservation of the logic state or meaning of the moving data signal. Of course, there is a propagation delay between each of the READ from the first flip-flop, the WRITE to the second flip-flop, and the serial chained WRITE to the third flip-flop.

Approximate timing is as follows:

| | |
|---|---|
| READ function delay; | 500 mSec. (milli-seconds) |
| Hose/conduit transmission delay; | 1.3 mSec. per mm. (400 mSec. per foot) |
| WRITE function delay; | 100 mSec. for no overturn (already positioned) |
| | or 600 mSec. for overturn (new positioning required) |

2. Data transfer case 2 : Single data line connected for transmission. (FIG. 42B)

First a RESET is sent as a default clear to the receiving flip-flop, via the control input signal clear, hose 481. Next, a READ-SYNC to input hose 479 is issued, resulting in either a Q-TRUE or a Q-NOT output from first stage 474. Single line data is transmitted via hose 480 and any ones' bit present will SET the receiving flip-flop of stage 476. Although the receiving flip-flop gets both signals SET, and RESET, it is only required to have one data line conduit run (with any needed path switching in more complex systems). In this case, the RESET line is considered a control, which sets up the conditions to do the data transfer, and the SET line is considered a data line, for transmitting a logical ONES' state to the flip-flop if the data is a ONE. By itself, this is a logical OR function, of the data into the state of the flip-flop wheel.

### Implications of Previous Data Transfer Discussion

There are several ramifications to the previous discussion on data transfer options:

1. Single-sided data transfer is basically a logical OR operation of the incoming data into the SET inputs of the receiving stage.

2. The R, or READ section functions opposite to the W, or WRITE section functions, that is a READ section has a logical zeros' state output on the left side, and a logical ones' state output on the right side, while a WRITE section has the logical zeros' state input (and chain output) on the left side and the logical ones' state input (and chain output) on the right side. Thus, the READ can be considered as a logical inverting operation, and seen is the hose cross-connection, (hose 478 and hose 480) which correct with another inversion for data transfers.

This shows the left-right physical positional encoded nature of the bus of the invention.

3. The discrete bus operation (see data transfer case type #1, seen in the previous section), is a fully self-clocking transfer, an important feature. Another interesting feature of discrete bus operation is that the device and bus act in a visual manner to reproduce the look of a moving signal. The moving signal that arrives and sets or resets a flip-flop can later be reproduced in visual form, although the aforementioned logical inversion of the READ must be taken into account.

An interesting feature option for simple output indications involves placement of two large printed dots or circles on the pivot-able portions of a flip-flop, (see FIG. 36C and FIG. 36D), and with a stationary mask that alternately hides one or the other indicating dot.

Thus a flip-flop positioned as SET, can have a feature that looks like a stationary or frozen version of a traveling ONES' signal. This appears as a large stationary dot or circle on the left or right side of the flip-flop wheel. Symmetrically, a flip-flop positioned as RESET will have a feature that looks like a stationary or frozen version of a traveling ZEROS' signal.

4. In order to read multiple flip-flops, one READ-SYNC is required per bit. This means that additional originating or controlling sequencing logic must have a wide path, of at least four bits for a four-bit parallel data bus.

5. In the implementation of a multiple bit data bus, such as for a register file, the means for path switching must have one path for each bit in the single-sided case, and must have two paths for each logical binary bit (or state) in the case of a double-sided connection.

At this point in this description, of FIGS. 42A and 42B, it is relevant to discuss some central issues of this invention.

### Basic Principles for Operating CAD/CAM Software for Mechanical Computer Components

A CAD/CAM program can be written which will keep track of components and conduit connections in three dimensional space. FIG. 43 views show various connections and the response of the CAD/CAM software to physical component placements, using the above orthagonal grid concept.

FIG. 43A shows the simplest, a straight-down connection with no change in logical state identity, and also with no physical translation. A Cartesian axis system is defined, along the above described orthogonal grid, having the X axis differentiate logical states, having the Z axis differentiate between flip-flop output functions, and having the Y axis as the main direction of movement (down, or down-field). On a larger scale, beyond any local flip-flop, the X and Z axis also define the placements of components, including flip-flops and conduits. Readers can also refer to the previous data transfer arrangement view of FIG. 42 which shows how a relative vertical mounting of components is done on the experimenter's rig.

### Example Type 1

### No Physical or Logical BUS Translation

In FIG. 43A, a straight-down connection is shown between two vertically aligned flip-flops. The coordinates shown apply to the conduit output on upper flip-flop, stage 474, and the conduit input on lower flip-flop, stage 476. (These stage reference numbers are re-used and appear in other drawings.) As seen, only the Y axis coordinate changes. Also, there is no logical change in the signal definition between the upper Q-N output and the lower connected RESET input.

Suppose a CAD/CAM software operator had placed these two flip-flops and connected them with a conduit by the conventional drag and click method, using a mouse pointing device. As is conventional for CAD/CAM, the software builds an internal 3-D model of these mechanical computer components. Then, the CAD/CAM software takes the definition of the destination flip-flop input (lower flip-flop, stage 476) and applies it all the way back up the connecting conduit. The symbols Q-n or Q-P are used to lable ZERO'S state or ONE'S state bus lines, respectively. In this example, FIG. 43A, the conduit is a ZERO'S state line, as it connects to a RESET input. Since the upper flip-flop connection is to a ZERO'S state output the CAD/CAM program detects no conflict.

This document does not attempt to give details of conventional CAD/CAM software, but it is expected that the connecting conduit be divided into many small elements, as the Y axis is transitioned from coordinate=54 down to coordinate=32. This will have the effect of enabling a design engineer to make additional connections into the conduit by using a Y connector with such additional connections automatically having the same ZERO'S state identification.

### Example Type 2

### Physical Translation with No Logical Change

FIG. 43B shows a situation where the CAD/CAM software operator or design engineer has moved the lower flip-flop so that it is no longer in direct alignment with the upper, sending flip-flop as shown in the coordinates. As before, the CAD/CAM program first identifies the conduit as a ZERO'S state line, according to the lower or receiving flip-flop. Then, the program can move attention along many tiny elements of the connecting conduit while assigning this ZERO'S signal status to each such element. This is similar to the above case, except that the X coordinates are changing along the conduit. This then allows the CAD/CAM software to build a list of elements that are ZERO'S state lines (labeled Q-N), each having a proper coordinate to match the actual physical conduit elements that are being modeled. As mentioned, with a design modification to add a mid-way conduit Y connector the CAD/CAM program can retrieve the logical Q-N identifier at that coordinate and use it for any new connection. There is only a brief discussion on CAD/CAM aspects of component placement as there are many other considerations involved in conventional 3-D mechanical design.

### Example Type 3

### Logical Change with No Physical Translation

This is where one register is directly above another's inputs, for a free-fall connection with no horizontal change to the movement path.

This brings up important aspects of the BUS of the invention. Readers may pose the question: Why not identify the flip-flop as an inverter as in convention, rather than identifying a conduit as such? The answer brings into focus a central aspect of this invention, that of BASE ONE operation. Using terminology derived from BINARY or BASE TWO computer science can cause some misunderstanding. Specifically, this document utilizes the symbols Q-N and Q-P to convey ZEROS and ONES states. This is appropriate for the mechanical flip-flop because from a Boolean standpoint P symbolizes positive or original un-changed data, while N symbolizes negated or opposite data. This physically matches the flip-flop 400 left and right output structure. However, the more accurate BUS signal identification (of Q-N and Q-P) does not have this opposing Boolean nature, but is rather an alphabetical set of values.

The previous large sections on multi-state and decimal operation help explain this. In other words, in BASE ONE there is no such thing as a literally inverting function, as there is no symbol or state to invert to. Thus the symbols Q-N and Q-P might be most correctly changed to Q-0 and Q-1, to avoid misunderstanding. However, since the flip-flop 400 internal wheel does operate with two states in BASE TWO these symbols (Q-N and Q-P) are still appropriate.

This discussion brings up some fundamental issues regarding number bases and this invention. It could be stated that while flip-flop 400 operates in BASE TWO, any interconnection lines (conduits) actually operate individually in BASE ONE. Conversely, it is IMPLICIT in most computer logic that there be a clock, as an additional qualifier for any useful application, especially in a data transfer.

### Counter Register with Pre-load

### Discrete Connections Using Flip-flop 400

Connections similar to the above for data transfer can be made between multiple flip-flops (400) in stages to create a serial-chained, or ripple-clock binary counter. In FIG. 43A, two such flip-flop stages are connected serially for count-up and for READ and WRITE functions as a parallel group. This closely resembles a text book or conventional four-bit electronic counter register, such as the TTL74SN190, and 74SN193, etc. To simplify this immediate description a register of a size of two bits is shown. However, the preferred modular construction consists of four flip-flops for a four-bit counter register.

This makes for a good moderate sized module, having, with four flip-flops, enough density and quantity of conduits to benefit from integrating, by using common separator walls, common support brackets, and especially by managing a moderately large number of raceway guide ducts or conduits. (A typical integrated four-bit register module has 11 inputs and 23 outputs, although only a small number of outputs are used while the rest are discarded.)

Continuing on this discussion on the version of the two-bit register, FIG. 43A shows the experimenter's rig with connections for implementing a two-bit binary counter register with an arrangement for counting up (in binary code.) There can be, optionally, up to four such flip-flops mounted serial chained vertically or up-right for operation on experimenter's rig 250.

As shown in FIG. 43A, the connection hose 492 provides for counting up, or sequencing to the next binary coded value. The connected signal represents a carry to the next flip- flop stage. As mentioned, omitted for clarity are the numerous outputs to be discarded by connection to conduits which lead to the discard drain 483. For example, the upper stage borrow signal, a signal which is complementary to carry signal hose 492, is one of the above mentioned discarded signals. This is seen as short hose 493 segment, paired with hose 492.

In FIG. 43B is a schematic view of this two-bit connection arrangement. The input, WRITE BUS 490, shows a two element BUS for sending parallel binary data into the two-bit register. These two signals are labeled according to the binary bit numbers 0 and 1, which correspond to the conventional power of twos binary weights 1 and 2. Literally, these two signals are for causing a SET of a particular flip-flop or counter stage, if the corresponding bit being received is a ONE. Readers will recall that if a bit is a ZERO, then there is simply no transmission. To facilitate this single-sided transmission is the signal CLEAR 502, which is chained through each flip-flop to pre-condition a data transfer by clearing all bits in this two bit register arrangement.

Control BUS 491 is the grouping of the miscellaneous signals CLEAR 502 and INC 504. It is loosely referred to as a BUS by exclusion, that is, a grouping of any signals that are non-data. Also, perhaps more correctly, the term CONTROL BUS indicates a connected run of conduits sometimes grouped together as a single multiple hose conduit, that originates all the way up in the sequencing controller, or to be issued from manual operation. Other possible control signals in this grouping include functions such as INC 2, INC 4, and INC 8, (these are not shown.)

For a READ function, READ BUS 494 shows a two element BUS for sending parallel strobe signals into the two-bit register. These were referred to as READ-SYNC in previous discussions. Essentially, this is a two-bit control word which has an all ONES' data state for interrogating in parallel each flip-flop or counter stage. READ output BUS 496 carries the results of a READ function, sending an impulse (falling steel ball) for any flip-flop or stage that is SET, (or ONES' state.)

Readers should realize that this discussion on the two-bit counter arrangement is a prelude to the more useful four-bit variation, identical in form. In logical terms, this form is to be integrated into a single module or housing, as will be seen.

### Background on Register and Experimenter's Rig

### FIGS. 43A and 43B

This connection arrangement can be considered in total or as a small sub-system, or built as an integrated module having two T or toggle type flip-flops with included separate or parallel SET inputs. For register loads, or writing to the register, the W, or WRITE inputs are the grouping of the two SET inputs, from each stage of the register/counter. So, for the parallel loading of data from an input bus this arrangement can also be considered as two S-R (SET-RESET) flip-flops. For counting purposes, the type is also considered as a T or TOGGLE, as mentioned. This depends on the inputs being used for any particular function, the T input for counting and the S and R inputs (SET and RESET) for parallel data loads. Since the mechanical flip-flop has these separate input functions operating on a common shaft, all of the functions track each other by causing and responding to the same flip-flop data state.

Obviously, the demands on sequencing properly become considerable when attempting to demonstrate parallel data loading function by hand, as the two individual resets must be activated first, for ensuring that any zero states will be copied, by dropping a ball into the CLEAR 502 conduit hose input. This is because this classroom demonstrator arrangement shown (FIG. 43A) is using one-sided data transmission where a steel ball is only received on the data line if there is a logical one, and therefore always first needs a default actuation for the zero case. The use of a two-sided (or called PN) data transfer would have required four total lines, two for each bit stage. Although it is possible to build such special registers the description immediately here assumes the more common, single data line for each bit type of bus. Otherwise, an eight-bit data bus system using two four-bit registers would have to have sixteen data lines, or conduits. That special arrangement does, however, have the advantage of being self-clocking, as was discussed.

Actually, it was the complexities of manual operation of this experimenter's rig that was the seed of the development efforts for the entire CM-1 binary computer. Originally, the attempt was to construct a kind of super-sequencer, or absolute minimal processor that could run a small program for sequencing signals, or actually a programmable state machine with perhaps 8 instructions. The concept was one of a state machine which a teacher or demonstrator would activate by simply dropping one steel ball into one of several request lines, with a resulting sequence, such as setting up and performing a Boolean XOR (exclusive OR). Out of this concept the expanded and more general purpose CM-1 machine was developed, having a more general purpose instruction set and operation.

Steering this theoretical discussion to include FIG. 43A, one way to simplify this requirement for two resets, (or other multiples in other sized registers), is to mount the two individual flip-flops vertically for cascading, as already seen, so that one reset signal can be chained from each bit stage (flip-flop) output to each next stage input, starting at the top with the lowest binary weighted flip-flop (stage 474) and progressing down to the next higher bit weight (stage 476). This vertical mounting is useful and needed anyway for cascading the count up and count down signals, or carry and borrow signals, through the stages for ripple counting arrangements.

It must be borne in mind that such a serial reset or CLEAR function arrangement has timing implications. The stages of the register must not be accessed until the reset impulse (steel ball) has completed the reset actuation through the last stage. Otherwise a logic race condition can exist.

### Notes on Sequencing the Experimenter's Rig

As the described complexity of the invention mechanical computer components increases, up the hierarchy towards describing a complete system, it becomes apparent that a data transfer sequencer (not shown here) would be helpful to a teacher or museum demonstrator. A teacher could then do one simple action such as dropping one steel ball to initiate or start a sequencer which will then issue several impulses to operate a complete data transfer between components. This dropped ball does not do the actuations but rather it changes a flip-flop in the sequencer, which acts as a request for the sequencer to perform actions which are automatic. After such multiple automatic sequencing signals are sent down to the apparatus, the sequencer then clears the flip-flop that started the request, in preparation for initiation of another later cycle.

This sequencer would be ultimately controlled or regulated by a periodic clock generator which issues an impulse in the analogous fashion of this invention, that is, the clock issues or dispenses a steel ball, in this case with a period timing of approximately twice per second (640 MSec. time period).

In keeping with the current intent of this mechanical computer components invention, it is not strictly necessary that students or even teachers completely understand the logic operations as there are many levels of interactivity available. The functioning of a semi-automatic demonstrator would allow motivation to learn computer science to be acquired without imposing strict pre-conditions. However, since a sequencer and clock are to be described later, as part of a whole CM-1 machine, this section will assume, for now, manual operation of the experimenter's rig. This will also help for understanding what is required of an automatic sequencer.

### Manual Operation of the Binary Counters

### Discrete Connections Using Flip-flop 400, or Similar

Function #1; CLEARING the register. FIG. 43A shows the two flip-flops with cascaded, or chained resets, using connected conduit hoses. To clear, a steel ball is dropped into a receptacle, (CLEAR 502.) As previously described, this steel ball then falls through each of the two flip-flops in turn, to cause each one to be reset.

Function #2: LOADING in a number. A two-bit binary coded number can be set into the register by first clearing, as above, and then by dropping a steel ball for each bit that will be set, into the conduits of WRITE BUS 490.

Function #3; COUNTING. To count up a steel ball is dropped into the clock up inlet hose 504 of the top-most flip-flop or counter stage. This is also called INC, or increment by one function.

Function #4; READ-OUT. The contents of each counter stage or bit can be read by dropping a steel ball into the respective inlet or input, called a READ-SYNC impulse or interrogating impulse, as described previously for READ BUS 494. This then creates the positional encoded output, READ OUTPUT BUS 496 that is characteristic of the mechanical computing logic bus signaling.

Various receiving buckets or trays (not shown) can be used to indicate the result, using this encoding of the flip-flop data and the result can also be observed being formed inside the flip-flop and connected output conduits. (The steel ball alone travels quite fast through the transparent conduits, such as conduit 492 and may not always be observed by students at a distance.) Other classroom possibilities, not shown, include the use of small bells for impacting by a ball or other sound generating output differentiation indicating devices which help enliven the flip-flip register demonstration by changing sounds according to the data.

### Expansion to Modular Register 600

### FIG. 44

### With De-multiplexing Bus Interface

Discussion in this specification will now extend to logical constructions using the same elements as flip-flop 400, although there are variations in their assembly. Literally, the structure of each internal data flip-flop differs from flip-flop 400 in that there is an additional layer and segment and in that the layers and segments themselves are placed in a different order on the pivoting shaft. Each of the four internally integrated data flip-flops has the layers ordered as TTWR, while flip-flop 400 was previously described with three layers ordered as WTR. The flip-flop structures used have an additional second counting layer added, for implementing both up and down counting functions, meaning increment by one or decrement by one, respectively.

There are additionally some inter-connecting conduits which have the same data or signal transfer functions as the conduit hoses previously discussed. That is, the two-bit interconnection arrangement just discussed is completely analogous, excepting that there is another counting (TOGGLE) layer in each of the four data storage flip-flops. Two front-end flip-flop switches for BUS de-multiplexing and register function selection will also be described. Again, this DE-MUX is just a logical variation of flip-flop 400. This is because the mechanical flip-flop invention actually is primarily a path switch, and so the functions of static numerical binary data or state storage and of static path selection are dependant on how flip-flop 400 and family derivatives are interfaced. Generally, register 600 is an interconnected combination of six pivoting flip-flops.

In FIG. 44 is a pure expansion to four bits of the form discussed previously of two bits in FIG. 43B. Readers should be cautioned that the schematic symbols for each flip-flop are presented in a logical form and so might not always be a literal match in terms of the ordering of the segments. Physically each flip-flop is ordered as TTWR, but for purposes of clarity in the schematic layout (FIG. 44) the logical order is WTTR. This is closely analogous to describing electronic circuits in logical and schematic terms, while for manufacturing there is another exact physical description (for printed circuit traces, pin numbers and IC chip placements.)

### Bus Organization for Functions

For the inputs (inlets) there is seen four-bit WRITE BUS 506, four-bit READ BUS 510, and a set of control signals, CONTROL BUS 512, (CLEAR 502, INC 501, DEC 503.) For a data READ function, outputs (outlets) for READ BUS 516 are seen forming a four-bit register output BUS, which operates in conjunction with READ input BUS 510. Extending previous discussion on the READ-SYNC signal, it is seen that binary data from register 600 is READ by having a system controller issue four READ-SYNC signals (or clocks) in parallel to the READ input BUS. This so-called strobe word will be conventionally notated as (1111b), indicating all bits are set.

For a data WRITE function, and as previously mentioned, the CLEAR control is shown cascading down for a RESET of each register stage in turn. This chain of RESET signals will not always be clearly shown in future, more complicated schematics. For counting functions, separate chain connections of signals are shown for the counting up layer, and for the counting down layer. For counting up, each right side output (Q-N) is chained to the next stage for ripple counting. An impulse (steel ball) emitted by a flip-flop Q-N output has the symbolic meaning that the flip-flop stage has just transitioned from a ONES' to a ZEROS' state. This has the functional effect, when connected to a following stage, of a logical falling edge, or clock to count up. (This is seen in the electronic binary ripple counters, such as the 74LS192 for example.)

Symmetrically, chained connection of down-counting layers is with each left side output (Q-P), with the impulse emitted representing a logical rising edge of a flip-flop transition from a ZEROS' to a ONES' state. (FIG. 41 showed Q-N and Q-P for each function.)

As is convention, there are labels seen for each bit weight to help identify each counter stage. The register 600 module has the discarded output (outlet) signals shown from the bit 3 data flip-flop 515 as discard signal group 514. Due to the flexible and diverse nature of logic in computer science in general it should be apparent that many optional features can be added, with signal group 514 containing useful signal outputs for chaining to additional counter registers, or other logic, such as a system CARRY flag flip-flop (not shown here). Designers could modify register 600, for example, to provide an inverted output copy of bit 3 by providing an additional outlet connecting to the Q-N output of bit 3 flip-flop 515. (This Q-N output is shown with an X in this FIG. 44A, also refer back to FIG. 41.) It is intended in this design for register 600 that all outputs marked with a letter X are included in the discard group 514. These places are shown in the other three stages, above the bit 3 stage. In the top most stage it is seen that the discards are: SET, Q-P for the toggle up layer, Q-N for the toggle down layer, and Q-N for the READ layer. These same logical flip-flop outputs are also discarded from the second layer (bit 1) and third layer (bit 2).

### Bus Input Interface Switches

Observation of this FIG. 44 reveals the need for some input interfacing. Otherwise, all eleven register inputs must have an external bus or conduit connection.

The first interface switch, or DE-MUX, is for the separation of incoming control signals, while the second switch, or DE-MUX, is for separation of incoming WRITE or READ signals.

The interface outputs shows the three blocks, CONTROL BUS 512, READ BUS 510, and WRITE BUS 506. These are meant to symbolize the register inputs of FIG. 44.

The interface is considered a part of integrated register 600 because it is contained within the housing.)

With the internal use of the structural equivalent of the two DE-MUX switches the register 600 input bus can be kept to a size of four bits plus an initializing signal called SELECT 508. DE-MUX 500 has one layer specially included for a toggle, rather than a read function.

There is additional multiple path selecting logic (not shown) used in most systems which selects one of a multiple of BUS outputs or ports. One of such BUS ports is connected, via conduit hoses, to inputs of each of a set of registers. This discussion will now assume that system path selection has been done, causing a signal to be issued to one register 600, called SELECT 508, issued by the controlling means path selection. The origination of SELECT will be described later, when the topic of path selection is detailed. Briefly, SELECT is a discard from the path switches that can be chained to pre-condition a device.

### Operation of the Bus Interface to Register 600

As just mentioned a SELECT 508 signal first pre-conditions the register 600 interface. The pre-conditioning consists of the issued SELECT 508 signal causing a RESET of control DE-MUX 498, which puts the interface into control mode, and RESET of read/write DE-MUX 500, so that DE-MUX 500 connects to the READ inputs of the actual data storage flip-flops of register 600 (FIG. 44). Then, the system controlling means issues one of several choices of function selection onto the four-bit system bus, as follows:

### Data Bus Words Sent for Function Selection

Data bit 0=exclusively SET to place DE-MUX 500 into WRITE data mode (binary word=0001b)

Data bit 1=exclusively SET to enter READ/WRITE data mode (binary word=0010b)

### Data Bus Words Sent to do a Control Function (INC or DEC)

Data bit 2=exclusively SET to do INC (count up) (binary word=0100b)

Data bit 3=exclusively SET to do DEC (count down) (binary word=1000b)

The sending down of either the INC or DEC selection control word is sufficient to do that function, which is as in a conventionally electronic ripple counter, that is, each carry or borrow is propagated down to a successive counter stage flip-flop clock input. (FIG. 44A and previous discussion shows this.)

For a WRITE data function, is the preparatory step of sending down of the control to enter WRITE data mode. The READ or WRITE functions have an additional step to gain access to DE-MUX 500 and then another step to actually send the data in or to read it out. Of these four control word bits, only one bit should be SET for any given function selection operation. Using a special feature of the mechanical binary flip-flop, by using one T, or TOGGLE, type of layer in the BUS switch, DE-MUX 498, specially and only in the bit 1 position, the passage of an impulse on the data bus of(0010b) will cause a flip or switch of the DE-MUX. Thus the passage of the special switching impulse will cause control DE-MUX 498 to switch paths to the alternate BUS path, which is for DATA mode, which connects directly to the second switch, data read/write DE-MUX 500. The data mode selecting impulse (binary word 0010b) is then discarded after passing out of the switched outlet of the control DE-MUX 498. In other words, the data mode selecting impulse goes nowhere, as it is the simple passage of the above data mode selecting binary word which switches DE-MUX 498 to DATA mode. Note that the SET 499 input, of DE-MUX 498 is not even connected. Readers should also note that since conventional binary data in parallel can contain more than one bit set, it is only one layer that can have a T or TOGGLE function in DE-MUX 498. Other wise there could be a mechanical race condition unless all ONES' bits arrived simultaneously on the BUS.

If the operation or function is to be a READ, then the controller can proceed with the cycle, as the BUS path now connects all the way down to the actual data flip-flops, as the earlier SELECT signal positioned the DEMUX 500 to select the READ BUS 510 input portion of the register flip-flops (as default). In FIG. 44 this READ input BUS is seen to connect to down each of the data flip-flops as a READ-SYNC or interrogating signal. To read the four bits in parallel, a binary word of all ones is sent (1111b).

For an operation or function of WRITE, the controller can also proceed with the cycle because of the previously issued control selecting word of (0001b), and since this control bit 0 then connects to the SET input of DEMUX 500, this WRITE select action sent a ball to SET the DE-MUX to WRITE mode. What this means is that, similar to the READ case, the data bus then connects all the way down to the WRITE inputs of the data flip-flops, so that the following step can issue the actual four bit binary data to be written to register 600. This is because the WRITE selecting control word first flipped DEMUX 498 by passing through it, and then SET DEMUX 500.

In addition, this WRITE selection control word (impulse) continues down out of the DE-MUX 500 SET outlet, again another chained signal, to perform a CLEAR of all register 600 data bits, in preparation for the actual WRITE data to arrive. This is a powerful feature as it saves steps that would otherwise be required to prepare for writing to register 600. This is by combined use of the signal for the selection of the path for the WRITE function as a signal as the issued CLEAR signal.

In review of the preceding explanation the four described input interface functions of register 600 are now listed:

For increment, controller issues SELECT, then data bus word of 0100b.

For decrement, controller issues SELECT, then data bus word of 1000b.

To READ, controller issues SELECT, then a data bus word of (0010b), and then a data bus word of (1111b).

To WRITE, controller issues SELECT, then a data bus word of (0001b), and then writes the desired new data word (bbbb), by sending it down the data bus.

Note that an additional useful fifth function, the instruction CLR (CLEAR register to zero), can be obtained by simply entering WRITE mode, as in the above steps, but not actually doing the final WRITE data step. This potential feature option, however, depends on the controlling means and adds a burden to any instruction set of the computer, by using an additional instruction OP code (operation code.) Readers should note that CLR can be done by the WRITE of (0000b) data without needing an additional dedicated instruction.

### Physical Implementation of Integrated Four Bit Register 600

A three dimensional space must now be defined containing the internal raceways (conduits) in the box-like module housing.

The following deductive design steps help greatly in understanding the very convoluted internal raceway structure, actually logically simple, and adds to the comprehension of the complex, abstract methodology of the invention BUS interface.

### Design Step #1

### Placement Along the Vertical Axis

Each of the four data flip-flops must be placed in a vertical column arrangement for downward chaining of the ripple count signals, and ordered downward from low binary bit to high binary bit. Any BUS interface must be above the four data flip-flops.

### Design Step #2

### Placements Along the Horizontal Axis

The left, right, (and middle) positional encoding of the raceways must match the arrangements of FIG. 44. It is always preferred to follow the number convention that binary weighted bits are ordered, from right to left. Design figure FIG. Bxxxx shows that it is convenient to shift each successively downward data flip-flop to the left. Note that four of the formerly described flip-flop 400 type of rectangular housings are used, and temporarily blocked into the physical space for design purposes, rather than attempting the convoluted design with just the pivoting wheel elements.

In FIG. 44, the READ BUS 510 and WRITE BUS 506 are placed neatly in columns, and that sufficient space between each data flip-flop allows connection of the increment and the decrement raceways. Observation of the diagonal offset of each data flip-flop (FIG. 45) shows that such READ output BUS can have output raceways (conduits) that run straight down from each flip-flop, as will be shown. The READ input BUS and WRITE input BUS, each shown here, have straight-down access to each flip-flop due to the diagonally offset mounting of each stage.

### Design Step #3

### Placements Along the Depth Axis

The depth axis coincides with the shafts of the four pivoting data flip-flop wheels, and so differentiates function by differentiating functional segments. Generally, most of the interconnecting raceways of the four data flip-flops stay within the associated strata layers.

DEMUX 500 can be conveniently placed at right angles to the data flip-flops, for a near perfect match of the two input BUSSES, WRITE BUS 506, and READ BUS 500. This, in one design step, takes care of the majority of the register 600 internal conduits. Also, placement of DE-MUX 498 outputs above DE-MUX 500 inputs produces a perfect vertical match for interconnecting, via short interim BUS 517.

### Design Step #4

### Miscellaneous Remaining Raceways

The last three raceways to be discussed here were designed after the majority of BUS conduits were in place, so that there were some minor inconveniences. The signal CLEAR 502 originates from bit 0 of incoming data BUS 518.

### Building a Subsystem

### Example of Register File

For a data transfer subsystem arrangement, having a feature for sending data both to and from an accumulator designated as the primary data register. A controlling means handles the signal sequencing by originating all of the impulses traveling down through the system. The accumulator is split into two separated housings. A sender housing and receiver housing have paired sets of tension lines running between. For each of the four register bits the logical position of the sending unit flip-flop is communicated to the corresponding receiving unit flip-flop by a pair of tension lines. This was also introduced in FIG. 4.

In preparation for performing a data transfer from the accumulator down to a register, the controlling means first sends SELECT, followed by a control word to cause the register interface to be positioned for an incoming data WRITE. This was just described in the previous section on operating the register multiplexed interface. Then, in order to perform a data transfer from the accumulator the controlling means sends down a BUS READ-SYNC signal set in the manner as has been described in previous sections on data transfer. This READ-SYNC control signal set aquires the accumulator data states, in parallel four-bit binary, and causes transmission of the states down the BUS to the register. The transmitted states then can enter and WRITE the data to the receiving register. The proper preparation of the multiplexed register allows these transmitted states to travel down and be impressed into the register.

In preparation for performing a data transfer from a register down to the accumulator, the controlling means first sends SELECT, followed by a control word to cause the register interface to be positioned for an incoming data READ, as was also described previously. Furthermore, the accumalator sender must be cleared in preparation for the new data to come in, as in previous single-sided data transfer descriptions. In order to save vertical space the four bits used in the accumulator sender are not stacked, but rather are side by side. This means that the CLEAR or the accumulator must be done using four individual reset signals instead of the serially chaining of one reset signal. Then, in order to perform a data transfer from a register the controlling means sends down a BUS READ-SYNC signal set to the register. This READ-SYNC control signal set aquires the register data states, in parallel four-bit binary, and causes transmission of the states down the BUS to the accumulator sender.

### ALU Functions with the Experimenter's Rig

Generally, in ALU or arithmetic logic unit functions a first binary integer number is placed in an accumulator, also simply called the A register, and a second number is used to operate on the accumulator in various ways. In the CM-1 mechanical computer design, this second binary integer number always comes from the B register.

In the mechanical computer bus, logic and ALU, the way of performing a particular function is novel in comparison to electronic bus, logic, and ALU methods in regards to physical signals. The ALU results, that is the logical output or result of processing steps is as conventional as possible, especially from the programmer's point of view. Most computer ALU functions are performed with the accumulator as a destination and also as a source of one of the parameters, such as when performing an OR of B into A.

In the experimenter's rig the A register is represented by a one-bit flip-flop and the other math operand, the B register is represented by a lower one-bit flip-flop.

The LOGICAL-OR, of B data into A data is straight-forward. The four binary bits contained in the B register are copied down from each B register Q-TRUE output to each bit SET input of the A register. This is by way of the same connections as previously described for the single-sided data transfer. A LOGICAL-OR can then be performed by the same actions as the instruction LDA B, except that the accumulator is not cleared before the single-sided data transfer. Readers will remember that the single-sided data transfer is used when only the logic ones state conduits are connected.

Thus each bit in the B register that is set will run down through the conduit and path selection means (not shown here) and cause a SET action on the same corresponding bit in the A register. Any accumulator bits that were already set will remain so.

A LOGICAL-AND has operation that is symmetrical with the LOGICAL-OR, and can be considered as a negative copy operation. For a LOGICAL-AND each B register bit Q-NOT output is connected to each bit RESET input of the A register. Thus, any zero present in the B register will be copied down into the accumulator RESET input for that bit.

For a LOGICAL-XOR, which is an exclusive OR function, the contents of the B register are copied into T, or TOGGLE inputs of the accumulator. In this XOR type of layer however, there are no serial connections between bit stages as seen previously in the counter implementation. This is because the function A=A XOR B does not have a carry or borrow from bit to bit. The outputs of each bit stage XOR layer (which contains a TOGGLE type of wheel segment) simply connect to the discard drain. This is eight outputs total, including a Q-TRUE and a Q-NOT for each of the four bit stages.

### Adding with XOR

Adding is done by having the A or accumulator data in a set of flip-flops, and by sending the B bit data, for each bit, into each wheel toggle (clock) input. No output indicates a zero coming in plus the A data bit, leaving the wheel in the same state. An arriving B bit set to a one, with A also set, causes a carry from the adder stage. The trick is to cascade each bit process, for cascading the carry from each lower bit weight stage. At the last stage, this carry can be transferred down to a system carry flag, or semaphore sender.

A previously described, a data compliment, or DATA-NOT function can be performed by connecting both sides of each B register flip flop without crossing the hoses from side to side and running these hoses directly to the A register SET and RESET inputs. Since a bit stage Q-NOT is on the left a zero state in a B bit will be copied down to the SET input for the corresponding A bit. In the same way, each B register stage bit Q-TRUE output runs down to the corresponding A register stage RESET input.

In each, operation of a logical function is accomplished by establishing or selecting a connection variation and then dispensing a SYNC particle Additional logic means must also be provided to configure these paths.

Also suggestive of discrete bus PN etc.

### One Shot Pulse Separator

A flip-flop toggle layer has omitted one side of the actuating paddles which were previously described. This allows an arrangement where the flip-flop can be armed, by a normal SET action (in the so-called WRITE layer of the disc assembly). A subsequent impulse arriving in the TOGGLE layer will be deflected and impact on a paddle to cause a RESET positioning of the flip-flop. The output after this action, exiting on an outlet, can be used as a single pulse output. Any subsequent arriving impulses to the T or Toggle input will be deflected to the left, but there will be no actuation to the flip-flop disc or wheel because there is no paddle on the left side of the pulse separator, only on the right side. This has the effect of picking off, or separating only the first arriving impulse after an arming action.

Various cascaded series of these pulse separators can be used to create a sequencer.

### Background Weighted Counter

A reverse or backwards weighted counter is made, by connecting toggle flip-flops in a tree or root configuration the fastest switching or lowest weight is at the top, with the slowest or highest binary weight at the bottom. This arrangement produces a strange binary-like counter that has the counting state distributed throughout. Each clock impulse, or falling steel ball, will cause a state switch or toggle on the top-most flip-flop and then will be directed either to left or right, alternatively, with this process repeated throughout the tree or root structure.

This results in a somewhat scrambled but ordered output from the array of connected flip-flops, with the following repeating output order from left to right; 0, 4, 1, 5, 2, 6, 3, 7. However, if these outputs are re-arranged and connected properly a sequencer with a repeating order of states or counts 0 through 7 can be made.

This reverse-weighed or scrambled order counter can be used for continuously sequencing of other parts or sub-systems of the mechanical computer.

mechanical logic discussed in this disclosure.

### Description of Module Construction

Overall, the module is a set of two mounting plates on which are mounted three individual bus switch devices. The three bus switch devices are rectangular box-like devices (seen in different context in a side view as the top two elements of the six components internal to integrated register FIG. 45.) A fourth rectangular box-like device is an input demux device for separating the first positioning signal from the data.

At the top of the module between the two main mounting plates is mounted the de-mux device. This mounting is permanent using an epoxy glue. An alternative (not shown) is to use conventional #4 machine screws to attach the device housings to the main plates and.

Since this disclosure is related more to the logical connections and operation of the mechanical computer devices it is assumed that variations of details of conventional plastic injection molding and simple mechanical assembly with various machine screws can be covered in brief. Most devices described are mechanically independent, that is, there are no gears, strings or linkages of any kind between the described logic elements and so this description can be somewhat relaxed in regards to issues like minor spacing variations between devices. If two devices are mounted slightly further apart then any connecting conduits are simply made slightly longer to compensate.

Most important in this description of construction is the following:

1. Construction variations must not alter the downward serial order of the mounted devices.

2. Construction variations must not add obstructions or constrictions to the conduit or duct means.

3. Variations of overall module construction and of mounting tabs or brackets must maintain the upright orientation of the module.

These principals also apply in general to other modules in this disclosure.

Resuming the description, moving downward from the de-mux switch there is mounted one bus switch element which is at the top of the binary data path pyramid and moving further down are two bus switches. These two switches are on the two bus data path legs coming down from the outputs of the top switch. This forms a classic binary subdivision tree having two levels and thus ultimately having four possible ultimate paths.

This subdivision tree has the de-mux switch above it. While one output side of the de-mux connects to the top of the binary data path tree the other output side of the de-mux connects, in block form, to the side of the bus switch module. This is a schematic form that is indicating that the switch position is controlled.

The purpose of the de-mux is to split off or separate any control pulse transfers for positioning of the switch module and then to dispatch any subsequent data transfers down into the path for useful output to one of four output ports.

### Register File Subsystem

Generally, as is seen in electronics, the 8 bit portions are addresses, or special data, and the 4 bit portions are the data path and ALU area. It should be noted that much complexity and design time is required to implement this flexibility of two bus sizes.

Conduits from each register output are combined by like bit weights, so that the re-mix combiner outputs and inputs constitute a bus combiner. The next item connected from the re-mix combiner is the accumulator semaphore sender, which then connects down to a particle discard drain.

Control signals flow down in conduit means also shown. Path setting input conduits connect to for bus path switching. The outputs, for after the path setting number has arrived and passed through the path switch, then connect to a particle discard drain for re-cycling by a conveyor means (not shown here). Part of this switched bus are the conduit means for the signals SET-WRITE and SET-CONTROL, which are to be switched along with the data conduits for use on the target register. (The register being addressed or selected by a BUS switch.) Another control signal, CLEAR-ACCUMULATOR, is a conduit means that runs down and connects to the accumulator semaphore sender.

### An Operating Example of Reading from the Register File

The computer instruction example is LDA 11, which means load accumulator by reading the four bit nibble at decimal address 11 and transfer of the data to the accumulator, sequenced as follows:

1. A header accumulator bypass is set, or activated, the bus path switch is properly positioned (to register 11 as will be described shortly), and the terminus accumulator bypass is reset, or de-activated. Also, the accumulator semaphore sender can be cleared in this step. For example, to send four balls down to clear the accumulator during clock time period number two, there is connected four hoses from the sequencer outputs for time four, with these four hoses then running all the way down as a clear accumulator control BUS. As is conventional with electronic micro-processor internal signals, these four control signals also are originated by any of the other instructions which write to the accumulator, and thus there is a terms collection done, by combining all like functional terms (signals) coming from all of the instruction sequencer outputs.

2. A data bus strobe set is sent down consisting of four signals (falling particles) falling side-by-side in four data bus conduits, originating in the BUS HEAD area.

The actions of these two steps (of LDA 11) will result in the data contained in decimal a address 11, (register reference item #132), to be copied, or transferred down, flowing through the confluences of a remix combiner and ending up properly activating the data input or inlets of the terminus accumulator semaphore sender.

### An Operating Example of Writing Data to the Register File

The instruction STA 3, which means copy or transfer the data in the accumulator register to a selected register in the register file, is sequenced as follows;

1. The header accumulator bypass is reset, or de-activated, and bus path means is properly positioned to the register at decimal address #3, as previously described.

2. The signal SET-WRITE is sent, which results in the register being conditioned to receive a new set of four data bits, as previously described.

3. A data bus strobe set is sent down consisting of four signals (four falling particles), falling side-by-side in four bus conduits.

### Reference Numbers

CM-1 system reference numerals are 100 through 199, CM-2 system from 200 through 299.

BINARY devices are generally 400 through 699, DECIMAL devices generally 700 through 900.

| ITEM# | ITEM |
|---|---|
| 100 | CM-1 Binary Computer System (FIG. 3) |
| 101 | register pod |
| 102 | memory pod |
| 103 | clock module |
| 104 | system supervisor pod |
| 105 | instruction execution sequencer pod |
| 106 | path distributor pod |
| 107 | system hollow core tower |
| 108 | stand |
| 109 | right diagonal brace |
| 110 | left diagonal brace |
| 111 | base connector plate |
| 112 | right rear diagonal brace |
| 113 | right front foot |
| 114 | (unused) |
| 115 | semaphore sender (FIG. 4) |
| 116 | sender input conduit |
| 117 | semaphore receiver |
| 118 | receiver output conduit |
| 119 | semaphore line pair |
| 120 | system flow indicating arrow (FIG. 5) |
| 121 | antique style oak wood trim |
| 122 | (unused) |
| 123 | particle elevator sub-system |
| 124 | elevator feed bin (FIG. 7) |
| 125 | drain |
| 126 | (unused) |
| 127 | belt system |
| 128 | roller |
| 129 | belt |
| 130 | pinch plate |
| 131 | reservoir |
| 132 | (unused) |
| 133 | register POD door |
| 134 | register POD Y re-combiner |
| 200 | CM-2 Decimal Computer System (FIG. 1 and FIG. 10) |
| 201 | CM-2 tower |
| 202 | Clock unit |
| 203 | supervisor segments 1 through 3 |
| 204 | ROM-CORE segments |
| 205 | Execution sequencer segments |
| 206 | segment 11 |
| 207 | segment 11 interior |
| 210 | data semaphore sender |
| 211 | data semaphore receiver |
| 214 | WRITE BUS input connector |
| 216 | READ BUS input connector |
| 218 | WRITE BUS output connector |
| 220 | READ BUS output connector |
| 230 | register TEN-POD block |
| 250 | Experimenter's Rig |
| 252 | WRITE BUS catch-bin |
| 254 | READ BUS catch-bin |
| 300 | Hourglass Digital Demonstrator System 300 |
| REF.# | ITEM |
| 400 | binary flip-flop assembly, RTW type |
| 402 | wheel assembly |
| 403 | back face |
| 404 | housing, flip-flop 400 |
| 405 | (unused) |
| 407 | hose receptacle stop shoulder |
| 408 | front housing face |
| 409 | conduit receptacle |
| 410 | pivot bearing element |
| 411 | (unused) |
| 412 | front partition wall |
| 413 | flared shoulder |
| 414 | READ segment front circular disc for read |
| 416 | gap for moving wheel assembly |
| WRITE SECTION: | |
| 418 | left stop wall |
| 419 | housing halves bonding seam |
| 420 | SET inlet |
| 421 | right stop wall |
| 422 | SET outlet |
| 423 | left side path restrictor |
| 424 | partition wall |
| 425 | mounting screw hole |
| 426 | left hand WRITE section raceway indicator arrow |
| 427 | ledge problem area in outlet 409 funnel corner |
| 428 | RESET inlet |
| 430 | RESET outlet |
| 431 | steel weight plug |
| 432 | right side WRITE section raceway |
| 433 | WRITE segment deflector vane (not functional) |
| 434 | left paddle |
| 435 | phantom line vane direction indicator |
| 436 | right paddle |
| READ SECTION: | |
| 440 | READ-SYNC strobe input |
| 442 | READ outlet for Q-NOT |
| 443 | middle separator wall |
| 448 | READ deflector vane (includes 450 and 452) |
| 450 | left deflector side of vane 448 |
| 451 | READ left side raceway |
| 452 | right deflector side of vane 448 |
| 453 | READ right side raceway |
| 454 | READ-Q outlet (Q-TRUE) |
| 455 | READ layer right side raceway path restrictor |
| LOGICAL LAYER DESIGNATORS: | |
| 456 | T, or TOGGLE type segment or layer |
| 458 | R, or READ type segment or layer |
| 460 | W, or WRITE type segment or layer |
| TOGGLE SECTION: | |
| 462 | left side deflector |
| 464 | right side deflector for TOGGLE |
| 465 | outlet for Q-NOT (Q-N) |
| 466 | left side paddle for TOGGLE |
| 467 | TOGGLE deflector vane (includes 462 and 464) |
| 468 | right side paddle for TOGGLE |
| 469 | outlet for Q-TRUE (Q-P) |
| 470 | TOGGLE disk element |
| 471 | TOGGLE input or inlet |
| DATA TRANSFER SECTION: | |
| 472 | generic interconnect hose segments of various lengths |
| 473 | steel ball of typical 4 mm. size |
| 474 | first or upper flip-flop stage (experimenter's rig) |
| 475 | double hose pair |
| 476 | second, or lower flip-flop stage (experimenter's rig) |
| 477 | mounting bracket |
| 478 | first stage Q-NOT data output conduit hose |
| 479 | first stage READ inlet hose (READ-SYNC) |
| 480 | first stage Q-TRUE data output conduit hose |
| 481 | second stage default reset hose |
| 482 | optional third flip-flop stage |
| 483 | drain or catch-pan |
| 484 | second stage Q-NOT output conduit hose |
| 486 | second stage Q-TRUE output conduit hose |
| 488 | optional third flip-flop stage (experimenter's rig) |
| 490 | WRITE BUS input (2 bit) |
| 491 | (unused) |
| 492 | first stage carry output conduit hose |
| 493 | (unused) |
| 494 | READ BUS input (2 bit) |
| 496 | READ BUS output (2 bit) |
| 498 | DE-MUX for control or data selection |
| 500 | DEMUX for WRITE or READ selection |
| 501 | INC input for (2 bit) |
| 502 | CLEAR signal for register 600 |
| 504 | CLOCK UP (INC), (4 bit) |
| 506 | WRITE BUS (4 bit) |
| 508 | SELECT signal |
| 510 | READ BUS input (4 bit) |
| 514 | chained outputs |
| 516 | READ output BUS |
| 517 | Interim four bit BUS |
| 518 | Incoming multiplexed data BUS |
| 600 | integrated four-bit register with MUX-BUS interface |
| 700 | decimal register, FIG. 11 |
| 701 | fillet between shaft and tab |
| 702 | right side bracket |
| 703 | left side bracket |
| 704 | WRITE cavity |
| 705 | READ cavity |
| 706 | WRITE BUS |
| 707 | READ selection (geometric) column |
| 708 | ball path deflection region |
| 709 | shaft #5 pivot hole |
| 710 | top-most shaft |
| 711 | housing back panel |
| 718 | shaft #2 reset tab |
| 720 | Table-Top Demonstrator, FIG. 13 |
| 721 | integer number scale, four state |
| 723 | duct opening, integer zero (#0) |
| 724 | display wheel, FIG. 13c |
| 725 | mask |
| 726 | lens |
| 727 | front face plate |
| 728 | flow-path arrow for WRITE |
| 729 | flow-path arrow for READ |
| 730 | left machine screw hinge |
| 731 | right machine screw hinge |
| 734 | shaft end neck-down |
| 735 | left-side plate |
| 736 | reset tab |
| 737 | reset tab |
| 738 | overturn tab |
| 739 | overturn tab |
| 740 | master RESET tab |
| 741 | diverter tab, selected position |
| 742 | ducts |
| 743 | WRITE inlets |
| 744 | WRITE chain outlets |
| 745 | conduit extensions |
| 746 | open position READ diverter with clear tab 809 |
| 747 | closed position READ diverter with clear tab 809 |
| 748 | inlet array, FIG. 14 |
| 749 | READ outlet array |
| 750 | back cavity |
| 751 | front cavity |
| 752 | guide ramp, FIG. 16a |
| 753 | tab |
| 754 | housing back panel |
| 755 | duct opening for integer #2 signal |
| 756 | READ-SYNC conduit |
| 757 | READ SYNC outlet duct |
| 758 | conduit slip cover (thin sheet) |
| 759 | READ diverter tab in un-selected position |
| 760 | upper sender Register 700, Data Transfer, FIG. 17 |
| 762 | lower receiver Register 700 |
| 763 | system READ-SYNC signal |
| 764 | System Controller |
| 765 | Data Transfer BUS |
| 766 | discard Y BUS combiner |
| 767 | data transfer modified decimal BUS |
| 768 | free-fall snubber vane |
| 770 | generic interconnection conduit hose, FIG. 18b |
| 771 | modified data transfer BUS |
| 772 | upper sending Register 720 |
| 773 | second upper sending register (for FIFO) |
| 774 | lower receiving Register 720 |
| 775 | steel ball |
| 776 | upper register READ-SYNC |
| 777 | System Controller |
| 778 | lower register READ-SYNC |
| 779 | Y combiner |
| 780 | Data transfer BUS (four-state) |
| 782 | through port-hole for READ conduit |
| 801 | raw grid plate |
| 805 | first WRITE BUS |
| 806 | second WRITE BUS |
| 807 | READ-SYNC signal conduit |
| 809 | overturn tab on READ diverter 746 |
| 810 | read and clear register 810 (using 720 housing) |
| 812 | upper or first FIFO register stage (register 810) |
| 813 | second FIFO register stage (register 810) |
| 814 | data receiver register (register 810) |
| 815 | common sub-system data transmission BUS |
| 820 | BUS sequencer stage |
| 821 | stage READ input BUS (row) |
| 822 | unused input row in grid plate |
| 825 | stage chain output |
| 826 | stage first separated output BUS (row) |
| 827 | selection conduit |
| 828 | select actuator tab |
| 829 | chained data BUS |
| 830 | DE-MUX shaft assembly (4 state) |
| 831 | decade 2X back plate output (4 state) |
| 832 | decade 3X bottom output (4 state) |
| 838 | WRITE input BUS |
| 839 | pulley pair with band |
| 840 | BUS SWITCH MODULE (decimal) |
| 841 | DE-MUX read and clear tab |
| 842 | front cavity |
| 843 | selecting tab for top shaft (logical #0) |
| 844 | back cavity |
| 845 | reset tab for shaft logical #5 |
| 846 | DE-MUX cavity |
| 847 | Diverter tab for shaft logical #5 |
| 848 | pivoting DE-MUX shaft assembly |
| 850 | front face plate |
| 851 | middle plate |
| 852 | back grid plate array |
| 853 | right side plate |
| 854 | top bracket plate |
| 855 | selection pen |
| 856 | bottom output grid array, or bracket plate |
| 857 | elastic band |
| 858 | Row 0 BUS conduits |
| 859 | BUS identifier lables |
| 860 | BUS ENCODER (100 to 10) |
| 862 | encoder read-sync input |
| 864 | wide BUS free-fall volume |
| 880 | BUS COMBINER |
| 900 | (unused) |
| 901 | generic WIDE-BUS frame (only) |
| 902 | BUS narrow-neck |
| 903 | multiplexed input BUS (MUX-BUS) |
| 904 | ENCODER opaque funnel |
| 905 | semi-circular header |
| 906 | ENCODER frame entire assembly half |
| 907 | DECODER SELECT input |
| 908 | DECODER frame entire assembly half |
| 909 | WIDE-BUS input header |
| 910 | integer number scale (0 through 99) |
| 912 | ENCODER conduit hose for integer zero |
| 914 | ENCODER conduit hose for integer 24 |
| 916 | conduit bundle narrow or neck-down |
| 920 | DECODER WIDE-BUS header |
| 922 | DECODER opaque funnel |

### Implications

### Comparisons of embodiments

Binary components, for operations with CM-1 computer concepts will now be compared with decimal components, for operations with CM-2 computer concepts.

1. The binary wheel flip flop, as an elemental device, is left and right symmetrical in both construction and in operation. The pivoting shaft/lever assembly as an elemental device is not symmetrical. Instead, there is a left side, un-select pathway for a signal and there is a right side select pathway for a signal. By stacking these elemental shaft/lever assemblies there will be a left side un-select pathway and then a multiple of select pathways lined up towards the right side.

An interesting operating feature of the decimal register 700 is that this left side un-select pathway guides a signal which is still considered to be a non-numeric clock impulse, which is what it arrived as. Eventually, of course, the signal does reach one selected pathway and it is then that the clock becomes a simultaneous clock plus data impulse. One option for the decimal digit register is to continue the channel for this un-select signal through to an output, called NIL, which indicates an in-active or empty state condition.

Usually, in electronics, this dual function signal emerging from one of the selected state outputs is not seen in combined form of clock with data. This is simply an impulse form of signaling which could be argued as being in the base one numbering system. As in any base, larger numbers are built by combinations of signals, loosely called bits. Generally, a signal is presented in each state form until all of the alphabet of the applicable base is used, and then another signal is tacked on. For example, in binary electronics a signal is presented in a logical zero static voltage state and a clock is presented on another wire or line. Then, for a transfer of a logical one, a ones static voltage state is presented on the same wire, again along with a qualifying clock on the clock wire or line.

This is base two number system operation. To encode numbers larger than 0, or 1, additional signal lines or wires are added. For binary this has an effect of giving each higher bit a weight based on the familiar power of twos, and gives a conventional multiple bit binary bus an exponential characteristic.

The discrete signal impulse bus of the mechanical computer is actually operating in base one, due to the simultaneous presence of the clock with the physical signal which takes up one state. In other words, a bit, or more correctly just a signal, is either in-active or active and only one of any set of bits is active at a time. The weight of each base one bit increases linearly rather than exponentially. This is actually an advantage in local processing because it gives easy access to each integer value and there is no encoding. Thus each integer value can be accessed as one signal, rather than by referencing all bits as a set. Of course, all bits must obey the mutually exclusive principal such that one and only one signal is selected at a time.

This discrete bus operation has some penalties. For example one decimal digit requires ten signal lines, whereas a conventional binary bus only requires four signals (plus an extra line for the clock.) It is to be seen however, that many conventional bus arrangements are eight bits and so the comparison is not so different. Also, many conventional computers will use a packing arrangement to put two such digits into an eight bit byte, but this is an additional process of packed BCD or binary coded decimal.

What is claimed is;

1. For mechanical Computer Sub-systems with DECIMAL operating capability:
A method of positional encoded signal transmission using a singular moving particle mechanical impulse means moving from device to device through a mechanical BUS means, and where sources of such mechanical BUS impulses comprise one or more signal originators mixed by separately merging into each defined signal path, and with this said data transfer method comprising;
(a.) providing one or more synchronizing signal origination means that dispense a singular field-accelerated particle with a motion vector, and main path, principally induced by the field, including providing means for conflux signal mixing for the case of multiple origination sources;
(b.) providing in each said origination means a secondary use of the synchronizing signal by positional variation of dispensing causing multiple parallel path differentiation of the signal for transmitting useful information, and with the positional variation substantially orthogonal (normal) to the main path of travel;
(c.) providing a general mechanical computer logic element means and providing positional (spatial) differentiated inlet and outlet path means on said logic element means such that in all cases a moving particle impulse means will enter, interact, and exit as a flow-through function, and subsequently continue transit;
(d.) providing a structure means principally aligned with said accelerating field for aligned attachment of each of said origination means and said logic element means to said accelerating field, and to each other;
(e.) providing basic structural alignment and serial connection relationships between said signal origination means, said transmission path, and said logic means, such that said origination means may usefully encode and transmit the impulse, which is then maintained during transit by the conduit means, and such that useful reception and differentiation of the impulse can be made by said logic means;
(f.) providing a conduit means for unconditional guiding of said impulse for simple offsets in which signal meanings are maintained between system components, and for useful logical conversions, in which general predetermined signal connections are made;
(g.) providing internally within all device components a means for complying with a unifying rule set for construction and external operation, these being defined under the immediately following claim subsection rule list, using a novel external system rule set called DISCRETE BUS;
(1.) a DISCRETE BUS rule for singular, mutually exclusive, moving particle transmission to a device in one main down-field direction and specifying a linear set of integer values (scalers), corresponding with quantized segments of a spatial displacement encoding vector orthogonal to the main transmission direction, and with use of said secondary direction axis having a shorthand term of positional encoded WRITE data BUS;
(2.) a DISCRETE BUS rule for initiating data outlet transmission for a READ operation from a device using a single synchronizing inlet strobe signal stimulus clock, called READ-SYNC where said resulting device data transmission has the said positional encoded form, and furthermore clarifying that definition of said READ-SYNC clock, being a system control, does not conflict with the statement that the BUS DATA WRITE method is self-clocking;
(h.) an initiating first action step in which said originating means dispenses a particle, in said positional encoded form, to said mechanical bus means;
(i.) a second step, a resulting guided propagation, which is movement of the particle, mechanically independent from the dispensing action, in which the particle mass-impulse transits both according to the main acceleration induced path and according to any secondary normal axis path but with any such secondary change not altering the ultimate encoded integer identity of such positional encoded data transmission;
(j.) a third step, of resulting propagation through the logic means and in which a processing function occurs, chosen from;
(1.) modification of positional encoding of the input impulse by creating a newly encoded output BUS impulse, re-using the same said singular moving particle both as a virtual synchronizing clock, and as an encoded data digit and where such internal logical modification processing includes the mathematical identity function having no logical change where said output encoding vector is identical to the said input vector but translated spatially, according to device housing spatial variations of offsets of outlets, and with said spatial translation including the case for zero translation offset in the directions normal to the main travel path and with said unchanged logical definitions on the BUS moving data path forcing a continuous re-definition of the relative axis origin, along each infinitesimal segment of the BUS transmission path;
(2.) modification of internal positional state encoding of the logic means, where such encoding affects future function response to the next arriving BUS transmission;
(k.) a final action step of resulting emission, where said logic means dispenses the said newly encoded BUS impulse for subsequent transmission, and with such dispensing allowing said logic to constitute yet another said origination means in further serial chaining to additional multiple serial logic means;
whereby
the DISCRETE BUS method features discrete sampling of a continuous analog range, by the inclusion of the separator walls of the conduit means, and operation of the bus is possible by eliminating said signal separator walls for temporary analog data transmission which can be re-quantized,
and whereby
the conclusion may be drawn that the said impulsive and positional encoded nature make the signal simultaneously both self-clocking and multi-state, where comparatively, the conventional electronic clocked binary method presents one of two voltage states on one connection/transmission wire and then a separate clock impulse, also having two states, on a second connection/transmission wire, and the conclusion is drawn that the mechanical computer DISCRETE BUS operates as a set of signals, each in BASE ONE, for providing operation in any other number base by grouping of said set of signals.

2. For the data transmission method and BUS interface of claim #1, where a novel signal is added to the DISCRETE BUS signal set definition, called SELECT, and where SELECT is for initializing a device module, with an arrival of a first transmission of SELECT, a means for the time-multiplexed differentiation of a second from subsequent arriving DISCRETE BUS transmissions, and where said second arriving transmission initiates internal actions of state changes for processing, and also including a separate internal mode switch to data transparent mode, by serial re-use of the said arriving second transmission which cancels the initial internal state produced by SELECT and where subsequent arriving transmissions utilize such variable internal device states for varied functions, whereby such grouping or bundling of DISCRETE BUS signals with a SELECT signal is called a MUX-BUS;
and whereby
the claim is made that said internal mode switch, after a second arriving transmission is facilitated by the novel DISCRETE BUS feature of having one and only one BUS signal, and using a read and clear functionality depending on said mutually exclusive single signal definition, as opposed to a parallel data BUS which would have a disadvantage of not being perfectly time-coordinated across all binary bits;
whereby, in conclusion of this claim,
said MUX-BUS constitutes an operating and sequencing arrangement where a first variable (N), (second transmission, after SELECT) configures the functional response (1 of N) of a device to subsequent one or more variables and whereby some non-limiting examples of said varied device functions (1 of N varieties) are chosen from the following list of varieties:
(1.) an internal device processing function selection of INCREMENT, of a single variable X, which arrives as the third transmission, with a resulting output of the answer value (X+1) as a DISCRETE BUS transmission;
(2.) an internal device processing function selection of MULTIPLY, of two subsequent arriving variables (X,Y), the third and fourth arriving BUS transmissions;
(3.) an internal device processing function of COSINE, where two subsequent arriving decimal digits are used internally as time-multiplexed high (decade) and low (units) digit inputs (or HL), in the range of 0 through 99 degrees and where said digit inputs constitute literally an input to create a BASE 100 number input value, or often called RADIX 100;
(4.) an internal device path addressing processing, or physical motor function of BUS SWITCH 840, where the function specifying N gives the data transparent commutator position resulting from said motor internal re-positioning, for sending multiple subsequent arriving general DISCRETE BUS transmissions out of 1 of N output BUS ports;
(5.) an alternate defined similar use of BUS SWITCH 840, where the two said subsequent arriving transmissions after SELECT are (X,Y) for a two axis positional encoded output, physically in an (X,Y) array, for use where X internally determines the ROW BUS output, as a BUS port, and the Y value commutated to said BUS port inherently determines the COLUMN output, by virtue of the Y value transmission DISCRETE BUS form having a linear positional encoding;
(6.) another alternately defined similar use of BUS SWITCH 840 where, also referring back to example #3, the 100 input values obtained from the switch are then output arranged physically linearly to create another said defined positional encoded DISCRETE BUS, in BASE 100;
(7.) a separate data READING access feature for reading two digit processing answer results from a standard MUX-BUS device, to create by originating a MUX-BUS defined output where said originated second and third MUX-BUS transmissions arriving at the device have the novel feature that both are READ requests, re-using said DISCRETE BUS READ-SYNC clocking signal of claim #1, and where physically said transmissions are identical to the said data WRITING (to a target device) transmissions, within this said MUX-BUS operating definition;
and furthermore,
the result of WRITING these said MUX-BUS inputs SELECT, first READ-SYNC, and second READ-SYNC, is that the two READ output transmissions (from said target device) take place in partial MUX-BUS form, with the advantageous feature that if another separate SELECT had been first sent into the input BUS of the second target device, from an auxiliary origination means, then the next serial target, the second target device will be operated with another MUX-BUS, having received the proper sequence of transmissions from the combined origination of the said auxiliary and first device and thus each of the above target and second target device have the identical plug compatibility as MUX-BUS input and MUX-BUS output and thus require no other controlling signals for the said two digit data transmissions;
and furthermore, a useful simplification allows said SELECT to be chained out from the first target device which allows said first target device, completely controlled by the said originator, to then completely control the second target device means;
(8.) a more complete variation for creating one complete MUX-BUS output of example #7, is an example device MUX-BUS defined output BUS where means for device output sourcing of said MUX-BUS SELECT signal exists, by re-use of the second arriving transmission (N) to the first device to originate another SELECT, for a completely serial string of what is called MUX-BUS PLUG-ABLE modularity;
(9.) a more complete variation for creating multiple complete MUX-BUS outputs in example #4, an example of device (MUX-BUS defined) multiple output BUSSES where means for device output sourcing of said MUX-BUS SELECT exists, by re-use and collated distribution of each term of the said second arriving transmission N individually to each corresponding said individual BUS output; and furthermore with all previously said in this claim defining a method for PLUGABLE interfacing as a BUS to COMPONENT to BUS to COMPONENT serial structure arrangement (as an advantage over the arrangement of controller connected directly to each random system component, in a star-like pattern).

3. For mechanical Computer Sub-systems, with BINARY operation:
A method of positional encoded signal transmission using a singular moving particle mechanical impulse means moving from device to device through a mechanical BUS means comprising;
(a.) providing a synchronizing signal origination means that dispenses a singular field-accelerated particle with a motion vector, and main path, principally induced by the field;
(b.) providing in said origination means a secondary use of the synchronizing signal by positional variation of dispensing causing multiple parallel path differentiation of the signal for transmitting useful information, and with the positional variation substantially orthogonal (normal) to the main path of travel;
(c.) providing a general mechanical computer logic element means and providing positional (spatial) differentiated inlet and outlet path means on said logic element means such that in all cases a moving particle impulse means will enter, interact, and exit as a flow-through function, and subsequently continue transit;
(d.) providing a structure means principally aligned with said accelerating field for aligned attachment of each of said origination means and said logic element means to said accelerating field, and to each other;
(e.) providing basic structural alignment and serial connection relationships between said signal origination means, said transmission path, and said logic means, such that said origination means may usefully encode and transmit the impulse, which is then maintained during transit by the conduit means, and such that useful reception and differentiation of the impulse can be made by said logic means;
(f.) providing a conduit means for unconditional guiding of said impulse for simple offsets in which signal meanings are maintained between system components, and for useful logical conversions, in which general predetermined signal connections are made;
(g.) providing internally within all device components a means for complying with a unifying rule set for construction and external operation, these being defined under the immediately following claim subsection rule list, using a novel external system rule set called MECHANICAL BINARY BUS:
(1.) a rule for conventional parallel binary coded data transmission to a device using a set of moving particles, to a device where each separate binary code weighted moving particle channel (or guiding conduit) contains a singular moving particle for each instance of a binary one (or set) bit, and with such parallel set of possible ones in the transmitted binary word being reasonably time-coordinated relative to general device and system timing requirements, and;
(2.) a rule for initiating data transmission from devices using a parallel set of strobe signals where such resulting data transmission has the above BINARY-CODED data form.
